(19) United States
(12) Patent Application Publication
(10) Pub. No.: US 2026/0221491 A1
(43) Pub. Date: Jul. 30, 2026

(54) RECHARGEABLE LITHIUM METAL BATTERY SYSTEM

(71) Applicant: Pure Lithium Corporation, Chicago, IL (US)

(72) Inventors: Anthony Childress, Chicago, IL (US); Hadley O’Malia, Chicago, IL (US); Pavithra Shanthi, Chicago, IL (US); Lincoln Miara, Chicago, IL (US); Brandon Day, Chicago, IL (US); Emily Kelley, Chicago, IL (US); Emilie Bodoin, Chicago, IL (US); Donald R. Sadoway, Chicago, IL (US); Krystal Lee, Chicago, IL (US)

(21) Appl. No.: 19/576,959

(22) Filed: Mar. 24, 2026

Related U.S. Application Data
(63) Continuation of application No. PCT/US2025/055111, filed on Nov. 12, 2025.
(60) Provisional application No. 63/719,805, filed on Nov. 13, 2024.
(60) Provisional application No. 63/725,800, filed on Nov. 27, 2024.
(60) Provisional application No. 63/730,330, filed on Dec. 10, 2024.

(51) Int. Cl. H01M 10/42; H01M 4/02; H01M 4/48; H01M 4/58; H01M 4/587; H01M 10/0525; H01M 10/0568; H01M 10/0569

(52) U.S. Cl. CPC H01M 10/0525; H01M 4/382; H01M 4/48; H01M 4/5825; H01M 4/587; H01M 10/0568; H01M 10/0569; H01M 2300/0037

(57) ABSTRACT

In some aspects, the present disclosure provides the use of specific carbon nanostructures as hosts for lithium. In certain aspects, the present disclosure provides a rechargeable energy source system comprising the lithium metal electrode. In certain aspects, the present disclosure provides an electrolyte composition for rechargeable energy source. The present disclosure also relates to a method of operating a system for lithium extraction from brine.

### CROSS-REFERENCE

This application is a continuation of International Application No. PCT/US2025/055111, filed Nov. 12, 2025, which claims the benefit of U.S. Provisional Application No. 63/719,805, filed Nov. 13, 2024, U.S. Provisional Application No. 63/730,330, filed Dec. 10, 2024, and U.S. Provisional Application No. 63/725,800, filed Nov. 27, 2024, each of which application is incorporated herein by reference in its entirely.

### BACKGROUND

Lithium metal batteries are regarded as one of the promising next-generation rechargeable energy source systems, since lithium metal possesses the lowest density and the highest theoretical specific capacity among metallic anode materials. However, despite these advantages, the practical commercialization of lithium metal batteries has been hindered by various engineering challenges, including the instability of the lithium metal surface, uncontrolled dendrite growth, and poor interfacial compatibility with conventional electrolytes. Accordingly, there remains a need for improved electrode structures and electrolyte compositions capable of enhancing the stability, safety, and cycle life of lithium metal batteries.

Various strategies have been developed to improve the performance of anode materials in lithium batteries. One approach involves using silicon-based anodes instead of conventional carbon-based materials. Silicon-based anodes offer benefits such as faster charging rates. However, a significant drawback of this strategy is the electrochemical behavior of lithium ions. Integrating silicon in the anode increases the potential range at which lithium ions can insert into the anode's structure. For lithium metal batteries, the wider intercalation range is not advantageous, as it requires more energy to facilitate the process. There is a need for new approaches to address the limitations of existing methods for enhancing the performance of anode materials in lithium batteries.

The lithium metal battery is considered to be the pinnacle of rechargeable energy source systems, as lithium metal is the lightest and has the highest density of electrochemical energy among metals in the periodic table. However, the commercialization of lithium metal batteries has been hindered by engineering challenges-lithium metal electrodes were often plagued with dendrite formation. Dendrite formation can cause concerns including cycling stability and safety. Dendrites can lead to capacity loss of a lithium metal battery through multiple charge discharge cycling when dendrites can break off from the lithium metal electrode and become electrically isolated. Dendrites can also lead to safety concerns because dendrites may short-circuit the battery by penetrating the separator between the negative and positive electrode, igniting components of the battery by the sudden generation of heat. An important factor that can influence the cycling stability and safety of a lithium metal battery is the chemical composition of the electrolyte.

In the lithium electrodeposition process from a brine solution, water present in the brine poses challenges. It can react with lithium to form lithium hydroxide and hydrogen, which can not only lead to wastage but also create safety concerns. Furthermore, water can interfere with the electrodeposition process by leading to the formation of a solid-electrolyte interphase (SEI) layer on the lithium electrode. Although this layer can shield lithium from direct contact with the electrolyte, preventing potential side reactions, it can degrade over time, reducing the efficiency of the process. To address this, focus has been placed on the dehydration of the brine to achieve water-free lithium deposition, thereby enhancing safety and efficiency of lithium production. This necessitates a combination of innovative membrane technologies, which are crucial to developing efficient and safe methods for lithium extraction from brine. Despite efforts to tackle this issue, there remains an unmet need to overcome inherent limitations.

### SUMMARY

In certain aspects, this disclosure provides a rechargeable energy source system. In some embodiments, the rechargeable energy source system comprises a positive electrode and a negative electrode comprising a plurality of carbon particles, wherein the plurality of carbon particles comprises a corrugated surface; wherein the rechargeable energy source system is configured to (1) intercalate a plurality of lithium ions into the plurality of carbon particles and (2) plate the plurality of lithium ions as lithium metal on the corrugated surface of the plurality of carbon particles from an electrolyte. In some embodiments, the rechargeable energy source system comprises a positive electrode and a negative electrode comprising a plurality of carbon particles, wherein the plurality of carbon particles comprises a corrugated surface and has a multimodal distribution of sizes; wherein the rechargeable energy source system is configured to (1) intercalate a plurality of lithium ions into the plurality of carbon particles and (2) plate the plurality of lithium ions as lithium metal on the corrugated of the plurality of carbon particles from an electrolyte. In some embodiments, the rechargeable energy source system comprises a positive electrode comprising a transition metal phosphate and a negative electrode comprising a plurality of carbon particles, wherein the plurality of carbon particles comprises a corrugated surface; wherein the rechargeable energy source system is configured to (1) intercalate a plurality of lithium ions into the plurality of carbon particles and (2) plate the plurality of lithium ions as lithium metal on the corrugated of the plurality of carbon particles from an electrolyte. In some embodiments, the rechargeable energy source system comprises a positive electrode that is substantially free of lithium when the rechargeable energy source system is in a charged state and a negative electrode comprising a plurality of carbon particles, wherein the plurality of carbon particles comprises a corrugated surface, wherein the rechargeable energy source system is configured to (1) intercalate a plurality of lithium ions into the plurality of carbon particles and (2) plate the plurality of lithium ions as lithium metal on the corrugated of the plurality of carbon particles from an electrolyte. In some embodiments, the rechargeable energy source system comprises a positive electrode and a negative electrode comprising a plurality of carbon particles, wherein the plurality of carbon particles comprises a corrugated surface, wherein the rechargeable energy source system is configured to maintain the capacity when the rechargeable energy source system is cycled for at least 1000 cycles, and wherein the rechargeable energy source system is configured to (1) intercalate a plurality of lithium ions into the plurality of carbon particles and (2) plate the plurality of lithium ions as lithium metal on the corrugated of the plurality of carbon particles from an electrolyte. In some embodiments, the rechargeable energy source system comprises a positive electrode, an electrolyte comprising lithium ions, and a negative electrode comprising lithium metal and a plurality of carbon particles, wherein the plurality of carbon particles comprises a corrugated surface, and wherein the negative electrode comprises an areal capacity 2-5 mAh/cm²; wherein the rechargeable energy source system is configured to (1) intercalate a plurality of lithium ions into the plurality of carbon particles and (2) plate the plurality of lithium ions as lithium metal on the corrugated of the plurality of carbon particles from an electrolyte.

In some embodiments, the rechargeable energy source system comprises a positive electrode; and a negative electrode comprising a plurality of carbon particles, wherein the plurality of carbon particles comprises a corrugated surface and comprises a plurality of nanosheets resembling flower petals and wherein each of the plurality of carbon particles has a diameter of about 400 nm to about 1400 nm; wherein the rechargeable energy source system is configured to (1) intercalate a plurality of lithium ions into the plurality of carbon particles and (2) plate the plurality of lithium ions as lithium metal on the corrugated of the plurality of carbon particles from an electrolyte. In some embodiments, the rechargeable energy source system comprises a positive electrode and a negative electrode comprising a plurality of carbon particles, wherein the plurality of carbon particles comprises a corrugated surface and comprises a plurality of nanosheets resembling flower petals and has a multimodal distribution of sizes; wherein the rechargeable energy source system is configured to (1) intercalate a plurality of lithium ions into the plurality of carbon particles and (2) plate the plurality of lithium ions as lithium metal on the corrugated of the plurality of carbon particles from an electrolyte. In some embodiments, the rechargeable energy source system comprises a positive electrode comprising a transition metal phosphate and a negative electrode comprising a plurality of carbon particles, wherein the plurality of carbon particles comprises a corrugated surface and comprises a plurality of nanosheets resembling flower petals; wherein the rechargeable energy source system is configured to (1) intercalate a plurality of lithium ions into the plurality of carbon particles and (2) plate the plurality of lithium ions as lithium metal on the corrugated of the plurality of carbon particles from an electrolyte. In some embodiments, the rechargeable energy source system comprises a positive electrode that is substantially free of lithium when the rechargeable energy source system is in a charged state; and a negative electrode comprising a plurality of carbon particles, wherein the plurality of carbon particles comprises a corrugated surface and comprises a plurality of nanosheets resembling flower petals; wherein the rechargeable energy source system is configured to (1) intercalate a plurality of lithium ions into the plurality of carbon particles and (2) plate the plurality of lithium ions as lithium metal on the corrugated of the plurality of carbon particles from an electrolyte. In some embodiments, the rechargeable energy source system comprises a positive electrode and a negative electrode comprising a plurality of carbon particles, wherein the plurality of carbon particles comprises a corrugated surface and comprises a plurality of nanosheets resembling flower petals; wherein the rechargeable energy source system is configured to maintain the capacity when the rechargeable energy source system is cycled for at least 1000 cycles, and wherein the rechargeable energy source system is configured to (1) intercalate a plurality of lithium ions into the plurality of carbon particles and (2) plate the plurality of lithium ions as lithium metal on the corrugated of the plurality of carbon particles from an electrolyte. In some embodiments, the rechargeable energy source system comprises a positive electrode, an electrolyte comprising lithium ions, and a negative electrode comprising lithium metal and a plurality of carbon particles, wherein the plurality of carbon particles comprises a corrugated surface and comprises a plurality of nanosheets resembling flower petals and wherein the negative electrode comprises an areal capacity of 2-5 mAh/cm²; wherein the rechargeable energy source system is configured to (1) intercalate a plurality of lithium ions into the plurality of carbon particles and (2) plate the plurality of lithium ions as lithium metal on the corrugated of the plurality of carbon particles from an electrolyte. In some embodiments, the rechargeable energy source system comprises: a positive electrode; and a negative electrode comprising a network of hard carbon nanosheets; wherein the rechargeable energy source system is configured to (1) intercalate a plurality of lithium ions into the network of hard carbon nanosheets and (2) plate the plurality of lithium ions as lithium intersecting metal on a surface of the network of hard carbon nanosheets from an electrolyte.

In some embodiments, the network of hard carbon nanosheets comprises a shape of intersecting nanosheets. In some embodiments, the plurality of carbon particles comprises hard carbon. In some embodiments, the plurality of carbon particles or the network of hard carbon nanosheets comprises amorphous carbon. In some embodiments, the plurality of carbon particles or the network of hard carbon nanosheets comprises nitrogen. In some embodiments, each of the plurality of carbon particles or each of the network of hard carbon nanosheets is spherical in morphology. In some embodiments, a diameter of the each of the plurality of carbon particles or the each of the network of hard carbon nanosheets ranges from about 400 to about 1400 nm. In some embodiments, the diameter of the each of the plurality of carbon particles or the each of the network of hard carbon nanosheets ranges from about 800 to about 950 nm.

In some embodiments, each of the plurality of carbon particles or the each of the network of hard carbon nanosheets has a multimodal distribution of sizes. In some embodiments, the multimodal distribution of sizes comprises a bimodal, a trimodal, or a quadmodal distribution.

In some embodiments, the positive electrode comprises a transition metal phosphate. In some embodiments, the transition metal phosphate comprises LiFePO₄.

In some embodiments, the positive electrode is substantially free of lithium when the rechargeable energy source system is in a charged state.

In some embodiments, the positive electrode comprises vanadium-based compounds. In some embodiments, the positive electrode comprises VₓO_{y}. In some embodiments, the positive electrode comprises VₓO_{y}F_{z}. In some embodiments, the positive electrode comprises at least one of: V₆O₅F₁₉, V₃OF₁₁, VO₂F, VOF₃, VPO₄F, LiV₃OF₁₁, Mn₃V(PO₄)₆, V₆O₅F₁₉, V₂(PO₄)₃, LiVOF₄, LiV(OF)₂, LiV(OF)₂, MnVP₂(O₄F)₂, V₄O₇F₅, LiV₃CoO₁₀, VPO₅, VFeP₂(O₄F)₂, TiVO₄, LiTiV₃O₁₀, VFeP₂(HO₅)₂, Li₂VOF₅, MnV₄O₁₂, VBO₄, LiV₂P₂(O₄F)₂, LiV₃CrO₈, V₄(OF₃)₃, LiV₄O₈, V(CO₃)₂, LiV₅O₁₀, VCuO₄, or VCo₃O₈.

In some embodiments, the positive electrode comprises MₓV₂O₅, wherein M comprises one or more of Li, Na, K, and Au.

In some embodiments, the negative electrode comprises an areal capacity of 2.5-3.5 mAh/cm². In some embodiments, the negative electrode comprises an areal capacity of about 3 mAh/cm².

In some embodiments, the rechargeable energy source system is configured to maintain a cycling efficiency of at least 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99% over at least 200, 300, 400, 500, 600, 700, 800, 900, or 1000 cycles when charged and discharged from 1.8 to 4 volts at a C-rate of at least 1C and a D-rate of at least 1C. In some embodiments, the rechargeable energy source system is configured to maintain a cycling efficiency of at least 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99% over at least 200, 300, 400, 500, 600, 700, 800, 900, or 1000 cycles when charged and discharged from 2.2 to 4 volts at a C-rate of at least 1C and a D-rate of at least 1C.

In some embodiments, the negative electrode is configured to provide a capacity of about 600 mAh/g to about 5000 mAh/g. In some embodiments, the negative electrode is configured to provide a capacity higher than 1000 mAh/g. In some embodiments, the negative electrode has an intercalation capacity of about 200 mAh/g to about 300 mAh/g. In some embodiments, the negative electrode has a lithium metal capacity of about 400 mAh/g to about 800 mAh/g.

In some embodiments, each carbon particle of the plurality of carbon particles comprises a plurality of indents and a plurality of apexes. In some embodiments, the plurality of carbon particles comprises a flower-like surface structure.

In some embodiments, the electrolyte comprises an ether-based solvent system. In some embodiments, the electrolyte further comprises one or more lithium salts or one or more additives. In some embodiments, the one or more lithium salts comprise lithium bis(trifluoromethane)sulfonimide (LiTFSI) or lithium bis(fluorosulfonyl)imide (LiFSI). In some embodiments, the one or more additives comprise LiNO₃. In some embodiments, the electrolyte is free of carbonate solvents.

In some embodiments, the cathode has a charge cutoff potential of 4V or less versus Li⁺/Li. In some embodiments, the cathode comprises LiFePO₄ or V₂O₅ with the full cell voltage range is 1.8 V to 4 V. In some embodiments, a current density ranges from about 0.1 mA/cm² to about 1 mA mA/cm² during charge and discharge. In some embodiments, a current density ranges from about 0.3 mA/cm² to about 0.6 mA mA/cm² during charge and discharge. In some embodiments, the current density promotes homogeneous lithium plating and stripping.

In some embodiments, the system maintains at least 85%, 90%, 95%, or 98% of its initial discharge capacity after at least 5500 charge-discharge cycles.

In some aspects, the present disclosure provides a method of operating a lithium metal battery, comprising: providing a cell comprising: a negative electrode comprising a plurality of carbon particles, wherein the plurality of carbon particles comprises a corrugated surface and/or comprises a plurality of nanosheets resembling flower petals; an electrolyte; and a positive electrode; cycling the battery within a voltage window of 1.8 V to 4 V; and applying a current density of 0.1 mA/cm² to 1 mA mA/cm² during charge and discharge. In some embodiments, the present disclosure also provides a method of operating a lithium metal battery, comprising: providing a cell comprising: a negative electrode comprising a plurality of carbon particles, wherein the plurality of carbon particles comprises a corrugated surface and/or comprises a plurality of nanosheets resembling flower petals; an electrolyte; and a positive electrode; and repeatedly cycling the cell at a current density of 0.1 mA/cm² to 1 mA/cm².

In some embodiments, the plurality of carbon particles comprises hard carbon. In some embodiments, the plurality of carbon particles comprises amorphous carbon. In some embodiments, the plurality of carbon particles comprises nitrogen. In some embodiments, each of the plurality of carbon particles is spherical in morphology. In some embodiments, a diameter of the plurality of carbon particles ranges from about 400 to about 1400 nm. In some embodiments, the diameter the plurality of carbon particles ranges from about 800 to about 950 nm.

In some embodiments, the plurality of carbon particles has a multimodal distribution of sizes. In some embodiments, the multimodal distribution of sizes comprises a bimodal, a trimodal, or a quadmodal distribution.

In some embodiments, the positive electrode comprises a transition metal phosphate. In some embodiments, the transition metal phosphate comprises LiFePO₄.

In some embodiments, the positive electrode is substantially free of lithium when the rechargeable energy source system is in a charged state.

In some embodiments, the positive electrode comprises vanadium-based compounds. In some embodiments, the positive electrode comprises VₓO_{y}. In some embodiments, the positive electrode comprises VₓO_{y}F_{z}. In some embodiments, the positive electrode comprises at least one of: V₆O₅F₁₉, V₃OF₁₁, VO₂F, VOF₃, VPO₄F, LiV₃OF₁₁, Mn₃V(PO₄)₆, V₆O₅F₁₉, V₂(PO₄)₃, LiVOF₄, LiV(OF)₂, LiV(OF)₂, MnVP₂(O₄F)₂, V₄O₇F₅, LiV₃CoO₁₀, VPO₅, VFeP₂(O₄F)₂, TiVO₄, LiTiV₃O₁₀, VFeP₂(HO₅)₂, Li₂VOF₅, MnV₄O₁₂, VBO₄, LiV₂P₂(O₄F)₂, LiV₃CrO₈, V₄(OF₃)₃, LiV₄₀₈, V(CO₃)₂, LiV₅O₁₀, VCuO₄, or VCo₃O₈. In some embodiments, the positive electrode comprises MₓV₂O₅, wherein M comprises one or more of Li, Na, K, and Au.

In some embodiments, the negative electrode comprises an areal capacity of 2.5-3.5 mAh/cm². In some embodiments, the negative electrode comprises an areal capacity of about 3 mAh/cm².

In some embodiments, the rechargeable energy source system is configured to maintain a cycling efficiency of at least 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99% over at least 200, 300, 400, 500, 600, 700, 800, 900, or 1000 cycles when charged and discharged from 2.2 to 4 volts at a C-rate of at least 1C and a D-rate of at least 1C. In some embodiments, the rechargeable energy source system is configured to maintain a cycling efficiency of at least 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99% over at least 200, 300, 400, 500, 600, 700, 800, 900, or 1000 cycles when charged and discharged from 1.8 to 4 volts at a C-rate of at least 1C and a D-rate of at least 1C.

In some embodiments, the negative electrode is configured to provide a capacity of about 600 mAh/g to about 5000 mAh/g. In some embodiments, the negative electrode is configured to provide a capacity higher than 1000 mAh/g. In some embodiments, the negative electrode has an intercalation capacity of about 200 mAh/g to about 300 mAh/g. In some embodiments, the negative electrode has a lithium metal capacity of about 400 mAh/g to about 800 mAh/g.

In some embodiments, each carbon particle of the plurality of carbon particles comprises a plurality of indents and a plurality of apexes.

In some embodiments, the electrolyte comprises an ether-based solvent system. In some embodiments, the electrolyte further comprises one or more lithium salts or one or more additives. In some embodiments, the one or more lithium salts comprise lithium bis(trifluoromethane)sulfonimide (LiTFSI) or lithium bis(fluorosulfonyl)imide (LiFSI). In some embodiments, the one or more additives comprise LiNO₃. In some embodiments, the electrolyte is free of carbonate solvents.

In some embodiments, the cathode has a charge cutoff potential of 4V or less versus Li⁺/Li. In some embodiments, the cathode comprises LiFePO₄ or V₂O₅ with the full cell voltage range is 1.8 V to 4 V.

In some embodiments, a current density ranges from about 0.3 mA/cm² to about 0.6 mA mA/cm² during charge and discharge. In some embodiments, the system maintains at least 85%, 90%, 95%, or 98% of its initial discharge capacity after at least 5500 charge-discharge cycles.

In certain aspects, the present disclosure provides an electrolyte composition comprising a plurality of solvents and a plurality of lithium salts, wherein the plurality of solvents comprises at least three solvents. In some embodiments, the present disclosure provides an electrolyte composition comprising a plurality of solvents and a plurality of lithium salts, wherein the plurality of solvents comprises at least two participating solvents and one or more non-participating solvents.

In some embodiments, the electrolyte comprises a localized high concentration electrolyte (LHCE). In some embodiments, the plurality of solvents comprises one or more participating solvents and one or more non-participating solvents. In some embodiments, the participating comprises dissolving or solvating the plurality of lithium salts. In some embodiments, the one or more non-participating solvents comprises a diluent. In some embodiments, the plurality of solvents comprises three participating solvents and one or more non-participating solvents. In some embodiments, the plurality of solvents comprises an ether. In some embodiments, the ether comprises a heterocyclic ether. In some embodiments, the heterocyclic ether comprises a heterocyclic acetal structure. In some embodiments, the heterocyclic acetal structure comprises a five-membered dioxolane ring structure. In some embodiments, the plurality of solvents comprises 1,3-dioxolane (DOL). In some embodiments, the plurality of solvents comprises an alkyl ether. In some embodiments, the alkyl ether comprises a dialkyl ether. In some embodiments, the dialkyl ether comprises a dimethyl ether (DME). In some embodiments, the plurality of solvents comprises a partially fluorinated alkyl ether. In some embodiments, the plurality of solvents comprises a partially fluorinated dialkyl ether. In some embodiments, the plurality of solvents comprises 1,1,2,2-tetrafluoroethyl-2,2,3,3-tetrafluoropropyl ether (TTE). In some embodiments, the plurality of solvents comprises a fully fluorinated alkyl ether. In some embodiments, the plurality of solvents comprises a fully fluorinated dialkyl ether.

In some embodiments, a lithium salt of the plurality of lithium salts comprises a nitrogen atom. In some embodiments, at least two lithium salts of the plurality of lithium salts comprises a nitrogen atom. In some embodiments, a lithium salt of the plurality of lithium salts comprises a non-coordinating anion. In some embodiments, at least two lithium salts of the plurality of lithium salts comprises a non-coordinating anion. In some embodiments, the non-coordinating anion comprises bis(trifluoromethane)sulfonimide (TFSI⁻) or bis(fluorosulfonyl)imide (FSI⁻).

In some embodiments, the electrolyte composition further comprises one or more additives. In some embodiments, the one or more additives comprise NO₃⁻.

In some embodiments, the plurality of solvents comprises a first solvent, a second solvent, and a third solvent. In some embodiments, the first solvent is present in an amount ranging from about 5 wt % to about 40 wt % of the electrolyte composition. In some embodiments, the first solvent is present in an amount ranging from about 15 wt % to about 25 wt % of the electrolyte composition. In some embodiments, the second solvent is present in an amount ranging from about 1 wt % to about 45 wt % of the electrolyte composition. In some embodiments, the second solvent is present in an amount ranging from about 10 wt % to about 20 wt % of the electrolyte composition. In some embodiments, the third solvent is present in an amount ranging from about 5 wt % to 70 wt % of the electrolyte composition. In some embodiments, the third solvent is present in an amount ranging from about 35 wt % to 55 wt % of the electrolyte composition.

In some embodiments, the plurality of solvents comprises DOL, DME, or TTE. In some embodiments, the first solvent is DME. In some embodiments, the second solvent is DOL. In some embodiments, the third solvent is TTE.

In some embodiments, the electrolyte is configured to promote SEI formation on an anode to prevent growth of dendrites. In some embodiments, the electrolyte includes excess solvents to maintain lithium salts in solution and prevent precipitation during cycling.

In some embodiments, the plurality of solvents is configured to decrease viscosity and improves conductivity.

In some aspects, the present disclosure also provides an electrolyte composition comprising a mixture of a localized high concentration electrolyte, a plurality of solvents, and a plurality of lithium salts. In some embodiments, the electrolyte composition comprises one or more participating solvents and one or more non-participating solvents. In some embodiments, the participating comprises dissolving or solvating the plurality of lithium salts. In some embodiments, the one or more non-participating solvents comprises a diluent. In some embodiments, the electrolyte composition comprises three participating solvents and one or more non-participating solvents.

In some embodiments, the electrolyte composition comprises an ether. In some embodiments, the ether comprises a heterocyclic ether. In some embodiments, the heterocyclic ether comprises a heterocyclic acetal structure. In some embodiments, the heterocyclic acetal structure comprises a five-membered dioxolane ring structure. In some embodiments, the electrolyte composition comprises 1,3-dioxolane (DOL). In some embodiments, the electrolyte composition comprises an alkyl ether. In some embodiments, the alkyl ether comprises a dialkyl ether. In some embodiments, the dialkyl ether comprises a dimethyl ether (DME). In some embodiments, the electrolyte composition comprises a partially fluorinated alkyl ether. In some embodiments, the electrolyte composition comprises a partially fluorinated dialkyl ether. In some embodiments, the electrolyte composition comprises 1,1,2,2-tetrafluoroethyl-2,2,3,3-tetrafluoropropyl ether (TTE). In some embodiments, the electrolyte composition comprises a fully fluorinated alkyl ether. In some embodiments, the electrolyte composition comprises a fully fluorinated dialkyl ether.

In some embodiments, a lithium salt of the plurality of lithium salts comprises a nitrogen atom. In some embodiments, at least two lithium salts of the plurality of lithium salts comprises a nitrogen atom. In some embodiments, a lithium salt of the plurality of lithium salts comprises a non-coordinating anion. In some embodiments, at least two lithium salts of the plurality of lithium salts comprises a non-coordinating anion. In some embodiments, the non-coordinating anion comprises bis(trifluoromethane)sulfonimide (TFSI⁻) or bis(fluorosulfonyl)imide (FSI⁻).

In some embodiments, the electrolyte composition further comprises one or more additives. In some embodiments, the one or more additives comprise LiNO₃.

In some embodiments, the electrolyte composition comprises a first solvent, a second solvent, and a third solvent. In some embodiments, the first solvent is present in an amount ranging from about 5 wt % to about 40 wt % of the electrolyte composition. In some embodiments, the first solvent is present in an amount ranging from about 15 wt % to about 25 wt % of the electrolyte composition. In some embodiments, the second solvent is present in an amount ranging from about 1 wt % to about 45 wt % of the electrolyte composition. In some embodiments, the second solvent is present in an amount ranging from about 10 wt % to about 20 wt % of the electrolyte composition. In some embodiments, the third solvent is present in an amount ranging from about 5 wt % to 70 wt % of the electrolyte composition. In some embodiments, the third solvent is present in an amount ranging from about 35 wt % to 55 wt % of the electrolyte composition.

In some embodiments, the electrolyte composition comprises DOL, DME, or TTE. In some embodiments, the first solvent is DME. In some embodiments, the second solvent is DOL. In some embodiments, the third solvent is TTE.

In some embodiments, the electrolyte composition is configured to promote SEI formation on an anode to prevent growth of dendrites. In some embodiments, the electrolyte composition includes excess solvents to maintain lithium salts in solution and prevent precipitation during cycling. In some embodiments, the electrolyte composition is configured to increases viscosity and improves conductivity.

In certain aspects, the present disclosure provides a rechargeable energy source system comprising the electrolyte composition disclosed herein, wherein a cycling efficiency of the rechargeable energy source system is at least 99.9% if measured at a cycling rate of a charge rate from about C/20 to about 10C, and a discharge rate from about D/20 to about 10D.

In certain aspects, the present disclosure provides a rechargeable energy source system comprising the electrolyte composition disclosed herein, wherein a capacity retention of the rechargeable energy source system is at least 80% if measured over 1000 cycles with a cycling rate of a charge rate from about C/20 to about 10C, and a discharge rate from about D/20 to about 10D.

In some embodiments, the rechargeable energy source system further comprises a lithium metal negative electrode. In some embodiments, the lithium metal negative electrode comprises a plurality of carbon particles, wherein the plurality of carbon particles is spherical in morphology with a corrugated surface. In some embodiments, the rechargeable energy source system further comprises a positive electrode comprising a redox material as an active material. In some embodiments, the redox material comprises iron phosphate (LiFePO₄), V₂O₅, or lithium nickel manganese cobalt (LiNiₓMn_{y}Co_{1-x-y}O₂).

In certain aspects, the present disclosure also relates to a method for lithium extraction from brine, comprising: contacting a composite membrane with brine, wherein the composite membrane comprises a polymer layer and a plurality of lithium ion conductive particles, wherein the plurality of lithium ion conductive particles have sizes bigger than a thickness of the polymer layer, and wherein the composite membrane is substantially impermeable to water and has a Li⁺ conductivity of at least 1.0×10⁻⁵ S/cm; and depositing one or more lithium metal islands onto a conductive substrate by subjecting a plurality of lithium ions from the brine to pass through the composite membrane to the conductive substrate, wherein at least one lithium metal island of the one or more lithium metal islands is smaller than 200 μm in at least one dimension.

In some embodiments, the one or more lithium metal islands are smaller than 190, 180, 170, 160, 150, 140, 130, 120, 110, 100, 90, 80, 70, 60, 50, 40, 30, 20, 10, 9, 8, 7, 6, 5, 4, 3, 2, or 1 μm in at least one dimension. In some embodiments, the one or more lithium metal islands are greater than 190, 180, 170, 160, 150, 140, 130, 120, 110, 100, 90, 80, 70, 60, 50, 40, 30, 20, 10, 9, 8, 7, 6, 5, 4, 3, 2, or 1 μm. In some embodiments, the one or more lithium metal islands are deposited with a nucleation site density of greater than 0.04 nucleation sites/mm². In some embodiments, the nucleation site density is greater than 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, or 10 nucleation sites/mm². In some embodiments, the nucleation site density is less than 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, or 10 nucleation sites/mm².

In some embodiments, the depositing is performed substantially free of side reactions caused by water and/or other impurities. In some embodiments, the depositing is performed using a current density of at least 1, 2, 3, 4, 5, 6, 7, 8, 9, 10, 20, 30, 40, or 50 mA/cm².

In some embodiments, the other impurities comprise oxygen, an organic electrolyte, a surfactant, sodium, potassium, magnesium, calcium, boron, chlorine, SO₄²⁻, nitrogen, an alkali metal, an alkali earth metal, or any combination thereof.

In some embodiments, the conductive substrate comprises copper, silicon, silver, carbon, aluminum, gold, or any combination thereof.

In some embodiments, the present disclosure provides a system for comprising a negative electrode, a positive electrode, and the composite membrane disclosed herein, wherein the composite membrane is substantially impermeable to water when the system is in operation or not in operation.

In some embodiments, the composite membrane is substantially impermeable to water over at least 100 lithium plating or deposition-stripping cycles of the system.

In some embodiments, the system further comprises a polymer layer between the negative electrode and the composite membrane. In some embodiments, the polymer layer is configured to prevent the plurality of lithium ion conductive particles in the composite membrane from contacting the negative electrode.

In some embodiments, the system further comprises a porous filter between the negative electrode and the composite membrane. In some embodiments, the porous filter is configured to prevent the plurality of lithium ion conductive particles in the composite membrane from contacting the negative electrode. In some embodiments, the porous filter is wet with a liquid organic electrolyte. In some embodiments, the composite membrane has a curved form factor.

In some embodiments, the system is a rechargeable energy source system, and wherein the composite membrane is substantially impermeable to water over at least 100, 500, or 1000 charge-discharge cycles of the rechargeable energy source system. In some embodiments, the rechargeable energy source system is anodeless. In some embodiments, the system comprises a lithium metal layer having a thickness greater than 1 μm and a nucleation site density greater than 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, or 10 nucleation sites/mm², when the rechargeable energy source system is fully charged.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows an example microscope image of carbon flowers, in accordance with one or more embodiments of the present disclosure.

FIG. 2A displays a voltage profile for five formation cycles using the synthesized carbon flower powder in carbon flower|electrolyte|lithium metal, in accordance with one or more embodiments of the present disclosure.

FIG. 2B displays the measurement results of capacity vs. cycle for the carbon flower powder after the formation process, in accordance with one or more embodiments of the present disclosure.

FIGS. 3A and 3B display the measurement results of discharge capacity (%) vs. cycle for a full cell comprising an LFP (lithium iron phosphate) cathode and an anode utilizing the carbon flower powder, in accordance with one or more embodiments of the present disclosure.

FIG. 3C displays the measurement results of coulombic efficiency vs. cycle for a full cell comprising an LFP (lithium iron phosphate) cathode and an anode utilizing the carbon flower powder, in accordance with one or more embodiments of the present disclosure.

FIG. 4 displays the measurement results of discharge capacity (%) vs. cycle for a full cell comprising an LFP (lithium iron phosphate) cathode and an anode utilizing the carbon flower powder, in accordance with one or more embodiments of the present disclosure.

FIG. 5 shows cycling experiments conducted for the electrochemical cells containing various electrolytes, in accordance with one or more embodiments of the present disclosure.

FIG. 6 displays a plot of specific capacity (mAh/g) vs. cycle for electrochemical cells utilizing an electrolyte solution described herein, in accordance with one or more embodiments of the present disclosure.

FIG. 7 displays a plot of discharge capacity (%) vs. cycle for the electrochemical cells utilizing electrolyte solutions described herein, in accordance with one or more embodiments of the present disclosure.

FIGS. 8A-8B show a schematic of a conductive composite membrane and its use in a system for extracting lithium from brine, in accordance with one or more embodiments of the present disclosure. FIG. 8A shows a conductive composite membrane. FIG. 8B shows a system for extracting lithium from brine using a conductive composite membrane, in accordance with one or more embodiments of the present disclosure.

FIGS. 9A-9B show a rechargeable energy source system comprising a conductive composite membrane, in accordance with one or more embodiments of the present disclosure.

FIG. 10 shows a hydrophobic modification of a surface of a lithium ion conductive particle, in accordance with one or more embodiments of the present disclosure.

FIGS. 11A-11B show electrolytic cells comprising a conductive composite membrane, in accordance with one or more embodiments of the present disclosure.

FIGS. 12A-12B show an illustration of a lithium conductive polymer compressing in response to a growing thickness of a lithium metal deposit, in accordance with one or more embodiments of the present disclosure.

### DETAILED DESCRIPTION

The lithium metal battery is regarded as the pinnacle of rechargeable energy sources due to the exceptional properties of lithium metal. As the lightest metal with the highest electrochemical energy density in the periodic table, lithium metal offers unparalleled potential for energy storage. However, the path to commercializing lithium metal batteries is riddled with complex engineering challenges, primarily stemming from the formation of dendrites on lithium metal electrodes. Dendrite formation poses a myriad of concerns that can significantly impact the battery's cycling stability and safety. Over numerous charge-discharge cycles, dendrites can detach from the lithium metal electrode, leading to a loss of capacity. Furthermore, the penetration of dendrites through the separator between the negative and positive electrodes can result in potential short-circuiting of the battery, leading to the ignition of components due to sudden heat generation, thereby posing significant safety risks.

To address the challenges of cyclic stability and safety arising from an unstable solid-electrolyte interphase (SEI), the present disclosure provides the use of specific carbon nanostructures as hosts for lithium. In certain aspects, the present disclosure provides a rechargeable energy source system comprising the lithium metal electrode. In certain aspects, the lithium metal electrode comprises a plurality of carbon particles comprising a plurality of carbon nanosheets resembling flower petals. In some embodiments, the carbon particles comprise a corrugated surface. In some embodiments, the carbon particles are spherical in morphology with a corrugated surface.

An important factor that can influence the cycling stability and safety of a lithium metal battery is the chemical composition of the electrolyte. The chemical composition in electrolyte can affect cycling stability and safety because the electrolyte can react with the lithium metal (or the positive electrode) when electrical potential is applied to the battery. The chemical composition in electrolyte can also affect cycling stability and safety because the electrolyte may decompose when electrical potential is applied to the battery even without reacting with another battery component, e.g., when the applied electrical potential can exceed the inherent electrochemical stability window of the electrolyte. In some aspects, the present disclosure provides an electrolyte composition.

In addition, one strategy for extracting lithium from brine is to electrodeposit lithium ions in brine on a substrate. Lithium can be extracted from brine by applying an electric potential between two electrodes. By applying an electric potential, lithium ions can conduct towards an electrode, where they are reduced to form lithium metal. In electrodeposition systems, water contamination in phases which are in contact with the electrodepositing lithium metal can degrade the lithium metal. Accordingly, it is advantageous to prevent or substantially reduce the presence of water that contacts the lithium metal. The lithium metal can be deposited onto a currently collector from a brine source to form an electrode, which can provide high purity lithium metal deposit that can improve cyclability of a rechargeable energy source integrating such an electrode.

Thus, improved electrochemical methods are needed for the purification of lithium and other electroactive metals from dilute sources, the production of smooth, high-purity lithium metal and lithium metal alloys, and the preparation of lithium and lithium alloy negative electrodes for lithium metal batteries, while preventing water from contacting the electrodeposited lithium. In some aspects, provided herein are strategies for blocking the transport of water to a working electrode.

Rechargeable Energy Source System with Lithium Metal Electrode and Complex Electrolyte

In certain aspects, the present disclosure provides a rechargeable energy source system comprising a positive electrode, a negative electrode, and an electrolyte. The rechargeable energy source system can comprise a negative electrode. The rechargeable energy source system can comprise a negative current collector. The rechargeable energy source system can comprise a positive electrode. The rechargeable energy source system can comprise a positive current collector. The rechargeable energy source system can comprise an electrolyte. The rechargeable energy source system can comprise a separator. The negative electrode can comprise a layer of lithium metal.

The components of the rechargeable energy source system can each constitute a predetermined mass fraction of the rechargeable energy source system. The specific predetermined mass fraction can be determined based on the thickness of the lithium metal (which can be tuned), choice of component materials (e.g., the redox material for the positive electrode, the electrolyte, and the current collectors), and performance requirements (e.g., energy density, safety, etc.).

The rechargeable energy source system can comprise a packaging. The packaging can be a pouch, coin, prismatic, or cylindrical packaging. Pouch packaging can be extremely light, which increases cell-level energy density. Fabricating pouch cells may involve providing external pressure to the cell, e.g., squeezing into a phone. Cylindrical, coin, and prismatic cells can provide for their own pressure from the casing, and can be swappable or self-contained.

In some aspects, the rechargeable energy source system can comprise a lithium metal electrode. The rechargeable energy source system can be configured to maintain at least 50, 60, 70, 80, 90, 91 92, 93, 94, 95, 96, 97, 98, 99, 99.1, 99.2, 99.3, 99.4, 99.5, 99.6, 99.7, 99.8, 99.9, 99.91, 99.92, 99.93, 99.94, 99.95, 99.96, 99.97, 99.98, or 99.99 percent of the capacity when the rechargeable energy source system is cycled for a predetermined number of times. The rechargeable energy source system can be configured to maintain at most 50, 60, 70, 80, 90, 91 92, 93, 94, 95, 96, 97, 98, 99, 99.1, 99.2, 99.3, 99.4, 99.5, 99.6, 99.7, 99.8, 99.9, 99.91, 99.92, 99.93, 99.94, 99.95, 99.96, 99.97, 99.98, or 99.99 percent of the capacity when the rechargeable energy source system is cycled for a predetermined number of times. The predetermined number of times can be at least 50, 100, 150, 200, 250, 300, 350, 400, 500, 600, 700, 800, 1000, 5000, 6000, 7000, 8000, or 9000 times. The predetermined number of times can be at most 50, 100, 150, 200, 250, 300, 350, 400, 500, 600, 700, 800, 1000, 5000, or 10000 times. The cycling can be from 2 V to 4.5 V, from 3 V to 4.5 V, or from 2 V to 3.9 V. The cycling can be performed using a C-rate of at least C/20, C/10, C/5, C/2, 1C, or 2C. The cycling can be performed using a C-rate of at most C/20, C/10, C/5, C/2, 1C, or 2C. The cycling can be performed using a D-rate of at least D/20, D/10, D/5, D/2, 1D, or 2D. The cycling can be performed using a D-rate of at most D/20, D/10, D/5, D/2, 1D, or 2D. The cycling can be performed using a C-rate of at least C/20, C/10, C/5, C/2, 0.5C, 1C, 2C, 3C, 5C, 6C, 7C, 8C, 9C, or 10C. The cycling can be performed using a C-rate of at most C/20, C/10, C/5, C/2, 0.5C, 1C, 2C, 3C, 5C, 6C, 7C, 8C, 9C, or 10C. The cycling can be performed using a D-rate of at least D/20, D/10, D/5, D/2, 0.5D, 1D, 2D, 3D, 5D, 6D, 7D, 8D, 9D, or 10D. The cycling can be performed using a D-rate of at most D/20, D/10, D/5, D/2, 0.5D, 1D, 2D, 3D, 5D, 6D, 7D, 8D, 9D, or 10D. For example, the rechargeable energy source system can be configured to maintain at least 80% of the capacity when the rechargeable energy source system is cycled for at least 200 cycles from 2 to 4.5 V at a D-rate of at least D/5 and a D-rate of at least D/5. In some cases, the rechargeable energy source system may maintain about 97% capacity after 800 cycles. In some cases, there is no dendrite formation or shorting observed during 800, 1000, 2000, 3000, 4000, or 5000 cycles. In some embodiments, the rechargeable energy storage system can be charged with a substantial constant current, or modulated current.

A cycling efficiency of the rechargeable energy source system can be at least 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99%, when measured at a cycling rate of C/20:D/20, C/10:D/10, C/5:D/5, C/2:D/2, 0.5C:0.5D, 1C:1D, 2C:2D, 3C:3D, 5C:5D, 6C:6D, 7C:7D, 8C:8D, 9C:9D, or 10C:10D. In some embodiments, a cycling efficiency of the rechargeable energy source system can be at least 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99%, when measured at a charge rate from about C/20 to about 10C, and a discharge rate from about D/20 to about 10D. A cycling efficiency of the rechargeable energy source system can be at most 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99%, when measured at a cycling rate of C/20:D/20, C/10:D/10, C/5:D/5, C/2:D/2, 0.5C:0.5D, 1C:1D, 2C:2D, 3C:3D, 5C:5D, 6C:6D, 7C:7D, 8C:8D, 9C:9D, or 10C:10D. In some embodiments, a cycling efficiency of the rechargeable energy source system can be at most 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99%, when measured at a charge rate from about C/20 to about 10C, and a discharge rate from about D/20 to about 10D.

A capacity retention with respect to cyclability of the rechargeable energy source system can be at least 80%, 85%, 90%, or 95% when measured over at least 200, 500, 1000, 2000, 3000, 4000, 5000, 6000, 7000, or more than 8000 cycles with a cycling rate of at least C/20:D/20, C/10:D/10, C/5:D/5, C/2:D/2, 0.5C:0.5D, 1C:1D, 2C:2D, 3C:3D, 5C:5D, 6C:6D, 7C:7D, 8C:8D, 9C:9D, or 10C:10D. A capacity retention with respect to cyclability of the rechargeable energy source system can be at most 80%, 85%, 90%, or 95% when measured over at least 200, 500, 1000, 2000, 3000, 4000, 5000, 6000, 7000, or more than 8000 cycles with a cycling rate of C/20:D/20, C/10:D/10, C/5:D/5, C/2:D/2, 0.5C:0.5D, 1C:1D, 2C:2D, 3C:3D, 5C:5D, 6C:6D, 7C:7D, 8C:8D, 9C:9D, or 10C:10D.

### Lithium Metal Electrode

In some embodiments, the negative electrode comprises (1) lithium metal which is the electrochemically active component and (2) a substrate which serves as current lead/collector and as the contact to the external circuit. Lithium metal can be chemically unstable in air, so the contact can be made via another material, e.g., one that is chemically stable in air and in the cell chemistry environment. Another material can be chemically and electrochemically inert so as not to compete with the lithium. In some embodiments, a negative electrode can comprise copper, aluminum, graphite coated copper, nickel, silicon, silver, carbon (e.g., rough-surface carbon, graphene), a lithophilic material, aluminum, gold, a copper alloy (Cu—Zn, Cu—Al, Cu—Sn), or any combination thereof. The negative electrode can comprise a layer of lithium metal deposited thereon. Lithium metal can be deposited on the negative electrode with a thickness of at least about 1, 2, 3, 4, 5, 6, 7, 8, 9, or 10 μm. Lithium metal can be deposited on the negative electrode with a thickness of at least about 1, 5, 10, 20, 30, 40, 50, 100, 200, 300, 400, or 500 μm. Lithium metal can be deposited on the negative electrode with a thickness of at most about 1, 5, 10, 20, 30, 40, 50, 100, 200, 300, 400, or 500 μm. Lithium metal can comprise a thickness from 1 to 380 μm, from 1 to 370 μm, from 1 to 360 μm, from 1 to 350 μm, from 1 to 340 μm, from 1 to 330 μm, from 1 to 320 μm, from 1 to 310 μm, from 1 to 300 μm, from 1 to 250 μm, from 1 to 200 μm, from 1 to 150 μm, from 1 to 100 μm, from 1 to 90 μm, from 1 to 80 μm, from 1 to 70 μm, from 1 to 60 μm, from 1 to 50 μm, from 1 to 45 μm, from 1 to 40 μm, from 1 to 35 μm, from 1 to 30 μm, from 1 to 25 μm, from 1 to 20 μm, from 1 to 15 μm, from 1 to 10 μm, or from 1 to 5 μm.

In some embodiments, a lithium metal electrode has a specific capacity of greater than about 3500, 3600, 3700, 3750, or 3800 mAh per gram. In some embodiments, a lithium metal electrode has a specific capacity of less than about 3600, 3700, 3750, or 3800 mAh per gram. The overall capacity of the lithium metal electrode (e.g., in basis of mAh) can be substantially matched with the capacity of the positive electrode. In some embodiments, a lithium metal electrode has a density of from 0.4 g/cm³ to 0.534 g/cm³. In some embodiments, lithium metal electrode has a density of from 0.45 g/cm³ to 0.543 g/cm³. In some embodiments, lithium metal electrode has a density of greater than 0.46, 0.47, 0.48, 0.49, 0.50, 0.51, 0.52, or 0.53 g/cm³. In some embodiments, lithium metal electrode has a density of less than 0.46, 0.47, 0.48, 0.49, 0.50, 0.51, 0.52, 0.53, or 0.543 g/cm³.

In some embodiments, lithium metal electrode can comprise less than 0.1 wt % or at % of nitrogen, oxygen, or both. In some embodiments, a lithium metal electrode can comprise less than 0.1 wt % or at % of boron. In some embodiments, a lithium metal electrode can comprise less than 0.1 wt % or at % of magnesium, aluminum, or both. In some embodiments, a lithium metal electrode can comprise less than 0.1 wt % or at % of non-conductive impurities. In some embodiments, a lithium metal electrode can comprise less than 0.1 wt % lithium alloys. In some embodiments, a lithium metal electrode can comprise less than 1 non-lithium subsurface structure/mm³. In some embodiments, a lithium metal electrode can comprise less than 1 non-lithium crystalline subsurface structure/mm³. Without being bound to a particular theory, it is hypothesized that some impurities in lithium may be capable of forming phases that are distinct from the lithium (e.g., crystallites of Li₃N or another compound or another element) after cycling experiments. Thus, a sample of lithium metal can be analyzed to detect the presence of impurities in the 3D images of the sample which can show structural impurities in lithium metal.

A sample of lithium metal can be imaged using monochromatic hard X-rays with energies chosen in the 22-25 keV range. X-rays can be generated using a synchrotron, which can illuminate the entire sample. The X-ray shadow cast by the sample can be converted into visible light using a scintillator. An optical microscope can magnify the image and convert it into digital format. The sample can be rotated, in fractions of degrees, up to 180 degrees to generate ~1000 images of the sample. The shadow images can be converted into cross-sectional slides that is stacked together to render a 3D reconstruction of the sample. The 3D reconstruction can reveal structural impurities, e.g., crystallites.

Lithium metal can comprise less than 1000, 900, 800, 700, 600, 500, 400, 300, 200, 100, 90, 80, 70, 60, 50, 40, 30, 20, 10, 9, 8, 7, 6, 5, 4, 3, 2, 1, 0.9, 0.8, 0.7, 0.6, 0.5, 0.4, 0.3, 0.2, or 0.1 ppm of a non-metallic element. The ppm can be by mass or by count. The ppm can correspond to a basis used for the instrument to detect the non-metallic element. Lithium metal can comprise less than 5 parts-per-million (ppm) of non-metallic elements. In some embodiments, the lithium metal includes no more than 1 ppm of non-metallic elements by mass. The non-metallic element can be nitrogen, boron, oxygen, carbon, hydrogen, or fluorine. Non-metallic elements can be present as atomic species, or molecular species (e.g., as Li₃N, OH, lithium-boron compounds, carbonate, or O₂). In some embodiments, a non-metallic element may form resistive material on a surface of the lithium metal. For example, LiCO₃ or LiOH can create resistive losses for a lithium metal electrode. The presence of a non-metallic element can be detected using, for example, inductively coupled plasma optical emission spectroscopy (ICP-OES) or X-ray microtomography. The presence of a non-metallic elements may be detected using focused Ion Beam (FIB) with a secondary ion mass spectrometry (SIMS). The presence of a non-metallic elements may be detected using electron energy loss spectroscopy (EELS), and/or transmission electron microscopy (TEM), by detecting and mapping lithium via the high ionization cross-section of the shallow Li K-edge that is 10-100 times greater than those of other light elements, e.g., O and F.

Lithium metal can comprise less than 1500 ppm of a trace metal. Lithium metal can comprise less than 1400, 1300, 1200, 1100, 1000, 900, 800, 700, 600, 500, 400, 300, 200, 100, 90, 80, 70, 60, 50, 40, 30, 20, 10, 9, 8, 7, 6, 5, 4, 3, 2, 1, 0.9, 0.8, 0.7, 0.6, 0.5, 0.4, 0.3, 0.2, or 0.1 ppm of a trace metal. Lithium metal can comprise more than 0, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, or 5000 parts-per-billion (ppb) of a trace metal. The ppb can be by mass or by count. The ppb can correspond to a basis used for the instrument to detect the trace element. The trace metal can be aluminum, barium, calcium, chromium, iron, iridium, magnesium, tungsten, zinc, cobalt, or sodium. In some embodiments, a trace element may form an alloy with lithium. An alloy can reduce the capacity of a lithium metal electrode. Lithium metal can comprise less than 12, 11, 10, 9, 8, 7, 6, 5, 4, 3, 2, 1, 0.9, 0.8, 0.7, 0.6, 0.5, 0.4, 0.3, 0.2, or 0.1 ppm of aluminum. Lithium metal can comprise less than 15, 14, 13, 12, 11, 10, 9, 8, 7, 6, 5, 4, 3, 2, 1, 0.9, 0.8, 0.7, 0.6, 0.5, 0.4, 0.3, 0.2, or 0.1 ppm of barium. Lithium metal can comprise less than 45, 40, 35, 30, 25, 20, 15, 10, 9, 8, 7, 6, 5, 4, 3, 2, 1, 0.9, 0.8, 0.7, 0.6, 0.5, 0.4, 0.3, 0.2, or 0.1 ppm of calcium. Lithium metal can comprise less than 1, 0.9, 0.8, 0.7, 0.6, 0.5, 0.4, 0.3, 0.2, or 0.1 ppm of chromium. Lithium metal can comprise less than 2, 1, 0.9, 0.8, 0.7, 0.6, 0.5, 0.4, 0.3, 0.2, or 0.1 ppm of iron. Lithium metal can comprise less than 13, 12, 11, 10, 9, 8, 7, 6, 5, 4, 3, 2, 1, 0.9, 0.8, 0.7, 0.6, 0.5, 0.4, 0.3, 0.2, or 0.1 ppm of iridium. Lithium metal can comprise less than 1000, 900, 800, 700, 600, 500, 400, 300, 200, 100, 90, 80, 70, 60, 5,0 40, 30, 20, 10, 9, 8, 7, 6, 5, 4, 3, 2, or 1 ppm of magnesium. Lithium metal can comprise less than 23, 20, 15, 10, 9, 8, 7, 6, 5, 4, 3, 2, 1, 0.9, 0.8, 0.7, 0.6, 0.5, 0.4, 0.3, 0.2, or 0.1 ppm of tungsten. Lithium metal can comprise less than 0.7, 0.6, 0.5, 0.4, 0.3, 0.2, or 0.1 ppm of zinc. Lithium metal can comprise less than 45, 40, 35, 30, 25, 20, 15, 10, 9, 8, 7, 6, 5, 4, 3, 2, 1, 0.9, 0.8, 0.7, 0.6, 0.5, 0.4, 0.3, 0.2, or 0.1 ppm of sodium. Lithium metal can comprise less than 45, 40, 35, 30, 25, 20, 15, 10, 9, 8, 7, 6, 5, 4, 3, 2, 1, 0.9, 0.8, 0.7, 0.6, 0.5, 0.4, 0.3, 0.2, or 0.1 ppm of cobalt. The presence of trace metals can be detected using, for example, inductively coupled plasma optical emission spectroscopy (ICP-OES).

A lithium metal electrode can comprise a low density of structural impurities, e.g., subsurface structural impurities. Without being bound to a particular theory, elemental or molecular impurities in lithium metal may form phases which are distinct from the lithium upon cycling. When current traverses through the lithium metal, the lithium metal may be heated. Higher temperature may permit impurities to conduct or diffuse in the lithium metal, which can lead to the formation of more stable phases of impurities in the lithium metal (e.g., crystallites). When such structural impurities (phases which have distinct crystal structures, or which have grain boundaries against lithium metal phases in the lithium metal) begin to form, they may continue to grow. Structural impurities can be detected by 3D techniques, e.g., X-ray tomography. Structural impurities may be present on the surface of lithium metal, or it may be present beneath the surface. The structural impurities can provide sites for dendrite nucleation or growth, and may crack the surrounding lithium metal. In some embodiments, the lithium metal can comprise less than 10, 9, 8, 7, 6, 5, 4, 3, 2, 1, 0.9, 0.8, 0.7, 0.6, 0.5, 0.4, 0.3, 0.2, or 0.1 structural impurities/mm³. In some embodiments, the lithium metal can comprise less than 1000, 900, 800, 700, 600, 500, 400, 300, 200, 100, 90, 80, 70, 60, 5,0 40, 30, 20, 10, 9, 8, 7, 6, 5, 4, 3, 2, or 1 ppm of structural impurities by weight.

In certain embodiments, the lithium metal negative electrode comprises a plurality of carbon particles that are spherical in morphology with a corrugated surface. Various positive electrodes for the rechargeable energy source system are contemplated herein. In some embodiments, the positive electrode comprises LiFePO₄ (LFP), nickel manganese cobalt (NMC), or a transition metal oxide as an active material.

### Complex Electrolyte

In certain aspects, the present disclosure provides an electrolyte composition. In some embodiments, the electrolyte composition comprises a plurality of solvents and a plurality of lithium salts. In some embodiments, the plurality of solvents comprises at least three solvents. In other embodiments, the plurality of solvents comprises at least one participating solvent and one or more non-participating solvents. In some cases, as used herein, the term “participating” refers to dissolving or solvating the plurality of lithium salts. In some embodiments, the participating solvents comprises a diluent. In some embodiments, the non-participating solvents comprises a diluent. In some embodiments, the electrolyte further comprises at least one semi-participating solvent. In some embodiments, the participating solvents may provide a high dielectric constant that allows effective salt dissolution, demonstrate chemical stability with respect to other electrolyte components, remain liquid phase across a broad temperature window, and provide efficient ion transport due to relatively low viscosity.

In some embodiments, the non-participating solvents may exhibit minimal solubility for the salts, thereby preventing disruption of the primary salt-participating solvent coordination structure. The non-participating solvent may be also miscible with the participating solvent so as to form a clear and homogeneous solution without phase separation. In addition, the non-participating solvent may not substantially interfere with the structure of the high concentration salt-participating solvent clusters. To preserve the coordination environment, the non-participating solvent can have a weak ability to solvate lithium ions, thereby avoiding alteration of the solvation shell. In some embodiments, the non-participating solvent may provide a low viscosity and remain chemically inert and stable toward other electrolyte components under operating conditions.

In certain embodiments, the electrolyte composition comprises a localized high-concentration electrolyte (LHCE), a plurality of solvents and a plurality of lithium salts. In some embodiments, the electrolyte comprises a plurality of solvents. In some embodiments, the electrolyte comprises a mixture of two solvents. In some embodiments, the electrolyte comprises a mixture of three solvents. In some embodiments, the electrolyte comprises a mixture of four solvents. In some embodiments, the electrolyte comprises a mixture of five solvents. In some embodiments, the electrolyte comprises a mixture of more than six solvents. The plurality of solvents comprises participating solvents and non-participating solvents.

In some embodiments, the electrolyte compositions disclosed herein may be nonflammable.

In some embodiments, the plurality of solvents comprises one or more participating solvents and one or more non-participating solvents. In some embodiments, the plurality of solvents comprises at least 1, 2, 3, 4, 5, 6, 7, 8, 9, or 10 participating solvents and at least 1, 2, 3, 4, 5, 6, 7, 8, 9, or 10 non-participating solvents. In some embodiments, the plurality of solvents comprises at most 1, 2, 3, 4, 5, 6, 7, 8, 9, or 10 participating solvents and at most 1, 2, 3, 4, 5, 6, 7, 8, 9, or 10 non-participating solvents. In some embodiments, the one or more non-participating solvents comprises a diluent. In some embodiments, the plurality of solvents comprises one participating solvents. In some embodiments, the plurality of solvents comprises two participating solvents. In some embodiments, the plurality of solvents comprises three participating solvents. In some embodiments, the plurality of solvents comprises four participating solvents. In some embodiments, the plurality of solvents comprises five participating solvents. In some embodiments, the plurality of solvents comprises more than six participating solvents. In some embodiments, the plurality of solvents comprises one non-participating solvents. In some embodiments, the plurality of solvents comprises two non-participating solvents. In some embodiments, the plurality of solvents comprises three non-participating solvents. In some embodiments, the plurality of solvents comprises four non-participating solvents. In some embodiments, the plurality of solvents comprises five non-participating solvents. In some embodiments, the plurality of solvents comprises more than six non-participating solvents. In some embodiments, the plurality of solvents comprises two participating solvents and one non-participating solvent. In some embodiments, the plurality of solvents comprises three participating solvents and one non-participating solvent. In some embodiments, the plurality of solvents comprises four participating solvents and one non-participating solvent. In some embodiments, the plurality of solvents comprises two participating solvents and two non-participating solvents. In some embodiments, the plurality of solvents comprises three participating solvents and two non-participating solvents.

In some embodiments, the localized high-concentration electrolyte (LHCE) comprises a mixture of two solvents. LHCE may promote the formation of an anion-rich surface layer formation on the anode to prevent dendrites which encourages longer cycle life. In some embodiments, a first solvent may solvate a lithium salt, and a second solvent may be miscible with the first solvent and substantially does not solvate the lithium salt. In some embodiments, the lithium salt may be soluble in the first solvent by at least 1, 10, 50, 100, 500, or 1000 times more than in the second solvent. The solubility can be measured by, e.g., the concentration at which the lithium salt is saturated in the solvent at standard temperature and pressure. The solubility can also be measured as the free energy of solvation at standard temperature and pressure.

In some embodiments, the electrolyte comprises an ether-based solvent system. These electrolytes are composed of a mixture of organic solvents, lithium salts, and additives. The electrolyte comprising an ether-based solvent system may have lower reduction potentials, indicating a higher tendency to donate electrons during a chemical reaction. As a result, the electrolyte may be less likely to react with the lithium metal in the cell, thereby improving the overall safety and stability of the battery. In some embodiments, the electrolyte may comprise an ether-based solvent comprising 1,3-dioxolane (DOL), 1,2-dimethoxyethane (DME), tetraethylene glycol dimethyl ether (TEGDME), poly(ethylene glycol) dimethyl ether (PEGDME), or a mixture thereof. In some embodiments, the electrolyte may be ethylene glycol dimethyl ether (EGDME) based electrolyte. EGDME exhibits good electrochemical performance and is used in lithium batteries as it is particularly efficient in transferring lithium ions from the anode to the cathode during discharging and the other way around during charging. This high conductivity results in increased efficiency of the battery. In some embodiments, the ether-based electrolyte may be tetraethylene glycol dimethyl ether (TEGDME) based electrolyte. TEGDME exhibits good thermal stability, high flash point, and high boiling point compared to other ether-based solvents. In some embodiments, the ether-based electrolyte can be poly(ethylene glycol) dimethyl ether (PEGDME) based electrolyte, exhibiting high lithium transference number, high ionic conductivity, and better cycling performance. In some embodiments, the electrolyte may be free of carbonate solvents.

In some embodiments, the electrolyte composition may be configured to weakly solvate the lithium salt. In some embodiments, the first solvent may be configured to form an incomplete or a partial solvation shell around a lithium ion. The first solvent can be configured to form an incomplete or a partial solvation shell around a counterion to the lithium ion. The solvation shell can be mediated by an electrostatic interaction, e.g., a partially negative atom of the molecule of the first solvent can attract and coordinate with a lithium ion. A partially positive atom of the molecule of the first solvent can attract and coordinate with the counterion. Without being bound to a particular theory, the weak solvation structure of the first solvent around the lithium ions can allow the lithium ions to easily escape the solvation structure to electroplate onto a lithium metal surface during electrodeposition.

In some embodiments, the lithium salt may be substantially insoluble in the second solvent. In some embodiments, the lithium salt can be weakly solvated by the second solvent. The second solvent can be miscible with the first solvent, such that, they can form a homogeneous solution when mixed. The second solvent can be configured to lower the viscosity of the electrolyte when mixed with the first solvent. Without being bound to a particular theory, when lithium salts are dissolved in the electrolyte, the solvation structure afforded by the combination of the first solvent and the second solvent can be a weak solvation structure, although, the solvation structure afforded by only the first solvent can be a strong solvation structure.

The electrolyte can comprise any number of solvents which dissolve the lithium salt. The electrolyte can comprise any number of solvents which does not dissolve the lithium salt. For example, the electrolyte can comprise 1, 2, 3, 4, 5, 6, 7, 8, 9, 10, or more solvents that solvates the lithium salt, and 1, 2, 3, 4, 5, 6, 7, 8, 9, 10, or more solvents that substantially does not solvate the lithium salt.

Various solvents are contemplated herein. In some embodiments, a solvent of the plurality of solvents comprises an ether. In some embodiments, the electrolyte composition comprises an ether-based solvent system. In some embodiments, the plurality of solvents comprises a plurality of ethers. In some embodiments, a solvent of the plurality of solvents comprises a ring. In some embodiments, the ring comprises a dioxolane ring. In some embodiments, the ether comprises a heterocyclic ether. In some embodiments, heterocyclic ether comprises a heterocyclic acetal structure. In some embodiments, the heterocyclic acetal structure comprises a five-membered dioxolane ring structure. In some embodiments, a solvent of the plurality of solvents comprises an acetal. In some embodiments, the acetal comprises a heterocyclic acetal. In some embodiments, the solvent comprises 1,3-dioxolane (DOL). In some embodiments, a solvent of the plurality of solvents comprises an alkyl ether. In some embodiments, the solvent comprises a dialkyl ether. In some embodiments, the solvent comprises a dimethyl ether (DME). In some embodiments, a solvent of the plurality of solvents comprises a partially fluorinated alkyl ether. In some embodiments, the solvent comprises a partially fluorinated dialkyl ether. In some embodiments, the solvent comprises 1,1,2,2-tetrafluoroethyl-2,2,3,3-tetrafluoropropyl ether (TTE). In some embodiments, a solvent of the plurality of solvents comprises a fully fluorinated alkyl ether. In some embodiments, the solvent comprises a fully fluorinated dialkyl ether. Without being bound to a theory, ether-based solvents may promote longer cycling in Li-metal batteries because they have a higher LUMO (lowest unoccupied molecular orbital) in contrast to some carbonate-based electrolytes, which can reduce the frequency of parasitic side reactions at the anode surface and elsewhere in an electrochemical cell. This can allow a more uniform anode surface layer to allow for stable plating and stripping during cycling.

In some embodiments, the electrolyte comprises a plurality of lithium salts. In some embodiments, the plurality of lithium salts can comprise at least 1, 2, 3, 4, 5, 6, 7, 8, 9, or 10 lithium salts. In some embodiments, the plurality of solvents can comprise at most 1, 2, 3, 4, 5, 6, 7, 8, 9, or 10 lithium salts.

Various lithium salts are contemplated herein. The salts described herein have proper salt solubility and dissociation ability, and are chemically inert toward the electrodes, solvents, and other components of the system. For example, the lithium salts can comprise Li₂SO₄, Li₂CO₃, LiNO₃, LiPF₆, LiBF₄, LiBH₄, LiBO₂, lithium difluoro(oxalato)borate (LiDFOB), LiClO₄, lithium bis(fluorosulfonyl)imide (LiFSI), lithium bis(trifluoromethane)sulfonimide (LiTFSI), or any combination thereof. In some embodiments, a lithium salt of the plurality of lithium salts comprises a nitrogen atom. In some embodiments, at least two lithium salts of the plurality of lithium salts comprises a nitrogen atom. In some embodiments, a lithium salt of the plurality of lithium salts comprises a non-coordinating anion. In some embodiments, at least two lithium salts of the plurality of lithium salts comprises a non-coordinating anion. In some embodiments, the non-coordinating anion comprises bis(trifluoromethane)sulfonimide (TFSI⁻) or bis(fluorosulfonyl)imide (FSI⁻). In some embodiments, a lithium salt of the plurality of lithium salts comprises NO₃⁻.

A lithium salt can comprise lithium 12-hydroxystearate, lithium acetate, lithium amide, lithium aspartate, lithium azide, lithium bis(trifluoromethanesulfonyl)imide, lithium borohydride, lithium bromide, lithium carbonate, lithium chlorate, lithium chloride, lithium citrate, lithium cyanide, lithium diphenylphosphide, lithium hexafluorogermanate, lithium hexafluorophosphate, lithium hypochlorite, lithium hypofluorite, lithium metaborate, lithium methoxide, lithium naphthalene, lithium niobate, lithium nitrate, lithium nitrite, lithium oxalate, lithium perchlorate, lithium stearate, lithium succinate, lithium sulfate, lithium sulfide, lithium superoxide, lithium tantalate, lithium tetrachloroaluminate, lithium tetrafluoroborate, lithium tetrakis(pentafluorophenyl)borate, lithium triflate, lithium tungstate, or any combination thereof. In some embodiments, an electrolyte can comprise lithium salts comprising an organic anion selected from the group consisting of trifluoromethanesulfonyl-imide (TFSI), N-butyl-N-methylpyrrolidinium bis(trifluoromethanesulfonyl)imide (PyruTFSI), trifluoromethanesulfonyl-imide, bis(trifluoromethanesulfonyl)imide (LiTFSI), 1-ethyl-3-methylimidazolium-bis(trifluoromethylsulfonyl)imide (EMI-TFSI), or any combination thereof. In some embodiments, the catholyte 290 comprises ionic liquid-forming salts dissolved in 1,3-dioxolane (DOL), 1,2 dimethoxyethane (DME), or tetraethylene glycol dimethyl ether (TEGDME). In some embodiments, an electrolyte can comprise Li₂SO₄, Li₂CO₃, LiPF₆, LiBF₄, LiBH₄, LiBO, LiDFOB, LiClO₄, LiTFSI, or any combination thereof. In some embodiments, an electrolyte can comprise LiPF₆, LiBF₄, LiBH₄, LiBO, LIDFOB, LiSbF₆, LiAsF₆, LiSbF₆, LiCF₃SO₃, Li(CF₃SO₂)₃C, Li(CF₃SO₂)₂N, LiC₄F₉SO₃, LiClO₄, LiAlO₄, LiAlCl₄, LiAlF₄, LiBPh₄, LiBioCl₁₀, CH₃SO₃Li, C₄F₃SO₃Li, (CF₃SO₂)₂NLi, LiN(CₓF₂ₓ₊₁SO₂)(CₓF_{2y+1}SO₂) (wherein x and y are natural numbers), CF₃CO₂Li, LiCl, LiBr, LiI, LIBOB (lithium bisoxalato borate), lower aliphatic carboxylic acid lithium, lithium terphenylborate, lithium imide, or any combination thereof. In some embodiments, a concentration of the lithium salt may be in a range of about 0.1 molar (“M”) to about 2.0 M. In some embodiments, a concentration of the lithium salt is at least 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.5, 2.0, 2.5, or 3 M. In some embodiments, a concentration of the lithium salt is at most 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.5, 2.0, 2.5, or 3 M.

In some embodiments, a lithium salt of the plurality of lithium salts comprises a nitrogen atom. In some embodiments, at least two lithium salts of the plurality of lithium salts comprises a nitrogen atom. In some embodiments, a lithium salt of the plurality of lithium salts comprises a non-coordinating anion. In some embodiments, at least two lithium salts of the plurality of lithium salts comprises a non-coordinating anion. In some embodiments, the non-coordinating anion comprises bis(trifluoromethane)sulfonimide (TFSI⁻) or bis(fluorosulfonyl)imide (FSI⁻). In some embodiments, a lithium salt of the plurality of lithium salts comprises NO₃⁻.

In some embodiments, the lithium salts can comprise Li₂SO₄, Li₂CO₃, LiNO₃, LiPF₆, LiBF₄, LiBH₄, LiBO₂, lithium difluoro(oxalato)borate (LiDFOB), lithium perchlorate (LiClO₄), lithium hexafluoroarsenate (LiAsF₆), lithium bis(fluorosulfonyl)imide (LiFSI), lithium bis(trifluoromethane)sulfonimide (LiTFSI), lithium bis(oxalate)borate (LiBOB), lithium trifluoromethanesulfonate (LiTf), lithium bis(pentafluoroethanesulfonyl)imide (LiBETI), or any derivatives thereof, or any combination thereof. In some embodiments, the lithium salts comprise LiFSI, LiTFSI, LiBETI, or derivatives thereof. In some embodiments, a lithium salt of the plurality of lithium salts comprises a nitrogen atom. In some embodiments, at least two lithium salts of the plurality of lithium salts comprises a nitrogen atom. In some embodiments, a lithium salt of the plurality of lithium salts comprises a non-coordinating anion. In some embodiments, at least two lithium salts of the plurality of lithium salts comprises a non-coordinating anion. In some embodiments, the non-coordinating anion comprises bis(trifluoromethane)sulfonimide (TFSI⁻) or bis(fluorosulfonyl)imide (FSI⁻). In some embodiments, a lithium salt of the plurality of lithium salts comprises NO₃⁻.

The ratio of the salt/solvent combination may be adjusted based on the solubility of the salt(s) in the solvent(s). In some embodiments, the one or more lithium salts are present in an amount of 0.01, 0.05, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.2, 2.4, 2.6, 2.8, or 3 M in the electrolyte composition. In some embodiments, the one or more lithium salts are present in an amount of about 0.01, 0.05, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.2, 2.4, 2.6, 2.8, or 3 M in the electrolyte composition. In some embodiments, the one or more lithium salts are present in an amount of at least 0.01, 0.05, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.2, 2.4, 2.6, 2.8, or 3 M in the electrolyte composition. In some embodiments, the one or more lithium salts are present in an amount of at most 0.01, 0.05, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.2, 2.4, 2.6, 2.8, or 3 M in the electrolyte composition. In some embodiments, the electrolyte composition comprises 1 M of LiTFSI. In some embodiments, the electrolyte composition comprises 0.5 M of LiTFSI. In some embodiments, the electrolyte composition comprises 2 M of LiTFSI. In some embodiments, the electrolyte composition comprises 1 M of LiFSI. In some embodiments, the electrolyte composition comprises 0.5 M of LiFSI. In some embodiments, the electrolyte composition comprises 2 M of LiFSI.

In some embodiments, the electrolyte component further comprises one or more additives. The one or more additives may be configured to enhance the performance and stability of electrolytes. In some embodiments, the one or more additives may contribute to the overall stability of the electrolyte by preventing degradation under high temperatures and minimizing side reactions with electrodes. By improving ionic conductivity, additives facilitate efficient ion transport, which is vital for maintaining high charge and discharge rates. In some embodiments, the one or more additives may be configured to promote the formation of a stable solid-electrolyte interphase (SEI) that protects the electrodes while allowing for effective ion conduction, thereby enhancing the longevity and safety of the device. In some embodiments, the one or more additives may be configured to modify the viscosity of the electrolyte, ensuring optimal flow and penetration into porous electrode materials. In some embodiments, the one or more additives include at least one of, but are not limited to, lithium difluorophosphate (LiDFP), lithium difluorobis(oxalate) phosphate (LiDFOP), lithium bis(oxalate)borate (LIBOB), lithium difluoro(oxalato)borate (LiDFOB), lithium hexafluorophosphate (LiPF₆), fluoroethylene carbonate (FEC), vinylene carbonate (VC), dimethyl carbonate (DMC), ethylene carbonate (EC), ammonium nitrate (NH₄NO₃), and lithium nitrate (LiNO₃). In some embodiments, the one or more additives comprise LiNO₃. In some embodiments, the one or more additives comprise VC. In some embodiments, the one or more additives comprise LiPF₆. In some embodiments, the one or more additives comprise LiDFP. In some embodiments, the one or more additives comprise LiDFOP. LiNO₃ may promote formation of a nitrogen-rich surface layer formation on the anode to prevent dendrites which encourages a longer cycle life.

In some embodiments, the one or more additives are present in an amount ranging from about 0.1 wt % to about 5 wt % of the electrolyte composition. In some embodiments, the one or more additives are present in an amount of 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.5, 3, 3.5, 4, 4.5, or 5 wt % of the electrolyte composition. In some embodiments, the one or more additives are present in an amount of about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.5, 3, 3.5, 4, 4.5, or 5 wt % of the electrolyte composition. In some embodiments, the one or more additives are present in an amount of at least 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.5, 3, 3.5, 4, 4.5, or 5 wt % of the electrolyte composition. In some embodiments, the one or more additives are present in an amount of at most 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.5, 3, 3.5, 4, 4.5, or 5 wt % of the electrolyte composition. In some embodiments, the one or more additives are present in an amount of 0.01, 0.02, 0.05, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, or 2 M in the electrolyte composition. In some embodiments, the one or more additives are present in an amount of about 0.01, 0.02, 0.05, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, or 2 M in the electrolyte composition. In some embodiments, the one or more additives are present in an amount of at least 0.01, 0.02, 0.05, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, or 2 M in the electrolyte composition. In some embodiments, the one or more additives are present in an amount of at most 0.01, 0.02, 0.05, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, or 2 M in the electrolyte composition. In some embodiments, the electrolyte composition comprises 0.5 wt % of LiNO₃. In some embodiments, the electrolyte composition comprises 1 wt % of LiNO₃. In some embodiments, the electrolyte composition comprises 2 wt % of LiNO₃. In some embodiments, the electrolyte composition comprises 0.5 wt % of LiDFP. In some embodiments, the electrolyte composition comprises 1 wt % of LiDFP. In some embodiments, the electrolyte composition comprises 2 wt % of LiDFP. In some embodiments, the electrolyte composition comprises 0.5 wt % of LiDFOP. In some embodiments, the electrolyte composition comprises 1 wt % of LiDFOP. In some embodiments, the electrolyte composition comprises 2 wt % of LiDFOP. In some embodiments, the electrolyte composition comprises 0.5 wt % of LiPF₆. In some embodiments, the electrolyte composition comprises 1 wt % of LiPF₆. In some embodiments, the electrolyte composition comprises 2 wt % of LiPF₆.

In some embodiments, the plurality of solvents comprises a first solvent, a second solvent, and a third solvent. In some embodiments, the first solvent comprises from 0.05 to 0.5, from 0.1 to 0.4, or from 0.2 to 0.3 v/v of the plurality of solvents. In some embodiments, the second solvent comprises from 0.1 to 0.6, from 0.2 to 0.5, or from 0.3 to 0.4 v/v of the plurality of solvents. In some embodiments, the third solvent comprises from 0.1 to 0.6, from 0.2 to 0.5, or from 0.3 to 0.4 v/v of the plurality of solvents. In some embodiments, the first solvent is DOL. In some embodiments, the second solvent is DME. In some embodiments, the third solvent is TTE.

In some embodiments, the plurality of solvents comprises a first solvent, a second solvent, and a third solvent. In some embodiments, each solvent of the plurality of solvents is present in an amount ranging from about 1 wt % to about 70 wt % of the electrolyte composition. In some embodiments, each solvent of the plurality of solvents is present in an amount of 1, 5, 10, 15, 20, 25, 30, 35, 40, 45, 50, 55, 60, 65, or 70 wt % of the electrolyte composition. In some embodiments, each solvent of the plurality of solvents is present in an amount of about 1, 5, 10, 15, 20, 25, 30, 35, 40, 45, 50, 55, 60, 65, or 70 wt % of the electrolyte composition. In some embodiments, each solvent of the plurality of solvents is present in an amount of at least 1, 5, 10, 15, 20, 25, 30, 35, 40, 45, 50, 55, 60, 65, or 70 wt % of the electrolyte composition. In some embodiments, each solvent of the plurality of solvents is present in an amount of at most 1, 5, 10, 15, 20, 25, 30, 35, 40, 45, 50, 55, 60, 65, or 70 wt % of the electrolyte composition.

In some embodiments, the first solvent is present in an amount ranging from about 5 wt % to about 40 wt % of the electrolyte composition. In some embodiments, the first solvent is present in an amount ranging from about 15 wt % to about 25 wt % of the electrolyte composition. In some embodiments, the first solvent is present in an amount of 5, 10, 15, 20, 25, 30, 35, or 40 wt % of the electrolyte composition. In some embodiments, the first solvent is present in an amount of about 5, 10, 15, 20, 25, 30, 35, or 40 wt % of the electrolyte composition. In some embodiments, the first solvent is present in an amount of at least 5, 10, 15, 20, 25, 30, 35, or 40 wt % of the electrolyte composition. In some embodiments, the first solvent is present in an amount of at most 5, 10, 15, 20, 25, 30, 35, or 40 wt % of the electrolyte composition.

In some embodiments, the second solvent is present in an amount ranging from about 1 wt % to about 45 wt % of the electrolyte composition. In some embodiments, the second solvent is present in an amount ranging from about 10 wt % to about 20 wt % of the electrolyte composition. In some embodiments, the second solvent is present in an amount of an amount of 1, 5, 10, 15, 20, 25, 30, 35, or 45 wt % of the electrolyte composition. In some embodiments, the second solvent is present in an amount of an amount of about 1, 5, 10, 15, 20, 25, 30, 35, or 45 wt % of the electrolyte composition. In some embodiments, the second solvent is present in an amount of an amount of at least 1, 5, 10, 15, 20, 25, 30, 35, or 45 wt % of the electrolyte composition. In some embodiments, the second solvent is present in an amount of an amount of at most 1, 5, 10, 15, 20, 25, 30, 35, or 45 wt % of the electrolyte composition.

In some embodiments, the third solvent is present in an amount ranging from about 5 wt % to 70 wt % of the electrolyte composition. In some embodiments, the third solvent is present in an amount ranging from about 35 wt % to 55 wt % of the electrolyte composition. In some embodiments, the third solvent is present in an amount of 5, 10, 15, 20, 25, 30, 35, 40, 45, 50, 55, 60, 65, or 70 wt % of the electrolyte composition. In some embodiments, the third solvent is present in an amount of about 5, 10, 15, 20, 25, 30, 35, 40, 45, 50, 55, 60, 65, or 70 wt % of the electrolyte composition. In some embodiments, the third solvent is present in an amount of at least 5, 10, 15, 20, 25, 30, 35, 40, 45, 50, 55, 60, 65, or 70 wt % of the electrolyte composition. In some embodiments, the third solvent is present in an amount of at most 5, 10, 15, 20, 25, 30, 35, 40, 45, 50, 55, 60, 65, or 70 wt % of the electrolyte composition.

In some embodiments, the plurality of solvents comprises DOL, DME, TEGDME, PEGDME, TTE, or any combination thereof. In some embodiments, the first solvent may be DOL. In some embodiments, the first solvent may be DME. In some embodiments, the first solvent may be TEGDME. In some embodiments, the first solvent may be PEGDME. In some embodiments, the first solvent may be TTE. In some embodiments, the second solvent may be DOL. In some embodiments, the second solvent may be DME. In some embodiments, the second solvent may be TEGDME. In some embodiments, the second solvent may be PEGDME. In some embodiments, the second solvent may be TTE. In some embodiments, the third solvent may be DOL. In some embodiments, the third solvent may be DME. In some embodiments, the third solvent may be TEGDME. In some embodiments, the third solvent may be PEGDME. In some embodiments, the third solvent may be TTE. In some embodiments, DOL is configured to balance viscosity and conductivity.

In some embodiments, the electrolyte composition comprises one or more solvating solvents, one or more lithium salts, and one or more diluents. The one or more diluents may have little or no solvating ability for the one or more lithium salts but may be readily miscible with the one or more solvating solvents. In some embodiments, the electrolyte composition may be configured to promote SEI formation on an anode to prevent growth of dendrites. In some embodiments, the electrolyte composition may be configured to reduce viscosity and improves conductivity. In some embodiments, the electrolyte composition may be configured to introduce excess solvents to maintain lithium salts in solution and prevent precipitation during cycling. In certain embodiments, the electrolyte composition provides excess solvating solvents capable of re-dissolving lithium salts that otherwise precipitate when the solvent is consumed or decomposed during cycling. By maintaining the salts in a solvated state, the electrolyte composition can suppress the formation of salt deposits or dendrite structures that lead to shorting and cell failure.

The electrolyte can comprise a lithium conductive polymer. The lithium conductive polymer can be a copolymer. In some embodiments, the polymer can comprise a block copolymer or a random copolymer. In some embodiments, a portion of the block copolymer is in contact with lithium metal, wherein the portion is substantially unreactive with the lithium metal. A block copolymer can, for example, be annealed to undergo microphase separation, providing an exposed hydrophobic surface that is substantially unreactive with lithium metal. Meanwhile, the block copolymer can further comprise a percolating hydrophilic domain that provides paths for lithium ions to traverse through from one side of the block copolymer to the other. In some embodiments, the block copolymer comprises diblock copolymer, triblock copolymer, triblock terpolymer, multiblock copolymer, grafted copolymer, or any combination thereof. In some embodiments, the block copolymer can comprise PDMS-PEG (e.g., poly(polydimethylsiloxane methacrylate)-b-poly(poly(ethylene glycol) methacrylate)). In some embodiments, the block copolymer can comprise POEM-b-PLMA, POEM-P (PDMSMA), PBA-b-PPEGMA, or any combination thereof. In some embodiments, a copolymer can comprise poly(butyl acrylate) (PBA), Poly(butyl methacrylate) (PBMA), Poly(lauryl methacrylate) (PLMA), Poly(ethylene) (PE), Poly(ethylene-alt-propylene) (PEP), Poly(urethane) (PU), Poly(butadiene) (PB), Poly(polyvinylidene methacrylate) (PPVDFMA), Poly(polytetrafluoroethylene methacrylate) (PPTFEMA), Poly(perfluoropolyether) (PFPE), Poly(perfluoropolyether methacrylate) (PFPEMA), Poly(perfluoropolyether acrylate) (PFPEA), Poly(poly(ethylene glycol) methacrylate) (PPEGMA), Poly(poly(ethylene glycol) acrylate) (PPEGA), Poly(perfluoropolyether methacrylate) (PFPEMA), Poly(perfluoropolyether acrylate) (PFPEA), or any combination thereof.

The hydrophobic polymer can comprise, e.g., a cyclic olefin copolymer, fluorinated ethylene propylene, ethylene-methyl acrylate copolymer, polymonochlorotrifluoroethylene, perfluoroalkoxy polymer, polymethylpentene, polypropylene, polyphenylene sulfide, polystyrene, polytetrafluoroethylene, polyvinylchloride, polyethylene, ethylene vinyl acetate, or any combination thereof.

In some embodiments, an electrolyte may be a high conductivity electrolyte with a lithium transference number >0.3, a low flammability, and weakly solvating ability to minimize the charge transfer resistance. In some embodiments, fluorinated compounds tend to make an inorganic rich SEI layer that promotes higher coulombic efficiencies.

In some embodiments, an electrolyte may be configured to form a passivation layer upon contact with a negative electrode, a positive electrode or both. The passivation layer can be a solid. The passivation layer can be stable such that further growth of the passivation layer is limited. The passivation layer can be configured to provide a low charge-transfer impedance. In some embodiments, an electrolyte can be configured to form a passivation layer upon contact with aluminum. In some embodiments, an electrolyte can be configured to form a passivation layer comprising AlF₃. In some embodiments, an electrolyte can be stable when contacted with water. In some embodiments, an electrolyte does not produce HF when contacted with water.

In some embodiments, an electrolyte may be configured to have a 1^{st} cycle Coulombic efficiency of at least 90, 91 92, 93, 94, 95, 96, 97, 98, 99, 99.1, 99.2, 99.3, 99.4, 99.5, 99.6, 99.7, 99.8, 99.9, 99.91, 99.92, 99.93, 99.94, 99.95, 99.96, 99.97, 99.98, or 99.99 percent when incorporated into a rechargeable energy source system of the present disclosure. In some embodiments, an electrolyte may be configured to have a 1st cycle Coulombic efficiency of at most 90, 91 92, 93, 94, 95, 96, 97, 98, 99, 99.1, 99.2, 99.3, 99.4, 99.5, 99.6, 99.7, 99.8, 99.9, 99.91, 99.92, 99.93, 99.94, 99.95, 99.96, 99.97, 99.98, or 99.99 percent when incorporated into a rechargeable energy source system of the present disclosure.

In some embodiments, an electrolyte may be compatible with a negative electrode of the present disclosure, a positive electrode of the present disclosure, or both. In some embodiments, the electrolyte comprises a carbonate. In some embodiments, the electrolyte comprises an ether. In some embodiments, the electrolyte comprises an inorganic salt. In some embodiments, the electrolyte comprises a co-salt in addition to the inorganic salt. In some embodiments, the electrolyte comprises a solvent. In some embodiments, the electrolyte is a mixture of various electrolyte components disclosed herein. The various electrolyte components can have a wide variety of concentrations. For example, the electrolyte can comprise LP30 (1.0 M LiPF6 EC/DMC). In some embodiments, the inorganic salt can comprise LiPF₆, LiDFOB, LiBOB, LiFSI, LiTFSI, LiCF₃SO₃, or any combination thereof. In some embodiments, the solvent can comprise EC, DMC, EMC (ethyl methyl carbonate), DOL, DME, TTE, or any combination thereof. In some embodiments, the electrolyte can comprise an additive. In some embodiments, the additive can comprise PC, FEC (fluoroethylene carbonate), VC (vinylene carbonate), LiNO₃, CsNO₃, or any combination thereof.

In some embodiments, an electrolyte comprises an aqueous electrolyte. In some embodiments, an electrolyte comprises a non-aqueous electrolyte. In some embodiments, an electrolyte comprises a polymer electrolyte. In some embodiments, an electrolyte comprises an organic electrolyte. In some embodiments, an electrolyte comprises a lithium salt. In some embodiments, an electrolyte comprises an ionic liquid. In some embodiments, an electrolyte comprises a deep eutectic solvent. The electrolyte can be used in the manufacture of a lithium metal electrode. The electrolyte can be used in a rechargeable energy source system.

In some embodiments, an electrolyte is non-flammable or fire-resistant. In some embodiments, an electrolyte is substantially non-volatile at room temperature and pressure. In some embodiments, an electrolyte is non-flammable at room temperature and pressure. In some embodiments, an electrolyte is self-extinguishing. In some embodiments, an electrolyte comprises additives, e.g., nitrogen, sulfur, phosphorus, or silicon compounds.

In some embodiments, an electrolyte is a liquid at a temperature of at least −40, −30, −20, −10, 0, 10, 20, 30, 40, 50, 60, or 70° C. In some embodiments, an electrolyte is a liquid at a temperature of at most −40, −30, −20, −10, 0, 10, 20, 30, 40, 50, 60, or 70° C.

In some embodiments, an electrolyte comprises a surface tension of at least 5, 10, 15, 20, 25, 30, 35, 40, 45, 50, 55, or 60 mN/m. In some embodiments, an electrolyte comprises a surface tension of at most 5, 10, 15, 20, 25, 30, 35, 40, 45, 50, 55, or 60 mN/m.

In some embodiments, an electrolyte comprises a decomposition potential of at least 2, 3, 4, 5, or 6 V. In some embodiments, an electrolyte comprises a decomposition potential of at most 2, 3, 4, 5, or 6 V. In some embodiments, an electrolyte comprises a dielectric constant of at least 2, 5, 10, 20, 30, 40, 50, 60, 70, or 80. In some embodiments, an electrolyte comprises a dielectric constant of at most 3, 5, 10, 20, 30, 40, 50, 60, 70, 80, or 90. An electrolyte can comprise various viscosities. Polymeric or polymer solution electrolytes can comprise a large viscosity, as the viscosity can scale exponentially with the molecular weight of the polymer above a critical molecular weight (e.g., entanglement molecular weight). In some embodiments, an electrolyte comprises a viscosity of at least 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, or 900 mPa·s. In some embodiments, an electrolyte comprises a viscosity of at least 1, 2, 3, 4, 5, 6, 7, 8, 9, 10, 20, 30, 40, 50, 60, 70, 80, 90, 100, 200, 300, 400, 500, 600, 700, 800, or 900 Pas. In some embodiments, an electrolyte comprises a viscosity of at least 1, 2, 3, 4, 5, 6, 7, 8, 9, 10, 20, 30, 40, 50, 60, 70, 80, 90, 100, 200, 300, 400, 500, 600, 700, 800, or 900 kPa·s. In some embodiments, an electrolyte comprises a viscosity of at most 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, or 900 mPa·s. In some embodiments, an electrolyte comprises a viscosity of at most 1, 2, 3, 4, 5, 6, 7, 8, 9, 10, 20, 30, 40, 50, 60, 70, 80, 90, 100, 200, 300, 400, 500, 600, 700, 800, or 900 Pa·s. In some embodiments, an electrolyte comprises a viscosity of at most 1, 2, 3, 4, 5, 6, 7, 8, 9, 10, 20, 30, 40, 50, 60, 70, 80, 90, 100, 200, 300, 400, 500, 600, 700, 800, or 900 kPa·s.

Various organic electrolytes can be used. In some embodiments, an organic electrolyte can comprise dimethyl carbonate, ethylmethyl carbonate, diethyl carbonate, ethylene carbonate, propylene carbonate, 1,3-dioxolan-2-one, 4-methyl-1,3-dioxolan-2-one, oxolan-2-one, and any combination thereof. In some embodiments, an electrolyte can comprise an organic carbonate compound, an ester compound, an ether compound, a ketone compound, an alcohol compound, an aprotic bipolar solvent, or a combination thereof. The carbonate compound may be an open chain carbonate compound, a cyclic carbonate compound, a fluorocarbonate derivative thereof, or a combination thereof.

In some embodiments, the chain carbonate compound can be diethyl carbonate (DEC), dimethyl carbonate, (DMC), dipropyl carbonate (DPC), methylpropyl carbonate (MPC), ethylpropylcarbonate (EPC), methylethyl carbonate (MEC), or any combination thereof. In some embodiments, the cyclic carbonate compound can be ethylene carbonate (EC), propylenecarbonate (PC), butylene carbonate (BC), fluoroethylene carbonate (FEC), vinylethylene carbonate (VEC), or any combination thereof. In some embodiments, the fluorocarbonate compound can be fluoroethylene carbonate (FEC), 4,5-difluoroethylene carbonate, 4,4-difluoroethylene carbonate, 4,4,5-trifluoroethylene carbonate, 4,4,5,5-tetrafluoroethylene carbonate, 4-fluoro-5-methylethylene carbonate, 4-fluoro-4-methylethylene carbonate, 4,5-difluoro-4-methylethylene carbonate, 4,4,5-trifluoro-5-methylethylene carbonate, trifluoromethylethylene carbonate, or any combination thereof. In some embodiments, the carbonate compound may include a combination of cyclic carbonate and chain carbonate, in consideration of dielectric constant and viscosity of the electrolyte. In some embodiments, the carbonate compound may be a mixture of such chain carbonate and/or cyclic carbonate compounds as described above with a fluorocarbonate compound. In some embodiments, the plurality of solvents comprises DEC, DMC, MEC, EC, or FEC. In some embodiments, the first solvent may be DEC. In some embodiments, the first solvent may be DMC. In some embodiments, the first solvent may be MEC. In some embodiments, the first solvent may be EC. In some embodiments, the first solvent may be FEC. In some embodiments, the second solvent may be DEC. In some embodiments, the second solvent may be DMC. In some embodiments, the second solvent may be MEC. In some embodiments, the second solvent may be EC. In some embodiments, the second solvent may be FEC. In some embodiments, the third solvent may be DEC. In some embodiments, the third solvent may be DMC. In some embodiments, the third solvent may be MEC. In some embodiments, the third solvent may be EC. In some embodiments, the third solvent may be FEC.

In some embodiments, the fluorocarbonate compound may increase solubility of a lithium salt to improve ionic conductivity of the electrolyte, and may facilitate formation of the thin film on the negative electrode.

In some embodiments, the ester compound is methyl acetate, ethyl acetate, n-propyl acetate, dimethyl acetate, methyl propionate (MP), ethyl propionate, γ-butyrolactone, decanolide, valerolactone, mevalonolactone, caprolactone, methyl formate, or any combination thereof. In some embodiments, the ether compound is dibutyl ether, tetraglyme, diglyme, 1,2-dimethoxyethane, 1,2-diethoxyethane, ethoxymethoxyethane, 2-methyltetrahydrofuran, tetrafluoroproyl ether (TTE), tetrahydrofuran, or any combination thereof. An example of the ketone compound is cyclohexanone. In some embodiments, the alcohol compound can be ethyl alcohol or isopropyl alcohol. In some embodiments, the aprotic solvent can be a nitrile (such as R—CN, wherein R is a C2-C20 linear, branched, or cyclic hydrocarbon-based moiety that may include a double-bond, an aromatic ring or an ether bond), amides (such as formamide and dimethylformamide), dioxolanes (such as 1,2-dioxolane and 1,3-dioxolane), methylsulfoxide, sulfolanes (such as sulfolane and methylsulfolane), 1,3-dimethyl-2-imidazolidinone, N-methyl-2-pyrrolidinone, nitromethane, trimethyl phosphate, triethyl phosphate, trioctyl phosphate, triester phosphate, or any combination thereof. In some embodiments, an electrolyte can comprise an aromatic hydrocarbon organic solvent in a carbonate solvent. In some embodiments, an aromatic hydrocarbon organic solvent can be benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, 2-fluorotoluene, 3-fluorotoluene, 4-fluorotoluene, 2,3-difluorotoluene, 2,4-difluorotoluene, 2,5-difluorotoluene, 2,6-difluorotoluene, 3,4-difluorotoluene, 3,5-difluorotoluene, 2,3,4-trifluorotoluene, 2,3,5-trifluorotoluene, 2,3,6-trifluorotoluene, 3,4,5-trifluorotoluene, 2,4,5-trifluorotoluene, 2,4,6-trifluorotoluene, 2-chlorotoluene, 3-chlorotoluene, 4-chlorotoluene, 2,3-dichlorotoluene, 2,4-dichlorotoluene, 2,5-dichlorotoluene, 2,6-dichlorotoluene, 2,3,4-trichlorotoluene, 2,3,5-trichlorotoluene, 2,3,6-trichlorotoluene, 3,4,5-trichlorotoluene, 2,4,5-trichlorotoluene, 2,4,6-trichlorotoluene, 2-iodotoluene, 3-iodotoluene, 4-iodotoluene, 2,3-diiodotoluene, 2,4-diiodotoluene, 2,5-diiodotoluene, 2,6-diiodotoluene, 3,4-diiodotoluene, 3,5-diiodotoluene, 2,3,4-triiodotoluene, 2,3,5-triiodotoluene, 2,3,6-triiodotoluene, 3,4,5-triiodotoluene, 2,4,5-triiodotoluene, 2,4,6-triiodotoluene, o-xylene, m-xylene, p-xylene, or any combination thereof.

Various polymeric electrolytes can be used. A polymer electrolyte can comprise poly(ethylene oxide), poly(vinyl alcohol), poly(methyl methacrylate), poly(caprolactone), poly(chitosan), poly(vinyl pyrrolidone), poly(vinyl chloride), poly(vinyl fluoride), poly(imide), or any combination thereof, which can inherently conduct lithium ions or be doped with one or more lithium salts to make the polymer be lithium conductive.

Various ionic liquids can be used, e.g., any one of the ionic liquids listed on the Ionic Liquids Database (ILThermo) of the National Institute of Standards and Technology.

Various lithium salts can be used. A lithium salt can comprise lithium 12-hydroxystearate, lithium acetate, lithium amide, lithium aspartate, lithium azide, lithium bis(trifluoromethanesulfonyl)imide, lithium borohydride, lithium bromide, lithium carbonate, lithium chlorate, lithium chloride, lithium citrate, lithium cyanide, lithium diphenylphosphide, lithium hexafluorogermanate, lithium hexafluorophosphate, lithium hypochlorite, lithium hypofluorite, lithium metaborate, lithium methoxide, lithium naphthalene, lithium niobate, lithium nitrate, lithium nitrite, lithium oxalate, lithium perchlorate, lithium stearate, lithium succinate, lithium sulfate, lithium sulfide, lithium superoxide, lithium tantalate, lithium tetrachloroaluminate, lithium tetrafluoroborate, lithium tetrakis(pentafluorophenyl)borate, lithium triflate, lithium tungstate, or any combination thereof. In some embodiments, an electrolyte can comprise lithium salts comprising an organic anion selected from the group consisting of trifluoromethanesulfonyl-imide (TFSI), N-butyl-N-methylpyrrolidinium bis(trifluoromethanesulfonyl)imide (PyruTFSI), trifluoromethanesulfonyl-imide, bis(trifluoromethanesulfonyl)imide (LiTFSI), 1-ethyl-3-methylimidazolium-bis(trifluoromethylsulfonyl)imide (EMI-TFSI), or any combination thereof. In some embodiments, the catholyte 290 comprises ionic liquid-forming salts dissolved in 1,3-dioxolane (DOL), 1,2 dimethoxyethane (DME), or tetraethylene glycol dimethyl ether (TEGDME). In some embodiments, an electrolyte can comprise Li₂SO₄, Li₂CO₃, LiPF₆, LiBF₄, LiBH₄, LiBO, LiDFOB, LiClO₄, LiTFSI, or any combination thereof. In some embodiments, an electrolyte can comprise LiPF₆, LiBF₄, LiBH₄, LiBO, LiDFOB, LiSbF₆, LiAsF₆, LiSbF₆, LiCF₃SO₃, Li(CF₃SO₂)₃C, Li(CF₃SO₂)₂N, LiC₄F₉SO₃, LiClO₄, LiAlO₄, LiAlCl₄, LiAlF₄, LiBPh₄, LiBioCl₁₀, CH₃SO₃Li, C₄F₃SO₃Li, (CF₃SO₂)₂NLi, LiN(CF₂ₓ₊₁SO₂)(CₓF_{2y+1}SO₂) (wherein x and y are natural numbers), CF₃CO₂Li, LiCl, LiBr, LiI, LIBOB (lithium bisoxalato borate), lower aliphatic carboxylic acid lithium, lithium terphenylborate, lithium imide, or any combination thereof. In some embodiments, a concentration of the lithium salt may be in a range of about 0.1 molar (“M”) to about 2.0 M. In some embodiments, a concentration of the lithium salt is at least 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.5, 2.0, 2.5, or 3 M. In some embodiments, a concentration of the lithium salt is at most 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.5, 2.0, 2.5, or 3 M.

The electrolyte can comprise a lithium conductive polymer. The lithium conductive polymer can be a copolymer. In some embodiments, the polymer can comprise a block copolymer or a random copolymer. In some embodiments, a portion of the block copolymer is in contact with lithium metal, wherein the portion is substantially unreactive with the lithium metal. A block copolymer can, for example, be annealed to undergo microphase separation, providing an exposed hydrophobic surface that is substantially unreactive with lithium metal. Meanwhile, the block copolymer can further comprise a percolating hydrophilic domain that provides paths for lithium ions to traverse through from one side of the block copolymer to the other. In some embodiments, the block copolymer comprises diblock copolymer, triblock copolymer, triblock terpolymer, multiblock copolymer, grafted copolymer, or any combination thereof. In some embodiments, the block copolymer can comprise PDMS-PEG (e.g., poly(polydimethylsiloxane methacrylate)-b-poly(poly(ethylene glycol) methacrylate)). In some embodiments, the block copolymer can comprise POEM-b-PLMA, POEM-P (PDMSMA), PBA-b-PPEGMA, or any combination thereof. In some embodiments, a copolymer can comprise poly(butyl acrylate) (PBA), Poly(butyl methacrylate) (PBMA), Poly(lauryl methacrylate) (PLMA), Poly(ethylene) (PE), Poly(ethylene-alt-propylene) (PEP), Poly(urethane) (PU), Poly(butadiene) (PB), Poly(polyvinylidene methacrylate) (PPVDFMA), Poly(polytetrafluoroethylene methacrylate) (PPTFEMA), Poly(perfluoropolyether) (PFPE), Poly(perfluoropolyether methacrylate) (PFPEMA), Poly(perfluoropolyether acrylate) (PFPEA), Poly(poly(ethylene glycol) methacrylate) (PPEGMA), Poly(poly(ethylene glycol) acrylate) (PPEGA), Poly(perfluoropolyether methacrylate) (PFPEMA), Poly(perfluoropolyether acrylate) (PFPEA), or any combination thereof.

The hydrophobic polymer can comprise, e.g., a cyclic olefin copolymer, fluorinated ethylene propylene, ethylene-methyl acrylate copolymer, polymonochlorotrifluoroethylene, perfluoroalkoxy polymer, polymethylpentene, polypropylene, polyphenylene sulfide, polystyrene, polytetrafluoroethylene, polyvinylchloride, polyethylene, ethylene vinyl acetate, or any combination thereof.

In some embodiments, an electrolyte may be a high conductivity electrolyte with a lithium transference number >0.3, a low flammability, and weakly solvating ability to minimize the charge transfer resistance. In some embodiments, fluorinated compounds tend to make an inorganic rich SEI layer that promotes higher coulombic efficiencies.

In some embodiments, an electrolyte may be configured to form a passivation layer upon contact with a negative electrode, a positive electrode or both. The passivation layer can be a solid. The passivation layer can be stable such that further growth of the passivation layer is limited. The passivation layer can be configured to provide a low charge-transfer impedance. In some embodiments, an electrolyte can be configured to form a passivation layer upon contact with aluminum. In some embodiments, an electrolyte can be configured to form a passivation layer comprising AlF₃. In some embodiments, an electrolyte can be stable when contacted with water. In some embodiments, an electrolyte does not produce HF when contacted with water.

In some embodiments, an electrolyte may be configured to have a 1st cycle Coulombic efficiency of at least 90, 91 92, 93, 94, 95, 96, 97, 98, 99, 99.1, 99.2, 99.3, 99.4, 99.5, 99.6, 99.7, 99.8, 99.9, 99.91, 99.92, 99.93, 99.94, 99.95, 99.96, 99.97, 99.98, or 99.99 percent when incorporated into a rechargeable energy source system of the present disclosure. In some embodiments, an electrolyte may be configured to have a 1st cycle Coulombic efficiency of at most 90, 91 92, 93, 94, 95, 96, 97, 98, 99, 99.1, 99.2, 99.3, 99.4, 99.5, 99.6, 99.7, 99.8, 99.9, 99.91, 99.92, 99.93, 99.94, 99.95, 99.96, 99.97, 99.98, or 99.99 percent when incorporated into a rechargeable energy source system of the present disclosure.

In some embodiments, an electrolyte may be compatible with a negative electrode of the present disclosure, a positive electrode of the present disclosure, or both. In some embodiments, the electrolyte comprises a carbonate. In some embodiments, the electrolyte comprises an ether. In some embodiments, the electrolyte comprises an inorganic salt. In some embodiments, the electrolyte comprises a co-salt in addition to the inorganic salt. In some embodiments, the electrolyte comprises a solvent. In some embodiments, the electrolyte is a mixture of various electrolyte components disclosed herein. The various electrolyte components can have a wide variety of concentrations. For example, the electrolyte can comprise LP30 (1.0 M LiPF₆ EC/DMC). In some embodiments, the inorganic salt can comprise LiPF₆, LiDFOB, LiBOB, LiFSI, LiTFSI, LiCF₃SO₃, or any combination thereof. In some embodiments, the solvent can comprise EC, DMC, EMC (ethyl methyl carbonate), DOL, DME, TTE, or any combination thereof. In some embodiments, the electrolyte can comprise an additive. In some embodiments, the additive can comprise PC, FEC (fluoroethylene carbonate), VC (vinylene carbonate), LiNO₃, CsNO₃, or any combination thereof.

An electrolyte can comprise various viscosities.

Polymeric or polymer solution electrolytes can comprise a large viscosity, as the viscosity can scale exponentially with the molecular weight of the polymer above a critical molecular weight (e.g., entanglement molecular weight). In some embodiments, an electrolyte comprises a viscosity of 0.1 mPa·s, 0.2 mPa·s, 0.3 mPa·s, 0.4 mPa·s, 0.5 mPa·s, 0.6 mPa·s, 0.7 mPa·s, 0.8 mPa·s, 0.9 mPa·s, 1 mPa·s, 2 mPa·s, 3 mPa·s, 4 mPa·s, 5 mPa·s, 6 mPa·s, 7 mPa·s, 8 mPa·s, 9 mPa·s, 10 mPa·s, 20 mPa·s, 30 mPa·s, 40 mPa·s, 50 mPa·s, 60 mPa·s, 70 mPa·s, 80 mPa·s, 90 mPa·s, 100 mPa·s, 200 mPa·s, 300 mPa·s, 400 mPa·s, 500 mPa·s, 600 mPa·s, 700 mPa·s, 800 mPa·s, or 900 mPa·s. In some embodiments, an electrolyte comprises a viscosity of about 0.1 mPa·s, about 0.2 mPa·s, about 0.3 mPa·s, about 0.4 mPa·s, about 0.5 mPa·s, about 0.6 mPa·s, about 0.7 mPa·s, about 0.8 mPa·s, about 0.9 mPa·s, about 1 mPa·s, about 2 mPa·s, about 3 mPa·s, about 4 mPa·s, about 5 mPa·s, about 6 mPa·s, about 7 mPa·s, about 8 mPa·s, about 9 mPa·s, about 10 mPa·s, about 20 mPa·s, about 30 mPa·s, about 40 mPa·s, about 50 mPa·s, about 60 mPa·s, about 70 mPa·s, about 80 mPa·s, about 90 mPa·s, about 100 mPa·s, about 200 mPa·s, about 300 mPa·s, about 400 mPa·s, about 500 mPa·s, about 600 mPa·s, about 700 mPa·s, about 800 mPa·s, or about 900 mPa·s. In some embodiments, an electrolyte comprises a viscosity of at least 0.1 mPa·s, at least 0.2 mPa·s, at least 0.3 mPa·s, at least 0.4 mPa·s, at least 0.5 mPa·s, at least 0.6 mPa·s, at least 0.7 mPa·s, at least 0.8 mPa·s, at least 0.9 mPa·s, at least 1 mPa·s, at least 2 mPa·s, at least 3 mPa·s, at least 4 mPa·s, at least 5 mPa·s, at least 6 mPa·s, at least 7 mPa·s, at least 8 mPa·s, at least 9 mPa·s, at least 10 mPa·s, at least 20 mPa·s, at least 30 mPa·s, at least 40 mPa·s, at least 50 mPa·s, at least 60 mPa·s, at least 70 mPa·s, at least 80 mPa·s, at least 90 mPa·s, at least 100 mPa·s, at least 200 mPa·s, at least 300 mPa·s, at least 400 mPa·s, at least 500 mPa·s, at least 600 mPa·s, at least 700 mPa·s, at least 800 mPa·s, or at least 900 mPa·s. In some embodiments, an electrolyte comprises a viscosity of at most 0.1 mPa·s, at most 0.2 mPa·s, at most 0.3 mPa·s, at most 0.4 mPa·s, at most 0.5 mPa·s, at most 0.6 mPa·s, at most 0.7 mPa·s, at most 0.8 mPa·s, at most 0.9 mPa·s, at most 1 mPa·s, at most 2 mPa·s, at most 3 mPa·s, at most 4 mPa·s, at most 5 mPa·s, at most 6 mPa·s, at most 7 mPa·ss, at most 8 mPa·s, at most 9 mPa·s, at most 10 mPa·ss, at most 20 mPa·s, at most 30 mPa·s, at most 40 mPa·s, at most 50 mPa·s, at most 60 mPa·s, at most 70 mPa·s, at most 80 mPa·s, at most 90 mPa·s, at most 100 mPa·s, at most 200 mPa·s, at most 300 mPa·s, at most 400 mPa·s, at most 500 mPa·s, at most 600 mPa·s, at most 700 mPa·s, at 1 most 800 mPa·s, or at most 900 mPa·s.

In some embodiments, an electrolyte comprises a viscosity of 1 Paes, 2 Pa·s, 3 Pa·s, 4 Pa·s, 5 Pa·s, 6 Pas, 7 Pa·s, 8 Pa·s, 9 Pa·s, 10 Pa·s, 20 Pas, 30 Pa·s, 40 Pas, 50 Pa·s, 60 Pa·s, 70 Pa·s, 80 Pa·s, 90 Pa·s, 100 Pa·s, 200 Pa·s, 300 Pa·s, 400 Pa·s, 500 Pa·s, 600 Pa·s, 700 Pa·s, 800 Pa·s, or 900 Pa·s. In some embodiments, an electrolyte comprises a viscosity of about 1 Pas, about 2 Pads, about 3 Pas, about 4 Pa·s, about 5 Pas, about 6 Pads, about 7 Pa·s, about 8 Pa·s, about 9 Pa·s, about 10 Pads, about 20 Pas, about 30 Pa·s, about 40 Pas, about 50 Pa·s, about 60 Pas, about 70 Pas, about 80 Pa·s, about 90 Pas, about 100 Pas, about 200 Pa·s, about 300 Pas, about 400 Pas, about 500 Pas, about 600 Pas, about 700 Pas, about 800 Pads, or about 900 Pa·s. In some embodiments, an electrolyte comprises a viscosity of at least 1 Pa·s, at least 2 Pa's, at least 3 Pas, at least 4 Pads, at least 5 Pads, at least 6 Pas, at least 7 Paos, at least 8 Pads, at least 9 Pads, at least 10 Pads, at least 20 Pads, at least 30 Pas, at least 40 Pa·s, at least 50 Pa·s, at least 60 Pas, at least 70 Pas, at least 80 Pas, at least 90 Pa·s, at least 100 Paes, at least 200 Pads, at least 300 Pads, at least 400 Pas, at least 500 Pa·s, at least 600 Pas, at least 700 Pas, at least 800 Pa·s, or at least 900 Pas. In some embodiments, an electrolyte comprises a viscosity of at most 1 Pas, at most 2 Pads, at most 3 Pas, at most 4 Pads, at most 5 Pas, at most 6 Pads, at most 7 Paos, at most 8 Paes, at most 9 Paes, at most 10 Pas, at most 20 Paes, at most 30 Pass, at most 40 Pads, at most 50 Pass, at most 60 Paes, at most 70 Paes, at most 80 Paos, at most 90 Pa·s, at most 100 Pas, at most 200 Pads, at most 300 Pa·s, at most 400 Pads, at most 500 Pa·s, at most 600 Pads, at most 700 Pa·s, at most 800 Pass, or at most 900 Pa·s.

In some embodiments, an electrolyte comprises a viscosity of 1 kPa·s, 2 kPa·s, 3 kPa·s, 4 kPa·s, 5 kPa·s, 6 kPa·s, 7 kPa·s, 8 kPa·s, 9 kPa·s, 10 kPa·s, 20 kPa·s, 30 kPa·s, 40 kPa·s, 50 kPa·s, 60 kPa·s, 70 kPa·s, 80 kPa·s, 90 kPa·s, 100 kPa·s, 200 kPa·s, 300 kPa·s, 400 kPa·s, 500 kPa·s, 600 kPa·s, 700 kPa·s, 800 kPa·s, or 900 kPa·s. In some embodiments, an electrolyte comprises a viscosity of about 1 kPa·s, about 2 kPa·s, about 3 kPa·s, about 4 kPa·s, about 5 kPa·s, about 6 kPa·s, about 7 kPa·s, about 8 kPa·s, about 9 kPa·s, about 10 kPa·s, about 20 kPa·s, about 30 kPa·s, about 40 kPa·s, about 50 kPa·s, about 60 kPa·s, about 70 kPa·s, about 80 kPa·s, about 90 kPa·s, about 100 kPa·s, about 200 kPa·s, about 300 kPa·s, about 400 kPa·s, about 500 kPa·s, about 600 kPa·s, about 700 kPa·s, about 800 kPa·s, or about 900 kPa·s. In some embodiments, an electrolyte comprises a viscosity of at least 1 kPa·s, at least 2 kPa·s, at least 3 kPa·s, at least 4 kPa·s, at least 5 kPa·s, at least 6 kPa·s, at least 7 kPa·s, at least 8 kPa·s, at least 9 kPa·s, at least 10 kPa·s, at least 20 kPa·s, at least 30 kPa·s, at least 40 kPa·s, at least 50 kPa·s, at least 60 kPa·s, at least 70 kPa·s, at least 80 kPa·s, at least 90 kPa·s, at least 100 kPa·s, at least 200 kPa·s, at least 300 kPa·s, at least 400 kPa·s, at least 500 kPa·s, at least 600 kPa·s, at least 700 kPa·s, at least 800 kPa·s, or at least 900 kPa·s. In some embodiments, an electrolyte comprises a viscosity of at most 1 kPa·s, at most 2 kPa·s, at most 3 kPa·s, at most 4 kPa·s, at most 5 kPa·s, at most 6 kPa·s, at most k7 Pa·s, at most 8 kPa·s, at most 9 kPa·s, at most 10 kPa·s, at most 20 kPa·s, at most 30 kPa·s, at most 40 kPa·s, at most 50 kPa·s, at most 60 kPa·s, at most 70 kPa·s, at most 80 kPa·s, at most 90 kPa·s, at most 100 kPa·s, at most 200 kPa·s, at most 300 kPa·s, at most 400 kPa·s, at most 500 kPa·s, at most 600 kPa·s, at most 700 kPa·s, at most 800 kPa·s, or at most 900 kPa·s.

The electrolyte may contain one or more lithium salts dissolved in a solvent to provide ionic conductivity between the positive and negative electrodes. Various lithium salts can be used. In some embodiments, the lithium salt in the electrolyte solution can be at least one of, but not limited to, lithium hexafluorophosphate (LiPF₆), lithium tetrafluoroborate (LiBF₄), lithium bis(fluorosulfonyl)imide (LiFSI), lithium bis(trifluoromethanesulfonyl)imide (LiTFSI), lithium tetrafluoroborate (LiBF₄), lithium perchlorate (LiClO₄), lithium trifluoromethanesulfonate (LiCF₃SO₃), lithium bs (oxalate)borate (LiBOB), and lithium difluoro(oxalate)borate (LiDFOB). These salts serve as ionic charge carriers and facilitate the transport of lithium ions between electrodes during charge and discharge. In certain embodiments, salts such as LiTFSI or LiFSI may further enhance electrochemical stability and reduce interfacial resistance, thereby improving the cycle life and safety of the cell. A lithium salt can comprise lithium 12-hydroxystearate, lithium acetate, lithium amide, lithium aspartate, lithium azide, lithium bis(trifluoromethanesulfonyl)imide, lithium borohydride, lithium bromide, lithium carbonate, lithium chlorate, lithium chloride, lithium citrate, lithium cyanide, lithium diphenylphosphide, lithium hexafluorogermanate, lithium hexafluorophosphate, lithium hypochlorite, lithium hypofluorite, lithium metaborate, lithium methoxide, lithium naphthalene, lithium niobate, lithium nitrate, lithium nitrite, lithium oxalate, lithium perchlorate, lithium stearate, lithium succinate, lithium sulfate, lithium sulfide, lithium superoxide, lithium tantalate, lithium tetrachloroaluminate, lithium tetrafluoroborate, lithium tetrakis(pentafluorophenyl)borate, lithium triflate, lithium tungstate, or any combination thereof. In some embodiments, an electrolyte can comprise lithium salts comprising an organic anion selected from the group consisting of trifluoromethanesulfonyl-imide (TFSI), N-butyl-N-methylpyrrolidinium bis(trifluoromethanesulfonyl)imide (PyruTFSI), trifluoromethanesulfonyl-imide, bis(trifluoromethanesulfonyl)imide (LiTFSI), and 1-ethyl-3-methylimidazolium-bis(trifluoromethylsulfonyl)imide (EMI-TFSI). In some embodiments, the catholyte 290 comprises ionic liquid-forming salts dissolved in 1,3-dioxolane (DOL), 1,2 dimethoxyethane (DME), or tetraethylene glycol dimethyl ether (TEGDME). In some embodiments, an electrolyte can comprise Li₂SO₄, Li₂CO₃, LiPF₆, LiBF₄, LiBH₄, LiBO, LiDFOB, LiClO₄, LiTFSI, and combinations thereof. In some embodiments, an electrolyte can comprise LiPF₆, LiBF₄, LiBH₄, LiBO, LiDFOB, LiSbF₆, LiAsF₆, LiSbF₆, LiCF₃SO₃, Li(CF₃SO₂)₃C, Li(CF₃SO₂)₂N, LiC₄F₉SO₃, LiClO₄, LiAlO₄, LiAlCl₄, LiAlF₄, LiBPh₄, LiBioCl₁₀, CH₃SO₃Li, C₄F₃SO₃Li, (CF₃SO₂)₂NLi, LiN(CₓF₂ₓ₊₁SO₂)(CₓF_{2y+1}SO₂) (wherein x and y are natural numbers), CF₃CO₂Li, LiCl, LiBr, LiI, LIBOB (lithium bisoxalato borate), lower aliphatic carboxylic acid lithium, lithium terphenylborate, lithium imide, and any combination thereof.

In some embodiments, a concentration of the lithium salt can be in a range of about 0.1 molar (M) to about 2.0 M. In some embodiments, a concentration of the lithium salt is 0.01 M, 0.02 M, 0.03 M, 0.04 M, 0.05 M, 0.06 M, 0.07 M, 0.08 M, 0.09 M, 0.1 M, 0.2 M, 0.3 M, 0.4 M, 0.5 M, 0.6 M, 0.7 M, 0.8 M, 0.9 M, 1.0 M, 1.5 M, 2.0 M, 2.5 M, or 3 M. In some embodiments, a concentration of the lithium salt is about 0.01 M, about 0.02 M, about 0.03 M, about 0.04 M, about 0.05 M, about 0.06 M, about 0.07 M, about 0.08 M, about 0.09 M, about 0.1 M, about 0.2 M, about 0.3 M, about 0.4 M, about 0.5 M, about 0.6 M, about 0.7 M, about 0.8 M, about 0.9 M, about 1.0 M, about 1.5 M, about 2.0 M, about 2.5 M, or about 3 M. In some embodiments, a concentration of the lithium salt is at least 0.01 M, at least 0.02 M, at least 0.03 M, at least 0.04 M, at least 0.05 M, at least 0.06 M, at least 0.07 M, at least 0.08 M, at least 0.09 M, at least 0.1 M, at least 0.2 M, at least 0.3 M, at least 0.4 M, at least 0.5 M, at least 0.6 M, at least 0.7 M, at least 0.8 M, at least 0.9 M, at least 1.0 M, at least 1.5 M, at least 2.0 M, at least 2.5 M, or at least 3 M. In some embodiments, a concentration of the lithium salt is at most 0.01 M, at most 0.02 M, at most 0.03 M, at most 0.04 M, at most 0.05 M, at most 0.06 M, at most 0.07 M, at most 0.08 M, at most 0.09 M, at most 0.1 M, at most 0.2 M, at most 0.3 M, at most 0.4 M, at most 0.5 M, at most 0.6 M, at most 0.7 M, at most 0.8 M, at most 0.9 M, at most 1.0 M, at most 1.5 M, at most 2.0 M, at most 2.5 M, or at most 3 M.

The electrolyte can comprise a lithium conductive polymer. The lithium conductive polymer can be a copolymer. In some embodiments, the polymer can comprise a block copolymer or a random copolymer. In some embodiments, a portion of the block copolymer is in contact with lithium metal, wherein the portion is substantially unreactive with the lithium metal. A block copolymer can, for example, be annealed to undergo microphase separation, providing an exposed hydrophobic surface that is substantially unreactive with lithium metal. Meanwhile, the block copolymer can further comprise a percolating hydrophilic domain that provides paths for lithium ions to traverse through from one side of the block copolymer to the other. In some embodiments, the block copolymer comprises diblock copolymer, triblock copolymer, triblock terpolymer, multiblock copolymer, and grafted copolymer. In some embodiments, the block copolymer can comprise PDMS-PEG (e.g., poly(polydimethylsiloxane methacrylate)-b-poly(poly(ethylene glycol) methacrylate)). In some embodiments, the block copolymer can comprise POEM-b-PLMA, POEM-P (PDMSMA), PBA-b-PPEGMA, or any combination thereof. In some embodiments, a copolymer can comprise poly(butyl acrylate) (PBA), Poly(butyl methacrylate) (PBMA), Poly(lauryl methacrylate) (PLMA), Poly(ethylene) (PE), Poly(ethylene-alt-propylene) (PEP), Poly(urethane) (PU), Poly(butadiene) (PB), Poly(polyvinylidene methacrylate) (PPVDFMA), Poly(polytetrafluoroethylene methacrylate) (PPTFEMA), Poly(perfluoropolyether) (PFPE), Poly(perfluoropolyether methacrylate) (PFPEMA), Poly(perfluoropolyether acrylate) (PFPEA), Poly(poly(ethylene glycol) methacrylate) (PPEGMA), Poly(poly(ethylene glycol) acrylate) (PPEGA), Poly(perfluoropolyether methacrylate) (PFPEMA), Poly(perfluoropolyether acrylate) (PFPEA), or any combination thereof.

The hydrophobic polymer can comprise, e.g., a cyclic olefin copolymer, fluorinated ethylene propylene, ethylene-methyl acrylate copolymer, polymonochlorotrifluoroethylene, perfluoroalkoxy polymer, polymethylpentene, polypropylene, polyphenylene sulfide, polystyrene, polytetrafluoroethylene, polyvinylchloride, polyethylene, ethylene vinyl acetate, or any combination thereof.

In some embodiments, an electrolyte can be a high conductivity electrolyte with a lithium transference number >0.3, a low flammability, and weakly solvating ability to minimize the charge transfer resistance. In some embodiments, fluorinated compounds tend to make an inorganic rich SEI layer that promotes higher coulombic efficiencies.

In some embodiments, an electrolyte may be configured to form a passivation layer upon contact with a negative electrode, a positive electrode or both. The passivation layer can be a solid. The passivation layer can be stable such that further growth of the passivation layer is limited. The passivation layer can be configured to provide a low charge-transfer impedance. In some embodiments, an electrolyte can be configured to form a passivation layer upon contact with aluminum. In some embodiments, an electrolyte can be configured to form a passivation layer comprising AlF₃. In some embodiments, an electrolyte can be stable when contacted with water. In some embodiments, an electrolyte does not produce HF when contacted with water.

In some embodiments, an electrolyte may be configured to have a 1st cycle Coulombic efficiency of at least 90, 91 92, 93, 94, 95, 96, 97, 98, 99, 99.1, 99.2, 99.3, 99.4, 99.5, 99.6, 99.7, 99.8, 99.9, 99.91, 99.92, 99.93, 99.94, 99.95, 99.96, 99.97, 99.98, or 99.99 percent when incorporated into a rechargeable energy source system of the present disclosure. In some embodiments, an electrolyte may be configured to have a 1st cycle Coulombic efficiency of at most 90, 91 92, 93, 94, 95, 96, 97, 98, 99, 99.1, 99.2, 99.3, 99.4, 99.5, 99.6, 99.7, 99.8, 99.9, 99.91, 99.92, 99.93, 99.94, 99.95, 99.96, 99.97, 99.98, or 99.99 percent when incorporated into a rechargeable energy source system of the present disclosure.

In some embodiments, an electrolyte may be compatible with a negative electrode of the present disclosure, a positive electrode of the present disclosure, or both. In some embodiments, the electrolyte comprises a carbonate. In some embodiments, the electrolyte comprises an ether. In some embodiments, the electrolyte comprises an inorganic salt. In some embodiments, the electrolyte comprises a co-salt in addition to the inorganic salt. In some embodiments, the electrolyte comprises a solvent. In some embodiments, the electrolyte is a mixture of various electrolyte components disclosed herein. The various electrolyte components can have a wide variety of concentrations. For example, the electrolyte can comprise LP30 (1.0 M LiPF6 EC/DMC). In some embodiments, the inorganic salt can comprise LiPF₆, LiDFOB, LiBOB, LiFSI, LiTFSI, LiCF₃SO₃, or any combination thereof. In some embodiments, the solvent can comprise EC, DMC, EMC (ethyl methyl carbonate), DOL, DME, TTE, or any combination thereof. In some embodiments, the electrolyte can comprise an additive. In some embodiments, the additive can comprise PC, FEC (fluoroethylene carbonate), VC (vinylene carbonate), LiNO₃, CsNO₃, or any combination thereof.

### Nanostructured Carbon for Negative Electrode

### Nanostructured Carbon

In some aspects, the present disclosure provides a negative electrode which can be used in a rechargeable energy storage device, for example a lithium metal battery. The negative electrode can comprise one or more carbon phases. The one or more carbon phases can be configured to intercalate lithium ions within the phase itself, spaces between carbon phase structures, or both. The one or more carbon phases can be hard carbon, amorphous carbon, or amorphous hard carbon. Hard carbon phase may be carbon that does not graphitize at temperatures higher than, or as high as, 500, 750, 1000, 1250, 1500, 1750, or 2000 degrees,

The one or more carbon phases can comprise particles, cylinders, sheets, or other continuous morphologies such as lamellae, gyroid, or a continuous comprising spherical or cylindrical holes. For example, a carbon phase can be fabricated from copolymers synthesized from free radical polymerization, where weight fractions of the block copolymer's monomers can be varied to create different phases. Various phases can be synthesized, e.g., in the case of block copolymers made of two different monomers: copolymer A forming spherical domains in a copolymer B matrix, copolymer A forming cylindrical domains in a copolymer B matrix, copolymer A and copolymer B forming a bicontinuous matrix (e.g., gyroid), copolymer A and copolymer B forming a lamellae, or vice versa. One of the domains can be etched via chemical etching, which may leave behind a matrix. The matrix can be pyrolyzed to form hard carbon, for example.

The negative electrode can comprise a plurality of carbon particles. The plurality of carbon particles can be amorphous, hard, or amorphous hard carbon. In some embodiments, the carbon particles can be concaved shaped. The carbon particles can be concavely shaped in that a particle can have one or more cavities or voids. In some embodiments, the carbon particles comprise a flower-like surface structure. In some embodiments, the carbon particles comprise a plurality of carbon nanosheets resembling flower petals. In some embodiments, the carbon particles can refer to carbon flowers. In some embodiments, the carbon particles can refer to carbon roses. The carbon particles disclosed herein are different or distinguishable from a carbon dot or a graphene dot because of their morphology. In some embodiments, carbon particles may be hard carbons. In some embodiments, the negative electrode can comprise one or more carbon phases that are configured to intercalate lithium ions. In some embodiments, the one or more carbon phases can comprise particles (spherical, cylindrical, or other shapes), sheets, ribbons, wires, and various other shapes.

In some embodiments, the one or more carbon phases can be doped with heteroatoms. The heteroatoms can comprise nitrogen, sulfur, oxygen, or metals. The heteroatoms can comprise additives, dopants, or inert elements, e.g., the one or more carbon phases can comprise oxygen, nitrogen, sulfur, fluorine, sodium, calcium, magnesium, or iron atoms. The heteroatoms elements may be in trace amounts. In some embodiments, the one or more carbon phases can be nitrogen-doped. In some embodiments, the one or more carbon phases can be sulfur-doped. The heteroatoms can be detected by X-ray photoelectron spectroscopy (XPS). The nitrogen-doped carbon can be detected by XPS. In some embodiments, the one or more carbon phases may be subjected to a high temperature treatment at about 1000° C. and the amount of any nitrogen element in the resulting material may be minimal.

In some embodiments, the carbon particles can comprise a shape comprising a plurality of protruding nanosheets. The plurality of protruding nanosheets can give the visual impression of a flower-shaped particle, e.g., a carbon flower. The carbon flowers can comprise a type of carbon microstructure/nanostructure that has a floral or flower-like morphology. The morphology of carbon flowers can consist of numerous petal-like structures. In some embodiments, these petals comprise a hard carbon phase, an amorphous carbon phase, or an amorphous hard carbon phase. In some embodiments, these petals further comprise graphene layers, graphite layers, or a combination thereof. In some embodiments, these petals comprise nanosheets. In some embodiments, the carbon nanosheets are stacked in a disorganized manner and separated by large void spaces, giving the appearance of a flower when viewed under an electron microscope. In some embodiments, the carbon particles are spherical in morphology with a corrugated surface. In some embodiments, each carbon particle comprises a network of interconnected corrugated carbon nanosheets. The structure of the carbon flowers may provide or contribute to a high surface area. In some cases, the surface area of the carbon flowers can be from about 100 m²/g to about 5000 m²/g. The carbon particles can provide a high porosity. In some cases, a porosity of the carbon flowers can be from 0.1 to 3 cm³/g.

In some embodiments, the carbon flowers can be doped with heteroatoms. The heteroatoms can comprise nitrogen, sulfur, oxygen, or metals. The heteroatoms can comprise additives, dopants, or inert elements, e.g., the carbon flowers can comprise oxygen, nitrogen, sulfur, fluorine, sodium, calcium, magnesium, or iron atoms. The heteroatoms elements may be in trace amounts. In some embodiments, the carbon flowers can be nitrogen-doped. In some embodiments, the carbon flowers can be sulfur-doped. The heteroatoms can be detected by X-ray photoelectron spectroscopy (XPS). The nitrogen-doped carbon can be detected by XPS.

The structure of carbon flowers may provide or contribute to a high surface area. In some cases, the surface area of the carbon flowers can be from about 10 m²/g to about 5000 m²/g. In certain embodiments, Brunauer-Emmett-Teller (BET) surface area measurements indicate that the carbon flowers have a specific surface area in the range of about 16 m²/g to about 32 m²/g, with a median value of approximately 25 m²/g. In some embodiments, the surface area of the carbon flower may be 12, 14, 16, 18, 20, 22, 24, 26, 28, 30, 32, 34, 36, 38, 40, 42, 44, 46, 48, or 50 m²/g. In some embodiments, the surface area of the carbon flower may be about 12, 14, 16, 18, 20, 22, 24, 26, 28, 30, 32, 34, 36, 38, 40, 42, 44, 46, 48, or 50 m²/g. In some embodiments, the surface area of the carbon flower may be at least 12, 14, 16, 18, 20, 22, 24, 26, 28, 30, 32, 34, 36, 38, 40, 42, 44, 46, 48, or 50 m²/g. In some embodiments, the surface area of the carbon flower may be at most 12, 14, 16, 18, 20, 22, 24, 26, 28, 30, 32, 34, 36, 38, 40, 42, 44, 46, 48, or 50 m²/g.

Higher surface areas can be achieved, e.g., by synthesizing smaller particles, adding heteroatoms which may be etched away from the hard carbon during or after synthesis. In some embodiments, the surface area of the carbon flowers can be from 10 m²/g to 5000 m²/g. In some embodiments, a surface area of the carbon flowers can be 10 m²/g, 20 m²/g, 40 m²/g, 60 m²/g, 80 m²/g, 100 m²/g, 200 m²/g, 400 m²/g, 600 m²/g, 800 m²/g, 1000 m²/g, 1200 m²/g, 1400 m²/g, 1600 m²/g, 1800 m²/g, 2000 m²/g, 2200 m²/g, 2400 m²/g, 2600 m²/g, 2800 m²/g, 3000 m²/g, 3200 m²/g, 3400 m²/g, 3600 m²/g, 3800 m²/g, 4000 m²/g, 4200 m²/g, 4400 m²/g, 4600 m²/g, 4800 m²/g, or 5000 m²/g. In some embodiments, a surface area of the carbon flowers can be about 10 m²/g, about 20 m²/g, about 40 m²/g, about 60 m²/g, about 80 m²/g, about 100 m²/g, about 200 m²/g, about 400 m²/g, about 600 m²/g, about 800 m²/g, about 1000 m²/g, about 1200 m²/g, about 1400 m²/g, about 1600 m²/g, about 1800 m²/g, about 2000 m²/g, about 2200 m²/g, about 2400 m²/g, about 2600 m²/g, about 2800 m²/g, about 3000 m²/g, about 3200 m²/g, about 3400 m²/g, about 3600 m²/g, about 3800 m²/g, about 4000 m²/g, about 4200 m²/g, about 4400 m²/g, about 4600 m²/g, about 4800 m²/g, or about 5000 m²/g. In some embodiments, a surface area of the carbon flowers can be at least 10 m²/g, at least 20 m²/g, at least 40 m²/g, at least 60 m²/g, at least 80 m²/g, at least 100 m²/g, at least 200 m²/g, at least 400 m²/g, at least 600 m²/g, at least 800 m²/g, at least 1000 m²/g, at least 1200 m²/g, at least 1400 m²/g, at least 1600 m²/g, at least 1800 m²/g, at least 2000 m²/g, at least 2200 m²/g, at least 2400 m²/g, at least 2600 m²/g, at least 2800 m²/g, at least 3000 m²/g, at least 3200 m²/g, at least 3400 m²/g, at least 3600 m²/g, at least 3800 m²/g, at least 4000 m²/g, at least 4200 m²/g, at least 4400 m²/g, at least 4600 m²/g, at least 4800 m²/g, or at least 5000 m²/g. In some embodiments, a surface area of the carbon flowers can be at most 400 m²/g, at most 600 m²/g, at most 800 m²/g, at most 1000 m²/g, at most 1200 m²/g, at most 1400 m²/g, at most 1600 m²/g, at most 1800 m²/g, at most 2000 m²/g, at most 2200 m²/g, at most 2400 m²/g, at most 2600 m²/g, at most 2800 m²/g, at most 3000 m²/g, at most 3200 m²/g, at most 3400 m²/g, at most 3600 m²/g, at most 3800 m²/g, at most 4000 m²/g, at most 4200 m²/g, at most 4400 m²/g, at most 4600 m²/g, at most 4800 m²/g, or at most 5000 m²/g. In some embodiments, a surface area of the carbon flowers can be 10 m²/g to 200 m²/g, 20 m²/g to 260 m²/g, 100 m²/g to 1600 m²/g, 200 m²/g to 2600 m²/g, 600 m²/g to 3000 m²/g, or 400 m²/g to 2400 m²/g, including all values and sub ranges in between.

In some embodiments, a pore volume of the carbon flowers can be from 0.1 to 3 cm³/g. In some embodiments, a pore volume of the carbon flowers can be 0.1 cm³/g, 0.2 cm³/g, 0.4 cm³/g, 0.6 cm³/g, 0.8 cm³/g, 1 cm³/g, 1.2 cm³/g, 1.4 cm³/g, 1.6 cm³/g, 1.8 cm³/g, 2 cm³/g, 2.2 cm³/g, 2.4 cm³/g, 2.6 cm³/g, 2.8 cm³/g, or 3 cm³/g. In some embodiments, a pore volume of the carbon flowers can be about 0.1 cm³/g, about 0.2 cm³/g, about 0.4 cm³/g, about 0.6 cm³/g, about 0.8 cm³/g, about 1 cm³/g, about 1.2 cm³/g, about 1.4 cm³/g, about 1.6 cm³/g, about 1.8 cm³/g, about 2 cm³/g, about 2.2 cm³/g, about 2.4 cm³/g, about 2.6 cm³/g, about 2.8 cm³/g, or about 3 cm³/g. In some embodiments, a pore volume of the carbon flowers can be at least 0.1 cm³/g, at least 0.2 cm³/g, at least 0.4 cm³/g, at least 0.6 cm³/g, at least 0.8 cm³/g, at least 1 cm³/g, at least 1.2 cm³/g, at least 1.4 cm³/g, at least 1.6 cm³/g, at least 1.8 cm³/g, at least 2 cm³/g, at least 2.2 cm³/g, at least 2.4 cm³/g, at least 2.6 cm³/g, at least 2.8 cm³/g, or at least 3 cm³/g. In some embodiments, a pore volume of the carbon flowers can be at most 0.6 cm³/g, at most 0.8 cm³/g, at most 1 cm³/g, at most 1.2 cm³/g, at most 1.4 cm³/g, at most 1.6 cm³/g, at most 1.8 cm³/g, at most 2 cm³/g, at most 2.2 cm³/g, at most 2.4 cm³/g, at most 2.6 cm³/g, at most 2.8 cm³/g, or at most 3 cm³/g. In some embodiments, a pore volume of the carbon flowers can be 0.2 cm³/g to 2.6 cm³/g, 1 cm³/g to 2.2 cm³/g, 0.6 cm³/g to 2.8 cm³/g, or 0.8 cm³/g to 3 cm³/g, including all values and sub ranges in between.

In some embodiments, a porosity of the carbon flowers can be from 0.1 to 3 cm³/g. In some embodiments, a porosity of the carbon flowers can be 0.1 cm³/g, 0.2 cm³/g, 0.4 cm³/g, 0.6 cm³/g, 0.8 cm³/g, 1 cm³/g, 1.2 cm³/g, 1.4 cm³/g, 1.6 cm³/g, 1.8 cm³/g, 2 cm³/g, 2.2 cm³/g, 2.4 cm³/g, 2.6 cm³/g, 2.8 cm³/g, or 3 cm³/g. In some embodiments, a porosity of the carbon flowers can be about 0.1 cm³/g, about 0.2 cm³/g, about 0.4 cm³/g, about 0.6 cm³/g, about 0.8 cm³/g, about 1 cm³/g, about 1.2 cm³/g, about 1.4 cm³/g, about 1.6 cm³/g, about 1.8 cm³/g, about 2 cm³/g, about 2.2 cm³/g, about 2.4 cm³/g, about 2.6 cm³/g, about 2.8 cm³/g, or about 3 cm³/g. In some embodiments, a porosity of the carbon flowers can be at least 0.1 cm³/g, at least 0.2 cm³/g, at least 0.4 cm³/g, at least 0.6 cm³/g, at least 0.8 cm³/g, at least 1 cm³/g, at least 1.2 cm³/g, at least 1.4 cm³/g, at least 1.6 cm³/g, at least 1.8 cm³/g, at least 2 cm³/g, at least 2.2 cm³/g, at least 2.4 cm³/g, at least 2.6 cm³/g, at least 2.8 cm³/g, or at least 3 cm³/g. In some embodiments, a porosity of the carbon flowers can be at most 0.6 cm³/g, at most 0.8 cm³/g, at most 1 cm³/g, at most 1.2 cm³/g, at most 1.4 cm³/g, at most 1.6 cm³/g, at most 1.8 cm³/g, at most 2 cm³/g, at most 2.2 cm³/g, at most 2.4 cm³/g, at most 2.6 cm³/g, at most 2.8 cm³/g, or at most 3 cm³/g. In some embodiments, a porosity of the carbon flowers can be 0.2 cm³/g to 2.6 cm³/g, 1 cm³/g to 2.2 cm³/g, 0.6 cm³/g to 2.8 cm³/g, or 0.8 cm³/g to 3 cm³/g, including all values and sub ranges in between.

In some embodiments, a diameter of the carbon particles or carbon flowers ranges from about 0.1 μm to about 20 μm. In some embodiments, a diameter of the carbon particles or carbon flowers ranges from about 200 nm to about 2000 nm. In some embodiments, a diameter of the carbon particles or carbon flowers ranges from about 450 nm to about 1350 nm. In some embodiments, a diameter of the carbon particles or carbon flowers ranges from about 200 nm to about 1500 nm. In some embodiments, a diameter of the carbon particles or carbon flowers ranges from about 800 nm to about 900 nm. In some embodiments, a diameter of the carbon particles or carbon flowers may be about 870 nm. In some embodiments, a diameter of the carbon particles or carbon flowers can be 0.1 μm, 0.2 μm, 0.3 μm, 0.4 μm, 0.5 μm, 1 μm, 1.5 μm, 2 μm, 2.5 μm, 3 μm, 3.5 μm, 4 μm, 4.5 μm, 5 μm, 5.5 μm, 6 μm, 6.5 μm, 7 μm, 7.5 μm, 8 μm, 8.5 μm, 9 μm, 9.5 μm, 10 μm, 12 μm, 14 μm, 16 μm, 18 μm, or 20 μm. In some embodiments, a diameter of the carbon particles or carbon flowers can be about 0.1 μm, about 0.2 μm, about 0.3 μm, about 0.4 μm, about 0.5 μm, about 1 μm, about 1.5 μm, about 2 μm, about 2.5 μm, about 3 μm, about 3.5 μm, about 4 μm, about 4.5 μm, about 5 μm, about 5.5 μm, about 6 μm, about 6.5 μm, about 7 μm, about 7.5 μm, about 8 μm, about 8.5 μm, about 9 μm, about 9.5 μm, about 10 μm, about 12 μm, about 14 μm, about 16 μm, about 18 μm, or about 20 μm. In some embodiments, a diameter of the carbon particles or carbon flowers can be at least 0.1 μm, at least 0.2 μm, at least 0.3 μm, at least 0.4 μm, at least 0.5 μm, at least 1 μm, at least 1.5 μm, at least 2 μm, at least 2.5 μm, at least 3 μm, at least 3.5 μm, at least 4 μm, at least 4.5 μm, at least 5 μm, at least 5.5 μm, at least 6 μm, at least 6.5 μm, at least 7 μm, at least 7.5 μm, at least 8 μm, at least 8.5 μm, at least 9 μm, at least 9.5 μm, at least 10 μm, at least 12 μm, at least 14 μm, or at least 16 μm. In some embodiments, a diameter of the carbon particles or carbon flowers can be at most 0.5 μm, at most 1 μm, at most 1.5 μm, at most 2 μm, at most 2.5 μm, at most 3 μm, at most 3.5 μm, at most 4 μm, at most 4.5 μm, at most 5 μm, at most 5.5 μm, at most 6 μm, at most 6.5 μm, at most 7 μm, at most 7.5 μm, at most 8 μm, at most 8.5 μm, at most 9 μm, at most 9.5 μm, at most 10 μm, at most 12 μm, at most 14 μm, at most 16 μm, at most 18 μm, or at most 20 μm. In some embodiments, a diameter of the carbon particles or carbon flowers can be 0.2 μm to 1.8 μm, 0.4 μm to 2.5 μm, 1.5 μm to 8 μm, 2 μm to 5.5 μm, 3.5 μm to 8.5 μm, 6 μm to 10 μm, 2.5 μm to 10 μm, or 4 μm to 9 μm, including all values and sub ranges in between.

In some embodiments, the plurality of carbon particles can have a multimodal distribution of sizes to increase packing density. In some embodiments, the multimodal distribution of sizes comprises a bimodal, a trimodal, or a quadmodal distribution.

In some embodiments, the plurality of carbon particles can have a bimodal distribution of sizes. In some embodiments, a diameter of the carbon particles or carbon flowers can be from 0.5 μm to 10 μm. In some embodiments, a first mode of the bimodal distribution represents the smaller particles, while a second mode of the bimodal distribution represents the larger ones. The specific ranges for each mode can vary depending on the distribution of sizes in the sample, and can be adjusted according to the requirements of the sample. The key characteristic of a bimodal distribution is the presence of two distinct size ranges in the distribution. For example, a diameter of the first mode of the bimodal distribution carbon particles can be from about 0.5 μm to about 2 μm, while a diameter of the second mode of the bimodal distribution carbon particles can be from about 2 μm to about 10 μm.

In some embodiments, the plurality of carbon particles can have a trimodal distribution of sizes. For example, a diameter of the first mode of the bimodal distribution carbon particles can be from about 0.5 μm to about 2 μm, while a diameter of the second mode of the bimodal distribution carbon particles can be from about 2 μm to about 5 μm. A diameter of the third mode of the bimodal distribution carbon particles can be from about 5 μm to about 10 μm.

In some embodiments, the plurality of carbon particles can have a quadmodal distribution of sizes. For example, a diameter of the first mode of the bimodal distribution carbon particles can be from about 0.5 μm to about 2 μm, while a diameter of the second mode of the bimodal distribution carbon particles can be from about 2 μm to about 4 μm. A diameter of the third mode of the bimodal distribution carbon particles can be from about 4 μm to about 7 μm. A diameter of the fourth mode of the bimodal distribution carbon particles can be from about 7 μm to about 10 μm.

In some embodiments, optimizations can be implemented on the carbon flower, primarily by reducing the overall carbon content in the anode. By minimizing the carbon mass or volume, the proportion of the active material in the anode can be increased, thereby enhancing the overall energy density of the cell. One of the key parameters contributing to the enhancement of energy density is the surface area. An increase in the surface area of the anode allows for more efficient deposition of lithium metal, aiding in the promotion of a homogeneous deposition and reducing the occurrence of dendritic growth. As a result, a larger surface area results in improved performance of the cell. Therefore, a balance between increasing the surface area as much as possible and reducing the carbon mass or volume can be important. The overall aim using the carbon flower powder can be to minimize the space that carbon occupies while maximizing the area available for lithium metal deposition. This approach increases the energy density and boosts the overall efficiency of the lithium battery, making it an effective strategy for improving battery performance.

In some embodiments, an areal capacity of the negative electrode can be at least 4 mAh/cm². In some embodiments, an areal capacity of the negative electrode can be 2 mAh/cm², 2.5 mAh/cm², 3 mAh/cm², 3.5 mAh/cm², 4 mAh/cm², 4.5 mAh/cm², 5 mAh/cm², 5.5 mAh/cm², 6 mAh/cm², 6.5 mAh/cm², 7 mAh/cm², 7.5 mAh/cm², 8 mAh/cm², 8.5 mAh/cm², 9 mAh/cm², 9.5 mAh/cm², or 10 mAh/cm². In some embodiments, an areal capacity of the negative electrode can be about 2 mAh/cm², about 2.5 mAh/cm², about 3 mAh/cm², about 3.5 mAh/cm², about 4 mAh/cm², about 4.5 mAh/cm², about 5 mAh/cm², about 5.5 mAh/cm², about 6 mAh/cm², about 6.5 mAh/cm², about 7 mAh/cm², about 7.5 mAh/cm², about 8 mAh/cm², about 8.5 mAh/cm², about 9 mAh/cm², about 9.5 mAh/cm², or about 10 mAh/cm². In some embodiments, an areal capacity of the negative electrode can be at least 2 mAh/cm², at least 2.5 mAh/cm², at least 3 mAh/cm², at least 3.5 mAh/cm², at least 4 mAh/cm², at least 4.5 mAh/cm², at least 5 mAh/cm², at least 5.5 mAh/cm², at least 6 mAh/cm², at least 6.5 mAh/cm², at least 7 mAh/cm², at least 7.5 mAh/cm², at least 8 mAh/cm², at least 8.5 mAh/cm², at least 9 mAh/cm², at least 9.5 mAh/cm², or at least 10 mAh/cm². In some embodiments, an areal capacity of the negative electrode can be at most 2 mAh/cm², at most 2.5 mAh/cm², at most 3 mAh/cm², at most 3.5 mAh/cm², at most 4 mAh/cm², at most 4.5 mAh/cm², at most 5 mAh/cm², at most 5.5 mAh/cm², at most 6 mAh/cm², at most 6.5 mAh/cm², at most 7 mAh/cm², at most 7.5 mAh/cm², at most 8 mAh/cm², at most 8.5 mAh/cm², at most 9 mAh/cm², at most 9.5 mAh/cm², or at most 10 mAh/cm². In some embodiments, an areal capacity of the negative electrode can be 2 mAh/cm² to 7.5 mAh/cm², 3 mAh/cm² to 9 mAh/cm², 4 mAh/cm² to 10 mAh/cm², 5 mAh/cm² to 9.5 mAh/cm², including all values and sub ranges in between.

In some embodiments, the capacity of the negative electrode can be 50 mAh/g, 100 mAh/g, 150 mAh/g, 200 mAh/g, 250 mAh/g, 300 mAh/g, 350 mAh/g, 400 mAh/g, 450 mAh/g, or 500 mAh/g. In some embodiments, the capacity of the negative electrode can be about 50 mAh/g, about 100 mAh/g, about 150 mAh/g, about 200 mAh/g, about 250 mAh/g, about 300 mAh/g, about 350 mAh/g, about 400 mAh/g, about 450 mAh/g, or about 500 mAh/g. In some embodiments, the capacity of the negative electrode can be at least 50 mAh/g, at least 100 mAh/g, at least 150 mAh/g, at least 200 mAh/g, at least 250 mAh/g, at least 300 mAh/g, at least 350 mAh/g, at least 400 mAh/g, at least 450 mAh/g, or at least 500 mAh/g. In some embodiments, the capacity of the negative electrode can be at most 50 mAh/g, at most 100 mAh/g, at most 150 mAh/g, at most 200 mAh/g, at most 250 mAh/g, at most 300 mAh/g, at most 350 mAh/g, at most 400 mAh/g, at most 450 mAh/g, or at most 500 mAh/g. In some embodiments, the capacity of the negative electrode can be 150 mAh/g to 300 mAh/g, 100 mAh/g to 400 mAh/g, 250 mAh/g to 500 mAh/g, or 100 mAh/g to 300 mAh/g, including all values and sub ranges in between. For example, the capacity of the negative electrode can be at least 250 mAh/g.

In some embodiments, the energy density of the negative electrode can be 200 Wh/kg, 400 Wh/kg, 600 Wh/kg, 800 Wh/kg, 1000 Wh/kg, 1200 Wh/kg, 1400 Wh/kg, or 1600 Wh/kg. In some embodiments, the energy density of the negative electrode can be about 200 Wh/kg, about 400 Wh/kg, about 600 Wh/kg, about 800 Wh/kg, about 1000 Wh/kg, about 1200 Wh/kg, about 1400 Wh/kg, or about 1600 Wh/kg. The energy density of the negative electrode can be at least 200 Wh/kg, at least 400 Wh/kg, at least 600 Wh/kg, at least 800 Wh/kg, at least 1000 Wh/kg, at least 1200 Wh/kg, at least 1400 Wh/kg, or at least 1600 Wh/kg. The energy density of the negative electrode can be at most 200 Wh/kg, at most 400 Wh/kg, at most 600 Wh/kg, at most 800 Wh/kg, at most 1000 Wh/kg, at most 1200 Wh/kg, at most 1400 Wh/kg, or at most 1600 Wh/kg. In some embodiments, the energy density of the negative electrode can be 400 Wh/kg to 1200 Wh/kg, 600 Wh/kg to 1600 Wh/kg, 800 Wh/kg to 1400 Wh/kg, or 400 Wh/kg to 1000 Wh/kg, including all values and sub ranges in between. For example, the energy density of the negative electrode can be at least 800 Wh/kg.

In some embodiments, the negative electrode comprises a cycling efficiency of 90 percent (%), 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99% over a predetermined number of cycles. In some embodiments, the negative electrode comprises a cycling efficiency of about 90 percent (%), about 91%, about 92%, about 93%, about 94%, about 95%, about 96%, about 97%, about 98%, about 99%, about 99.1%, about 99.2%, about 99.3%, about 99.4%, about 99.5%, about 99.6%, about 99.7%, about 99.8%, about 99.9%, about 99.91%, about 99.92%, about 99.93%, about 99.94%, about 99.95%, about 99.96%, about 99.97%, about 99.98%, about 99.99% over a predetermined number of cycles. In some embodiments, the negative electrode comprises a cycling efficiency of at least 90 percent (%), at least 91%, at least 92%, at least 93%, at least 94%, at least 95%, at least 96%, at least 97%, at least 98%, at least 99%, at least 99.1%, at least 99.2%, at least 99.3%, at least 99.4%, at least 99.5%, at least 99.6%, at least 99.7%, at least 99.8%, at least 99.9%, at least 99.91%, at least 99.92%, at least 99.93%, at least 99.94%, at least 99.95%, at least 99.96%, at least 99.97%, at least 99.98%, at least 99.99% over a predetermined number of cycles. In some embodiments, the negative electrode comprises a cycling efficiency of at most 90 percent (%), at most 91%, at most 92%, at most 93%, at most 94%, at most 95%, at most 96%, at most 97%, at most 98%, at most 99%, at most 99.1%, at most 99.2%, at most 99.3%, at most 99.4%, at most 99.5%, at most 99.6%, at most 99.7%, at most 99.8%, at most 99.9%, at most 99.91%, at most 99.92%, at most 99.93%, at most 99.94%, at most 99.95%, at most 99.96%, at most 99.97%, at most 99.98%, at most 99.99% over a predetermined number of cycles. In some embodiments, the negative electrode comprises a cycling efficiency of 90% to 99%, 99.2% to 99.8%, 92% to 98%, 99.8% to 99.99%, 99.5% to 99.8%, 92% to 99.6%, or 99% to 99.99%, including all values and sub ranges in between. The predetermined number of cycles can be 50 cycles, 100 cycles, 150 cycles, 200 cycles, 250 cycles, 300 cycles, 350 cycles, 400 cycles, 500 cycles, 600 cycles, 700 cycles, 800 cycles, 900 cycles, 1000 cycles, 2000 cycles, 3000 cycles, 4000 cycles, 5000 cycles, 5500 cycles, 6000 cycles, 6500 cycles, 7000 cycles, 7500 cycles, 8000 cycles, 8500 cycles, or 9000 cycles. The predetermined number of times can be about 50 cycles, about 100 cycles, about 150 cycles, about 200 cycles, about 250 cycles, about 300 cycles, about 350 cycles, about 400 cycles, about 500 cycles, about 600 cycles, about 700 cycles, about 800 cycles, about 900 cycles, about 1000 cycles, about 2000 cycles, about 3000 cycles, about 4000 cycles, about 5000 cycles, about 5500 cycles, about 6000 cycles, about 6500 cycles, about 7000 cycles, about 7500 cycles, about 8000 cycles, about 8500 cycles, or about 9000 cycles. The predetermined number of times can be at least 50 cycles, at least 100 cycles, at least 150 cycles, at least 200 cycles, at least 250 cycles, at least 300 cycles, at least 350 cycles, at least 400 cycles, at least 500 cycles, at least 600 cycles, at least 700 cycles, at least 800 cycles, at least 900 cycles, at least 1000 cycles, at least 2000 cycles, at least 3000 cycles, at least 4000 cycles, at least 5000 cycles, at least 5500 cycles, at least 6000 cycles, at least 6500 cycles, at least 7000 cycles, at least 7500 cycles, at least 8000 cycles, at least 8500 cycles, or at least 9000 cycles. The predetermined number of times can be at most 50 cycles, at most 100 cycles, at most 150 cycles, at most 200 cycles, at most 250 cycles, at most 300 cycles, at most 350 cycles, at most 400 cycles, at most 500 cycles, at most 600 cycles, at most 700 cycles, at most 800 cycles, at most 900 cycles, at most 1000 cycles, at most 2000 cycles, at most 3000 cycles, at most 4000 cycles, at most 5000 cycles, at most 5500 cycles, at most 6000 cycles, at most 6500 cycles, at most 7000 cycles, at most 7500 cycles, at most 8000 cycles, at most 8500 cycles, or at most 9000 cycles. In some embodiments, the negative electrode may be cycled from 2 V to 5 V. In some embodiments, the negative electrode may be cycled from 1.5 V to 4 V. In some embodiments, the negative electrode may be cycled from 2.5 V to 3.75 V, 3 V to 4V, 3 V to 3.8 V, or 2 V to 3 V. In some embodiments, the negative electrode may be cycled from about 2 V to about 5 V. In some embodiments, the negative electrode may be cycled from about 2.5 V to about 3.75 V, about 3 V to about 4V, about 3 V to about 4.5 V, or about 2 V to about 3 V. In some embodiments, the cycling starts from about 2 V, about 2.5 V, about 3 V, about 3.5 V, or about 4 V. In some embodiments, the cycling starts from at least 2 V, at least 2.5 V, at least 3 V, at least 3.5 V, or at least 4 V. In some embodiments, the cycling starts from at most 2 V, at most 2.5 V, at most 3 V, at most 3.5 V, or at most 4 V. In some embodiments, the cycling finishes at 3 V, 3.25V, 3.5 V, 3.75 V, 4 V, 4.25 V, 4.5 V, 4.75 V, or 5 V. In some embodiments, the cycling finishes at about 3 V, about 3.25V, about 3.5 V, about 3.75 V, about 4 V, about 4.25 V, about 4.5 V, about 4.75 V, or about 5 V. In some embodiments, the cycling finishes at least 3 V, at least 3.25V, at least 3.5 V, at least 3.75 V, at least 4 V, at least 4.25 V, at least 4.5 V, at least 4.75 V, or at least 5 V. In some embodiments, the cycling finishes at most 3 V, at most 3.25V, at most 3.5 V, at most 3.75 V, at most 4 V, at most 4.25 V, at most 4.5 V, at most 4.75 V, or at most 5 V. The cycling can be performed at a C rate of at least 1C and a D-rate of at least 1C. The cycling can be performed at a C rate of at least 1C, 2C, 3C, 4C, 5C, C/2, C/3, C/4, or C/5 and a D-rate of at least 1C, 2C, 3C, 4C, 5C, C/2, C/3, C/4, or C/5. The cycling can be performed at a C rate of at least C/20:C/20, C/10:C/10, C/5:C/5, C/2:C/2, 1C:1C, or 2C:2C. The cycling can be performed at a C rate of at most C/20:C/20, C/10:C/10, C/5:C/5, C/2:C/2, 1C:1C, or 2C:2C. The cycling can be performed at a C rate of at least C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed at a C rate of at most C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed using a C-rate of at least C/20, C/10, C/5, C/2, 0.5C, 1C, 2C, 3C, 5C, 6C, 7C, 8C, 9C, or 10C. The cycling can be performed using a C-rate of at most C/20, C/10, C/5, C/2, 0.5C, 1C, 2C, 3C, 5C, 6C, 7C, 8C, 9C, or 10C. The cycling can be performed using a D-rate of at least D/20, D/10, D/5, D/2, 0.5D, 1D, 2D, 3D, 5D, 6D, 7D, 8D, 9D, or 10D. The cycling can be performed using a D-rate of at most D/20, D/10, D/5, D/2, 0.5D, 1D, 2D, 3D, 5D, 6D, 7D, 8D, 9D, or 10D.

In some embodiments, the negative electrode comprises a columbic efficiency of 90 percent (%), 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99% over a predetermined number of cycles. In some embodiments, the negative electrode comprises a columbic efficiency of about 90 percent (%), about 91%, about 92%, about 93%, about 94%, about 95%, about 96%, about 97%, about 98%, about 99%, about 99.1%, about 99.2%, about 99.3%, about 99.4%, about 99.5%, about 99.6%, about 99.7%, about 99.8%, about 99.9%, about 99.91%, about 99.92%, about 99.93%, about 99.94%, about 99.95%, about 99.96%, about 99.97%, about 99.98%, about 99.99% over a predetermined number of cycles. In some embodiments, the negative electrode comprises a columbic efficiency of at least 90 percent (%), at least 91%, at least 92%, at least 93%, at least 94%, at least 95%, at least 96%, at least 97%, at least 98%, at least 99%, at least 99.1%, at least 99.2%, at least 99.3%, at least 99.4%, at least 99.5%, at least 99.6%, at least 99.7%, at least 99.8%, at least 99.9%, at least 99.91%, at least 99.92%, at least 99.93%, at least 99.94%, at least 99.95%, at least 99.96%, at least 99.97%, at least 99.98%, at least 99.99% over a predetermined number of cycles. In some embodiments, the negative electrode comprises a columbic efficiency of at most 90 percent (%), at most 91%, at most 92%, at most 93%, at most 94%, at most 95%, at most 96%, at most 97%, at most 98%, at most 99%, at most 99.1%, at most 99.2%, at most 99.3%, at most 99.4%, at most 99.5%, at most 99.6%, at most 99.7%, at most 99.8%, at most 99.9%, at most 99.91%, at most 99.92%, at most 99.93%, at most 99.94%, at most 99.95%, at most 99.96%, at most 99.97%, at most 99.98%, at most 99.99% over a predetermined number of cycles. In some embodiments, the negative electrode comprises a columbic efficiency of 90% to 99%, 99.2% to 99.8%, 92% to 98%, 99.8% to 99.99%, 99.5% to 99.8%, 92% to 99.6%, or 99% to 99.99%, including all values and sub ranges in between. The predetermined number of cycles can be 50 cycles, 100 cycles, 150 cycles, 200 cycles, 250 cycles, 300 cycles, 350 cycles, 400 cycles, 500 cycles, 600 cycles, 700 cycles, 800 cycles, 900 cycles, 1000 cycles, 2000 cycles, 3000 cycles, 4000 cycles, 5000 cycles, 5500 cycles, 6000 cycles, 6500 cycles, 7000 cycles, 7500 cycles, 8000 cycles, 8500 cycles, or 9000 cycles. The predetermined number of times can be about 50 cycles, about 100 cycles, about 150 cycles, about 200 cycles, about 250 cycles, about 300 cycles, about 350 cycles, about 400 cycles, about 500 cycles, about 600 cycles, about 700 cycles, about 800 cycles, about 900 cycles, about 1000 cycles, about 2000 cycles, about 3000 cycles, about 4000 cycles, about 5000 cycles, about 5500 cycles, about 6000 cycles, about 6500 cycles, about 7000 cycles, about 7500 cycles, about 8000 cycles, about 8500 cycles, or about 9000 cycles. The predetermined number of times can be at least 50 cycles, at least 100 cycles, at least 150 cycles, at least 200 cycles, at least 250 cycles, at least 300 cycles, at least 350 cycles, at least 400 cycles, at least 500 cycles, at least 600 cycles, at least 700 cycles, at least 800 cycles, at least 900 cycles, at least 1000 cycles, at least 2000 cycles, at least 3000 cycles, at least 4000 cycles, at least 5000 cycles, at least 5500 cycles, at least 6000 cycles, at least 6500 cycles, at least 7000 cycles, at least 7500 cycles, at least 8000 cycles, at least 8500 cycles, or at least 9000 cycles. The predetermined number of times can be at most 50 cycles, at most 100 cycles, at most 150 cycles, at most 200 cycles, at most 250 cycles, at most 300 cycles, at most 350 cycles, at most 400 cycles, at most 500 cycles, at most 600 cycles, at most 700 cycles, at most 800 cycles, at most 900 cycles, at most 1000 cycles, at most 2000 cycles, at most 3000 cycles, at most 4000 cycles, at most 5000 cycles, at most 5500 cycles, at most 6000 cycles, at most 6500 cycles, at most 7000 cycles, at most 7500 cycles, at most 8000 cycles, at most 8500 cycles, or at most 9000 cycles. In some embodiments, the cycling can be from 2 V to 5 V. In some embodiments, the negative electrode may be cycled from 1.5 V to 4 V. In some embodiments, the negative electrode may be cycled from 2.5 V to 3.75 V, 3 V to 4V, 3 V to 3.8 V, or 2 V to 3 V. In some embodiments, the negative electrode may be cycled can be from about 2 V to about 5 V. In some embodiments, the cycling can be from about 2.5 V to about 3.75 V, about 3 V to about 4V, about 3 V to about 4.5 V, or about 2 V to about 3 V. In some embodiments, the cycling starts from about 2 V, about 2.5 V, about 3 V, about 3.5 V, or about 4 V. In some embodiments, the cycling starts from at least 2 V, at least 2.5 V, at least 3 V, at least 3.5 V, or at least 4 V. In some embodiments, the cycling starts from at most 2 V, at most 2.5 V, at most 3 V, at most 3.5 V, or at most 4 V. In some embodiments, the cycling finishes at 3 V, 3.25V, 3.5 V, 3.75 V, 4 V, 4.25 V, 4.5 V, 4.75 V, or 5 V. In some embodiments, the cycling finishes at about 3 V, about 3.25V, about 3.5 V, about 3.75 V, about 4 V, about 4.25 V, about 4.5 V, about 4.75 V, or about 5 V. In some embodiments, the cycling finishes at least 3 V, at least 3.25V, at least 3.5 V, at least 3.75 V, at least 4 V, at least 4.25 V, at least 4.5 V, at least 4.75 V, or at least 5 V. In some embodiments, the cycling finishes at most 3 V, at most 3.25V, at most 3.5 V, at most 3.75 V, at most 4 V, at most 4.25 V, at most 4.5 V, at most 4.75 V, or at most 5 V. The cycling can be performed at a C rate of at least 1C and a D-rate of at least 1C. The cycling can be performed at a C rate of at least 1C, 2C, 3C, 4C, 5C, C/2, C/3, C/4, or C/5 and a D-rate of at least 1C, 2C, 3C, 4C, 5C, C/2, C/3, C/4, or C/5. The cycling can be performed at a C rate of at least C/20:C/20, C/10:C/10, C/5:C/5, C/2:C/2, 1C:1C, or 2C:2C. The cycling can be performed at a C rate of at most C/20:C/20, C/10:C/10, C/5:C/5, C/2:C/2, 1C:1C, or 2C:2C. The cycling can be performed at a C rate of at least C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed at a C rate of at most C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed using a C-rate of at least C/20, C/10, C/5, C/2, 0.5C, 1C, 2C, 3C, 5C, 6C, 7C, 8C, 9C, or 10C. The cycling can be performed using a C-rate of at most C/20, C/10, C/5, C/2, 0.5C, 1C, 2C, 3C, 5C, 6C, 7C, 8C, 9C, or 10C. The cycling can be performed using a D-rate of at least D/20, D/10, D/5, D/2, 0.5D, 1D, 2D, 3D, 5D, 6D, 7D, 8D, 9D, or 10D. The cycling can be performed using a D-rate of at most D/20, D/10, D/5, D/2, 0.5D, 1D, 2D, 3D, 5D, 6D, 7D, 8D, 9D, or 10D.

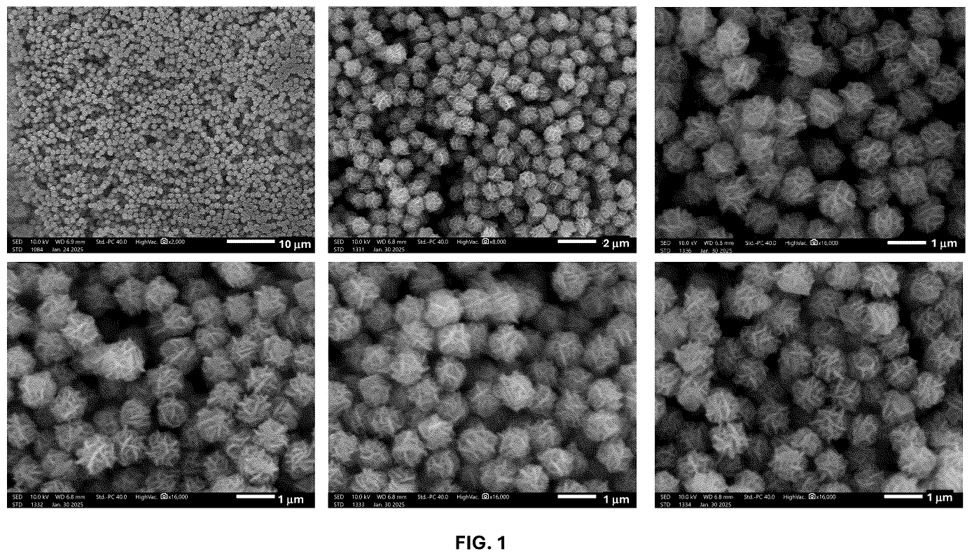

The negative electrode can comprise a plurality of carbon particles. In some embodiments, the carbon particles can be concaved shaped as shown in FIG. 1. In some embodiments, the carbon particles comprise a plurality of carbon nanosheets resembling flower petals, referred to herein as “carbon flowers.” The carbon particles are spherical in morphology with a corrugated surface. The structure of carbon flowers provides a high surface area. In some cases, the surface area of the carbon flowers can be from 10 m²/g to 5000 m²/g. In certain embodiments, Brunauer-Emmett-Teller (BET) surface area measurements indicate that the carbon flowers have a specific surface area in the range of about 16 m²/g to about 32 m²/g, with a median value of approximately 25 m²/g.

The carbon particles can provide a high porosity. In some cases, a porosity of the carbon flowers can be from 0.1 to 3 cm³/g. The positive electrode can comprise a transition metal phosphate, for example lithium iron phosphate (LFP). The positive electrode can be substantially free of lithium when the rechargeable energy source system is in a charged state.

In some embodiments, the rechargeable energy source system can be configured to (1) facilitate the intercalation of the plurality of carbon particles with a plurality of lithium ions derived from an electrolyte, and (2) effectuate the plating of these plurality of lithium ions as lithium metal on a surface of the plurality of carbon particles. In some embodiments, the rechargeable energy source system can be configured to intercalate the plurality of carbon particles with a plurality of lithium ions from an anode through an electrolyte at a near zero voltage. As potential increases, the lithium ions achieve full intercalation, subsequently transforming into lithium metal at which point lithium metal deposition begins. The rechargeable energy source system disclosed herein can be configured to effectuate a homogeneous distribution of lithium ions prior to the initiation of nucleation into lithium metal. It can allow the uniform distribution of current across the carbon particles, thereby enhancing system stability. In particular, this feature mitigates the risk of formation or propagation of lithium dendrites, which are commonly induced by high and localized currents. By ensuring the uniform distribution of current and the controlled lithium metal deposition, the rechargeable energy storage system herein disclosed offers improved safety, efficiency, and reliability.

In some embodiments, the rechargeable energy source system can be configured to (1) intercalate a plurality of lithium ions into the plurality of carbon particles and (2) plate the plurality of lithium ions as lithium metal on a surface of the plurality of carbon particles from an electrolyte. In some embodiments, the rechargeable energy source system can be configured to intercalate a plurality of lithium ions into the plurality of carbon particles at a near zero voltage. As potential increases, the lithium ions achieve full intercalation, subsequently transforming into lithium metal at which point lithium metal deposition begins. The rechargeable energy source system disclosed herein can be configured to effectuate a homogeneous distribution of lithium ions prior to the initiation of nucleation into lithium metal. It can allow the uniform distribution of current across the carbon particles, thereby enhancing system stability. In particular, this feature mitigates the risk of formation or propagation of lithium dendrites.

Carbon flowers, due to their unique nanostructured morphology, present a high surface area for interaction with lithium ions. This physical characteristic may provide a dual mode of operation. This operation can accommodate both lithium-ion intercalation into the carbon flowers at voltages near zero (relative to lithium), and lithium metal plating at voltages slightly below zero. When the battery is charging, the lithium ions from the electrolyte can be intercalated into the carbon flowers at lower potentials, mimicking the operation of a typical lithium-ion battery. As the charging process continues and the potential increases, the system can transition into a lithium metal battery operation. The lithium ions can be then plated onto the surface of the carbon flowers as lithium metal.

The rechargeable energy source system can be configured to provide a capacity of 600 mAh/g-5000 mAh/g. The rechargeable energy source system can be configured to provide a capacity higher than 1000 mAh/g. In some embodiments, the rechargeable energy source system can be configured to provide a capacity of 600 mAh/g, 650 mAh/g, 700 mAh/g, 750 mAh/g, 800 mAh/g, 850 mAh/g, 900 mAh/g, 950 mAh/g, 1000 mAh/g, 1100 mAh/g, 1200 mAh/g, 1300 mAh/g, 1400 mAh/g, 1500 mAh/g, 1600 mAh/g, 1700 mAh/g, 1800 mAh/g, 1900 mAh/g, 2000 mAh/g, 2500 mAh/g, 3000 mAh/g, 3500 mAh/g, 4000 mAh/g, 4500 mAh/g, or 5000 mAh/g. In some embodiments, the rechargeable energy source system can be configured to provide a capacity of about 600 mAh/g, about 650 mAh/g, about 700 mAh/g, about 750 mAh/g, about 800 mAh/g, about 850 mAh/g, about 900 mAh/g, about 950 mAh/g, about 1000 mAh/g, about 1100 mAh/g, about 1200 mAh/g, about 1300 mAh/g, about 1400 mAh/g, about 1500 mAh/g, about 1600 mAh/g, about 1700 mAh/g, about 1800 mAh/g, about 1900 mAh/g, about 2000 mAh/g, about 2500 mAh/g, about 3000 mAh/g, about 3500 mAh/g, about 4000 mAh/g, about 4500 mAh/g, or about 5000 mAh/g. In some embodiments, the rechargeable energy source system can be configured to provide a capacity of at least 600 mAh/g, at least 650 mAh/g, at least 700 mAh/g, at least 750 mAh/g, at least 800 mAh/g, at least 850 mAh/g, at least 900 mAh/g, at least 950 mAh/g, at least 1000 mAh/g, at least 1100 mAh/g, at least 1200 mAh/g, at least 1300 mAh/g, at least 1400 mAh/g, at least 1500 mAh/g, at least 1600 mAh/g, at least 1700 mAh/g, at least 1800 mAh/g, at least 1900 mAh/g, at least 2000 mAh/g, at least 2500 mAh/g, at least 3000 mAh/g, at least 3500 mAh/g, at least 4000 mAh/g, at least 4500 mAh/g, or at least 5000 mAh/g. In some embodiments, the rechargeable energy source system can be configured to provide a capacity of at most 700 mAh/g, at most 750 mAh/g, at most 800 mAh/g, at most 850 mAh/g, at most 900 mAh/g, at most 950 mAh/g, at most 1000 mAh/g, at most 1100 mAh/g, at most 1200 mAh/g, at most 1300 mAh/g, at most 1400 mAh/g, at most 1500 mAh/g, at most 1600 mAh/g, at most 1700 mAh/g, at most 1800 mAh/g, at most 1900 mAh/g, at most 2000 mAh/g, at most 2500 mAh/g, at most 3000 mAh/g, at most 3500 mAh/g, at most 4000 mAh/g, at most 4500 mAh/g, or at most 5000 mAh/g. In some embodiments, the rechargeable energy source system can be configured to provide a capacity of 800 mAh/g-1200 mAh/g, 700 mAh/g-1100 mAh/g, 900 mAh/g-1400 mAh/g, 1500 mAh/g-4200 mAh/g, 1700 mAh/g-3900 mAh/g, 1900 mAh/g-4000 mAh/g, or 2600 mAh/g-4000 mAh/g, including all values and sub ranges in between.

The rechargeable energy source system can be configured to maintain the capacity when the rechargeable energy source system is cycled for at least 200 cycles. In some embodiments, the rechargeable energy source system can be configured to maintain the capacity when the rechargeable energy source system is cycled for 200 cycles, 300 cycles, 400 cycles, 500 cycles, 600 cycles, 700 cycles, 800 cycles, 900 cycles, 1000 cycles, 1100 cycles, 1200 cycles, 1400 cycles, 1500 cycles, 1600 cycles, 1700 cycles, 1800 cycles, 1900 cycles, 2000 cycles, 2500 cycles, 3000 cycles, 3500 cycles, 4000 cycles, 4500 cycles, 5000 cycles, 5500 cycles, or 6000 cycles. In some embodiments, the rechargeable energy source system can be configured to maintain the capacity when the rechargeable energy source system is cycled for about 200 cycles, about 300 cycles, about 400 cycles, about 500 cycles, about 600 cycles, about 700 cycles, about 800 cycles, about 900 cycles, about 1000 cycles, about 1100 cycles, about 1200 cycles, about 1300 cycles, about 1400 cycles, about 1500 cycles, about 1600 cycles, about 1700 cycles, about 1800 cycles, about 1900 cycles, about 2000 cycles, about 2500 cycles, about 3000 cycles, about 3500 cycles, about 4000 cycles, about 4500 cycles, about 5000 cycles, about 5500 cycles, or about 6000 cycles. In some embodiments, the rechargeable energy source system can be configured to maintain the capacity when the rechargeable energy source system is cycled for at least 200 cycles, at least 300 cycles, at least 400 cycles, at least 500 cycles, at least 600 cycles, at least 700 cycles, at least 800 cycles, at least 900 cycles, at least 1000 cycles, at least 1100 cycles, at least 1200 cycles, at least 1300 cycles, at least 1400 cycles, at least 1500 cycles, at least 1600 cycles, at least 1700 cycles, at least 1800 cycles, at least 1900 cycles, at least 2000 cycles, at least 2500 cycles, at least 3000 cycles, at least 3500 cycles, at least 4000 cycles, at least 4500 cycles, at least 5000 cycles, at least 5500 cycles, or at least 6000 cycles. In some embodiments, the rechargeable energy source system can be configured to maintain the capacity when the rechargeable energy source system is cycled for at most 400 cycles, at most 500 cycles, at most 600 cycles, at most 700 cycles, at most 800 cycles, at most 900 cycles, at most 1000 cycles, at most 1100 cycles, at most 1200 cycles, at most 1300 cycles, at most 1400 cycles, at most 1500 cycles, at most 1600 cycles, at most 1700 cycles, at most 1800 cycles, at most 1900 cycles, at most 2000 cycles, at most 2100 cycles, at most 2200 cycles, at most 2300 cycles, at most 2400 cycles, at most 2500 cycles, at most 2600 cycles, at most 2700 cycles, at most 2800 cycles, at most 2900 cycles, at most 3000 cycles, at most 3500 cycles, at most 4000 cycles, at most 4500 cycles, at most 5000 cycles, at most 5500 cycles, or at most 6000 cycles. In some embodiments, the rechargeable energy source system can be configured to maintain the capacity when the rechargeable energy source system is cycled for 400 cycles to 2000 cycles, 600 cycles to 1800 cycles, 800 cycles to 2200 cycles, 500 cycles to 2300 cycles, 1400 cycles to 4000 cycles, 2600 cycles to 4800 cycles, 1800 cycles to 5200 cycles, 3500 cycles to 5300 cycles or 2400 cycles to 4600 cycles, including all values and sub ranges in between.

Excess lithium deposition can undermine the cyclability of the battery. In some cases, higher levels of lithium loading can induce cracking in the anode material. This physical degradation can lead to a loss of active material, which in turn reduces the capacity and overall efficiency of the battery. With a more balanced lithium deposition disclosed herein, it can effectively enhance the durability and performance of the anode, thereby leading to more effective and sustainable battery performance. In some embodiments, the rechargeable energy source system can be configured to provide lithium deposition of 1.5 mAh/cm². In some embodiments, the rechargeable energy source system can be configured to provide lithium deposition of less than 2 mAh/cm². In some embodiments, the rechargeable energy source system can be configured to provide lithium deposition of 0.6 mAh/cm², 0.7 mAh/cm², 0.8 mAh/cm², 0.9 mAh/cm², 1 mAh/cm², 1.1 mAh/cm², 1.2 mAh/cm², 1.3 mAh/cm², 1.4 mAh/cm², 1.5 mAh/cm², 1.6 mAh/cm², 1.7 mAh/cm², or 1.8 mAh/cm². In some embodiments, the rechargeable energy source system can be configured to provide lithium deposition of about 0.6 mAh/cm², about 0.7 mAh/cm², about 0.8 mAh/cm², about 0.9 mAh/cm², about 1 mAh/cm², about 1.1 mAh/cm², about 1.2 mAh/cm², about 1.3 mAh/cm², about 1.4 mAh/cm², about 1.5 mAh/cm², about 1.6 mAh/cm², about 1.7 mAh/cm², or about 1.8 mAh/cm². In some embodiments, the rechargeable energy source system can be configured to provide lithium deposition of at least 0.6 mAh/cm², at least 0.7 mAh/cm², at least 0.8 mAh/cm², at least 0.9 mAh/cm², at least 1 mAh/cm², at least 1.1 mAh/cm², at least 1.2 mAh/cm², at least 1.3 mAh/cm², at least 1.4 mAh/cm², at least 1.5 mAh/cm², at least 1.6 mAh/cm², at least 1.7 mAh/cm², or at least 1.8 mAh/cm². In some embodiments, the rechargeable energy source system can be configured to provide lithium deposition of at most 0.6 mAh/cm², at most 0.7 mAh/cm², at most 0.8 mAh/cm², at most 0.9 mAh/cm², at most 1 mAh/cm², at most 1.1 mAh/cm², at most 1.2 mAh/cm², at most 1.3 mAh/cm², at most 1.4 mAh/cm², at most 1.5 mAh/cm², at most 1.6 mAh/cm², at most 1.7 mAh/cm², or at most 1.8 mAh/cm². In some embodiments, the rechargeable energy source system can be configured to provide lithium deposition of 0.6 mAh/cm² to 0.9 mAh/cm², 0.7 mAh/cm² to 1.2 mAh/cm², 0.8 mAh/cm² to 1.4 mAh/cm², or 0.6 mAh/cm² to 1.5 mAh/cm², including all values and sub ranges in between.

In some embodiments, the rechargeable energy source system is configured to maintain a cycling efficiency of 90 percent (%), 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99% over a predetermined number of cycles. In some embodiments, the rechargeable energy source system is configured to maintain a cycling efficiency of about 90 percent (%), about 91%, about 92%, about 93%, about 94%, about 95%, about 96%, about 97%, about 98%, about 99%, about 99.1%, about 99.2%, about 99.3%, about 99.4%, about 99.5%, about 99.6%, about 99.7%, about 99.8%, about 99.9%, about 99.91%, about 99.92%, about 99.93%, about 99.94%, about 99.95%, about 99.96%, about 99.97%, about 99.98%, about 99.99% over a predetermined number of cycles. In some embodiments, the rechargeable energy source system is configured to maintain a cycling efficiency of at least 90 percent (%), at least 91%, at least 92%, at least 93%, at least 94%, at least 95%, at least 96%, at least 97%, at least 98%, at least 99%, at least 99.1%, at least 99.2%, at least 99.3%, at least 99.4%, at least 99.5%, at least 99.6%, at least 99.7%, at least 99.8%, at least 99.9%, at least 99.91%, at least 99.92%, at least 99.93%, at least 99.94%, at least 99.95%, at least 99.96%, at least 99.97%, at least 99.98%, at least 99.99% over a predetermined number of cycles. In some embodiments, the rechargeable energy source system is configured to maintain a cycling efficiency of at most 90 percent (%), at most 91%, at most 92%, at most 93%, at most 94%, at most 95%, at most 96%, at most 97%, at most 98%, at most 99%, at most 99.1%, at most 99.2%, at most 99.3%, at most 99.4%, at most 99.5%, at most 99.6%, at most 99.7%, at most 99.8%, at most 99.9%, at most 99.91%, at most 99.92%, at most 99.93%, at most 99.94%, at most 99.95%, at most 99.96%, at most 99.97%, at most 99.98%, at most 99.99% over a predetermined number of cycles. In some embodiments, the rechargeable energy source system is configured to maintain a cycling efficiency of 90% to 99%, 99.2% to 99.8%, 92% to 98%, 99.8% to 99.99%, 99.5% to 99.8%, 92% to 99.6%, or 99% to 99.99%, including all values and sub ranges in between. The predetermined number of cycles can be 50 cycles, 100 cycles, 150 cycles, 200 cycles, 250 cycles, 300 cycles, 350 cycles, 400 cycles, 500 cycles, 600 cycles, 700 cycles, 800 cycles, 900 cycles, 1000 cycles, 2000 cycles, 3000 cycles, 4000 cycles, 5000 cycles, 5500 cycles, 6000 cycles, 6500 cycles, 7000 cycles, 7500 cycles, 8000 cycles, 8500 cycles, or 9000 cycles. The predetermined number of times can be about 50 cycles, about 100 cycles, about 150 cycles, about 200 cycles, about 250 cycles, about 300 cycles, about 350 cycles, about 400 cycles, about 500 cycles, about 600 cycles, about 700 cycles, about 800 cycles, about 900 cycles, about 1000 cycles, about 2000 cycles, about 3000 cycles, about 4000 cycles, about 5000 cycles, about 5500 cycles, about 6000 cycles, about 6500 cycles, about 7000 cycles, about 7500 cycles, about 8000 cycles, about 8500 cycles, or about 9000 cycles. The predetermined number of times can be at least 50 cycles, at least 100 cycles, at least 150 cycles, at least 200 cycles, at least 250 cycles, at least 300 cycles, at least 350 cycles, at least 400 cycles, at least 500 cycles, at least 600 cycles, at least 700 cycles, at least 800 cycles, at least 900 cycles, at least 1000 cycles, at least 2000 cycles, at least 3000 cycles, at least 4000 cycles, at least 5000 cycles, at least 5500 cycles, at least 6000 cycles, at least 6500 cycles, at least 7000 cycles, at least 7500 cycles, at least 8000 cycles, at least 8500 cycles, or at least 9000 cycles. The predetermined number of times can be at most 50 cycles, at most 100 cycles, at most 150 cycles, at most 200 cycles, at most 250 cycles, at most 300 cycles, at most 350 cycles, at most 400 cycles, at most 500 cycles, at most 600 cycles, at most 700 cycles, at most 800 cycles, at most 900 cycles, at most 1000 cycles, at most 2000 cycles, at most 3000 cycles, at most 4000 cycles, at most 5000 cycles, at most 5500 cycles, at most 6000 cycles, at most 6500 cycles, at most 7000 cycles, at most 7500 cycles, at most 8000 cycles, at most 8500 cycles, or at most 9000 cycles. In some embodiments, the system may be cycled from 2 V to 5 V during charge and discharge. In some embodiments, the system may be cycled from 1.5 V to 4 V during charge and discharge. In some embodiments, the system may be cycled from 2.2 V to 4 V, 1.8 V to 4 V, 2.5 V to 3.75 V, 3 V to 4V, 3 V to 3.8 V, or 2 V to 3 V during charge and discharge. In some embodiments, the system may be cycled from about 1.5 V to about 4 V during charge and discharge. In some embodiments, the system may be cycled from about 2.2 V to about 4 V, about 1.8 V to about 4 V, about 2.5 V to about 3.75 V, about 3 V to about 4V, about 3 V to about 3.8 V, or about 2 V to about 3 V during charge and discharge. In some embodiments, the system may be cycled from 2.2 V to 4 V during charge and discharge. In some embodiments, the system may be cycled from 1.8 V to 4 V during charge and discharge. In some embodiments, the system may be cycled from about 2.2 V to about 4 V during charge and discharge. In some embodiments, the system may be cycled from about 1.8 V to about 4 V during charge and discharge.

The cyclability of the rechargeable energy source system may be enhanced (e.g., higher number of cycles, higher cycling efficiency) when operated at a reduced current density. The reduced current density can be 0.1 mA/cm² to 1 mA mA/cm². In some embodiments, the system may be cycled by applying a current density of 0.1 mA/cm² to 1 mA mA/cm² during charge and discharge. In some embodiments, the system may be cycled by applying a current density of about 0.1 mA/cm² to about 1 mA mA/cm² during charge and discharge. In some embodiments, the system may be cycled by applying a current density of 0.1 mA/cm², 0.2 mA/cm², 0.3 mA/cm², 0.4 mA/cm², 0.5 mA/cm², 0.6 mA/cm², 0.7 mA/cm², 0.8 mA/cm², 0.9 mA/cm², or 1 mA mA/cm² during charge and discharge. In some embodiments, the system may be cycled by applying a current density of about 0.1 mA/cm², about 0.2 mA/cm², about 0.3 mA/cm², about 0.4 mA/cm², about 0.5 mA/cm², about 0.6 mA/cm², about 0.7 mA/cm², about 0.8 mA/cm², about 0.9 mA/cm², or about 1 mA mA/cm² during charge and discharge. In some embodiments, the system may be cycled by applying a current density of at least 0.1 mA/cm², at least 0.2 mA/cm², at least 0.3 mA/cm², at least 0.4 mA/cm², at least 0.5 mA/cm², at least 0.6 mA/cm², at least 0.7 mA/cm², at least 0.8 mA/cm², at least 0.9 mA/cm², or at least 1 mA mA/cm² during charge and discharge. In some embodiments, the system may be cycled by applying a current density of at most 0.1 mA/cm², at most 0.2 mA/cm², at most 0.3 mA/cm², at most 0.4 mA/cm², at most 0.5 mA/cm², at most 0.6 mA/cm², at most 0.7 mA/cm², at most 0.8 mA/cm², at most 0.9 mA/cm², or at most 1 mA mA/cm² during charge and discharge.

In some embodiments, the cycling starts from about 2 V, about 2.5 V, about 3 V, about 3.5 V, or about 4 V. In some embodiments, the cycling starts from at least 2 V, at least 2.5 V, at least 3 V, at least 3.5 V, or at least 4 V. In some embodiments, the cycling starts from at most 2 V, at most 2.5 V, at most 3 V, at most 3.5 V, or at most 4 V. In some embodiments, the cycling finishes at 3 V, 3.25V, 3.5 V, 3.75 V, 4 V, 4.25 V, 4.5 V, 4.75 V, or 5 V. In some embodiments, the cycling finishes at about 3 V, about 3.25V, about 3.5 V, about 3.75 V, about 4 V, about 4.25 V, about 4.5 V, about 4.75 V, or about 5 V. In some embodiments, the cycling finishes at least 3 V, at least 3.25V, at least 3.5 V, at least 3.75 V, at least 4 V, at least 4.25 V, at least 4.5 V, at least 4.75 V, or at least 5 V. In some embodiments, the cycling finishes at most 3 V, at most 3.25V, at most 3.5 V, at most 3.75 V, at most 4 V, at most 4.25 V, at most 4.5 V, at most 4.75 V, or at most 5 V. The cycling can be performed at a C rate of at least 1C and a D-rate of at least 1C. The cycling can be performed at a C rate of at least 1C, 2C, 3C, 4C, 5C, C/2, C/3, C/4, or C/5 and a D-rate of at least 1C, 2C, 3C, 4C, 5C, C/2, C/3, C/4, or C/5. The cycling can be performed at a C rate of at least C/20:C/20, C/10:C/10, C/5:C/5, C/2:C/2, 1C:1C, or 2C:2C. The cycling can be performed at a C rate of at most C/20:C/20, C/10:C/10, C/5:C/5, C/2:C/2, 1C:1C, or 2C:2C. The cycling can be performed at a C rate of at least C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed at a C rate of at most C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed using a C-rate of at least C/20, C/10, C/5, C/2, 0.5C, 1C, 2C, 3C, 5C, 6C, 7C, 8C, 9C, or 10C. The cycling can be performed using a C-rate of at most C/20, C/10, C/5, C/2, 0.5C, 1C, 2C, 3C, 5C, 6C, 7C, 8C, 9C, or 10C. The cycling can be performed using a D-rate of at least D/20, D/10, D/5, D/2, 0.5D, 1D, 2D, 3D, 5D, 6D, 7D, 8D, 9D, or 10D. The cycling can be performed using a D-rate of at most D/20, D/10, D/5, D/2, 0.5D, 1D, 2D, 3D, 5D, 6D, 7D, 8D, 9D, or 10D.

In some embodiments, the rechargeable energy source system is configured to maintain a columbic efficiency of 90 percent (%), 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99% over a predetermined number of cycles. In some embodiments, the rechargeable energy source system is configured to maintain a columbic efficiency of about 90 percent (%), about 91%, about 92%, about 93%, about 94%, about 95%, about 96%, about 97%, about 98%, about 99%, about 99.1%, about 99.2%, about 99.3%, about 99.4%, about 99.5%, about 99.6%, about 99.7%, about 99.8%, about 99.9%, about 99.91%, about 99.92%, about 99.93%, about 99.94%, about 99.95%, about 99.96%, about 99.97%, about 99.98%, about 99.99% over a predetermined number of cycles. In some embodiments, the rechargeable energy source system is configured to maintain a columbic efficiency of at least 90 percent (%), at least 91%, at least 92%, at least 93%, at least 94%, at least 95%, at least 96%, at least 97%, at least 98%, at least 99%, at least 99.1%, at least 99.2%, at least 99.3%, at least 99.4%, at least 99.5%, at least 99.6%, at least 99.7%, at least 99.8%, at least 99.9%, at least 99.91%, at least 99.92%, at least 99.93%, at least 99.94%, at least 99.95%, at least 99.96%, at least 99.97%, at least 99.98%, at least 99.99% over a predetermined number of cycles. In some embodiments, the rechargeable energy source system is configured to maintain a columbic efficiency of at most 90 percent (%), at most 91%, at most 92%, at most 93%, at most 94%, at most 95%, at most 96%, at most 97%, at most 98%, at most 99%, at most 99.1%, at most 99.2%, at most 99.3%, at most 99.4%, at most 99.5%, at most 99.6%, at most 99.7%, at most 99.8%, at most 99.9%, at most 99.91%, at most 99.92%, at most 99.93%, at most 99.94%, at most 99.95%, at most 99.96%, at most 99.97%, at most 99.98%, at most 99.99% over a predetermined number of cycles. In some embodiments, the rechargeable energy source system is configured to maintain a columbic efficiency of 90% to 99%, 99.2% to 99.8%, 92% to 98%, 99.8% to 99.99%, 99.5% to 99.8%, 92% to 99.6%, or 99% to 99.99%, including all values and sub ranges in between. The predetermined number of cycles can be 50 cycles, 100 cycles, 150 cycles, 200 cycles, 250 cycles, 300 cycles, 350 cycles, 400 cycles, 500 cycles, 600 cycles, 700 cycles, 800 cycles, 900 cycles, 1000 cycles, 2000 cycles, 3000 cycles, 4000 cycles, 5000 cycles, 5500 cycles, 6000 cycles, 6500 cycles, 7000 cycles, 7500 cycles, 8000 cycles, 8500 cycles, or 9000 cycles. The predetermined number of times can be about 50 cycles, about 100 cycles, about 150 cycles, about 200 cycles, about 250 cycles, about 300 cycles, about 350 cycles, about 400 cycles, about 500 cycles, about 600 cycles, about 700 cycles, about 800 cycles, about 900 cycles, about 1000 cycles, about 2000 cycles, about 3000 cycles, about 4000 cycles, about 5000 cycles, about 5500 cycles, about 6000 cycles, about 6500 cycles, about 7000 cycles, about 7500 cycles, about 8000 cycles, about 8500 cycles, or about 9000 cycles. The predetermined number of times can be at least 50 cycles, at least 100 cycles, at least 150 cycles, at least 200 cycles, at least 250 cycles, at least 300 cycles, at least 350 cycles, at least 400 cycles, at least 500 cycles, at least 600 cycles, at least 700 cycles, at least 800 cycles, at least 900 cycles, at least 1000 cycles, at least 2000 cycles, at least 3000 cycles, at least 4000 cycles, at least 5000 cycles, at least 5500 cycles, at least 6000 cycles, at least 6500 cycles, at least 7000 cycles, at least 7500 cycles, at least 8000 cycles, at least 8500 cycles, or at least 9000 cycles. The predetermined number of times can be at most 50 cycles, at most 100 cycles, at most 150 cycles, at most 200 cycles, at most 250 cycles, at most 300 cycles, at most 350 cycles, at most 400 cycles, at most 500 cycles, at most 600 cycles, at most 700 cycles, at most 800 cycles, at most 900 cycles, at most 1000 cycles, at most 2000 cycles, at most 3000 cycles, at most 4000 cycles, at most 5000 cycles, at most 5500 cycles, at most 6000 cycles, at most 6500 cycles, at most 7000 cycles, at most 7500 cycles, at most 8000 cycles, at most 8500 cycles, or at most 9000 cycles. In some embodiments, the system (e.g., a cell) may be cycled from 2.2 V to 4 V, 1.8 V to 4 V, 2.5 V to 3.75 V, 3 V to 4V, 3 V to 3.8 V, or 2 V to 3 V during charge and discharge. In some embodiments, the system may be cycled from about 1.5 V to about 4 V during charge and discharge. In some embodiments, the system may be cycled from about 2.2 V to about 4 V, about 1.8 V to about 4 V, about 2.5 V to about 3.75 V, about 3 V to about 4V, about 3 V to about 3.8 V, or about 2 V to about 3 V during charge and discharge. In some embodiments, the system may be cycled from 2.2 V to 4 V during charge and discharge. In some embodiments, the system may be cycled from 1.8 V to 4 V during charge and discharge. In some embodiments, the system may be cycled from about 2.2 V to about 4 V during charge and discharge. In some embodiments, the system may be cycled from about 1.8 V to about 4 V during charge and discharge. In some embodiments, the cycling can be from 2 V to 5 V. In some embodiments, the cycling can be from 2.5 V to 3.75 V, 3 V to 4V, 3 V to 4.5 V, or 2 V to 3 V. In some embodiments, the cycling can be from about 2 V to about 5 V. In some embodiments, the cycling can be from about 2.5 V to about 3.75 V, about 3 V to about 4V, about 3 V to about 4.5 V, or about 2 V to about 3 V. In some embodiments, the cycling starts from about 2 V, about 2.5 V, about 3 V, about 3.5 V, or about 4 V. In some embodiments, the cycling starts from at least 2 V, at least 2.5 V, at least 3 V, at least 3.5 V, or at least 4 V. In some embodiments, the cycling starts from at most 2 V, at most 2.5 V, at most 3 V, at most 3.5 V, or at most 4 V. In some embodiments, the cycling finishes at 3 V, 3.25V, 3.5 V, 3.75 V, 4 V, 4.25 V, 4.5 V, 4.75 V, or 5 V. In some embodiments, the cycling finishes at about 3 V, about 3.25V, about 3.5 V, about 3.75 V, about 4 V, about 4.25 V, about 4.5 V, about 4.75 V, or about 5 V. In some embodiments, the cycling finishes at least 3 V, at least 3.25V, at least 3.5 V, at least 3.75 V, at least 4 V, at least 4.25 V, at least 4.5 V, at least 4.75 V, or at least 5 V. In some embodiments, the cycling finishes at most 3 V, at most 3.25V, at most 3.5 V, at most 3.75 V, at most 4 V, at most 4.25 V, at most 4.5 V, at most 4.75 V, or at most 5 V. The cycling can be performed at a C rate of at least 1C and a D-rate of at least 1C. The cycling can be performed at a C rate of at least 1C, 2C, 3C, 4C, 5C, C/2, C/3, C/4, or C/5 and a D-rate of at least 1C, 2C, 3C, 4C, 5C, C/2, C/3, C/4, or C/5. The cycling can be performed at a C rate of at least C/20:C/20, C/10:C/10, C/5:C/5, C/2:C/2, 1C:1C, or 2C:2C. The cycling can be performed at a C rate of at most C/20:C/20, C/10:C/10, C/5:C/5, C/2:C/2, 1C:1C, or 2C:2C. The cycling can be performed at a C rate of at least C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed at a C rate of at most C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed using a C-rate of at least C/20, C/10, C/5, C/2, 0.5C, 1C, 2C, 3C, 5C, 6C, 7C, 8C, 9C, or 10C. The cycling can be performed using a C-rate of at most C/20, C/10, C/5, C/2, 0.5C, 1C, 2C, 3C, 5C, 6C, 7C, 8C, 9C, or 10C. The cycling can be performed using a D-rate of at least D/20, D/10, D/5, D/2, 0.5D, 1D, 2D, 3D, 5D, 6D, 7D, 8D, 9D, or 10D. The cycling can be performed using a D-rate of at most D/20, D/10, D/5, D/2, 0.5D, 1D, 2D, 3D, 5D, 6D, 7D, 8D, 9D, or 10D.

In certain embodiments, the rechargeable energy source system may maintain 80%, 85%, 90%, 95%, 98%, 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, or 99.99% of its initial discharge capacity after at least 5500 charge-discharge cycles. In some embodiments, the rechargeable energy source system may maintain about 80%, about 85%, about 90%, about 95%, about 98%, about 99%, about 99.1%, about 99.2%, about 99.3%, about 99.4%, about 99.5%, about 99.6%, about 99.7%, about 99.8%, about 99.9%, about 99.91%, about 99.92%, about 99.93%, about 99.94%, about 99.95%, about 99.96%, about 99.97%, about 99.98%, or about 99.99% of its initial discharge capacity after at least 5500 charge-discharge cycles. In some embodiments, the rechargeable energy source system may maintain at least 80%, at least 85%, at least 90%, at least 95%, at least 98%, at least 99%, at least 99.1%, at least 99.2%, at least 99.3%, at least 99.4%, at least 99.5%, at least 99.6%, at least 99.7%, at least 99.8%, at least 99.9%, at least 99.91%, at least 99.92%, at least 99.93%, at least 99.94%, at least 99.95%, at least 99.96%, at least 99.97%, at least 99.98%, or at least 99.99% of its initial discharge capacity after at least 5500 charge-discharge cycles. In some embodiments, the rechargeable energy source system may maintain at most 80%, at most 85%, at most 90%, at most 95%, at most 98%, at most 99%, at most 99.1%, at most 99.2%, at most 99.3%, at most 99.4%, at most 99.5%, at most 99.6%, at most 99.7%, at most 99.8%, at most 99.9%, at most 99.91%, at most 99.92%, at most 99.93%, at most 99.94%, at most 99.95%, at most 99.96%, at most 99.97%, at most 99.98%, or at most 99.99% of its initial discharge capacity after at least 5500 charge-discharge cycles. In some embodiments, the rechargeable energy source system may maintain at least 80% of its initial discharge capacity after at least 5500 charge-discharge cycles. In some embodiments, the rechargeable energy source system may maintain at least 85% of its initial discharge capacity after at least 5000 charge-discharge cycles. In some embodiments, the rechargeable energy source system may maintain at least 90% of its initial discharge capacity after at least 5500 charge-discharge cycles. In some embodiments, the rechargeable energy source system may maintain at least 95% of its initial discharge capacity after at least 5500 charge-discharge cycles. In some embodiments, the rechargeable energy source system may maintain at least 98% of its initial discharge capacity after at least 5500 charge-discharge cycles.

### Electrolyte

Various organic electrolytes can be used. In some embodiments, an electrolyte for an electrochemical cell comprising nanostructured carbon can be a complex electrolyte of the present disclosure. For example, an electrolyte for an electrochemical cell comprising nanostructured carbon can comprise one or more participating solvents and one or more non-participating solvents. The electrolyte can further comprise one or more semi-participating solvents. In some embodiments, an organic electrolyte can comprise dimethyl carbonate, ethylmethyl carbonate, diethyl carbonate, ethylene carbonate, propylene carbonate, 1,3-dioxolan-2-one, 4-methyl-1,3-dioxolan-2-one, oxolan-2-one, and any combination thereof. In some embodiments, an electrolyte can comprise an organic carbonate compound, an ester compound, an ether compound, a ketone compound, an alcohol compound, an aprotic bipolar solvent, or a combination thereof. The carbonate compound can be an open chain carbonate compound, a cyclic carbonate compound, a fluorocarbonate derivative thereof, or a combination thereof.

In some embodiments, the electrolyte can comprise an ether-based electrolytes. In some embodiments, the electrolyte comprises an ether-based solvent system. These electrolytes are composed of a mixture of organic solvents, lithium salts, and additives. The electrolyte comprising an ether-based solvent system may have lower reduction potentials, indicating a higher tendency to donate electrons during a chemical reaction. As a result, the electrolyte is less likely to react with the lithium metal with the cell, thereby improving the overall safety and stability of the battery. In some embodiments, the electrolyte may comprise an ether-based solvent comprising 1,3-dioxolane (DOL), 1,2-dimethoxyethane (DME), tetraethylene glycol dimethyl ether (TEGDME), poly(ethylene glycol) dimethyl ether (PEGDME), or a mixture thereof. In some embodiments, the electrolyte may be ethylene glycol dimethyl ether (EGDME) based electrolyte. EGDME exhibits good electrochemical performance and is used in lithium batteries as it is particularly efficient in transferring lithium ions from the anode to the cathode during discharging and the other way around during charging. This high conductivity results in increased efficiency of the battery. In some embodiments, the ether-based electrolyte may be tetraethylene glycol dimethyl ether (TEGDME) based electrolyte. TEGDME exhibits good thermal stability, high flash point, and high boiling point compared to other ether-based solvents. In some embodiments, the ether-based electrolyte can be poly(ethylene glycol) dimethyl ether (PEGDME) based electrolyte, exhibiting high lithium transference number, high ionic conductivity, and better cycling performance. In some embodiments, the electrolyte may be free of carbonate solvents.

In certain embodiments, the electrolyte may comprise an ether-based solvent system. In some embodiments, the rechargeable energy source system can be configured to provide a capacity of 600 mAh/g, 650 mAh/g, 700 mAh/g, 750 mAh/g, 800 mAh/g, 850 mAh/g, 900 mAh/g, 950 mAh/g, 1000 mAh/g, 1100 mAh/g, 1200 mAh/g, 1300 mAh/g, 1400 mAh/g, 1500 mAh/g, 1600 mAh/g, 1700 mAh/g, 1800 mAh/g, 1900 mAh/g, 2000 mAh/g, 2500 mAh/g, 3000 mAh/g, 3500 mAh/g, 4000 mAh/g, 4500 mAh/g, or 5000 mAh/g with an ether-based electrolyte. In some embodiments, the rechargeable energy source system can be configured to provide a capacity of about 600 mAh/g, about 650 mAh/g, about 700 mAh/g, about 750 mAh/g, about 800 mAh/g, about 850 mAh/g, about 900 mAh/g, about 950 mAh/g, about 1000 mAh/g, about 1100 mAh/g, about 1200 mAh/g, about 1300 mAh/g, about 1400 mAh/g, about 1500 mAh/g, about 1600 mAh/g, about 1700 mAh/g, about 1800 mAh/g, about 1900 mAh/g, about 2000 mAh/g, about 2500 mAh/g, about 3000 mAh/g, about 3500 mAh/g, about 4000 mAh/g, about 4500 mAh/g, or about 5000 mAh/g with an ether-based electrolyte. In some embodiments, the rechargeable energy source system can be configured to provide a capacity of at least 600 mAh/g, at least 650 mAh/g, at least 700 mAh/g, at least 750 mAh/g, at least 800 mAh/g, at least 850 mAh/g, at least 900 mAh/g, at least 950 mAh/g, at least 1000 mAh/g, at least 1100 mAh/g, at least 1200 mAh/g, at least 1300 mAh/g, at least 1400 mAh/g, at least 1500 mAh/g, at least 1600 mAh/g, at least 1700 mAh/g, at least 1800 mAh/g, at least 1900 mAh/g, at least 2000 mAh/g, at least 2500 mAh/g, at least 3000 mAh/g, at least 3500 mAh/g, at least 4000 mAh/g, at least 4500 mAh/g, or at least 5000 mAh/g with an ether-based electrolyte. In some embodiments, the rechargeable energy source system can be configured to provide a capacity of at most 700 mAh/g, at most 750 mAh/g, at most 800 mAh/g, at most 850 mAh/g, at most 900 mAh/g, at most 950 mAh/g, at most 1000 mAh/g, at most 1100 mAh/g, at most 1200 mAh/g, at most 1300 mAh/g, at most 1400 mAh/g, at most 1500 mAh/g, at most 1600 mAh/g, at most 1700 mAh/g, at most 1800 mAh/g, at most 1900 mAh/g, at most 2000 mAh/g, at most 2500 mAh/g, at most 3000 mAh/g, at most 3500 mAh/g, at most 4000 mAh/g, at most 4500 mAh/g, or at most 5000 mAh/g with an ether-based electrolyte. In some embodiments, the rechargeable energy source system can be configured to provide a capacity of 800 mAh/g-1200 mAh/g, 700 mAh/g-1100 mAh/g, 900 mAh/g-1400 mAh/g, 1500 mAh/g-4200 mAh/g, 1700 mAh/g-3900 mAh/g, 1900 mAh/g-4000 mAh/g, or 2600 mAh/g-4000 mAh/g with an ether-based electrolyte, including all values and sub ranges in between.

In some embodiments, the rechargeable energy source system may maintain 80%, 85%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99% of its initial discharge capacity after at least 5500 charge-discharge cycles with an ether-based electrolyte. In certain embodiments, the rechargeable energy source system may maintain about 80%, about 85%, about 91%, about 92%, about 93%, about 94%, about 95%, about 96%, about 97%, about 98%, about 99%, about 99.1%, about 99.2%, about 99.3%, about 99.4%, about 99.5%, about 99.6%, about 99.7%, about 99.8%, about 99.9%, about 99.91%, about 99.92%, about 99.93%, about 99.94%, about 99.95%, about 99.96%, about 99.97%, about 99.98%, about 99.99% of its initial discharge capacity after at least 5500 charge-discharge cycles with an ether-based electrolyte. In certain embodiments, the rechargeable energy source system may maintain at least 80%, at least 85%, at least 90%, at least 91%, at least 92%, at least 93%, at least 94%, at least 95%, at least 96%, at least 97%, at least 98%, at least 99%, at least 99.1%, at least 99.2%, at least 99.3%, at least 99.4%, at least 99.5%, at least 99.6%, at least 99.7%, at least 99.8%, at least 99.9%, at least 99.91%, at least 99.92%, at least 99.93%, at least 99.94%, at least 99.95%, at least 99.96%, at least 99.97%, at least 99.98%, at least 99.99% of its initial discharge capacity after at least 5500 charge-discharge cycles with an ether-based electrolyte. In certain embodiments, the rechargeable energy source system may maintain at most 80%, at most 85%, at most 90%, at most 91%, at most 92%, at most 93%, at most 94%, at most 95%, at most 96%, at most 97%, at most 98%, at most 99%, at most 99.1%, at most 99.2%, at most 99.3%, at most 99.4%, at most 99.5%, at most 99.6%, at most 99.7%, at most 99.8%, at most 99.9%, at most 99.91%, at most 99.92%, at most 99.93%, at most 99.94%, at most 99.95%, at most 99.96%, at most 99.97%, at most 99.98%, at most 99.99% of its initial discharge capacity after at least 5500 charge-discharge cycles with an ether-based electrolyte. In certain embodiments, the rechargeable energy source system may maintain at least 80% of its initial discharge capacity after at least 5500 charge-discharge cycles with an ether-based electrolyte. In certain embodiments, the rechargeable energy source system may maintain at least 85% of its initial discharge capacity after at least 5500 charge-discharge cycles with an ether-based electrolyte. In certain embodiments, the rechargeable energy source system may maintain at least 90% of its initial discharge capacity after at least 5500 charge-discharge cycles with an ether-based electrolyte. In certain embodiments, the rechargeable energy source system may maintain at least 95% of its initial discharge capacity after at least 5500 charge-discharge cycles with an ether-based electrolyte. In certain embodiments, the rechargeable energy source system may maintain at least 98% of its initial discharge capacity after at least 5500 charge-discharge cycles with an ether-based electrolyte.

In some embodiments, the organic electrolyte can comprise dimethyl carbonate, ethylmethyl carbonate, diethyl carbonate, ethylene carbonate, propylene carbonate, 1,3-dioxolan-2-one, 4-methyl-1,3-dioxolan-2-one, oxolan-2-one, and any combination thereof. In some embodiments, the electrolyte can comprise an organic carbonate compound, an ester compound, an ether compound, a ketone compound, an alcohol compound, an aprotic bipolar solvent, or a combination thereof. The carbonate compound can be an open chain carbonate compound, a cyclic carbonate compound, a fluorocarbonate derivative thereof, or a combination thereof.

In some embodiments, an electrolyte comprises an aqueous electrolyte. In some embodiments, an electrolyte comprises a non-aqueous electrolyte. In some embodiments, an electrolyte comprises a polymer electrolyte. In some embodiments, an electrolyte comprises an organic electrolyte. In some embodiments, an electrolyte comprises a lithium salt. In some embodiments, an electrolyte comprises an ionic liquid. In some embodiments, an electrolyte comprises a deep eutectic solvent. The electrolyte can be used in the manufacture of a lithium metal electrode. The electrolyte can be used in a rechargeable energy source system.

In some embodiments, an electrolyte is non-flammable or fire-resistant. In some embodiments, an electrolyte is substantially non-volatile at room temperature and pressure. In some embodiments, an electrolyte is non-flammable at room temperature and pressure. In some embodiments, an electrolyte is self-extinguishing.

In some embodiments, the electrolyte further comprises one or more additives, e.g., nitrogen, sulfur, phosphorus, or silicon compounds. The additives may improve the electrochemical performance and stability of the cell. Without being bound by theory, such additives may function to form or stabilize a solid electrolyte interphase (SEI) on the anode surface, suppress gas generation or transition-metal dissolution, enhance oxidation stability at the cathode, or improve overall ionic conductivity. The additives include but are not limited to vinyl carbonate (VC), fluoroethylene carbonate (FEC), lithium difluoro(oxalate)borate (LiDFOB), lithium bis(oxalate)borate (LiBOB), lithium nitrate (LiNO₃), tris(trimethylsilyl) phosphate (TMSP), 1,3-propane sultone (PS), ethylene sulfate(ES), and dimethyl sulfite (DMS). In some embodiments, the one or more additives comprise lithium nitrate (LiNO₃). In some embodiments, the one or more additives comprise VC. In some embodiments, the one or more additives comprise LiDFOB. In some embodiments, the one or more additives comprise FEC. In some embodiments, the one or more additives comprise ES. In some embodiment, the electrolyte comprises one or more additives of 0.5 wt, 1 wt %, 2 wt %, 3 wt %, 4 wt %, 5 wt %, 6 wt %, 7 wt %, 8 wt %, 9 wt %, or 10 wt % of the electrolyte. In some embodiment, the electrolyte comprises one or more additives of about 0.5 wt, about 1 wt %, about 2 wt %, about 3 wt %, about 4 wt %, about 5 wt %, about 6 wt %, about 7 wt %, about 8 wt %, about 9 wt %, or about 10 wt % of the electrolyte. In some embodiment, the electrolyte comprises one or more additives of at least 0.5 wt, at least 1 wt %, at least 2 wt %, at least 3 wt %, at least 4 wt %, at least 5 wt %, at least 6 wt %, at least 7 wt %, at least 8 wt %, at least 9 wt %, or at least 10 wt % of the electrolyte. In some embodiment, the electrolyte comprises one or more additives of at most 0.5 wt, at most 1 wt %, at most 2 wt %, at most 3 wt %, at most 4 wt %, at most 5 wt %, at most 6 wt %, at most 7 wt %, at most 8 wt %, at most 9 wt %, or at most 10 wt % of the electrolyte. In some embodiments, an electrolyte comprises a decomposition potential of 2 V, 3 V, 4 V, 5 V, or 6 V. In some embodiments, an electrolyte comprises a decomposition potential of 4 V or higher. In some embodiments, a solvent of the electrolyte decomposes oxidatively above ~4 V. In some embodiments, an electrolyte comprises a decomposition potential of about 2 V, about 3 V, about 4 V, about 5 V, or about 6 V. In some embodiments, an electrolyte comprises a decomposition potential of at least 2 V, at least 3 V, at least 4 V, at least 5 V, or at least 6 V. In some embodiments, an electrolyte comprises a decomposition potential of at most 2 V, at most 3 V, at most 4 V, at most 5 V, or at most 6 V.

In some embodiments, an electrolyte comprises a dielectric constant of 2, 5, 10, 20, 30, 40, 50, 60, 70, or 80. In some embodiments, an electrolyte comprises a dielectric constant of about 2, about 5, about 10, about 20, about 30, about 40, about 50, about 60, about 70, or about 80. In some embodiments, an electrolyte comprises a dielectric constant of at least 2, at least 5, at least 10, at least 20, at least 30, at least 40, at least 50, at least 60, at least 70, or at least 80. In some embodiments, an electrolyte comprises a dielectric constant of at most 3, at most 5, at most 10, at most 20, at most 30, at most 40, at most 50, at most 60, at most 70, at most 80, or at most 90.

Various organic electrolytes can be used. In some embodiments, an organic electrolyte can comprise dimethyl carbonate, ethylmethyl carbonate, diethyl carbonate, ethylene carbonate, propylene carbonate, 1,3-dioxolan-2-one, 4-methyl-1,3-dioxolan-2-one, oxolan-2-one, and any combination thereof. In some embodiments, an electrolyte can comprise an organic carbonate compound, an ester compound, an ether compound, a ketone compound, an alcohol compound, an aprotic bipolar solvent, or a combination thereof. The carbonate compound may be an open chain carbonate compound, a cyclic carbonate compound, a fluorocarbonate derivative thereof, or a combination thereof.

In some embodiments, the chain carbonate compound can be diethyl carbonate (DEC), dimethyl carbonate (DMC), dipropyl carbonate (DPC), methylpropyl carbonate (MPC), ethylpropylcarbonate (EPC), methylethyl carbonate (MEC), and a combination thereof. In some embodiments, the cyclic carbonate compound can be ethylene carbonate (EC), propylenecarbonate (PC), butylene carbonate (BC), fluoroethylene carbonate (FEC), vinylethylene carbonate (VEC), and a combination thereof. In some embodiments, the fluorocarbonate compound can be fluoroethylene carbonate (FEC), 4,5-difluoroethylene carbonate, 4,4-difluoroethylene carbonate, 4,4,5-trifluoroethylene carbonate, 4,4,5,5-tetrafluoroethylene carbonate, 4-fluoro-5-methylethylene carbonate, 4-fluoro-4-methylethylene carbonate, 4,5-difluoro-4-methylethylene carbonate, 4,4,5-trifluoro-5-methylethylene carbonate, trifluoromethylethylene carbonate, and a combination thereof. In some embodiments, the carbonate compound can include a combination of cyclic carbonate and chain carbonate, in consideration of dielectric constant and viscosity of the electrolyte. In some embodiments, the carbonate compound can be a mixture of such chain carbonate and/or cyclic carbonate compounds as described above with a fluorocarbonate compound.

In some embodiments, the fluorocarbonate compound can increase solubility of a lithium salt to improve ionic conductivity of the electrolyte, and can facilitate formation of the thin film on the negative electrode. In some embodiments, the ester compound is methyl acetate, ethyl acetate, n-propyl acetate, dimethyl acetate, methyl propionate (MP), ethyl propionate, γ-butyrolactone, decanolide, valerolactone, mevalonolactone, caprolactone, and methyl formate.

In some embodiments, the ether compound is dibutyl ether, tetraglyme, diglyme, 1,2-dimethoxyethane, 1,2-diethoxyethane, ethoxymethoxyethane, 2-methyltetrahydrofuran, tetrafluoroproyl ether (TTE), and tetrahydrofuran. An example of the ketone compound is cyclohexanone. In some embodiments, the alcohol compound can be ethyl alcohol or isopropyl alcohol. In some embodiments, the aprotic solvent can be a nitrile (such as R—CN, wherein R is a C₂-C₂₀ linear, branched, or cyclic hydrocarbon-based moiety that can include a double-bond, an aromatic ring or an ether bond), amides (such as formamide and dimethylformamide), dioxolanes (such as 1,2-dioxolane and 1,3-dioxolane), methylsulfoxide, sulfolanes (such as sulfolane and methylsulfolane), 1,3-dimethyl-2-imidazolidinone, N-methyl-2-pyrrolidinone, nitromethane, trimethyl phosphate, triethyl phosphate, trioctyl phosphate, and triester phosphate.

In some embodiments, an electrolyte can comprise an aromatic hydrocarbon organic solvent in a carbonate solvent. In some embodiments, an aromatic hydrocarbon organic solvent can be benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, 2-fluorotoluene, 3-fluorotoluene, 4-fluorotoluene, 2,3-difluorotoluene, 2,4-difluorotoluene, 2,5-difluorotoluene, 2,6-difluorotoluene, 3,4-difluorotoluene, 3,5-difluorotoluene, 2,3,4-trifluorotoluene, 2,3,5-trifluorotoluene, 2,3,6-trifluorotoluene, 3,4,5-trifluorotoluene, 2,4,5-trifluorotoluene, 2,4,6-trifluorotoluene, 2-chlorotoluene, 3-chlorotoluene, 4-chlorotoluene, 2,3-dichlorotoluene, 2,4-dichlorotoluene, 2,5-dichlorotoluene, 2,6-dichlorotoluene, 2,3,4-trichlorotoluene, 2,3,5-trichlorotoluene, 2,3,6-trichlorotoluene, 3,4,5-trichlorotoluene, 2,4,5-trichlorotoluene, 2,4,6-trichlorotoluene, 2-iodotoluene, 3-iodotoluene, 4-iodotoluene, 2,3-diiodotoluene, 2,4-diiodotoluene, 2,5-diiodotoluene, 2,6-diiodotoluene, 3,4-diiodotoluene, 3,5-diiodotoluene, 2,3,4-triiodotoluene, 2,3,5-triiodotoluene, 2,3,6-triiodotoluene, 3,4,5-triiodotoluene, 2,4,5-triiodotoluene, 2,4,6-triiodotoluene, o-xylene, m-xylene, p-xylene, and combinations thereof.

An electrolyte can comprise various viscosities. Polymeric or polymer solution electrolytes can comprise a large viscosity, as the viscosity can scale exponentially with the molecular weight of the polymer above a critical molecular weight (e.g., entanglement molecular weight). In some embodiments, an electrolyte comprises a viscosity of 0.1 mPa·s, 0.2 mPa·s, 0.3 mPa·s, 0.4 mPa·s, 0.5 mPa·s, 0.6 mPa·s, 0.7 mPa·s, 0.8 mPa·s, 0.9 mPa·s, 1 mPa·s, 2 mPa·s, 3 mPa·s, 4 mPa·s, 5 mPa·s, 6 mPa·s, 7 mPa·s, 8 mPa·s, 9 mPa·s, 10 mPa·s, 20 mPa·s, 30 mPa·s, 40 mPa·s, 50 mPa·s, 60 mPa·s, 70 mPa·s, 80 mPa·s, 90 mPa·s, 100 mPa·s, 200 mPa·s, 300 mPa·s, 400 mPa·s, 500 mPa·s, 600 mPa·s, 700 mPa·s, 800 mPa·s, or 900 mPa·s. In some embodiments, an electrolyte comprises a viscosity of about 0.1 mPa·s, about 0.2 mPa·s, about 0.3 mPa·s, about 0.4 mPa·s, about 0.5 mPa·s, about 0.6 mPa·s, about 0.7 mPa·s, about 0.8 mPa·s, about 0.9 mPa·s, about 1 mPa·s, about 2 mPa·s, about 3 mPa·s, about 4 mPa·s, about 5 mPa·s, about 6 mPa·s, about 7 mPa·s, about 8 mPa·s, about 9 mPa·s, about 10 mPa·s, about 20 mPa·s, about 30 mPa·s, about 40 mPa·s, about 50 mPa·s, about 60 mPa·s, about 70 mPa·s, about 80 mPa·s, about 90 mPa·s, about 100 mPa·s, about 200 mPa·s, about 300 mPa·s, about 400 mPa·s, about 500 mPa·s, about 600 mPa·s, about 700 mPa·s, about 800 mPa·s, or about 900 mPa·s. In some embodiments, an electrolyte comprises a viscosity of at least 0.1 mPa·s, at least 0.2 mPa·s, at least 0.3 mPa·s, at least 0.4 mPa·s, at least 0.5 mPa·s, at least 0.6 mPa·s, at least 0.7 mPa·s, at least 0.8 mPa·s, at least 0.9 mPa·s, at least 1 mPa·s, at least 2 mPa·s, at least 3 mPa·s, at least 4 mPa·s, at least 5 mPa·s, at least 6 mPa·s, at least 7 mPa·s, at least 8 mPa·s, at least 9 mPa's, at least 10 mPa·s, at least 20 mPa·s, at least 30 mPa·s, at least 40 mPa·s, at least 50 mPa·s, at least 60 mPa·s, at least 70 mPa·s, at least 80 mPa·s, at least 90 mPa·s, at least 100 mPa·s, at least 200 mPa·s, at least 300 mPa·s, at least 400 mPa·s, at least 500 mPa·s, at least 600 mPa·s, at least 700 mPa·s, at least 800 mPa·s, or at least 900 mPa·s. In some embodiments, an electrolyte comprises a viscosity of at most 0.1 mPa·s, at most 0.2 mPa·s, at most 0.3 mPa·s, at most 0.4 mPa·s, at most 0.5 mPa·s, at most 0.6 mPa·s, at most 0.7 mPa·s, at most 0.8 mPa·s, at most 0.9 mPa·s, at most 1 mPa·s, at most 2 mPa·s, at most 3 mPa·s, at most 4 mPa·s, at most 5 mPa·s, at most 6 mPa·s, at most 7 mPa·s, at most 8 mPa·s, at most 9 mPa·s, at most 10 mPa·s, at most 20 mPa·s, at most 30 mPa·s, at most 40 mPa·s, at most 50 mPa·s, at most 60 mPa·s, at most 70 mPa·s, at most 80 mPa·s, at most 90 mPa·s, at most 100 mPa·s, at most 200 mPa·s, at most 300 mPa·s, at most 400 mPa·s, at most 500 mPa·s, at most 600 mPa·s, at most 700 mPa·s, at 1 most 800 mPa·ss, or at most 900 mPa·s.

In some embodiments, an electrolyte comprises a viscosity of 1 Pa·s, 2 Pa·s, 3 Pa·s, 4 Pa·s, 5 Pa·s, 6 Pa·s, 7 Pa·s, 8 Pa·s, 9 Pa·s, 10 Pa·s, 20 Pa·s, 30 Pa·s, 40 Pa·s, 50 Pas, 60 Pas, 70 Pa·s, 80 Pas, 90 Pa·s, 100 Pa·s, 200 Pas, 300 Pa·s, 400 Pa·s, 500 Pas, 600 Pa·s, 700 Paes, 800 Pa·s, or 900 Pa·s. In some embodiments, an electrolyte comprises a viscosity of about 1 Pas, about 2 Pa·s, about 3 Pas, about 4 Pads, about 5 Pas, about 6 Pads, about 7 Pa·s, about 8 Pa's, about 9 Pas, about 10 Pas, about 20 Pads, about 30 Pas, about 40 Pas, about 50 Pads, about 60 Pa·s, about 70 Pas, about 80 Pa·s, about 90 Pads, about 100 Pas, about 200 Pa·s, about 300 Pas, about 400 Pas, about 500 Pas, about 600 Pa·s, about 700 Pa·s, about 800 Pa·s, or about 900 Pa·s. In some embodiments, an electrolyte comprises a viscosity of at least 1 Pa·s, at least 2 Pa·s, at least 3 Pas, at least 4 Pa·s, at least 5 Pads, at least 6 Pads, at least 7 Pads, at least 8 Pas, at least 9 Pas, at least 10 Pas, at least 20 Pas, at least 30 Pas, at least 40 Pads, at least 50 Pa·s, at least 60 Pas, at least 70 Pas, at least 80 Pas, at least 90 Pas, at least 100 Pa·s, at least 200 Pas, at least 300 Pads, at least 400 Pads, at least 500 Pa·s, at least 600 Pads, at least 700 Pas, at least 800 Pas, or at least 900 Pa·s. In some embodiments, an electrolyte comprises a viscosity of at most 1 Pa·s, at most 2 Paes, at most 3 Paes, at most 4 Paos, at most 5 Paes, at most 6 Pads, at most 7 Paos, at most 8 Paes, at most 9 Paes, at most 10 Pads, at most 20 Pas, at most 30 Paos, at most 40 Pads, at most 50 Pads, at most 60 Pas, at most 70 Pas, at most 80 Paos, at most 90 Pas, at most 100 Pads, at most 200 Pas, at most 300 Paes, at most 400 Paes, at most 500 Pa's, at most 600 Pas, at most 700 Pas, at most 800 Paes, or at most 900 Pa·s.

In some embodiments, an electrolyte comprises a viscosity of 1 kPa·s, 2 kPa·s, 3 kPa·s, 4 kPa·s, 5 kPa·s, 6 kPa·s, 7 kPa·s, 8 kPa·s, 9 kPa·s, 10 kPa·s, 20 kPa·s, 30 kPa·s, 40 kPa·s, 50 kPa·s, 60 kPa·s, 70 kPa·s, 80 kPa·s, 90 kPa·s, 100 kPa·s, 200 kPa·s, 300 kPa·s, 400 kPa·s, 500 kPa·s, 600 kPa·s, 700 kPa·s, 800 kPa·s, or 900 kPa·s. In some embodiments, an electrolyte comprises a viscosity of about 1 kPa·s, about 2 kPa·s, about 3 kPa·s, about 4 kPa·s, about 5 kPa·s, about 6 kPa·s, about 7 kPa·s, about 8 kPa·s, about 9 kPa·s, about 10 kPa·s, about 20 kPa·s, about 30 kPa·s, about 40 kPa·s, about 50 kPa·s, about 60 kPa·s, about 70 kPa·s, about 80 kPa·s, about 90 kPa·s, about 100 kPa·s, about 200 kPa·s, about 300 kPa·s, about 400 kPa·s, about 500 kPa·s, about 600 kPa·s, about 700 kPa·s, about 800 kPa·s, or about 900 kPa·s. In some embodiments, an electrolyte comprises a viscosity of at least 1 kPa·s, at least 2 kPa·s, at least 3 kPa·s, at least 4 kPa·s, at least 5 kPa·s, at least 6 kPa·s, at least 7 kPa·s, at least 8 kPa·s, at least 9 kPa·s, at least 10 kPa·s, at least 20 kPa·s, at least 30 kPa·s, at least 40 kPa·s, at least 50 kPa·s, at least 60 kPa·s, at least 70 kPa·s, at least 80 kPa·s, at least 90 kPa·s, at least 100 kPa·s, at least 200 kPa·s, at least 300 kPa·s, at least 400 kPa·s, at least 500 kPa·s, at least 600 kPa·s, at least 700 kPa·s, at least 800 kPa·s, or at least 900 kPa·s. In some embodiments, an electrolyte comprises a viscosity of at most 1 kPa·s, at most 2 kPa·s, at most 3 kPa·s, at most 4 kPa·s, at most 5 kPa·s, at most 6 kPa·s, at most k7 Pa·s, at most 8 kPa·s, at most 9 kPa·s, at most 10 kPa·s, at most 20 kPa·s, at most 30 kPa·s, at most 40 kPa·s, at most 50 kPa·s, at most 60 kPa·s, at most 70 kPa·s, at most 80 kPa·s, at most 90 kPa·s, at most 100 kPa·s, at most 200 kPa·s, at most 300 kPa·s, at most 400 kPa·s, at most 500 kPa·s, at most 600 kPa·s, at most 700 kPa·s, at most 800 kPa·s, or at most 900 kPa·s.

Various polymeric electrolytes can be used. A polymer electrolyte can comprise poly(ethylene oxide), poly(vinyl alcohol), poly(methyl methacrylate), poly(caprolactone), poly(chitosan), poly(vinyl pyrrolidone), poly(vinyl chloride), poly(vinyl fluoride), poly(imide), or any combination thereof, which can inherently conduct lithium ions or be doped with one or more lithium salts to make the polymer be lithium conductive.

Various ionic liquids can be used, e.g., any one of the ionic liquids listed on the Ionic Liquids Database (ILThermo) of the National Institute of Standards and Technology.

Various lithium salts can be used. In some embodiments, the lithium salt in the electrolyte solution can be, but not limited to lithium hexafluorophosphate (LiPF₆), lithium tetrafluoroborate (LiBF₄), or lithium bis(trifluoromethanesulfonyl)imide (LiTFSI). A lithium salt can comprise lithium 12-hydroxystearate, lithium acetate, lithium amide, lithium aspartate, lithium azide, lithium bis(trifluoromethanesulfonyl)imide, lithium borohydride, lithium bromide, lithium carbonate, lithium chlorate, lithium chloride, lithium citrate, lithium cyanide, lithium diphenylphosphide, lithium hexafluorogermanate, lithium hexafluorophosphate, lithium hypochlorite, lithium hypofluorite, lithium metaborate, lithium methoxide, lithium naphthalene, lithium niobate, lithium nitrate, lithium nitrite, lithium oxalate, lithium perchlorate, lithium stearate, lithium succinate, lithium sulfate, lithium sulfide, lithium superoxide, lithium tantalate, lithium tetrachloroaluminate, lithium tetrafluoroborate, lithium tetrakis(pentafluorophenyl)borate, lithium triflate, lithium tungstate, or any combination thereof. In some embodiments, an electrolyte can comprise lithium salts comprising an organic anion selected from the group consisting of trifluoromethanesulfonyl-imide (TFSI), N-butyl-N-methylpyrrolidinium bis(trifluoromethanesulfonyl)imide (PyruTFSI), trifluoromethanesulfonyl-imide, bis(trifluoromethanesulfonyl)imide (LiTFSI), and 1-ethyl-3-methylimidazolium-bis(trifluoromethylsulfonyl)imide (EMI-TFSI). In some embodiments, the catholyte 290 comprises ionic liquid-forming salts dissolved in 1,3-dioxolane (DOL), 1,2 dimethoxyethane (DME), or tetraethylene glycol dimethyl ether (TEGDME). In some embodiments, an electrolyte can comprise Li₂SO₄, Li₂CO₃, LiPF₆, LiBF₄, LiBH₄, LiBO, LiDFOB, LiClO₄, LiTFSI, and combinations thereof. In some embodiments, an electrolyte can comprise LiPF₆, LiBF₄, LiBH₄, LiBO, LiDFOB, LiSbF₆, LiAsF₆, LiSbF₆, LiCF₃SO₃, Li(CF₃SO₂)₃C, Li(CF₃SO₂)₂N, LiC₄F₉SO₃, LiClO₄, LiAlO₄, LiAlCl₄, LiAlF₄, LiBPh₄, LiBioCl₁₀, CH₃SO₃Li, C₄F₃SO₃Li, (CF₃SO₂)₂NLi, LiN(CₓF₂ₓ₊₁SO₂)(CₓF_{2y+1}SO₂) (wherein x and y are natural numbers), CF₃CO₂Li, LiCl, LiBr, LiI, LIBOB (lithium bisoxalato borate), lower aliphatic carboxylic acid lithium, lithium terphenylborate, lithium imide, and any combination thereof. In some embodiments, a concentration of the lithium salt can be in a range of about 0.1 molar (“M”) to about 2.0 M. In some embodiments, a concentration of the lithium salt is 0.01 M, 0.02 M, 0.03 M, 0.04 M, 0.05 M, 0.06 M, 0.07 M, 0.08 M, 0.09 M, 0.1 M, 0.2 M, 0.3 M, 0.4 M, 0.5 M, 0.6 M, 0.7 M, 0.8 M, 0.9 M, 1.0 M, 1.5 M, 2.0 M, 2.5 M, or 3 M. In some embodiments, a concentration of the lithium salt is about 0.01 M, about 0.02 M, about 0.03 M, about 0.04 M, about 0.05 M, about 0.06 M, about 0.07 M, about 0.08 M, about 0.09 M, about 0.1 M, about 0.2 M, about 0.3 M, about 0.4 M, about 0.5 M, about 0.6 M, about 0.7 M, about 0.8 M, about 0.9 M, about 1.0 M, about 1.5 M, about 2.0 M, about 2.5 M, or about 3 M. In some embodiments, a concentration of the lithium salt is at least 0.01 M, at least 0.02 M, at least 0.03 M, at least 0.04 M, at least 0.05 M, at least 0.06 M, at least 0.07 M, at least 0.08 M, at least 0.09 M, at least 0.1 M, at least 0.2 M, at least 0.3 M, at least 0.4 M, at least 0.5 M, at least 0.6 M, at least 0.7 M, at least 0.8 M, at least 0.9 M, at least 1.0 M, at least 1.5 M, at least 2.0 M, at least 2.5 M, or at least 3 M. In some embodiments, a concentration of the lithium salt is at most 0.01 M, at most 0.02 M, at most 0.03 M, at most 0.04 M, at most 0.05 M, at most 0.06 M, at most 0.07 M, at most 0.08 M, at most 0.09 M, at most 0.1 M, at most 0.2 M, at most 0.3 M, at most 0.4 M, at most 0.5 M, at most 0.6 M, at most 0.7 M, at most 0.8 M, at most 0.9 M, at most 1.0 M, at most 1.5 M, at most 2.0 M, at most 2.5 M, or at most 3 M.

The electrolyte can comprise a lithium conductive polymer. The lithium conductive polymer can be a copolymer. In some embodiments, the polymer can comprise a block copolymer or a random copolymer. In some embodiments, a portion of the block copolymer is in contact with lithium metal, wherein the portion is substantially unreactive with the lithium metal. A block copolymer can, for example, be annealed to undergo microphase separation, providing an exposed hydrophobic surface that is substantially unreactive with lithium metal. Meanwhile, the block copolymer can further comprise a percolating hydrophilic domain that provides paths for lithium ions to traverse through from one side of the block copolymer to the other. In some embodiments, the block copolymer comprises diblock copolymer, triblock copolymer, triblock terpolymer, multiblock copolymer, and grafted copolymer. In some embodiments, the block copolymer can comprise PDMS-PEG (e.g., poly(polydimethylsiloxane methacrylate)-b-poly(poly(ethylene glycol) methacrylate)). In some embodiments, the block copolymer can comprise POEM-b-PLMA, POEM-P (PDMSMA), PBA-b-PPEGMA, or any combination thereof. In some embodiments, a copolymer can comprise poly(butyl acrylate) (PBA), Poly(butyl methacrylate) (PBMA), Poly(lauryl methacrylate) (PLMA), Poly(ethylene) (PE), Poly(ethylene-alt-propylene) (PEP), Poly(urethane) (PU), Poly(butadiene) (PB), Poly(polyvinylidene methacrylate) (PPVDFMA), Poly(polytetrafluoroethylene methacrylate) (PPTFEMA), Poly(perfluoropolyether) (PFPE), Poly(perfluoropolyether methacrylate) (PFPEMA), Poly(perfluoropolyether acrylate) (PFPEA), Poly(poly(ethylene glycol) methacrylate) (PPEGMA), Poly(poly(ethylene glycol) acrylate) (PPEGA), Poly(perfluoropolyether methacrylate) (PFPEMA), Poly(perfluoropolyether acrylate) (PFPEA), or any combination thereof.

The hydrophobic polymer can comprise, e.g., a cyclic olefin copolymer, fluorinated ethylene propylene, ethylene-methyl acrylate copolymer, polymonochlorotrifluoroethylene, perfluoroalkoxy polymer, polymethylpentene, polypropylene, polyphenylene sulfide, polystyrene, polytetrafluoroethylene, polyvinylchloride, polyethylene, ethylene vinyl acetate, or any combination thereof. In some embodiments, an electrolyte can be a high conductivity electrolyte with a lithium transference number >0.3, a low flammability, and weakly solvating ability to minimize the charge transfer resistance. In some embodiments, fluorinated compounds tend to make an inorganic rich SEI layer that promotes higher coulombic efficiencies.

### Positive Electrode

In some aspects, the present disclosure provides a positive electrode. The positive electrode can comprise a redox material as an active material. The redox material can be synthesized to be substantially free of lithium. The redox material can be in contact with a substrate.

The redox material can comprise a lithium intercalating material. The redox material can comprise a multi-electron intercalating material. The redox material can comprise a transition metal, which undergoes a change in oxidation state of at least two between a charged and discharged state. The redox material can be configured to receive lithium via an intercalation mechanism, a conversion mechanism, or both.

The redox material can comprise atoms with multiple oxidation states. The redox material can comprise titanium, vanadium, chromium, manganese, iron, cobalt, copper, germanium, arsenic, niobium, molybdenum, technetium, ruthenium, rhodium, palladium, tin, antimony, or any combination thereof.

The redox material can comprise a transition metal. The redox material can comprise at least one of: vanadium, cobalt, nickel, a cobalt-aluminum alloy, manganese, niobium, molybdenum, technetium, tungsten, rhenium, rhodium, ruthenium, iridium, palladium, or platinum. The redox material can comprise vanadium. The redox material can comprise an oxide. The redox material can comprise VₓO_{y}. The redox material can comprise VₓO_{y}F_{z}. ‘X’, ‘Y’, and ‘Z’ can be integers. ‘X’, ‘Y’, and ‘Z’ can be real numbers, which can represent variations from exact stoichiometric ratios. The redox material can comprise at least one of: V₆O₅F₁₉, V₃OF₁₁, VO₂F, VOF₃, VPO₄F, LiV₃OF₁₁, Mn₃V(PO₄)₆, V₆O₅F₁₉, V₂(PO₄)₃, LiVOF₄, LiV(OF)₂, LiV(OF)₂, MnVP₂(O₄F)₂, V₄O₇F₅, LiV₃CoO₁₀, VPO₅, VFeP₂(O₄F)₂, TiVO₄, LiTiV₃O₁₀, VFeP₂(HO₅)₂, Li₂ VOF₅, MnV₄O₁₂, VBO₄, LiV₂P₂(O₄F)₂, LiV₃CrO₈, V₄(OF₃)₃, LiV₄O₈, V(CO₃)₂, LiV₅O₁₀, VCuO₄, VCo₃O₈, or any combination thereof. The redox material can comprise FePO₄, NiMnCoO₂, or TiS₂.

The redox material can comprise a transition metal phosphate. The redox material can comprise LiFePO₄. In some embodiments, the positive electrode comprises LiFePO₄ as an active material. In some embodiments, the positive electrode may be made of LifePO₄. (LFP). In some embodiments, the redox material comprises LiMFePO₄. The ‘M’ in LiMFePO₄ can be a secondary metal. The secondary metal can be nickel, cobalt, manganese, or vanadium, for example. In some embodiments, the redox material comprises particles. In some embodiments, the redox material comprises lithium manganese iron phosphate (LiMnₓFe_{y}PO₄; LMFP). In some embodiments, the redox material comprises LiMn_{0.8}Fe_{0.2}PO₄. The particles can be agglomerated, well-dispersed, or a combination of both. The particles can be rods, wires, spheres, spheroids, or plates.

The redox material can comprise V₂O₅.

The high valence vanadium pentoxide, where vanadium exists in the +5 oxidation state and oxygen in the −2 oxidation state, may crystallize in the orthorhombic (Pmna) structure. In the Pmna structure, atomically there are alternating pairs of V₂O₅ corner-sharing square pyramidal polyhedra that edge-share with polyhedra pointing in opposite directions along the crystallographic c-axis. This two-dimensional layered structure is commonly referred to as the alpha phase (α-V₂O₅). This initial V₂O₅ framework can undergo numerous layer shifts and develop shear planes that rearrange into alternate phases still described as V₂O₅. These polymorphic phases include the alpha (α), beta (β), and gamma (γ), that can be described using an orthorhombic, monoclinic, or triclinic system. The polymorphs of the V₂O₅ maintain the V⁺⁵ oxidation state. All these structures can provide significant amounts of empty interstitial space that can accommodate inserted species that makes vanadium oxide a strong candidate for electrochemical intercalation batteries. Without being bound to a particular theory, electrochemical lithiation of V₂O₅ described by the formula LiₓV₂O₅ can reach a limit of x=3 in the structure however, when x>1 the lithium ions become irreversibly trapped in the vanadium oxide framework. Some work has shown the alpha phase has a sequential phase transformation to four different lithiated phases named, epsilon (ε), delta (δ), gamma (γ), and finally (ω). Pre-intercalation of other elements into V₂O₅ can yield the beta structure (β-MₓV₂O₅). This structure belongs to the general class of compounds known as bronzes in that the inserted alkali or transition metal maintains the same β-MₓV₂O₅ crystalline structure, where x can be 0.33 or 0.66. The addition of other elements while maintaining the V₂O₅ structure can cause a change in the electronic structure of the vanadium oxide due to charge neutrality with the intercalated elements remaining in an ionic state and vanadium is proportionately reduced from V⁵⁺ to V⁴⁺ and/or V³⁺ depending on the oxidation state and amount of intercalant. The stoichiometry for the pre-intercalated templated synthesis ion is determined by both the β-V₂O₅ lattice space available and the ionic radii of the chosen element. It has been demonstrated that Na or Ag ions can incorporate at ~0.33 but for smaller ions such as Li or Cu they can incorporate at ~0.66. In both cases, there is a proportionate reduction of vanadium to an average of approximately +4.84 oxidation state for x=0.33 and approximately +4.66 for x=0.66 and it is assumed the Li, Ag, and Cu all exist at an oxidation state of +1 in the crystalline structure of β-MₓV₂O₅.

To increase the electrochemical performance of these vanadium oxide phases, the M ion concentration can be finely controlled and tuned thereby increasing the usable specific capacity and significantly opening the structure promoting faster charge and discharge rates. Herein, vanadium pentoxide compounds can be written as ζ-M_{y}V₂O₅ and ζ-M_{y}N_{z}V_{2-z}O₅ where M and N are interstitial or substitutional elements, respectively the concentration M is denoted by y can be less than 0.15. These phases where the concentration of M denoted by y is greatly below 0.33 can be referred to as zeta phases. It is worthwhile to note that there are residual M and N ions impact the structure stability, electrochemical stability, and performance of the material in a battery.

In some aspects, the present disclosure relates to the electrochemical reaction of ζ-V₂O₅ (zeta vanadium oxide, ZVO) and derivative compounds such as ζ-AₓM_{y}V₂O₅ and ζ-AₓM_{y}N_{z}V_{2-z}O₅ that are incorporated into a positive electrode material to provide an extra lithium reserve at the positive electrode to overcome capacity losses during cycling without the need to add any additional chemical, component, or positive electrode material. In ζ-AₓM_{y}N_{z}V_{2-z}O₅, A can be one or more ions selected from the group consisting of Li, Na, K, Mg, Ca, Zn, and Al. The concentration of x can range from 0.0-3.0 during charging and discharging the rechargeable electrochemical cell. M can be a transitional metal, alkaline earth, alkali, post-transition metal, metalloid, or combination thereof. In some variations, y can range from 0.0001-0.66. N can be a transition metal, post-transition metal, metalloid, or combinations thereof. In some variations, z can range from 0-2. The terms ζ-V₂O₅, V₂O₅, or ZVO may be used interchangeably to include all derivates of the vanadium oxide compounds including ζ-V₂O₅, ζ-AₓV₂O₅, ζ-AₓM_{y}V₂O₅, and ζ-AₓM_{y}N_{z}V_{2-z}O₅ in various states of charge ranging from fully lithiated (3 Li) to unlithiated (0 Li).

The positive electrode material can be incorporated into a positive electrode. The positive electrode can be a mixture of the ZVO positive electrode material, a polymeric binder (such as polyvinylidene fluoride), conductive additives (such as, carbon blacks, graphite, carbon nanotubes, graphene, etc.), or any combination thereof, that are deposited on a current collector, typically aluminum. The ZVO positive electrode material can comprise the chemical compound in the positive electrode that intercalates ions and is responsible for generating the electrochemical potential. The conductive additive can be a form of carbon that acts to electrically connect the ZVO positive electrode materials to the current collector. The polymeric binder can hold the ZVO positive electrode material and conductive additives together through cohesion. The polymeric binder can hold the entire deposited layer on the current collector.

In an electrochemical energy storage system ZVO can undergo the following reaction below.

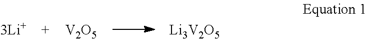

Lithium-ions in Equation 1 can be replaced with other metal ions such as Na, Mg, K, Ca, Zn, Al, or other generally known electrochemical intercalation ions. In ζ-AₓM_{y}V₂O₅, and ζ-AₓM_{y}N_{z}V_{2-z}O₅ this is represented by the concentration of A as denoted by x.

The theoretical specific capacity, CT, can follow the Equation 2 below:

$${C}_{T} = ( n \cdot F ) / ( 3.6 \cdot {M}_{W} ) \qquad Equation 2$$

where n is the number of electrons participating in the electrochemical reaction, F is Faraday's constant (96,485.33 C/mol), 3.6 is a constant that converts theoretical specific capacity from C/g to mAh/g, and Mw is the molecular weight in g/mol of the positive electrode material chemical composition. Equation 2 results in 442 mAh/g of theoretical specific capacity when 3 lithium ions participate in the electrochemical reaction and the Mw is 181.88 g/mol V₂O₅. Equation 2 results in 396.66 mAh/g of theoretical specific capacity when 3 lithium ions participate in the electrochemical reaction and the Mw is 202.7 g/mol Li₃V₂O₅.

Unlike other pre-lithiation reagents that commonly result in inactive components after the formation cycle; the positive electrode material taught herein does not require any sacrificial additive or component but instead relies on the inherent specific capacity of the ZVO material composition to provide extra lithium capacity.

Distinct to previously attempted over lithiation of positive electrode materials such as Li_{1.2}NMC, ZVO is a positive electrode material that can store extra lithium capacity. The extra lithium capacity in ZVO can be easily accessible on the bottom of the voltage between 2.2-1.5 V where upon charging is transferred to the negative electrode and used to mitigate first cycle capacity loss. This is distinct from NCA and NMC positive electrode materials that indeed contain extra lithium capacity above 4.2 V wherein electrolyte and positive electrode active material (cathode active material; CAM) stability of these layered intercalation materials rapidly degrades cycle life. This phenomenon is often observed at high voltages above 4.2 V where the CAM particles crack, resulting in fresh positive electrode surfaces that consume more lithium capacity to build additional passivation layers on the newly formed surfaces, further exacerbating CE capacity loss.

With all these considerations a positive electrode material is presented for a rechargeable electrochemical cell that comprises a negative electrode, a positive electrode, and an electrolyte. The positive electrode material can comprise a compound with the general formula ζ-AₓM_{y}V₂O₅ and/or ζ-AₓM_{y}N_{z}V_{2-z}O₅, where M and N are transition metals, alkaline earths, alkalis, post-transition metals, metalloids, or a combination thereof and A can be one or more ions selected from the group consisting of Li, Na, K, Mg, Ca, Zn, and Al ions. The positive electrode material may be incorporated in rechargeable electrochemical cells operating in a voltage window between 1.5-4.5 V. The concentration of “A” as denoted by “x” can be between 0 and 3.0. The concentration of “M” as denoted by “y” can be between 0.00001 and 0.66. The concentration of “N” as denoted “z” can be between 0 and 1.33.

Some compositions of positive electrode material that have been found to be particularly effective include a positive electrode material wherein a concentration of “A” as denoted by “x” can be between 0-3, a concentration of “M” as denoted by “y” can be 0.0001-0.15, and where “M” can be one or more selected from the group consisting of Cu, Ag, Na, K, Mg, Ca, Pb, Al, Sn, Cs, Rb, and Fe.

Another effective composition of positive electrode material comprises a concentration of “A” as denoted by “x” can be between 0-3, a concentration of “M” as denoted by “y” can be between 0.0001-0.15, a concentration of “N” as denoted by “z” can be between 0-1.33, and where “N” is from the group consisting of W, Nb, Mo, Zr, Y, Hf, Cr, Sn, Fe, Ti, Mn, Ta, Ce, La, Ni, Si, Ga, Ge, and Co.

Some variations of the rechargeable electrochemical cell in which the positive electrode material is incorporated could have a negative electrode that is one of graphite, carbon, silicon, Li metal, Na metal, Mg metal, Ca metal, Zn metal, Al metal, and a combination thereof. In other variations of positive electrode material, the first cycle capacity loss associated with establishing a passivation layer can be mitigated by a reservoir of additional “A” ions above the concentration “x” used for cycling the rechargeable electrochemical cell. In other variations of positive electrode material, the rechargeable electrochemical cell has a lithium reservoir for passivation layer formation and operates in a voltage window between 2.0-4.5 V for cycling and below 2.0 V to access the lithium reservoir. In other variations of positive electrode material an intermittent charge/discharge cycling protocol is used wherein the charge/discharge cycles occur between 2.0-4.5 V and on-demand cycles between 1.5-4.5 V to deliver additional capacity to an external circuit. In other variations of positive electrode material, a continuous charge/discharge cycling protocol cycles from 1.5-4.5 V to deliver capacity to an external circuit.

The redox material can comprise a zeta-polymorph of V₂O₅ (ζ-V₂O₅). In some embodiments, the redox material is a metastable phase. The redox material can comprise intercalated Na⁺ ions, Al³⁺ ions, Y³⁺ ions, Ca²⁺ ions, Mg²⁺ ions, Zn²⁺ ions, K⁺ ions, or any combination thereof. Without being bound to a particular theory, the ions intercalation can prop open lithium-conductive tunnels within the redox material, can reduce electrostatic repulsions between inserted Li-ions, and can modify diffusion pathways within the redox material, or any combination thereof. The intercalation of ions can provide higher Li-ion diffusivities and/or conductivities, and can provide higher capacities for the positive electrode. The redox material comprising V₂O₅ can be manufactured, for example, using a process disclosed in PCT/US2018/067392 or PCT/US2023/033969, each of which is incorporated herein by reference in their entirety.

In some embodiments, the redox material is manufactured without the use of a silver precursor. In some embodiments, the redox material does not comprise above 1, 10, 100, or 1000 ppm of silver. In some embodiments, the redox material is manufactured with a copper precursor. In some embodiments, the redox material comprises copper at a stoichiometric ratio of less than 0.01, 0.001, or 0.0001 of copper to V₂O₅. In some embodiments, the redox material comprises copper at a stoichiometric ratio of greater than 0, 0.01, 0.001, or 0.0001 of copper to V₂O₅. In some embodiments, the redox material shows no copper signal when analyzed by energy dispersive X-ray spectroscopy.

In some embodiments, the redox material comprises ζ-V₂O₅ nanowires. In some embodiments, the ζ-V₂O₅ nanowires are magnesiated metastable ζ-V₂O₅ nanowires. In some embodiments, the ζ-V₂O₅ nanowires comprise a theoretical or measured lattice constants comprising: a=15.25±0.4 Å, b=3.60-0.02 Å, and c=10.10-0.03 Å. In some embodiments, the ζ-V₂O₅ nanowires comprise a unit cell angle, B, between about 109.1° and about 110.9°. The lattice constants and/or the unit cell angle can be measured using X-ray diffraction (XRD) such as powder XRD.

In some embodiments, the redox material is pre-intercalated. In some embodiments, the redox material comprises β-NaₓV₂O₅, β-K_{y}V₂O₅, or both. In some embodiments, x is about 0.20 to about 0.34. In some embodiments, y is about 0.22 to about 0.33. In some embodiments, x is at least 0.20, 0.21, 0.22, 0.23, 0.24, 0.25, 0.26, 0.27, 0.28, 0.29, 0.30, 0.31, 0.32, or 0.33. In some embodiments, x is at most 0.21, 0.22, 0.23, 0.24, 0.25, 0.26, 0.27, 0.28, 0.29, 0.30, 0.31, 0.32, 0.33, or 0.34. In some embodiments, y is at least 0.22, 0.23, 0.24, 0.25, 0.26, 0.27, 0.28, 0.29, 0.30, 0.31, 0.32. In some embodiments, y is at most 0.23, 0.24, 0.25, 0.26, 0.27, 0.28, 0.29, 0.30, 0.31, 0.32, or 0.33. In some embodiments x is about 0.32. In some embodiments y is about 0.22

In some embodiments, the redox material comprises pre-intercalated β-NaₓV₂O₅, where x is about 0.22 to about 0.28 or is about 0.25. In some embodiments, the redox material comprises pre-intercalated β-K_{y}V₂O₅, where y is about 0.22 to about 0.33 or is about 0.27. In some embodiments, the redox material comprises β-NaₓV₂O₅, having lattice constants comprising a=15.409 (8) Å, b=3.609 (1) Å, and c=10.780 (9) Å for x=0.25. In some embodiments, the redox material comprises β-NaₓV₂O₅, having lattice constants comprising a=15.3629 (7) Å, b=3.6109 (2) Å, and c=10.0502 (5) Å for x=0.32. In some embodiments, the redox material comprises β-K_{y}V₂O₅, having lattice constants comprising a=15.60 (2) Å, b=3.612 (1) Å, and c=10.093 (9) Å for y=0.27. In some embodiments, the redox material comprises β-K_{y}V₂O₅, having lattice constants comprising a=15.4753 (10) Å, b=3.6123 (2) Å, and c=10.0693 (6) Å for y=0.22.

In some embodiments, the redox material comprises β-K_{0.27}V₂O₅ having a unit cell volume of 537.085 Å3. In some embodiments, the redox material comprises β-Na_{0.25} V₂O₅ having a unit cell volume of 528.168 Å3. In some embodiments, the redox material comprises β-Na_{0.32}/β′-Li_{0.33} V₂O₅. In some embodiments, the redox material comprises a unit cell volume of 530.32(3) Å3 and lattice constants comprising: a=10.1482(3) Å, b=3.6308(1) Å, and c=15.2420(4) Å.

In some embodiments, the redox material comprises MgₓV₂O₅. In some embodiments, x is between about 0.01 and about 0.85.

In some embodiments, metal ions may be reversibly inserted into and extracted from the redox material many times. In some embodiments, metal ions may be reversibly inserted into and extracted from the redox material 10 times, 20 times, 50 times, 100 times, 200 times, or more without significantly affecting the structure of the redox material. As discussed further herein with respect to batteries of the present disclosure, such reversible insertion and extraction leads to high ion discharge capacities.

In some embodiments, the redox material comprises metastable ζ-V₂O₅ nanowires. In some embodiments, the metastable 2-V₂O₅ nanowire comprises lattice constants comprising: a=15.25-0.4 Å, b=3.60-0.02 Å, and c=10.10-0.03 Å. In some embodiments, the metastable ζ-V₂O₅ nanowire comprises a unit cell volume, V, between about 515 Å3 and about 540 Å3.

In some embodiments, the interstices of the metastable ζ-V₂O₅ nanowire include quasi-one-dimensional tunnels. In some embodiments, the quasi-one-dimensional tunnels are configured to reversibly accept one or more metal ions. In some embodiments, the quasi-one-dimensional tunnels extend parallel to a major axis of the metastable ζ-V₂O₅ nanowire. In some embodiments, the metastable-V₂O₅ nanowire comprises has a unit cell angle, β, between about 108° and about 111°. In some embodiments, the unit cell angle, B, is the angle between the a and c axes of the metastable ζ-V₂O₅ nanowire.

In some embodiments, the residual of equivalents of the metastable ζ-V₂O₅ nanowire is 0.04-0.06. In some embodiments, the metastable ζ-V₂O₅ nanowire comprises residual precursor metal ions intercalated into the quasi-one-dimensional tunnels of the ζ-V₂O₅ nanowires. In some embodiments, the metastable ζ-V₂O₅ nanowire comprises a formula ζ-(Cuₓ)V₂O₅, wherein x is between about 0.006 and 0.33. In some embodiments, x is at least 0.006, 0.01, 0.05, 0.1, 0.15, 0.2, 0.25, or 0.3. In some embodiments, x is at most 0.01, 0.05, 0.1, 0.15, 0.2, 0.25, 0.3, or 0.33. In some embodiments, the metastable ζ-V₂O₅ nanowire comprises a formula β/β′-(Cuₓ)V₂O₅. In some embodiments, x is between 0.006 and 0.66. In some embodiments, x is at least 0.006, 0.01, 0.05, 0.1, 0.2, 0.3, 0.4, or 0.5. In some embodiments, x is at most 0.01, 0.05, 0.1, 0.2, 0.3, 0.4, 0.5, or 0.6. In some embodiments, the metastable ζ-V₂O₅ nanowire comprises a smallest dimension between about 20 nm and about 80 nm. In some embodiments, the smallest dimension is at least 20, 30, 40, 50, 60, 70, or 80 nm. In some embodiments, the smallest dimension is at most 20, 30, 40, 50, 60, 70, or 80 nm.

Without being bound to a particular theory, the high strength of the bonds between oxygen atoms and vanadium atoms of V₂O₅ may be the underlying reason that V₂O₅ has a high thermal runway temperature. Meanwhile, the strength of the bonds formed between oxygen atoms and lithium atoms might not be so strong as to prevent lithium release during charging of a rechargeable energy storage system. Thus, another advantage of V₂O₅ as a positive electrode is that a rechargeable energy source system can comprise numerous cells, each comprising a V₂O₅, in a densely packed arrangement.

In some embodiments, the positive electrode comprises V₂O₅ and an electrically conductive filler. In some embodiments, the electrically conductive filler comprises graphene. In some embodiments, the positive electrode comprises V₂O₅ and at least 2.5% by weight electrically conductive filler, at least 3.0% by weight electrically conductive filler, at least 3.5% by weight electrically conductive filler, at least 4.0% by weight electrically conductive filler, at least 5% by weight electrically conductive filler, at least 6% by weight electrically conductive filler, at least 7% by weight electrically conductive filler, at least 8% by weight electrically conductive filler, at least 9% by weight electrically conductive filler, or at least 10% by weight electrically conductive filler. The positive electrode can comprise, for example, at least 75% by weight V₂O₅, at least 5% by weight graphene nanoplatelets, and at least 5% by weight of a poly vinylidene fluoride (PVDF) binder. The intercalation electrode composition may comprise 85% by weight V₂O₅, at least 5% by weight graphene nanoplatelets, and 10% by weight binder. The intercalation electrode composition may comprise 75% by weight V₂O₅, 15% by weight graphene nanoplatelets, and 10% by weight of a polyvinylidene fluoride (PVDF) binder. In some embodiments, the electrode composition may comprise 88% by weight V₂O₅, 6.9% carbon, and 5.1% binder. In some embodiments, the carbon comprises carbon nanotubes.

The redox material can comprise a metal sulfide. The redox material can comprise titanium disulfide. The redox material can comprise a metal oxide. The positive electrode can comprise LiₓMO₂, wherein M is a metal. The redox material can comprise vanadium. The redox material can comprise vanadium, cobalt, nickel, a cobalt-aluminum alloy, manganese, niobium, molybdenum, technetium, tungsten, rhenium, rhodium, ruthenium, iridium, palladium, platinum, or any combination thereof. The redox material can comprise a polyatomic anion. The polyatomic anion can comprise PO₄.

The redox material can comprise additives. The redox material can comprise phosphate based materials such as FePO₄, VPO₄F, V₂(PO₄)₂F₃, FePO₄F, and V₂(PO₄)₃; oxides such as CoO₂, V₂O₅, orthorhombic MnO₂, layered iron oxides FeO₂, chromium oxide CrO₂, layered Ni_{0.5}Mn_{0.5}O₂, and V₆O₁₅ nanorods; layer sulfides such as TiS₂; perovskite transition metal fluorides, or a mixture thereof. The redox material can comprise a filler, which can be conductive, e.g., graphene. The redox material can comprise a binder, which can be a polymer, e.g., poly vinylidene fluoride.

The redox material can comprise 20 percent (%), 15%, 10%, 9%, 8%, 7%, 6%, 5%, 4%, 3%, 2%, or 1% lithium by mass. The redox material can comprise about 20%, about 15%, about 10%, about 9%, about 8%, about 7%, about 6%, about 5%, about 4%, about 3%, about 2%, or about 1% lithium by mass. The redox material can comprise less than 20%, 15%, 10%, 9%, 8%, 7%, 6%, 5%, 4%, 3%, 2%, or 1% lithium by mass. The redox material can comprise greater than 20%, 15%, 10%, 9%, 8%, 7%, 6%, 5%, 4%, 3%, 2%, or 1% lithium by mass. For example, the redox material can comprise less than 10% lithium by mass. The amount of lithium can be measured at a delithiated state.

In some embodiments, a positive electrode can be substantially free of lithium when the rechargeable energy source system is in a charged state.

In some embodiments, a positive electrode can be selected based on factors including, not limited to a high conductivity (both ionic and electronic), a low toxicity, a high crustal abundance, a low oxygen evolution, an upper voltage limit less than 4.5, and a low voltage cutoff higher than 50% of the upper cutoff window.

The redox material can comprise a binder. The binder can bind the redox material to the current collector. The binder can be electrically conductive. The binder can comprise polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber (SBR), acrylated SBR, epoxy resin, and nylon. The binder can comprise carbon black or vapor ground carbon fibers. The binder can be polyvinylidene fluoride (PVDF), sodium alginate, and sodium carboxymethyl cellulose. The binder can comprise PVDF, polytetrafluoroethylene (PTFE), styrene butadiene rubber (SBR), and polyimide. The binder can graphene or carbon nanotubes.

The redox material can comprise a surface coating. The surface coating can comprise an oxide, a hydroxide, an oxyhydroxide, an oxycarbonate, or a hydroxycarbonate. The surface coating can be amorphous or crystalline. The surface coating can comprise magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or any combination thereof. The surface coating can be formed using a spray coating method, a dipping method, or any other suitable method.

The redox material can comprise a polymer binder. The polymer binder can comprise a block copolymer. The block copolymer can provide a hydrophobic domain on a surface of the electrode. A hydrophobic polymer membrane can be bound to the hydrophobic domain on the surface of the redox material.

The substrate can comprise a current collector. The current collector can comprise copper, stainless steel, aluminum, nickel, titanium, sintered carbon, copper or stainless steel that is surface-treated with carbon, nickel, titanium or silver, and aluminum-cadmium alloys. The structures, foams, and non-woven fabrics. The current collector can comprise carbon, carbon paper, carbon cloth or a metal or noble metal mesh or foil. The current collector can comprise fine irregularities on surfaces thereof so as to enhance the adhesive strength of the current collector to the redox material. The current collector can have a thickness of 1 μm, 2 μm, 3 μm, 4 μm, 5 μm, 6 μm, 7 μm, 8 μm, 9 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, or 1000 μm. The current collector can have a thickness of about 1 μm, about 2 μm, about 3 μm, about 4 μm, about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, or about 1000 μm. The current collector can have a thickness of at least 1 μm, at least 2 μm, at least 3 μm, at least 4 μm, at least 5 μm, at least 6 μm, at least 7 μm, at least 8 μm, at least 9 μm, at least 10 μm, at least 20 μm, at least 30 μm, at least 40 μm, at least 50 μm, at least 60 μm, at least 70 μm, at least 80 μm, at least 90 μm, at least 100 μm, at least 200 μm, at least 300 μm, at least 400 μm, at least 500 μm, at least 600 μm, at least 700 μm, at least 800 μm, at least 900 μm, or at least 1000 μm. The current collector can have a thickness of at most 1 μm, at most 2 μm, at most 3 μm, at most 4 μm, at most 5 μm, at most 6 μm, at most 7 μm, at most 8 μm, at most 9 μm, at most 10 μm, at most 20 μm, at most 30 μm, at most 40 μm, at most 50 μm, at most 60 μm, at most 70 μm, at most 80 μm, at most 90 μm, at most 100 μm, at most 200 μm, at most 300 μm, at most 400 μm, at most 500 μm, at most 600 μm, at most 700 μm, at most 800 μm, at most 900 μm, or at most 1000 μm.

The positive electrode can be configured to have a stable capacity. Over numerous cycles, the positive electrode can resist loss of redox material. For example, uncontrolled crack formation and propagation can lead to loss of redox material when a piece of the redox material comprising lithium breaks loose. The broken piece can become electrically isolated from the rest of the positive electrode, and the lithium contained within cannot be able to participate in the redox reactions and not be able to contribute to the capacity and the energy density of the electrochemical system. Stable volume of the redox material with respect to its state of charge, temperature, and pressure can reflect the physical stability of the positive electrode.

In some embodiments, the positive electrode may have a charge cutoff potential of 4 V or less versus Li⁺/Li. In some embodiments, the positive electrode may have a charge cutoff potential of about 4 V or less versus Li⁺/Li.

In some embodiments, the capacity of the positive electrode can be 50 mAh/g, 100 mAh/g, 150 mAh/g, 200 mAh/g, 250 mAh/g, 300 mAh/g, 350 mAh/g, 400 mAh/g, 450 mAh/g, or 500 mAh/g. In some embodiments, the capacity of the positive electrode can be about 50 mAh/g, about 100 mAh/g, about 150 mAh/g, about 200 mAh/g, about 250 mAh/g, about 300 mAh/g, about 350 mAh/g, about 400 mAh/g, about 450 mAh/g, or about 500 mAh/g. In some embodiments, the capacity of the positive electrode can be at least 50 mAh/g, at least 100 mAh/g, at least 150 mAh/g, at least 200 mAh/g, at least 250 mAh/g, at least 300 mAh/g, at least 350 mAh/g, at least 400 mAh/g, at least 450 mAh/g, or at least 500 mAh/g. In some embodiments, the capacity of the positive electrode can be at most 50 mAh/g, at most 100 mAh/g, at most 150 mAh/g, at most 200 mAh/g, at most 250 mAh/g, at most 300 mAh/g, at most 350 mAh/g, at most 400 mAh/g, at most 450 mAh/g, or at most 500 mAh/g. In some embodiments, the capacity of the positive electrode can be 150 mAh/g to 300 mAh/g, 100 mAh/g to 400 mAh/g, 250 mAh/g to 500 mAh/g, or 100 mAh/g to 300 mAh/g, including all values and sub ranges in between. For example, the capacity of the negative electrode can be at least 250 mAh/g.

In some embodiments, the energy density of the positive electrode can be 200 Wh/kg, 400 Wh/kg, 600 Wh/kg, 800 Wh/kg, 1000 Wh/kg, 1200 Wh/kg, 1400 Wh/kg, or 1600 Wh/kg. In some embodiments, the energy density of the positive electrode can be about 200 Wh/kg, about 400 Wh/kg, about 600 Wh/kg, about 800 Wh/kg, about 1000 Wh/kg, about 1200 Wh/kg, about 1400 Wh/kg, or about 1600 Wh/kg. The energy density of the positive electrode can be at least 200 Wh/kg, at least 400 Wh/kg, at least 600 Wh/kg, at least 800 Wh/kg, at least 1000 Wh/kg, at least 1200 Wh/kg, at least 1400 Wh/kg, or at least 1600 Wh/kg. The energy density of the positive electrode can be at most 200 Wh/kg, at most 400 Wh/kg, at most 600 Wh/kg, at most 800 Wh/kg, at most 1000 Wh/kg, at most 1200 Wh/kg, at most 1400 Wh/kg, or at most 1600 Wh/kg. In some embodiments, the energy density of the positive electrode can be 400 Wh/kg to 1200 Wh/kg, 600 Wh/kg to 1600 Wh/kg, 800 Wh/kg to 1400 Wh/kg, or 400 Wh/kg to 1000 Wh/kg, including all values and sub ranges in between. For example, the energy density of the negative electrode can be at least 800 Wh/kg.

In some embodiments, the redox material exhibits a volumetric change of 50%, 45%, 40%, 35%, 30%, 25%, 20%, 15%, 10%, 5%, 4%, 3%, 2%, or 1% when cycled for a predetermined number of times. In some embodiments, the redox material exhibits a volumetric change of about 50%, about 45%, about 40%, about 35%, about 30%, about 25%, about 20%, about 15%, about 10%, about 5%, about 4%, about 3%, about 2%, or about 1% when cycled for a predetermined number of times. In some embodiments, the redox material exhibits a volumetric change of less than 50%, less than 45%, less than 40%, less than 35%, less than 30%, less than 25%, less than 20%, less than 15%, less than 10%, less than 5%, less than 4%, less than 3%, less than 2%, or less than 1% when cycled for a predetermined number of times. In some embodiments, the redox material exhibits a volumetric change of more than 50%, more than 45%, more than 40%, more than 35%, more than 30%, more than 25%, more than 20%, more than 15%, more than 10%, more than 5%, more than 4%, more than 3%, more than 2%, or more than 1% when cycled for a predetermined number of times. The predetermined number of times can be 50, 100, 150, 200, 250, 300, 350, 400, 500, 600, 700, 800, 1000, or 5000 times. The predetermined number of times can be about 50, about 100, about 150, about 200, about 250, about 300, about 350, about 400, about 500, about 600, about 700, about 800, about 1000, or about 5000 times. The predetermined number of times can be at least 50, at least 100, at least 150, at least 200, at least 250, at least 300, at least 350, at least 400, at least 500, at least 600, at least 700, at least 800, at least 1000, or at least 5000 times. The predetermined number of times can be at most 50, at most 100, at most 150, at most 200, at most 250, at most 300, at most 350, at most 400, at most 500, at most 600, at most 700, at most 800, at most 1000, or at most 5000 times. The cycling can be from 1.5 V to 4 V, 2 V to 4.5 V, 3 V to 4.5 V, or 2 V to 3 V. The cycling can be performed at a C rate of at least C/20:C/20, C/10:C/10, C/5:C/5, C/2:C/2, 1C:1C, or 2C:2C. The cycling can be performed at a C rate of at most C/20:C/20, C/10:C/10, C/5:C/5, C/2:C/2, 1C:1C, or 2C:2C. The cycling can be performed at a C rate of at least C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed at a C rate of at most C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed using a C-rate of at least C/20, C/10, C/5, C/2, 0.5C, 1C, 2C, 3C, 5C, 6C, 7C, 8C, 9C, or 10C. The cycling can be performed using a C-rate of at most C/20, C/10, C/5, C/2, 0.5C, 1C, 2C, 3C, 5C, 6C, 7C, 8C, 9C, or 10C. The cycling can be performed using a D-rate of at least D/20, D/10, D/5, D/2, 0.5D, 1D, 2D, 3D, 5D, 6D, 7D, 8D, 9D, or 10D. The cycling can be performed using a D-rate of at most D/20, D/10, D/5, D/2, 0.5D, 1D, 2D, 3D, 5D, 6D, 7D, 8D, 9D, or 10D

In some embodiments, an energy capacity loss of the positive electrode can be 30%, 25%, 20%, 15%, 10%, 5%, 4%, 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, or 0.01% over a predetermined number of cycles. In some embodiments, an energy capacity loss of the positive electrode can be about 30%, about 25%, about 20%, about 15%, about 10%, about 5%, about 4%, about 3%, about 2%, about 1%, about 0.9%, about 0.8%, about 0.7%, about 0.6%, about 0.5%, about 0.4%, about 0.3%, about 0.2%, about 0.1%, about 0.09%, about 0.08%, about 0.07%, about 0.06%, about 0.05%, about 0.04%, about 0.03%, about 0.02%, or about 0.01% over a predetermined number of cycles. In some embodiments, an energy capacity loss of the positive electrode can be less than 30%, less than 25%, less than 20%, less than 15%, less than 10%, less than 5%, less than 4%, less than 3%, less than 2%, less than 1%, less than 0.9%, less than 0.8%, less than 0.7%, less than 0.6%, less than 0.5%, less than 0.4%, less than 0.3%, less than 0.2%, less than 0.1%, less than 0.09%, less than 0.08%, less than 0.07%, less than 0.06%, less than 0.05%, less than 0.04%, less than 0.03%, less than 0.02%, or less than 0.01% over a predetermined number of cycles. The energy capacity loss of the positive electrode can be greater than 30%, greater than 25%, greater than 20%, greater than 15%, greater than 10%, greater than 5%, greater than 4%, greater than 3%, greater than 2%, greater than 1%, greater than 0.9%, greater than 0.8%, greater than 0.7%, greater than 0.6%, greater than 0.5%, greater than 0.4%, greater than 0.3%, greater than 0.2%, greater than 0.1%, greater than 0.09%, greater than 0.08%, greater than 0.07%, greater than 0.06%, greater than 0.05%, greater than 0.04%, greater than 0.03%, greater than 0.02%, or greater than 0.01% over a predetermined number of cycles. The predetermined number of times can be 50, 100, 150, 200, 250, 300, 350, 400, 500, 600, 700, 800, 1000, or 5000 times. The predetermined number of times can be about 50, about 100, about 150, about 200, about 250, about 300, about 350, about 400, about 500, about 600, about 700, about 800, about 1000, or about 5000 times. The predetermined number of times can be at least 50, at least 100, at least 150, at least 200, at least 250, at least 300, at least 350, at least 400, at least 500, at least 600, at least 700, at least 800, at least 1000, or at least 5000 times. The predetermined number of times can be at most 50, at most 100, at most 150, at most 200, at most 250, at most 300, at most 350, at most 400, at most 500, at most 600, at most 700, at most 800, at most 1000, or at most 5000 times. The cycling can be from 1.5 V to 4 V, 2 V to 4.5 V, 3 V to 4.5 V, or 2 V to 3 V. The cycling can be performed at a C rate of at least C/20:C/20, C/10:C/10, C/5:C/5, C/2:C/2, 1C:1C, or 2C:2C. The cycling can be performed at a C rate of at most C/20:C/20, C/10:C/10, C/5:C/5, C/2:C/2, 1C:1C, or 2C:2C. The cycling can be performed at a C rate of at least C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed at a C rate of at most C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed using a C-rate of at least C/20, C/10, C/5, C/2, 0.5C, 1C, 2C, 3C, 5C, 6C, 7C, 8C, 9C, or 10C. The cycling can be performed using a C-rate of at most C/20, C/10, C/5, C/2, 0.5C, 1C, 2C, 3C, 5C, 6C, 7C, 8C, 9C, or 10C. The cycling can be performed using a D-rate of at least D/20, D/10, D/5, D/2, 0.5D, 1D, 2D, 3D, 5D, 6D, 7D, 8D, 9D, or 10D. The cycling can be performed using a D-rate of at most D/20, D/10, D/5, D/2, 0.5D, 1D, 2D, 3D, 5D, 6D, 7D, 8D, 9D, or 10D

In some embodiments, a positive electrode comprises a coulombic efficiency of 90 percent (%), 91%, 92%, 93%, 94%, 95%, 96%, 97%, 98%, 99%, 99.1%, 99.2%, 99.3%, 99.4%, 99.5%, 99.6%, 99.7%, 99.8%, or 99.9% over a predetermined number of cycles. In some embodiments, a positive electrode comprises a coulombic efficiency of about 90 percent (%), about 91%, about 92%, about 93%, about 94%, about 95%, about 96%, about 97%, about 98%, about 99%, about 99.1%, about 99.2%, about 99.3%, about 99.4%, about 99.5%, about 99.6%, about 99.7%, about 99.8%, or about 99.9% over a predetermined number of cycles. In some embodiments, a positive electrode comprises a coulombic efficiency of at least 90 percent (%), at least 91%, at least 92%, at least 93%, at least 94%, at least 95%, at least 96%, at least 97%, at least 98%, at least 99%, at least 99.1%, at least 99.2%, at least 99.3%, at least 99.4%, at least 99.5%, at least 99.6%, at least 99.7%, at least 99.8%, or at least 99.9% over a predetermined number of cycles. In some embodiments, a positive electrode comprises a coulombic efficiency of at most 90 percent (%), at most 91%, at most 92%, at most 93%, at most 94%, at most 95%, at most 96%, at most 97%, at most 98%, at most 99%, at most 99.1%, at most 99.2%, at most 99.3%, at most 99.4%, at most 99.5%, at most 99.6%, at most 99.7%, at most 99.8%, or at most 99.9% over a predetermined number of cycles. In some embodiments, a positive electrode comprises a coulombic efficiency of 90% to 99%, 99.2% to 99.8%, 92% to 98%, or 99% to 99.9%, including all values and sub ranges in between. The predetermined number of times can be 50, 100, 150, 200, 250, 300, 350, 400, 500, 600, 700, 800, 1000, or 5000 times. The predetermined number of times can be about 50, about 100, about 150, about 200, about 250, about 300, about 350, about 400, about 500, about 600, about 700, about 800, about 1000, or about 5000 times. The predetermined number of times can be at least 50, at least 100, at least 150, at least 200, at least 250, at least 300, at least 350, at least 400, at least 500, at least 600, at least 700, at least 800, at least 1000, or at least 5000 times. The predetermined number of times can be at most 50, at most 100, at most 150, at most 200, at most 250, at most 300, at most 350, at most 400, at most 500, at most 600, at most 700, at most 800, at most 1000, or at most 5000 times. The cycling can be from 2 V to 4.5 V, 3 V to 4.5 V, or 2 V to 3 V. The cycling can be performed at a C rate of at least C/20:C/20, C/10:C/10, C/5:C/5, C/2:C/2, 1C:1C, or 2C:2C. The cycling can be performed at a C rate of at most C/20:C/20, C/10:C/10, C/5:C/5, C/2:C/2, 1C:1C, or 2C:2C. The cycling can be performed at a C rate of at least C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed at a C rate of at most C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed using a C-rate of at least C/20, C/10, C/5, C/2, 0.5C, 1C, 2C, 3C, 5C, 6C, 7C, 8C, 9C, or 10C. The cycling can be performed using a C-rate of at most C/20, C/10, C/5, C/2, 0.5C, 1C, 2C, 3C, 5C, 6C, 7C, 8C, 9C, or 10C. The cycling can be performed using a D-rate of at least D/20, D/10, D/5, D/2, 0.5D, 1D, 2D, 3D, 5D, 6D, 7D, 8D, 9D, or 10D. The cycling can be performed using a D-rate of at most D/20, D/10, D/5, D/2, 0.5D, 1D, 2D, 3D, 5D, 6D, 7D, 8D, 9D, or 10D.

In some embodiments, the positive electrode comprises a cycling efficiency of 90 percent (%), 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99% over a predetermined number of cycles. In some embodiments, the positive electrode comprises a cycling efficiency of about 90 percent (%), about 91%, about 92%, about 93%, about 94%, about 95%, about 96%, about 97%, about 98%, about 99%, about 99.1%, about 99.2%, about 99.3%, about 99.4%, about 99.5%, about 99.6%, about 99.7%, about 99.8%, about 99.9%, about 99.91%, about 99.92%, about 99.93%, about 99.94%, about 99.95%, about 99.96%, about 99.97%, about 99.98%, about 99.99% over a predetermined number of cycles. In some embodiments, the positive electrode comprises a cycling efficiency of at least 90 percent (%), at least 91%, at least 92%, at least 93%, at least 94%, at least 95%, at least 96%, at least 97%, at least 98%, at least 99%, at least 99.1%, at least 99.2%, at least 99.3%, at least 99.4%, at least 99.5%, at least 99.6%, at least 99.7%, at least 99.8%, at least 99.9%, at least 99.91%, at least 99.92%, at least 99.93%, at least 99.94%, at least 99.95%, at least 99.96%, at least 99.97%, at least 99.98%, at least 99.99% over a predetermined number of cycles. In some embodiments, the positive electrode comprises a cycling efficiency of at most 90 percent (%), at most 91%, at most 92%, at most 93%, at most 94%, at most 95%, at most 96%, at most 97%, at most 98%, at most 99%, at most 99.1%, at most 99.2%, at most 99.3%, at most 99.4%, at most 99.5%, at most 99.6%, at most 99.7%, at most 99.8%, at most 99.9%, at most 99.91%, at most 99.92%, at most 99.93%, at most 99.94%, at most 99.95%, at most 99.96%, at most 99.97%, at most 99.98%, at most 99.99% over a predetermined number of cycles. In some embodiments, the positive electrode comprises a cycling efficiency of 90% to 99%, 99.2% to 99.8%, 92% to 98%, 99.8% to 99.99%, 99.5% to 99.8%, 92% to 99.6%, or 99% to 99.99%, including all values and sub ranges in between. The predetermined number of cycles can be 50 cycles, 100 cycles, 150 cycles, 200 cycles, 250 cycles, 300 cycles, 350 cycles, 400 cycles, 500 cycles, 600 cycles, 700 cycles, 800 cycles, 900 cycles, 1000 cycles, 2000 cycles, 3000 cycles, 4000 cycles, 5000 cycles, 5500 cycles, 6000 cycles, 6500 cycles, 7000 cycles, 7500 cycles, 8000 cycles, 8500 cycles, or 9000 cycles. The predetermined number of times can be about 50 cycles, about 100 cycles, about 150 cycles, about 200 cycles, about 250 cycles, about 300 cycles, about 350 cycles, about 400 cycles, about 500 cycles, about 600 cycles, about 700 cycles, about 800 cycles, about 900 cycles, about 1000 cycles, about 2000 cycles, about 3000 cycles, about 4000 cycles, about 5000 cycles, about 5500 cycles, about 6000 cycles, about 6500 cycles, about 7000 cycles, about 7500 cycles, about 8000 cycles, about 8500 cycles, or about 9000 cycles. The predetermined number of times can be at least 50 cycles, at least 100 cycles, at least 150 cycles, at least 200 cycles, at least 250 cycles, at least 300 cycles, at least 350 cycles, at least 400 cycles, at least 500 cycles, at least 600 cycles, at least 700 cycles, at least 800 cycles, at least 900 cycles, at least 1000 cycles, at least 2000 cycles, at least 3000 cycles, at least 4000 cycles, at least 5000 cycles, at least 5500 cycles, at least 6000 cycles, at least 6500 cycles, at least 7000 cycles, at least 7500 cycles, at least 8000 cycles, at least 8500 cycles, or at least 9000 cycles. The predetermined number of times can be at most 50 cycles, at most 100 cycles, at most 150 cycles, at most 200 cycles, at most 250 cycles, at most 300 cycles, at most 350 cycles, at most 400 cycles, at most 500 cycles, at most 600 cycles, at most 700 cycles, at most 800 cycles, at most 900 cycles, at most 1000 cycles, at most 2000 cycles, at most 3000 cycles, at most 4000 cycles, at most 5000 cycles, at most 5500 cycles, at most 6000 cycles, at most 6500 cycles, at most 7000 cycles, at most 7500 cycles, at most 8000 cycles, at most 8500 cycles, or at most 9000 cycles. In some embodiments, the cycling can be from 2 V to 5 V. In some embodiments, the cycling can be from 1.5 V to 4 V. In some embodiments, the cycling can be from 2.5 V to 3.75 V, 3 V to 4V, 3 V to 4.5 V, or 2 V to 3 V. In some embodiments, the cycling can be from about 2 V to about 5 V. In some embodiments, the cycling can be from about 2.5 V to about 3.75 V, about 3 V to about 4V, about 3 V to about 4.5 V, or about 2 V to about 3 V. In some embodiments, the cycling starts from about 2 V, about 2.5 V, about 3 V, about 3.5 V, or about 4 V. In some embodiments, the cycling starts from at least 2 V, at least 2.5 V, at least 3 V, at least 3.5 V, or at least 4 V. In some embodiments, the cycling starts from at most 2 V, at most 2.5 V, at most 3 V, at most 3.5 V, or at most 4 V. In some embodiments, the cycling finishes at 3 V, 3.25V, 3.5 V, 3.75 V, 4 V, 4.25 V, 4.5 V, 4.75 V, or 5 V. In some embodiments, the cycling finishes at about 3 V, about 3.25V, about 3.5 V, about 3.75 V, about 4 V, about 4.25 V, about 4.5 V, about 4.75 V, or about 5 V. In some embodiments, the cycling finishes at least 3 V, at least 3.25V, at least 3.5 V, at least 3.75 V, at least 4 V, at least 4.25 V, at least 4.5 V, at least 4.75 V, or at least 5 V. In some embodiments, the cycling finishes at most 3 V, at most 3.25V, at most 3.5 V, at most 3.75 V, at most 4 V, at most 4.25 V, at most 4.5 V, at most 4.75 V, or at most 5 V. The cycling can be performed at a C rate of at least 1C and a D-rate of at least 1C. The cycling can be performed at a C rate of at least 1C, 2C, 3C, 4C, 5C, C/2, C/3, C/4, or C/5 and a D-rate of at least 1C, 2C, 3C, 4C, 5C, C/2, C/3, C/4, or C/5. The cycling can be performed at a C rate of at least C/20:C/20, C/10:C/10, C/5:C/5, C/2:C/2, 1C:1C, or 2C:2C. The cycling can be performed at a C rate of at most C/20:C/20, C/10:C/10, C/5:C/5, C/2:C/2, 1C:1C, or 2C:2C. The cycling can be performed at a C rate of at least C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed at a C rate of at most C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed using a C-rate of at least C/20, C/10, C/5, C/2, 0.5C, 1C, 2C, 3C, 5C, 6C, 7C, 8C, 9C, or 10C. The cycling can be performed using a C-rate of at most C/20, C/10, C/5, C/2, 0.5C, 1C, 2C, 3C, 5C, 6C, 7C, 8C, 9C, or 10C. The cycling can be performed using a D-rate of at least D/20, D/10, D/5, D/2, 0.5D, 1D, 2D, 3D, 5D, 6D, 7D, 8D, 9D, or 10D. The cycling can be performed using a D-rate of at most D/20, D/10, D/5, D/2, 0.5D, 1D, 2D, 3D, 5D, 6D, 7D, 8D, 9D, or 10D.

In some embodiments, the positive electrode comprises a columbic efficiency of 90 percent (%), 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99% over a predetermined number of cycles. In some embodiments, the positive electrode comprises a columbic efficiency of about 90 percent (%), about 91%, about 92%, about 93%, about 94%, about 95%, about 96%, about 97%, about 98%, about 99%, about 99.1%, about 99.2%, about 99.3%, about 99.4%, about 99.5%, about 99.6%, about 99.7%, about 99.8%, about 99.9%, about 99.91%, about 99.92%, about 99.93%, about 99.94%, about 99.95%, about 99.96%, about 99.97%, about 99.98%, about 99.99% over a predetermined number of cycles. In some embodiments, the positive electrode comprises a columbic efficiency of at least 90 percent (%), at least 91%, at least 92%, at least 93%, at least 94%, at least 95%, at least 96%, at least 97%, at least 98%, at least 99%, at least 99.1%, at least 99.2%, at least 99.3%, at least 99.4%, at least 99.5%, at least 99.6%, at least 99.7%, at least 99.8%, at least 99.9%, at least 99.91%, at least 99.92%, at least 99.93%, at least 99.94%, at least 99.95%, at least 99.96%, at least 99.97%, at least 99.98%, at least 99.99% over a predetermined number of cycles. In some embodiments, the positive electrode comprises a columbic efficiency of at most 90 percent (%), at most 91%, at most 92%, at most 93%, at most 94%, at most 95%, at most 96%, at most 97%, at most 98%, at most 99%, at most 99.1%, at most 99.2%, at most 99.3%, at most 99.4%, at most 99.5%, at most 99.6%, at most 99.7%, at most 99.8%, at most 99.9%, at most 99.91%, at most 99.92%, at most 99.93%, at most 99.94%, at most 99.95%, at most 99.96%, at most 99.97%, at most 99.98%, at most 99.99% over a predetermined number of cycles. In some embodiments, the positive electrode comprises a columbic efficiency of 90% to 99%, 99.2% to 99.8%, 92% to 98%, 99.8% to 99.99%, 99.5% to 99.8%, 92% to 99.6%, or 99% to 99.99%, including all values and sub ranges in between. The predetermined number of cycles can be 50 cycles, 100 cycles, 150 cycles, 200 cycles, 250 cycles, 300 cycles, 350 cycles, 400 cycles, 500 cycles, 600 cycles, 700 cycles, 800 cycles, 900 cycles, 1000 cycles, 2000 cycles, 3000 cycles, 4000 cycles, 5000 cycles, 5500 cycles, 6000 cycles, 6500 cycles, 7000 cycles, 7500 cycles, 8000 cycles, 8500 cycles, or 9000 cycles. The predetermined number of times can be about 50 cycles, about 100 cycles, about 150 cycles, about 200 cycles, about 250 cycles, about 300 cycles, about 350 cycles, about 400 cycles, about 500 cycles, about 600 cycles, about 700 cycles, about 800 cycles, about 900 cycles, about 1000 cycles, about 2000 cycles, about 3000 cycles, about 4000 cycles, about 5000 cycles, about 5500 cycles, about 6000 cycles, about 6500 cycles, about 7000 cycles, about 7500 cycles, about 8000 cycles, about 8500 cycles, or about 9000 cycles. The predetermined number of times can be at least 50 cycles, at least 100 cycles, at least 150 cycles, at least 200 cycles, at least 250 cycles, at least 300 cycles, at least 350 cycles, at least 400 cycles, at least 500 cycles, at least 600 cycles, at least 700 cycles, at least 800 cycles, at least 900 cycles, at least 1000 cycles, at least 2000 cycles, at least 3000 cycles, at least 4000 cycles, at least 5000 cycles, at least 5500 cycles, at least 6000 cycles, at least 6500 cycles, at least 7000 cycles, at least 7500 cycles, at least 8000 cycles, at least 8500 cycles, or at least 9000 cycles. The predetermined number of times can be at most 50 cycles, at most 100 cycles, at most 150 cycles, at most 200 cycles, at most 250 cycles, at most 300 cycles, at most 350 cycles, at most 400 cycles, at most 500 cycles, at most 600 cycles, at most 700 cycles, at most 800 cycles, at most 900 cycles, at most 1000 cycles, at most 2000 cycles, at most 3000 cycles, at most 4000 cycles, at most 5000 cycles, at most 5500 cycles, at most 6000 cycles, at most 6500 cycles, at most 7000 cycles, at most 7500 cycles, at most 8000 cycles, at most 8500 cycles, or at most 9000 cycles. In some embodiments, the cycling can be from 2 V to 5 V. In some embodiments, the cycling can be from 1.5 V to 4 V. In some embodiments, the cycling can be from 2.5 V to 3.75 V, 3 V to 4V, 3 V to 4.5 V, or 2 V to 3 V. In some embodiments, the cycling can be from about 2 V to about 5 V. In some embodiments, the cycling can be from about 2.5 V to about 3.75 V, about 3 V to about 4V, about 3 V to about 4.5 V, or about 2 V to about 3 V. In some embodiments, the cycling starts from about 2 V, about 2.5 V, about 3 V, about 3.5 V, or about 4 V. In some embodiments, the cycling starts from at least 2 V, at least 2.5 V, at least 3 V, at least 3.5 V, or at least 4 V. In some embodiments, the cycling starts from at most 2 V, at most 2.5 V, at most 3 V, at most 3.5 V, or at most 4 V. In some embodiments, the cycling finishes at 3 V, 3.25V, 3.5 V, 3.75 V, 4 V, 4.25 V, 4.5 V, 4.75 V, or 5 V. In some embodiments, the cycling finishes at about 3 V, about 3.25V, about 3.5 V, about 3.75 V, about 4 V, about 4.25 V, about 4.5 V, about 4.75 V, or about 5 V. In some embodiments, the cycling finishes at least 3 V, at least 3.25V, at least 3.5 V, at least 3.75 V, at least 4 V, at least 4.25 V, at least 4.5 V, at least 4.75 V, or at least 5 V. In some embodiments, the cycling finishes at most 3 V, at most 3.25V, at most 3.5 V, at most 3.75 V, at most 4 V, at most 4.25 V, at most 4.5 V, at most 4.75 V, or at most 5 V. The cycling can be performed at a C rate of at least 1C and a D-rate of at least 1C. The cycling can be performed at a C rate of at least 1C, 2C, 3C, 4C, 5C, C/2, C/3, C/4, or C/5 and a D-rate of at least 1C, 2C, 3C, 4C, 5C, C/2, C/3, C/4, or C/5. The cycling can be performed at a C rate of at least C/20:C/20, C/10:C/10, C/5:C/5, C/2:C/2, 1C:1C, or 2C:2C. The cycling can be performed at a C rate of at most C/20:C/20, C/10:C/10, C/5:C/5, C/2:C/2, 1C:1C, or 2C:2C. The cycling can be performed at a C rate of at least C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed at a C rate of at most C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed using a C-rate of at least C/20, C/10, C/5, C/2, 0.5C, 1C, 2C, 3C, 5C, 6C, 7C, 8C, 9C, or 10C. The cycling can be performed using a C-rate of at most C/20, C/10, C/5, C/2, 0.5C, 1C, 2C, 3C, 5C, 6C, 7C, 8C, 9C, or 10C. The cycling can be performed using a D-rate of at least D/20, D/10, D/5, D/2, 0.5D, 1D, 2D, 3D, 5D, 6D, 7D, 8D, 9D, or 10D. The cycling can be performed using a D-rate of at most D/20, D/10, D/5, D/2, 0.5D, 1D, 2D, 3D, 5D, 6D, 7D, 8D, 9D, or 10D.

Provided herein are various redox materials. The redox material can be integrated into a rechargeable energy source system. Table 1 provides a list of some redox materials for the positive electrode, in accordance with some embodiments (Volts: V; milliampere-hours: mAh; gram: g; watt-hours: Wh; kilograms: kg).

TABLE 1
Some material choices for the redox materials of the
positive electrode.

| | | | | | Volume |
|---|---|---|---|---|---|
| | | | | | Change |
| Chemical | Chemical | Aver- | | Energy | between |
| Formula | Formula | age | Ca- | Den- | Charged |
| in a | in a | Volt- | pacity | sity | State and |
| Charged | Discharged | age | (mAh/ | (Wh/ | Discharged |
| State | State | (V) | g) | kg) | State |
| V₆O₅F₁₉ | Li₁₁V₆O₅F₁₉ | 3.7 | 358.24 | 1326.04 | 0.03 |
| V₃OF₁₁ | Li₄V₃OF₁₁ | 3.78 | 264.33 | 999.54 | 0.11 |
| VO₂F | LiVO₂F | 3.68 | 246.16 | 906.4 | 0 |
| VOF₃ | LiVOF₃ | 4.1 | 204.78 | 839.22 | 0.05 |
| VPO₄F | Li₂VPO₄F | 2.81 | 299.8 | 841.6 | 0.15 |
| LiV₃OF₁₁ | Li₄V₃OF₁₁ | 4.05 | 198.25 | 803.4 | 0.03 |
| Mn₃V(PO₄)₆ | Li₆Mn₃V(PO₄)₆ | 3.96 | 194.39 | 770.77 | 0.05 |
| V₆O₅F₁₉ | Li₅V₆O₅F₁₉ | 4.25 | 171.51 | 728.68 | 0.07 |
| V₂(PO₄)₃ | Li₃V₂(PO₄)₃ | 3.38 | 197.25 | 667.23 | 0.06 |
| LiVOF₄ | Li₂VOF₄ | 4.15 | 170.91 | 709.09 | 0.06 |
| LiV(OF)₂ | Li₂V(OF)₂ | 3.74 | 198.8 | 744.23 | 0.02 |
| LiV(OF)₂ | Li₂V(OF)₂ | 3.24 | 198.8 | 644.82 | 0.05 |
| MnVP₂(O₄F)₂ | Li₂MnVP₂(O₄F)₂ | 4.23 | 154.16 | 652.3 | 0.04 |
| V₄O₇F₅ | Li₃V₄O₇F₅ | 3.44 | 186.3 | 640.52 | 0.02 |
| LiV₃CoO₁₀ | Li₄V₃CoO₁₀ | 3.52 | 201.25 | 709.28 | 0.02 |
| VPO₅ | LiVPO₅ | 3.83 | 158.73 | 608.25 | 0.01 |
| VFeP₂(O₄F)₂ | Li₂VFeP₂(O₄F)₂ | 4.14 | 153.76 | 635.86 | 0.04 |
| TiVO₄ | Li₂TiVO₄ | 2.09 | 303.38 | 633.01 | 0.06 |
| LiTiV₃O₁₀ | Li₄TiV₃O₁₀ | 3.09 | 206.99 | 640.22 | 0.01 |
| VFeP₂(HO₅)₂ | Li₂VFeP₂(HO₅)₂ | 4.07 | 155.54 | 632.36 | 0.02 |
| Li₂ VOF₅ | Li₃VOF₅ | 4.11 | 146.65 | 602.68 | 0.01 |
| MnV₄O₁₂ | Li₃MnV₄O₁₂ | 3.66 | 170.52 | 624.68 | 0.08 |
| VBO₄ | LiVBO₄ | 2.79 | 201.98 | 564.52 | 0.13 |
| LiV₂P₂(O₄F)₂ | Li₂VPO₄F | 2.52 | 224.85 | 567.71 | 0.06 |
| LiV₃CrO₈ | Li₄V₃CrOg | 2.83 | 222.99 | 631.23 | 0.01 |
| V₄(OF₃)₃ | Li₃V₄(OF₃)₃ | 2.96 | 181.27 | 535.66 | 0.01 |
| LiV₄O₈ | LiVO₂ | 2.73 | 223.64 | 611.49 | 0.02 |
| V(CO₃)₂ | LiV(CO₃)₂ | 4.03 | 150.65 | 607.76 | 0.18 |
| LiV₅O₁₀ | LiVO₂ | 2.55 | 238.55 | 608.7 | 0.01 |
| VCuO₄ | LiVCuO₄ | 3.86 | 144.54 | 557.67 | 0.06 |
| VCo₃O₈ | Li₂VCo₃O₈ | 4.19 | 145.02 | 607.14 | 0.05 |

The redox material can comprise atoms with multiple oxidation states. The redox material can comprise atoms of titanium, vanadium, chromium, manganese, iron, cobalt, copper, germanium, arsenic, niobium, molybdenum, technetium, ruthenium, rhodium, palladium, tin, antimony, or any combination thereof. The redox material can comprise vanadium atoms.

The redox material can comprise a transition metal. The redox material can comprise at least one of: vanadium, cobalt, nickel, a cobalt-aluminum alloy, manganese, niobium, molybdenum, technetium, tungsten, rhenium, rhodium, ruthenium, iridium, palladium, or platinum atoms. The redox material can comprise vanadium atoms. The redox material can comprise an oxide. The redox material can comprise VₓO_{y}. The redox material can comprise VₓO_{y}F_{z}. ‘X’, ‘Y’, and ‘Z’ may be integers. ‘X’, ‘Y’, and ‘Z’ may be real numbers, which can represent variations from exact stoichiometric ratios. The redox material can comprise at least one of: V₆O₅F₁₉, V₃OF₁₁, VO₂F, VOF₃, VPO₄F, LiV₃OF₁₁, Mn₃V (PO₄)₆, V₆O₅F₁₉, V₂(PO₄)₃, LiVOF₄, LiV(OF)₂, LiV(OF)₂, MnVP₂(O₄F)₂, V₄O₇F₅, LiV₃CoO₁₀, VPO₅, VFeP₂(O₄F)₂, TiVO₄, LiTiV₃O₁₀, VFeP₂(HO₅)₂, Li₂VOF₅, MnV₄O₁₂, VBO₄, LiV₂P₂(O₄F)₂, LiV₃CrO₈, V₄(OF₃)₃, LiV₄₀₈, V(CO₃)₂, LiV₅O₁₀, VCuO₄, VCo₃O₈, or any combination thereof. The redox material can comprise a V₂O₅ based compound with the general formula ζ-AₓM_{y}V₂O₅ and/or ζ-AₓM_{y}N_{z}V_{2-z}O₅, where M and N may be real fractional numbers and represent transition metals, alkaline earths, alkalis, post-transition metals, metalloids, or a combination thereof and A is one or more ions selected from the group consisting of Li, Na, K, Mg, Ca, Zn, and Al ions with a concentration of x ranging from 0.0-3.0 during charging and discharging the rechargeable electrochemical cell. The redox material can comprise FePO₄, NiMnCoO₂, or TiS₂.

The redox material can comprise a metal sulfide. The redox material can comprise titanium disulfide. The redox material can comprise a metal oxide. The positive electrode can comprise LiₓMO₂, wherein M is a metal. The redox material can comprise vanadium atoms. The redox material can comprise vanadium, cobalt, nickel, a cobalt-aluminum alloy, manganese, niobium, molybdenum, technetium, tungsten, rhenium, rhodium, ruthenium, iridium, palladium, platinum atoms, or any combination thereof. The redox material can comprise a polyatomic anion. The polyatomic anion can comprise PO₄.

The redox material can comprise additives. The redox material can comprise phosphate based materials such as FePO₄, VPO₄F, V₂(PO₄)₂F₃, FePO₄F, and V₂(PO₄)₃; oxides such as CoO₂, V₂O₅ based compounds, orthorhombic MnO₂, layered iron oxides FeO₂, chromium oxide CrO₂, layered Ni_{0.5}Mn_{0.5}O₂, and V₆O₁₅ nanorods; layer sulfides such as TiS₂; perovskite transition metal fluorides, or a mixture thereof. The redox material can comprise a filler, which can be conductive, e.g., graphene. The redox material can comprise a binder, which can be a polymer, e.g., poly vinylidene fluoride.

The redox material can comprise less than 20, 15, 10, 9, 8, 7, 6, 5, 4, 3, 2, or 1 percent lithium by mass. The redox material can comprise greater than 20, 15, 10, 9, 8, 7, 6, 5, 4, 3, 2, or 1 percent lithium by mass. For example, the redox material can comprise less than 10% lithium by mass. The amount of lithium can be measured at a delithiated state.

In some embodiments, a positive electrode may be selected based on factors including, not limited to a high conductivity (both ionic and electronic), a low toxicity, a high crustal abundance, a low oxygen evolution, an upper voltage limit less than 4.5, and a low voltage cutoff higher than 50% of the upper cutoff window.

In some embodiments, a positive electrode comprises a capacity of at least 275, 280, 290, 300, or 305 mAh/g. In some embodiments, a positive electrode comprises a capacity of at most 275, 280, 290, 300, or 305 mAh/g.

In some embodiments, a positive electrode comprises a current collector. In some embodiments, a positive electrode comprises an active material. In some embodiments, a positive electrode comprises an active material disposed on a current collector. In some embodiments, a current collector may have a thickness of at least 1, 2, 3, 4, 5, 6, 7, 8, 9, 10, 20, 30, 40, 50, 60, 70, 80, 90, 100, 200, 300, 400, 500, 600, 700, 800, 900, or 1000 μm. In some embodiments, a current collector may have a thickness of at most 1, 2, 3, 4, 5, 6, 7, 8, 9, 10, 20, 30, 40, 50, 60, 70, 80, 90, 100, 200, 300, 400, 500, 600, 700, 800, 900, or 1000 μm. In some embodiments, a current collector comprises copper, stainless steel, aluminum, nickel, titanium, sintered carbon, copper or stainless steel that is surface-treated with carbon, nickel, titanium or silver, and aluminum-cadmium alloys In some embodiments, a current collector comprises fine irregularities on surfaces thereof so as to enhance adhesive strength of the positive electrode current collector to the positive electrode active material. In some embodiments, a current collector comprises can comprise various forms including films, sheets, foils, nets, porous structures, foams, and non-woven fabrics. In some embodiments, a current collector comprises carbon, carbon paper, carbon cloth or a metal or noble metal mesh or foil.

In some embodiments, a positive electrode comprises a surface coating. In some embodiments, a surface coating comprises an oxide, a hydroxide, an oxyhydroxide, an oxycarbonate, or a hydroxycarbonate. In some embodiments, a surface coating is amorphous or crystalline. In some embodiments, a surface coating comprises magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or any combination thereof. In some embodiments, a surface coating comprises is formed using a spray coating method, a dipping method, or any other suitable method.

In some embodiments, a positive electrode comprises a binder. The binder can bind an active material to a current collector. In some embodiments, a binder comprises polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber (“SBR”), acrylated SBR, epoxy resin, and nylon. In some embodiments, a binder is electrically conductive. In some embodiments, a binder comprises carbon black or vapor ground carbon fibers. In some embodiments, a binder comprises polyvinylidene fluoride (PVDF), sodium alginate, and sodium carboxymethyl cellulose. In some embodiments, a binder comprises PVDF, polytetrafluoroethylene (PTFE), styrene butadiene rubber (SBR), and polyimide. In some embodiments, a binder comprises graphene or carbon nanotubes.

In some embodiments, a positive electrode comprises an electron intercalating material. In some embodiments, a positive electrode comprises a multi-electron intercalating material. In some embodiments, a positive electrode comprises a transition metal, which undergoes a change in oxidation state of at least two between a charged and discharged state. In some embodiments, a positive electrode comprises titanium disulfide. In some embodiments, a positive electrode comprises a metal oxide. In some embodiments, a positive electrode comprises LiₓMO₂, wherein M is a metal. In some embodiments, a positive electrode comprises vanadium. In some embodiments, a positive electrode comprises vanadium, cobalt, nickel, a cobalt-aluminum alloy, manganese, niobium, molybdenum, technetium, tungsten, rhenium, rhodium, ruthenium, iridium, palladium, or platinum. In some embodiments, a positive electrode comprises a polyatomic anion. In some embodiments, a polyatomic anion comprises PO₄.

In some embodiments, a positive electrode comprises vanadyl. In some embodiments, a positive electrode comprises phosphate. In some embodiments, a positive electrode comprises V₂O₅ based compounds. In some embodiments, a positive electrode comprises vanadyl phosphate (VOPO₄). In some embodiments, VOPO₄ can comprise alpha(I)-VOPO₄, alpha(II)-VOPO₄, beta-VOPO₄, epsilon-VOPO₄, delta-VOPO₄, omega-VOPO₄, or gamma-VOPO₄.

In some embodiments, a positive electrode comprises a sheet, ribbon, particles, or other forms. In some embodiments, a positive electrode comprises microstructures. In some embodiments, a positive electrode comprises nanostructures. The microstructures or the nanostructures can comprise substantially spherical, cylinder, or lamellar morphologies, or any combination thereof.

In some embodiments, a vanadyl phosphate positive electrode comprises two redox couples of a vanadium cation (V⁵⁺/V⁴⁺ and V⁴⁺/V³⁺). In some embodiments, the two redox couples can permit more than one lithium ion to be stored in the unit structure per vanadium ion.

In some embodiments, a positive electrode comprises additives. In some embodiments, a positive electrode comprises phosphate based materials such as FePO₄, VPO₄F, V₂(PO₄)₂F₃, FePO₄F, and V₂(PO₄)₃; oxides such as CoO₂, V₂O₅ based compounds, orthorhombic MnO₂, layered iron oxides FeO₂, chromium oxide CrO₂, layered Ni_{0.5}Mn_{0.5}O₂, and V₆O₁₅ nanorods; layer sulfides such as TiS₂; perovskite transition metal fluorides, or a mixture thereof.

In some embodiments, a positive electrode comprises ε-VOPO₄. The epsilon polymorph of vanadyl phosphate, ε-VOPO₄, can be made from hydrothermally or solvothermally synthesized H₂VOPO₄. In some embodiments, VOPO₄ can be synthesized using carbothermal reduction, ball-milling, micro-wave assisted solvothermal synthesis, exfoliation from sheets, or any combination thereof. In some embodiments, VOPO₄ can be annealed.

In some embodiments, a positive electrode comprises a coulombic efficiency of at least 90, 91, 92, 93, 94, 95, 96, 97, 98, 99, 99.1, 99.2, 99.3, 99.4, 99.5, 99.6, 99.7, 99.8, or 99.9% for at least 10, 20, 30, 40, 50, 60, 70, 80, 90, 100, 200, 300, 400, 500, 600, 700, 800, 900, or 1000 cycles. In some embodiments, a positive electrode comprises a coulombic efficiency of at most 90, 91, 92, 93, 94, 95, 96, 97, 98, 99, 99.1, 99.2, 99.3, 99.4, 99.5, 99.6, 99.7, 99.8, 99.9, or 100% for at most 10, 20, 30, 40, 50, 60, 70, 80, 90, 100, 200, 300, 400, 500, 600, 700, 800, 900, or 1000 cycles. In some embodiments, a positive electrode comprising ε-VOPO₄ comprises a coulombic efficiency of at least 90, 91, 92, 93, 94, 95, 96, 97, 98, 99, 99.1, 99.2, 99.3, 99.4, 99.5, 99.6, 99.7, 99.8, or 99.9% for at least 10, 20, 30, 40, 50, 60, 70, 80, 90, 100, 200, 300, 400, 500, 600, 700, 800, 900, or 1000 cycles. In some embodiments, a positive electrode comprising ε-VOPO₄ comprises a coulombic efficiency of at most 90, 91, 92, 93, 94, 95, 96, 97, 98, 99, 99.1, 99.2, 99.3, 99.4, 99.5, 99.6, 99.7, 99.8, 99.9, or 100% for at most 10, 20, 30, 40, 50, 60, 70, 80, 90, 100, 200, 300, 400, 500, 600, 700, 800, 900, or 1000 cycles. In some embodiments, a cycle can comprise a charge/discharge cycle from 1.6 to 4.5 Volts, from 1.6 to 3 Volts, from 3 to 4.5 Volts. The voltage can be in reference to a lithium metal. In some embodiments, a cycle can comprise a charge/discharge cycle rate of at least C/50, C/20, C/10 C/5, C/4, C/3, C/2, C/1, 2C, 3C, 4C, or 5C. In some embodiments, a cycle can comprise a charge/discharge cycle rate of at most C/50, C/20, C/10 C/5, C/4, C/3, C/2, C/1, 2C, 3C, 4C, or 5C. The cycling can be performed using a C-rate of at least C/20, C/10, C/5, C/2, 0.5C, 1C, 2C, 3C, 5C, 6C, 7C, 8C, 9C, or 10C. The cycling can be performed using a C-rate of at most C/20, C/10, C/5, C/2, 0.5C, 1C, 2C, 3C, 5C, 6C, 7C, 8C, 9C, or 10C. The cycling can be performed using a D-rate of at least D/20, D/10, D/5, D/2, 0.5D, 1D, 2D, 3D, 5D, 6D, 7D, 8D, 9D, or 10D. The cycling can be performed using a D-rate of at most D/20, D/10, D/5, D/2, 0.5D, 1D, 2D, 3D, 5D, 6D, 7D, 8D, 9D, or 10D.

In some embodiments, a positive electrode comprises a capacity of at least 275, 280, 290, 300, or 305 mAh/g. In some embodiments, a positive electrode comprises a capacity of at most 275, 280, 290, 300, or 305 mAh/g.

In some embodiments, a positive electrode comprises ε-VOPO₄ and an electrically conductive filler. In some embodiments, an electrically conductive filler comprises graphene. In some embodiments, a positive electrode comprises ε-VOPO₄ and at least 2.5% by weight electrically conductive filler, at least 3.0% by weight electrically conductive filler, at least 3.5% by weight electrically conductive filler, at least 4.0% by weight electrically conductive filler, at least 5% by weight electrically conductive filler, at least 6% by weight electrically conductive filler, at least 7% by weight electrically conductive filler, at least 8% by weight electrically conductive filler, at least 9% by weight electrically conductive filler, or at least 10% by weight electrically conductive filler. The positive electrode can comprise, for example, at least 75% by weight ε-VOPO₄, at least 5% by weight graphene nanoplatelets, and at least 5% by weight of a poly vinylidene fluoride (PVDF) binder. The intercalation electrode composition may comprise 85% by weight ε-VOPO₄, at least 5% by weight graphene nanoplatelets, and 10% by weight binder. The intercalation electrode composition may comprise 75% by weight ε-VOPO₄, 15% by weight graphene nano platelets, and 10% by weight of a poly vinylidene fluoride (PVDF) binder.

In some embodiments, a positive electrode comprises a current collector. In some embodiments, a positive electrode comprises an active material. A positive electrode can refer to the electrode that is positively charged during charging of a rechargeable battery, and negatively charged during discharging of a rechargeable battery. The positive electrode can refer to the electrode where an oxidation half-reaction occurs during charging, and a reduction half-reaction occurs during discharging. In some embodiments, a positive electrode comprises an active material disposed on a current collector. In some embodiments, a current collector may have a thickness of at least 1, 2, 3, 4, 5, 6, 7, 8, 9, 10, 20, 30, 40, 50, 60, 70, 80, 90, 100, 200, 300, 400, 500, 600, 700, 800, 900, or 1000 μm. In some embodiments, a current collector may have a thickness of at most 1, 2, 3, 4, 5, 6, 7, 8, 9, 10, 20, 30, 40, 50, 60, 70, 80, 90, 100, 200, 300, 400, 500, 600, 700, 800, 900, or 1000 μm. In some embodiments, a current collector comprises copper, stainless steel, aluminum, nickel, titanium, sintered carbon, copper or stainless steel that is surface-treated with carbon, nickel, titanium or silver, and aluminum-cadmium alloys In some embodiments, a current collector comprises fine irregularities on surfaces thereof so as to enhance adhesive strength of the current collector to the active material. In some embodiments, a current collector comprises can comprise various forms including films, sheets, foils, nets, porous structures, foams, and non-woven fabrics. In some embodiments, a current collector comprises carbon, carbon paper, carbon cloth or a metal or noble metal mesh or foil.

In some embodiments, a positive electrode comprises a surface coating. The surface coating can comprise niobium. In some embodiments, the surface coating can further comprise an oxide, a hydroxide, an oxyhydroxide, an oxycarbonate, or a hydroxycarbonate. In some embodiments, the surface coating is amorphous, crystalline, or comprises portions that are amorphous and portions that are crystalline. In some embodiments, the surface coating further comprises magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or any combination thereof. In some embodiments, the surface coating can be is formed using a spray coating method, a dipping method, or any other suitable method.

In some embodiments, a positive electrode comprises a binder. The binder can bind an active material to a current collector. In some embodiments, a binder comprises polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber (SBR), acrylated SBR, epoxy resin, and nylon. In some embodiments, a binder is electrically conductive. In some embodiments, a binder comprises carbon black or vapor ground carbon fibers. In some embodiments, a binder comprises polyvinylidene fluoride (PVDF), sodium alginate, and sodium carboxymethyl cellulose. In some embodiments, a binder comprises PVDF, polytetrafluoroethylene (PTFE), styrene butadiene rubber (SBR), and polyimide. In some embodiments, a binder comprises graphene or carbon nanotubes.

In some embodiments, a positive electrode comprises an electron intercalating material. In some embodiments, a positive electrode comprises a multi-electron intercalating material. In some embodiments, a positive electrode comprises a transition metal, which undergoes a change in oxidation state of at least two between a charged and discharged state. In some embodiments, a positive electrode comprises titanium disulfide. In some embodiments, a positive electrode comprises a metal oxide. In some embodiments, a positive electrode comprises LiₓMO₂, wherein M is a metal. In some embodiments, a positive electrode comprises vanadium. In some embodiments, a positive electrode comprises vanadium, cobalt, nickel, a cobalt-aluminum alloy, manganese, niobium, molybdenum, technetium, tungsten, rhenium, rhodium, ruthenium, iridium, palladium, or platinum. In some embodiments, a positive electrode comprises a polyatomic anion. In some embodiments, a polyatomic anion comprises PO₄.

In some embodiments, a positive electrode comprises vanadyl. In some embodiments, a positive electrode comprises phosphate. In some embodiments, a positive electrode comprises vanadyl phosphate (VOPO₄). In some embodiments, VOPO₄ can comprise alpha(I)-VOPO₄, alpha(II)-VOPO₄, beta-VOPO₄, epsilon-VOPO₄, delta-VOPO₄, omega-VOPO₄, or gamma-VOPO₄.

In some embodiments, a positive electrode comprises a sheet, ribbon, particles, or other forms. In some embodiments, a positive electrode comprises microstructures. In some embodiments, a positive electrode comprises nanostructures. The microstructures or the nanostructures can comprise substantially spherical, cylinder, or lamellar morphologies, or any combination thereof.

In some embodiments, a positive electrode comprises additives. In some embodiments, a positive electrode comprises phosphate based materials such as FePO₄, VPO₄F, V₂(PO₄)₂F₃, FePO₄F, and V₂(PO₄)₃; oxides such as CoO₂, V₂O₅ based compounds, orthorhombic MnO₂, layered iron oxides FeO₂, chromium oxide CrO₂, and V₆O₁₅ nanorods; layer sulfides such as TiS₂; perovskite transition metal fluorides, or a mixture thereof.

In some embodiments, a positive electrode comprises ε-VOPO₄. The epsilon polymorph of vanadyl phosphate, ε-VOPO₄, can be made from hydrothermally or solvothermally synthesized H₂VOPO₄. In some embodiments, VOPO₄ can be synthesized using carbothermal reduction, ball-milling, micro-wave assisted solvothermal synthesis, exfoliation from sheets, or any combination thereof. In some embodiments, VOPO₄ can be annealed.

In some embodiments, a positive electrode comprises a coulombic efficiency of at least 90, 91, 92, 93, 94, 95, 96, 97, 98, 99, 99.1, 99.2, 99.3, 99.4, 99.5, 99.6, 99.7, 99.8, or 99.9% for at least 10, 20, 30, 40, 50, 60, 70, 80, 90, 100, 200, 300, 400, 500, 600, 700, 800, 900, or 1000 cycles. In some embodiments, a positive electrode comprises a coulombic efficiency of at most 90, 91, 92, 93, 94, 95, 96, 97, 98, 99, 99.1, 99.2, 99.3, 99.4, 99.5, 99.6, 99.7, 99.8, 99.9, or 100% for at most 10, 20, 30, 40, 50, 60, 70, 80, 90, 100, 200, 300, 400, 500, 600, 700, 800, 900, or 1000 cycles. In some embodiments, a positive electrode comprising ε-VOPO₄ comprises a coulombic efficiency of at least 90, 91, 92, 93, 94, 95, 96, 97, 98, 99, 99.1, 99.2, 99.3, 99.4, 99.5, 99.6, 99.7, 99.8, or 99.9% for at least 10, 20, 30, 40, 50, 60, 70, 80, 90, 100, 200, 300, 400, 500, 600, 700, 800, 900, or 1000 cycles. In some embodiments, a positive electrode comprising &-VOPO₄ comprises a coulombic efficiency of at most 90, 91, 92, 93, 94, 95, 96, 97, 98, 99, 99.1, 99.2, 99.3, 99.4, 99.5, 99.6, 99.7, 99.8, 99.9, or 100% for at most 10, 20, 30, 40, 50, 60, 70, 80, 90, 100, 200, 300, 400, 500, 600, 700, 800, 900, or 1000 cycles. In some embodiments, a cycle can comprise a charge/discharge cycle from 1.6 to 4.5 Volts, from 1.6 to 3 Volts, from 3 to 4.5 Volts. The voltage can be in reference to a lithium metal. In some embodiments, a cycle can comprise a charge/discharge cycle rate of at least C/50, C/20, C/10 C/5, C/4, C/3, C/2, C/1, 2C, 3C, 4C, or 5C. In some embodiments, a cycle can comprise a charge/discharge cycle rate of at most C/50, C/20, C/10 C/5, C/4, C/3, C/2, C/1, 2C, 3C, 4C, or 5C. The cycling can be performed using a C-rate of at least C/20, C/10, C/5, C/2, 0.5C, 1C, 2C, 3C, 5C, 6C, 7C, 8C, 9C, or 10C. The cycling can be performed using a C-rate of at most C/20, C/10, C/5, C/2, 0.5C, 1C, 2C, 3C, 5C, 6C, 7C, 8C, 9C, or 10C. The cycling can be performed using a D-rate of at least D/20, D/10, D/5, D/2, 0.5D, 1D, 2D, 3D, 5D, 6D, 7D, 8D, 9D, or 10D. The cycling can be performed using a D-rate of at most D/20, D/10, D/5, D/2, 0.5D, 1D, 2D, 3D, 5D, 6D, 7D, 8D, 9D, or 10D.

In some embodiments, a positive electrode comprises a capacity of at least 275, 280, 290, 300, or 305 mAh/g. In some embodiments, a positive electrode comprises a capacity of at most 275, 280, 290, 300, or 305 mAh/g.

In some embodiments, a positive electrode comprises ε-VOPO₄ and an electrically conductive filler. In some embodiments, an electrically conductive filler comprises graphene. In some embodiments, a positive electrode comprises ε-VOPO₄ and at least 2.5% by weight electrically conductive filler, at least 3.0% by weight electrically conductive filler, at least 3.5% by weight electrically conductive filler, at least 4.0% by weight electrically conductive filler, at least 5% by weight electrically conductive filler, at least 6% by weight electrically conductive filler, at least 7% by weight electrically conductive filler, at least 8% by weight electrically conductive filler, at least 9% by weight electrically conductive filler, or at least 10% by weight electrically conductive filler. The positive electrode can comprise, for example, at least 75% by weight ε-VOPO₄, at least 5% by weight graphene nanoplatelets, and at least 5% by weight of a poly vinylidene fluoride (PVDF) binder. The intercalation electrode composition may comprise 85% by weight ε-VOPO₄, at least 5% by weight graphene nanoplatelets, and 10% by weight binder. The intercalation electrode composition may comprise 75% by weight ε-VOPO₄, 15% by weight graphene nano platelets, and 10% by weight of a poly vinylidene fluoride (PVDF) binder.

### Structure

The redox material can comprise various forms. For example, the redox material can comprise sheets, ribbons, or particles. The redox material can comprise microstructures. The redox material can comprise nanostructures. The microstructures or the nanostructures can comprise substantially spherical, cylinder, or lamellar morphologies, or any combination thereof. Such structures may be deposited on a substrate surface.

### Additives

The redox material can comprise a binder. The binder can bind the redox material to the current collector. The binder can be electrically conductive. The binder can comprise polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber (SBR), acrylated SBR, epoxy resin, and nylon. The binder can comprise carbon black or vapor ground carbon fibers. The binder can be polyvinylidene fluoride (PVDF), sodium alginate, and sodium carboxymethyl cellulose. The binder can comprise PVDF, polytetrafluoroethylene (PTFE), styrene butadiene rubber (SBR), and polyimide. The binder can graphene or carbon nanotubes.

The redox material can comprise a surface coating. The surface coating can comprise an oxide, a hydroxide, an oxyhydroxide, an oxycarbonate, or a hydroxycarbonate. The surface coating can be amorphous or crystalline. The surface coating can comprise magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr) atoms, or any combination thereof. The surface coating can be formed using a spray coating method, a dipping method, or any other suitable method.

The redox material can comprise a polymer binder. The polymer binder can comprise a block copolymer. The block copolymer can provide a hydrophobic domain on a surface of the electrode. A hydrophobic polymer membrane can be bound to the hydrophobic domain on the surface of the redox material.

### Substrate

The substrate can comprise a current collector. The current collector can comprise copper, stainless steel, aluminum, nickel, titanium, sintered carbon, copper or stainless steel that is surface-treated with carbon, nickel, titanium or silver, and aluminum-cadmium alloys. The structures, foams, and non-woven fabrics. The current collector can comprise carbon, carbon paper, carbon cloth or a metal or noble metal mesh or foil. The current collector can comprise fine irregularities on surfaces thereof so as to enhance the adhesive strength of the current collector to the redox material. The current collector can have a thickness of at least 1, 2, 3, 4, 5, 6, 7, 8, 9, 10, 20, 30, 40, 50, 60, 70, 80, 90, 100, 200, 300, 400, 500, 600, 700, 800, 900, or 1000 μm. The current collector can have a thickness of at most 1, 2, 3, 4, 5, 6, 7, 8, 9, 10, 20, 30, 40, 50, 60, 70, 80, 90, 100, 200, 300, 400, 500, 600, 700, 800, 900, or 1000 μm.

### Properties

The positive electrode can be configured to have a stable capacity. Over numerous cycles, the positive electrode can resist loss of redox material. For example, uncontrolled crack formation and propagation can lead to loss of redox material when a piece of the redox material comprising lithium breaks loose. The broken piece may become electrically isolated from the rest of the positive electrode, and the lithium contained within may not be able to participate in the redox reactions and not be able to contribute to the capacity and the energy density of the electrochemical system. Stable volume of the redox material with respect to its state of charge, temperature, and pressure may reflect the physical stability of the positive electrode.

The capacity of the positive electrode can be at least 50, 100, 150, 200, 250, 300, 350, 400, 450, or 500 mAh/g. The capacity of the positive electrode can be at most 50, 100, 150, 200, 250, 300, 350, 400, 450, or 500 mAh/g. For example, the capacity of the positive electrode can be at least 250 mAh/g. The energy density of the positive electrode can be at least 200, 400, 600, 800, 1000, 1200, 1400, or 1600 Wh/kg. The energy density of the positive electrode can be at most 200, 400, 600, 800, 1000, 1200, 1400, or 1600 Wh/kg. For example, the energy density of the positive electrode can be at least 800 Wh/kg.

In some embodiments, the redox material exhibits a volumetric change of less than about 50%, 45%, 40%, 35%, 30%, 25%, 20%, 15%, 10%, 5%, 4%, 3%, 2%, or 1% when cycled for a predetermined number of times. In some embodiments, the redox material exhibits a volumetric change of more than about 50%, 45%, 40%, 35%, 30%, 25%, 20%, 15%, 10%, 5%, 4%, 3%, 2%, or 1% when cycled for a predetermined number of times. The predetermined number of times can be at least 50, 100, 150, 200, 250, 300, 350, 400, 500, 600, 700, 800, 900, 1000, 2000, 3000, 4000, or 5000 times. The predetermined number of times can be at most 50, 100, 150, 200, 250, 300, 350, 400, 500, 600, 700, 800, 900, 1000, 2000, 3000, 4000, or 5000 times. The cycling can be from 2 V to 4.5 V, from 3 V to 4.5 V, or from 2 V to 3 V. The cycling can be performed at a C rate of at least C/20:C/20, C/10:C/10, C/5:C/5, C/2:C/2, 1C:1C, or 2C:2C. The cycling can be performed at a C rate of at most C/20:C/20, C/10:C/10, C/5:C/5, C/2:C/2, 1C:1C, or 2C:2C. The cycling can be performed at a C rate of at least C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed at a C rate of at most C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C.

In some embodiments, an energy capacity loss of the positive electrode can be less than about 30%, 25%, 20%, 15%, 10%, 5%, 4%, 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, or 0.01% over a predetermined number of cycles. The energy capacity loss of the positive electrode can be greater than about 30%, 25%, 20%, 15%, 10%, 5%, 4%, 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, or 0.01% over a predetermined number of cycles. The predetermined number of times can be at least 50, 100, 150, 200, 250, 300, 350, 400, 500, 600, 700, 800, 1000, or 5000 times. The predetermined number of times can be at most 50, 100, 150, 200, 250, 300, 350, 400, 500, 600, 700, 800, 1000, or 5000 times. The cycling can be from 2 V to 4.5 V, from 3 V to 4.5 V, or from 2 V to 3 V. The cycling can be performed at a C rate of at least C/20:C/20, C/10:C/10, C/5:C/5, C/2:C/2, 1C:1C, or 2C:2C. The cycling can be performed at a C rate of at most C/20:C/20, C/10:C/10, C/5:C/5, C/2:C/2, 1C:1C, or 2C:2C. The cycling can be performed at a C rate of at least C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed at a C rate of at most C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed using a C-rate of at least C/20, C/10, C/5, C/2, 0.5C, 1C, 2C, 3C, 5C, 6C, 7C, 8C, 9C, or 10C. The cycling can be performed using a C-rate of at most C/20, C/10, C/5, C/2, 0.5C, 1C, 2C, 3C, 5C, 6C, 7C, 8C, 9C, or 10C. The cycling can be performed using a D-rate of at least D/20, D/10, D/5, D/2, 0.5D, 1D, 2D, 3D, 5D, 6D, 7D, 8D, 9D, or 10D. The cycling can be performed using a D-rate of at most D/20, D/10, D/5, D/2, 0.5D, 1D, 2D, 3D, 5D, 6D, 7D, 8D, 9D, or 10D.

In some embodiments, a positive electrode comprises a coulombic efficiency of at least 90, 91, 92, 93, 94, 95, 96, 97, 98, 99, 99.1, 99.2, 99.3, 99.4, 99.5, 99.6, 99.7, 99.8, or 99.9 percent over a predetermined number of cycles. In some embodiments, a positive electrode comprises a coulombic efficiency of at most 90, 91, 92, 93, 94, 95, 96, 97, 98, 99, 99.1, 99.2, 99.3, 99.4, 99.5, 99.6, 99.7, 99.8, or 99.9 percent over a predetermined number of cycles. The predetermined number of times can be at least 50, 100, 150, 200, 250, 300, 350, 400, 500, 600, 700, 800, 1000, or 5000 times. The predetermined number of times can be at most 50, 100, 150, 200, 250, 300, 350, 400, 500, 600, 700, 800, 1000, or 5000 times. The cycling can be from 2 V to 4.5 V, from 3 V to 4.5 V, or from 2 V to 3 V. The cycling can be performed at a C rate of at least C/20:C/20, C/10:C/10, C/5:C/5, C/2:C/2, 1C:1C, or 2C:2C. The cycling can be performed at a C rate of at most C/20:C/20, C/10:C/10, C/5:C/5, C/2:C/2, 1C:1C, or 2C:2C. The cycling can be performed at a C rate of at least C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed at a C rate of at most C/2:C/5, 1C:C/5, 2C:C/5, C/2:C/2, 1C:C/2, 2C:C/2, C/2:1C, 1C:1C, 2C:1C, C/2:2C, 1C:2C, or 2C:2C. The cycling can be performed using a C-rate of at least C/20, C/10, C/5, C/2, 0.5C, 1C, 2C, 3C, 5C, 6C, 7C, 8C, 9C, or 10C. The cycling can be performed using a C-rate of at most C/20, C/10, C/5, C/2, 0.5C, 1C, 2C, 3C, 5C, 6C, 7C, 8C, 9C, or 10C. The cycling can be performed using a D-rate of at least D/20, D/10, D/5, D/2, 0.5D, 1D, 2D, 3D, 5D, 6D, 7D, 8D, 9D, or 10D. The cycling can be performed using a D-rate of at most D/20, D/10, D/5, D/2, 0.5D, 1D, 2D, 3D, 5D, 6D, 7D, 8D, 9D, or 10D.

In some embodiments, the positive electrode has a capacity of at least 250 mAh/g. In some embodiments, the positive electrode has a capacity of at least 100, 150, 200, 250, 300, or 350 mAh/g. In some embodiments, the positive electrode has a capacity of at most 500 mAh/g. In some embodiments, the positive electrode has a capacity of at most 450, 400, 350, 300, 250, 200, or 150 mAh/g.

In some embodiments, the positive electrode has a gravimetric energy density of at least 800 Wh/kg. In some embodiments, the positive electrode has a gravimetric energy density of at least 400, 450, 500, 550, 600, 650, 700, 750, 800, 850, 900, 950, 1000, 1050, 1100, 1150, 1200, 1250, or 1300 Wh/kg. In some embodiments, the positive electrode has a gravimetric energy density of at most 1500 Wh/kg. In some embodiments, the positive electrode has a gravimetric energy density of at most 450, 500, 550, 600, 650, 700, 750, 800, 850, 900, 950, 1000, 1050, 1100, 1150, 1200, 1250, 1300, 1350, 1400, or 1450 Wh/kg.

In some embodiments, the positive electrode comprises an atoms with multiple oxidation states. In some embodiments, the positive electrode comprises titanium, vanadium, chromium, manganese, iron, cobalt, copper, germanium, arsenic, niobium, molybdenum, technetium, ruthenium, rhodium, palladium, tin, antimony atoms, or any combination thereof. In some embodiments, the positive electrode comprises vanadium atoms.

In some embodiments, the positive electrode comprises an oxide. In some embodiments, the positive electrode comprises VₓO_{y}. In some embodiments, the positive electrode comprises VₓO_{y}F_{z}. ‘X’, ‘Y’, and ‘Z’ may be integers. ‘X’, ‘Y’, and ‘Z’ may be real numbers, which can represent variations from exact stoichiometric ratios. In some embodiments, the positive electrode comprises at least one of: V₆O₅F₁₉, V₃OF₁₁, VO₂F, VOF₃, VPO₄F, LiV₃OF₁₁, Mn₃V(PO₄)₆, V₆O₅F₁₉, V₂(PO₄)₃, LiVOF₄, LiV(OF)₂, LiV(OF)₂, MnVP₂(O₄F)₂, V₄O₇F₅, LiV₃CoO₁₀, VPO₅, VFeP₂(O₄F)₂, TiVO₄, LiTiV₃O₁₀, VFeP₂(HO₅)₂, Li₂VOF₅, MnV₄O₁₂, VBO₄, LiV₂P₂(O₄F)₂, LiV₃CrO₈, V₄(OF₃)₃, LiV₄₀₈, V(CO₃)₂, LiV₅O₁₀, VCuO₄, or VCo₃O₈. In some embodiments, the positive electrode comprises FePO₄, NiMnCoO₂, or TiS₂.

The rechargeable energy source system can comprise a negative electrode. The negative electrode can comprise lithium metal. The lithium metal can be comprised in a layer. The layer of lithium metal can be substantially pure or dense. For example, the layer of lithium metal can comprise density of at least 0.4 g/cm³. In some embodiments, the layer of lithium metal can comprise density of at least 0.41, 0.42, 0.43 0.44, 0.45, 0.46, 0.47, 0.48, 0.49, 0.50, 0.51, or 0.52 g/cm³. In some cases, the layer of lithium metal can comprise density of at most 0.41, 0.42, 0.43 0.44, 0.45, 0.46, 0.47, 0.48, 0.49, 0.50, 0.51, 0.52, or 0.53 g/cm³. The density can be determined, e.g., at room temperature. In some embodiments, the layer of lithium metal can comprise less than 50 ppm of an impurity. The layer of lithium metal can comprise less than 45, 40, 35, 30, 25, 20, 15, 10, or 5 ppm of an impurity. The layer of lithium metal can comprise greater than 0, 5, 10, 15, 20, 25, 30, 35, 40, or 45 ppm of an impurity. The impurity can be determined by mass or moles. The impurity can be a metallic impurity.

The rechargeable energy source system can be an “anodeless” system. As used herein, an “anodeless” system can refer to a rechargeable energy storage system comprising, at a fully discharged state, an anode-free state but with a current collector. An “anodeless” system may comprise a trace of an anode material (e.g., small portion of remaining lithium, which could be identified with a surface interrogation technique) but comprise a current collector, when at a fully discharged state.

In some embodiments, an anodic reaction of an anodeless system occurs within the electrolyte rather than on or in a substrate. For example, in a wet-state “anode-free” lithium metal battery system, the negative electrode comprises metallic lithium, and the positive electrode is functionally within the electrolyte. The potential of the positive electrode reaction can be collected by an electrochemically inactive metal current collector. The electrolyte can serve both as the electrolyte and the site of the positive electrode reaction. The electrolyte and positive electrode can be referred to as “phase-unified,” or “mutually solvated.”

A N/P ratio can be a measure of a capacity ratio between the negative electrode and the positive electrode in the rechargeable energy system. In some embodiments, the rechargeable energy source system comprises a N/P ratio of less than 0.1 when the rechargeable energy source system is fully discharged. In some embodiments, the rechargeable energy source system comprises a N/P ratio of less than 0.2, 0.15, 0.1, 0.9, 0.8, 0.7, 0.6, 0.5, 0.4, 0.3, 0.2, 0.1, 0.09, 0.08, 0.07, 0.06, 0.05, 0.04, 0.03, 0.02, 0.01, 1e⁻³, 1e⁻⁴, 1e⁻⁵, or 1e⁻⁶ when the rechargeable energy source system is fully discharged. In some embodiments, the rechargeable energy source system comprises a N/P ratio of greater than 0.15, 0.1, 0.9, 0.8, 0.7, 0.6, 0.5, 0.4, 0.3, 0.2, 0.1, 0.09, 0.08, 0.07, 0.06, 0.05, 0.04, 0.03, 0.02, 0.01, 1e⁻³, 1e⁻⁴, 1e⁻⁵, or 1e⁻⁶ when the rechargeable energy source system is fully discharged. In some embodiments, the rechargeable energy source system comprises a N/P ratio of about zero when the rechargeable energy source system is fully discharged. In some embodiments, the positive electrode comprises less than 10% lithium in the rechargeable energy source system by mass. In some embodiments, the positive electrode comprises less than 20%, 15%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, or 0.1% lithium in the rechargeable energy source system by mass when charged. In some embodiments, the positive electrode comprises greater than 15%, 10%, 9%, 8%, 7%, 6%, 5%, 4%, 3%, 2%, 1%, 0.9%, 0.8%, 0.7%, 0.6%, 0.5%, 0.4%, 0.3%, 0.2%, 0.1%, or 0% lithium in the rechargeable energy source system by mass when charged. When charged, the negative electrode can comprise a layer of lithium metal comprising a thickness of less than 100 μm. When charged, the negative electrode can comprise a layer of lithium metal comprising a thickness of less than 500, 400, 300, 200, 100, 90, 80, 70, 60, 50, 40, 30, 20, or 10 μm. When charged, the negative electrode can comprise a layer of lithium metal comprising a thickness of greater than 0, 10, 20, 30, 40, 50, 60, 70, 80, 90, 100, 200, 300, or 400 μm.

The rechargeable energy source system can comprise some or no lithium in excess. The lithium in excess can be a fraction of a net amount of lithium transferred between the negative electrode and the positive electrode during discharging or charging of the rechargeable energy source system. The lithium in excess can be a fraction of a net amount of lithium transferred between the two opposing electrodes during discharging or charging of the rechargeable energy source system. The lithium in excess can be less than 20%, 15%, 10%, 9%, 8%, 7%, 6%, 5%, 4%, 3%, 2%, or 1%. The lithium in excess can be more than 20%, 15%, 10%, 9%, 8%, 7%, 6%, 5%, 4%, 3%, 2%, or 1%.

The positive electrode can be configured to have a stable capacity. Over numerous cycles, the positive electrode can resist loss of active material. For example, uncontrolled crack formation and propagation can lead to loss of active material when a piece of the positive electrode comprising lithium breaks loose. The broken piece may become electrically isolated from the rest of the positive electrode, and the lithium contained within may not be able to participate in the redox reactions that contribute to the capacity and the energy density of the electrochemical system. Stable volume of the positive electrode may reflect the physical stability of the positive electrode. In some embodiments, the positive electrode can be configured to exhibit a volumetric change of less than about 10% over at least 100 charge/discharge cycles of the rechargeable energy source system. In some embodiments, the positive electrode can be configured to exhibit a volumetric change of less than 30%, 25%, 20%, 15%, 10%, 5%, 4%, 3%, 2%, or 1% over at least 100 charge/discharge cycles of the rechargeable energy source system. In some embodiments, the positive electrode can be configured to exhibit a volumetric change of at least 0% over at least 100 charge/discharge cycles of the rechargeable energy source system. In some embodiments, the positive electrode can be configured to exhibit a volumetric change of greater than 1%, 2%, 3%, 4%, 5%, 10%, 15%, 20%, or 25% over at least 100 charge/discharge cycles of the rechargeable energy source system. In some embodiments, the positive electrode can be configured to exhibit a volumetric change of less than about 20% over at least 1000 charge/discharge cycles of the rechargeable energy source system. In some embodiments, the positive electrode can be configured to exhibit a volumetric change of less than about 50%, 45%, 40%, 35%, 30%, 25%, 20%, 15%, 10%, or 5% over at least 1000 charge/discharge cycles of the rechargeable energy source system. In some embodiments, the positive electrode can be configured to exhibit a volumetric change of greater than about 0%, 5%, 10%, 15%, 20%, 25%, 30%, 35%, 40%, or 45% over at least 1000 charge/discharge cycles of the rechargeable energy source system. In some embodiments, an energy capacity loss of the rechargeable energy source system can be less than about 1% over at least 100 charge/discharge cycles. In some embodiments, an energy capacity loss of the rechargeable energy source system can be less than about 30%, 25%, 20%, 15%, 10%, 5%, 4%, 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, or 0.01% over at least 100 charge/discharge cycles. In some embodiments, an energy capacity loss of the rechargeable energy source system can be greater than about 0.01% over at least 100 charge/discharge cycles. In some embodiments, an energy capacity loss of the rechargeable energy source system can be greater than about 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 2%, 3%, 4%, 5%, 10%, 15%, 20%, or 25% over at least 100 charge/discharge cycles.

### Separator

A separator can be provided between a negative electrode and a positive electrode. The separator can be in contact with the layer of lithium metal. The separator can be in contact with the positive electrode.

The separator can comprise a polymer or a ceramic membrane. The separator can be wetted with an electrolyte. The separator can comprise a surface that is substantially non-reactive with lithium metal.

The separator can comprise a polypropylene surface. The separator can comprise a single layer or multiple layers. The separator can comprise glass fiber, polyester, Teflon, polyethylene, polypropylene, polyvinylidene fluoride (“PVDF”), polytetrafluoroethylene (“PTFE”), or a combination thereof. The separator can comprise at least three layers. The at least three layers can comprise polypropylene, polyethylene, and polypropylene, in order.

The separator can have a porosity of at least 10, 20, 30, 40, 50, 60, 70, or 80 percent. The separator can have a porosity of at most 10, 20, 30, 40, 50, 60, 70, or 80 percent. The separator can have a porosity of at least 55%. The separator can have a porosity of at most 55%. The separator can have a porosity of about 55%.

The separator can be at least 5, 10, 15, 20, 25, 30, 35, 40, 45, or 50 μm thick. The separator can be at most 5, 10, 15, 20, 25, 30, 35, 40, 45, or 50 μm thick. The separator can be 5 to 50 μm thick.

The separator can selectively conduct lithium ions between the negative electrode and the positive electrode. The separator can substantially prevent or inhibit the passage of organic solvents, anions of lithium salts, water, or a contaminant from being transferred between the negative electrode and the positive electrode. The separator can hydrophobic polymers. The separator can comprise lithium-ion conductive channels.

In some embodiments, a membrane may be disposed between the positive electrode and the negative electrode. In some embodiments, the membrane may selectively conduct lithium ions between the positive electrode and the negative electrode. In some embodiments, the membrane may substantially prevent or inhibit the passage organic solvents, anions of lithium salts, water, or a contaminant from being transferred between the negative electrode and the positive electrode. A membrane can comprise a single layer or multiple layers. In some embodiments, a membrane can comprise glass fiber, polyester, polyethylene, polypropylene, polyvinylidene fluoride (PVDF), polytetrafluoroethylene (PTFE), and a combination thereof. In some embodiments, a membrane can comprise hydrophobic polymers. In some embodiments, a membrane can comprise lithium-ion conductive channels.

In some embodiments, the lithium conductive polymer comprises a copolymer. In some embodiments, the polymer can comprise a block copolymer or a random copolymer. In some embodiments, a portion of the block copolymer is in contact with lithium metal, wherein the portion is substantially unreactive with the lithium metal. A block copolymer can, for example, be annealed to undergo microphase separation, providing an exposed hydrophobic surface that is substantially unreactive with lithium metal. Meanwhile, the block copolymer can further comprise a percolating hydrophilic domain that provides paths for lithium ions to traverse through from one side of the block copolymer to the other. In some embodiments, the block copolymer comprises diblock copolymer, triblock copolymer, triblock terpolymer, and multiblock copolymer, and grafted copolymer. In some embodiments, the block copolymer can comprise PDMS-PEG (e.g., poly(polydimethylsiloxane)-b-poly(poly(ethylene glycol) methacrylate)). In some embodiments, the block copolymer can comprise POEM-b-PLMA (poly(oxyethylene methacrylate)-b-poly(lauryl methacrylate)), POEM ((polyoxyethylene methyl methacrylate))-P (PDMSMA (polydimethylsiloxane methacrylate)), PBA-b-PPEGMA, or any combination thereof. In some embodiments, a copolymer can comprise poly(butyl acrylate) (PBA), Poly(butyl methacrylate) (PBMA), Poly(lauryl methacrylate) (PLMA), Poly(ethylene) (PE), Poly(ethylene-alt-propylene) (PEP), Poly(urethane) (PU), Poly(butadiene) (PB), Poly(polyvinylidene methacrylate) (PPVDFMA), Poly(polytetrafluoroethylene methacrylate) (PPTFEMA), Poly(perfluoropolyether) (PFPE), Poly(perfluoropolyether methacrylate) (PFPEMA), Poly(perfluoropolyether acrylate) (PFPEA), Poly(poly(ethylene glycol) methacrylate) (PPEGMA), Poly(poly(ethylene glycol) acrylate) (PPEGA), Poly(perfluoropolyether methacrylate) (PFPEMA), Poly(perfluoropolyether acrylate) (PFPEA), or any combination thereof.

The hydrophobic polymer can comprise, e.g., a cyclic olefin copolymer, fluorinated ethylene propylene, ethylene-methyl acrylate copolymer, polymonochlorotrifluoroethylene, perfluoroalkoxy polymer, polymethylpentene, polypropylene, polyphenylene sulfide, polystyrene, polytetrafluoroethylene, polyvinylchloride, polyethylene, ethylene vinyl acetate, or any combination thereof.

### Solid State Electrolytes for Blocking Water Passage

In some aspects, the present disclosure provides systems and methods for blocking the passage of water with solid state electrolytes. A solid state electrolyte can provide a partition between a working electrode configured to reduce lithium ions to lithium metal thereon, and a lithium resource which can be aqueous. In some embodiments, a solid state electrolyte can be configured to selectively conduct lithium ions, while preventing the passage of water. In some embodiments, a solid state electrolyte can comprise a polymer, a ceramic, or both. In some embodiments, a solid state electrolyte can comprise a composite comprising a polymer and a plurality of lithium ion conductive particles. Any number and any combination of solid state electrolytes disclosed herein may be employed to reduce or prevent water contamination at the working electrode. For example, a method or system of the present disclosure may use 1, 2, 3, 4, 5, or more solid state electrolytes. The solid state electrolytes may be integrated into a unitary film, e.g., having multiple solid state electrolytes adhered to one another. The solid state electrolytes may be interposed, e.g., two nearest solid state electrolytes may be interposed by a liquid electrolyte.

In some aspects, the present disclosure provides a method for lithium extraction from brine. The method can deposit lithium metal islands smaller than 200 μm in diameter on a substrate using a composite membrane of the present disclosure. The composite membrane can comprise numerous fine particles, which can provide a dense network of pathways for lithium ions to traverse through from one side of the composite membrane to the other. By electrodepositing lithium on a substrate through the dense network of pathways, lithium metal islands can nucleate with higher density. When the lithium metal islands nucleate with higher density, the resulting lithium metal morphology can have increased uniformity and density. In some embodiments, the lithium metal islands are smaller than 190, 180, 170, 160, 150, 140, 130, 120, 110, 100, 90, 80, 70, 60, 50, 40, 30, 20, 10, 9, 8, 7, 6, 5, 4, 3, 2, or 1 μm. In some embodiments, the lithium metal islands are greater than 190, 180, 170, 160, 150, 140, 130, 120, 110, 100, 90, 80, 70, 60, 50, 40, 30, 20, 10, 9, 8, 7, 6, 5, 4, 3, 2, or 1 μm. The method can deposit lithium metal with a nucleation site density of greater than 0.04 nucleation sites/mm² on a substrate using a composite membrane disclosed in the present disclosure. In some embodiments, nucleation site density is greater than 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, or 10 nucleation sites/mm². In some embodiments, nucleation site density is less than 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, or 10 nucleation sites/mm². In some embodiments, the depositing of the lithium can be substantially free of side reactions caused by water and/or other impurities. In some embodiments, the depositing lithium can be performed using a current density of at least 1, 2, 3, 4, 5, 6, 7, 8, 9, 10, 20, 30, 40, or 50 mA/cm². In some embodiments, the other impurities comprise oxygen, an organic electrolyte, a surfactant, sodium, potassium, magnesium, calcium, boron, chlorine, SO₄²⁻, nitrogen, an alkali metal, an alkali earth metal, or any combination thereof. In some embodiments, the substrate comprises copper, silicon, silver, carbon, aluminum, gold, or any combination thereof.

In some aspects, the present disclosure provides a system comprising a composite membrane disclosed in the present disclosure. The system can comprise a lithium metal negative electrode and a polymer layer between the lithium metal negative electrode and the composite membrane. In some aspects, the present disclosure provides a system comprising a lithium metal negative electrode and a composite membrane disclosed in the present disclosure. The system can further comprise a polymer layer between the lithium metal negative electrode and the composite membrane. The system can comprise a porous filter between a lithium metal negative electrode and the composite membrane. The system can comprise a lithium metal layer having a thickness greater than 10 μm and a nucleation site density greater than 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, or 10 nucleation sites/mm², when the rechargeable energy source system is fully charged.

### Composite Membranes

Conductive inorganic membranes (e.g., certain ceramic membranes) can provide a barrier that selectively permits the passage of lithium ions in electrochemical systems. However, it can be challenging and costly to manufacture solid ion conductive membranes while minimizing grain boundaries that constitute defects, which can detrimentally affect the stability and the water permeability of the solid ion conductive membrane. Solid ion conductive membranes can also be brittle, which can make it difficult to manufacture solid ion conductive materials at scale for use in various form factors in electrochemical systems. Accordingly, solid ion conductive materials can be difficult to use for extracting lithium from brine at an industrial scale.

Meanwhile, lithium ion conductive polymers can be flexible and moldable for various form factors, and may lack certain manufacturing challenges associated with ceramic compositions. However, lithium ion conductive polymers may be hydrophilic and absorb moisture, which can permit the passage of undesirable species (e.g., water or other metal ions) through the lithium ion conductive polymers. Accordingly, lithium ion conductive polymers can be difficult to use for extracting lithium from brine with high purity and quality.

In some aspects, the present disclosure provides conductive composite membranes, electrochemical systems comprising conductive composite membranes, methods of using thereof, and methods of making thereof. Conductive composite membranes can be configured to block the passage of water molecules from a lithium resource, such as brine, to a working electrode when electrodepositing lithium. Conductive composite membranes disclosed herein can comprise a combination of one or more lithium ion conductive particles and a polymer. In some embodiments, the lithium ion conductive particles can comprise a solid ion conductive material. In some embodiments, the polymer can comprise a hydrophobic polymer.

Without being bound to a particular theory, the composite membrane can provide boundaries between particles and the polymer that creates an interface, where lithium ions can rapidly diffuse in the interface. Using lithium ion conductive particles can further provide additional diffusivity for lithium ions through the particles and thereby the composite membrane.

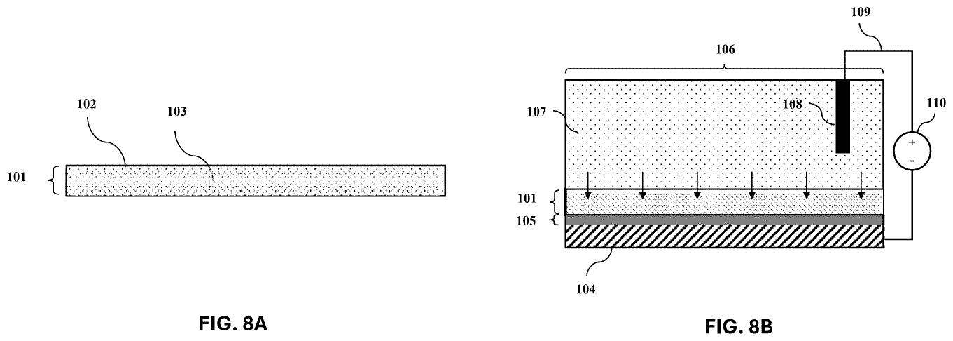

FIG. 8A shows a conductive composite membrane, in accordance with some embodiments. The conductive composite membrane 101 can comprise a hydrophobic film layer 102. The conductive composite membrane can comprise one or more lithium ion conductive particles 103. The one or more lithium ion conductive particles can be dispersed in the hydrophobic film layer. The one or more lithium ion conductive particles can be dispersed in the hydrophobic film layer to form a percolating network, which can provide a conductive path for lithium ions to traverse from one side of the hydrophobic film layer to another. The conductive composite membrane can thus provide a barrier that selectively permits the passage of lithium ions in electrochemical systems via the lithium ion conductive particles. The hydrophobic film layer can provide flexibility and moldability to a composite.

In some aspects, provided herein is a system for extracting lithium from brine using a conductive composite membrane. FIG. 8B shows a system for extracting lithium from brine using a conductive composite membrane, in accordance with some embodiments. The conductive composite membrane can be provided in a chamber with brine. The system can comprise an electrode or a current collector 104. The system can comprise a layer 105 between the conductive composite membrane and the electrode or the current collector. The layer can comprise a porous filter, or a portion of the conductive composite membrane 101, or both. The layer can comprise a non-aqueous electrolyte. For example, the layer can comprise a liquid organic electrolyte, a polymer electrolyte, or an organic lithium salt. The system can comprise a chamber 106 comprising brine 107. The brine can be, for example, brine sourced from a geological deposit or seawater. The brine can be provided in raw form, or after having been enriched for lithium or depleted of certain impurities, e.g., sodium or calcium. The system can comprise a counter electrode 108 that can form an electrochemical circuit 109 with the electrode or current collector. The electrochemical circuit can comprise a power source 110 that can apply an electric potential to polarize the counter electrode with a positive electric potential and the electrode or current collector with a negative electric potential. Upon application of the electric potential, lithium ions in the brine can form a current (Arrows), in response to an electric field created by the polarization, that traverses through the one or more lithium ion conductive particles of the conductive composite membrane. Meanwhile, other ions in the brine, which can be considered as impurities, can be substantially prevented or inhibited from forming a part of the current that traverses through the one or more lithium ion conductive particles to come into contact with the electrode or current collector. When the lithium ions contact or come into proximity with the electrode or current collector, lithium ions can be reduced to lithium metal. The conductive composite membrane can be substantially impermeable to water when the system for lithium extraction is in operation, and also when the system is not in operation. The conductive composite membrane can be used for extracting lithium more than once. The deposition of lithium at the electrode or current collector can be substantially free of side reactions caused by water. The deposition of lithium at the electrode or current collector can be substantially free of side reactions caused by other impurities, as the conductive composite membrane can selectively permit the passage of lithium ions. Other impurities that are present in the brine can comprise oxygen, an alkali metal ion, an alkali earth metal ion, sodium salt, magnesium salt, calcium salt, or any combination thereof.

In some embodiments, the conductive composite membrane is substantially impermeable to water while electroplating lithium with a thickness of 10 to 50 μm. In some embodiments, the conductive composite membrane can be used at least 100 times in the system for lithium extraction. In some embodiments, the conductive composite membrane is substantially impermeable to water while electroplating lithium with a thickness of 10 to 50 μm at least 100 times in the system for lithium extraction. In some embodiments, the conductive composite membrane is substantially impermeable to water while electroplating lithium with a thickness of at least 10, 20, 30, 40, or 50 μm; a thickness of at most 10, 20, 30, 40, or 50 μm; at least 100, 200, 300, 400, or 500 times; and/or at most 100, 200, 300, 400, or 500 times.

The electroplating can be performed using an applied potential of at least 3, 4, 5, 6, 7, or 8 V. The electroplating can be performed using an applied potential of at most 3, 4, 5, 6, 7, or 8 V. The electroplating can be performed using a current density of at least 0.1, 1, 2, 3, 4, 5, 6, 7, 8, 9, 10, 20, 30, 40, or 50 mA/cm². The electroplating can be performed using a current density of at most 1, 2, 3, 4, 5, 6, 7, 8, 9, 10, 20, 30, 40, or 50 mA/cm². The electroplating can be performed at a temperature between about room temperature and the boiling temperature of the brine, about 100 degrees Celsius. The temperature can be at least 15, 20, 25, 30, 40, 50, 60, 70, 80, 90, or 100° C. The temperature can be at most 25, 30, 40, 50, 60, 70, 80, 90, or 100° C. Lower temperatures can be associated with fewer occurrences of side reactions, such as the decomposition of electrolyte, solid electrolyte interphase formation, or both. Higher temperatures can increase the conductivity of lithium, may smoothen the lithium metal surface, or both. Temperatures higher than 100° C. can also be used with high-pressures.

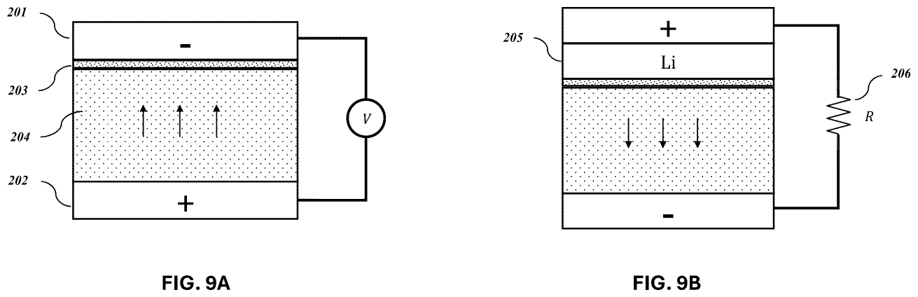

Also provided herein is a rechargeable energy source system comprising a conductive composite membrane. A conductive composite membrane of the present disclosure can be useful for depositing high purity lithium. FIGS. 9A-9B show a rechargeable energy source system comprising a conductive composite membrane, in accordance with some embodiments. An advantage of using the conductive composite membrane in a rechargeable energy source system is that the electrode or current collector can be substantially prevented or inhibited from contacting and reacting with non-lithium components (e.g., any organic electrolytes, water, and oxygen) in the rechargeable energy source system, whether the rechargeable energy source system is in operation or not. Reaction of non-lithium components can lead to the loss of active lithium metal, evolution of gaseous species, deterioration/decomposition of electrodes or electrolytes, or any combination thereof. In some embodiments, the release of gaseous species can compromise the safety of the rechargeable energy source system. The rechargeable energy source system can comprise a negative electrode 201 and a positive electrode 202. The rechargeable energy source system can comprise the conductive composite membrane 203 proximal to the negative electrode. The conductive composite membrane can comprise another lithium ion conductive layer between the membrane and the current collector or lithium metal. The rechargeable energy source system can comprise an electrolyte 204 comprising lithium ions. The electrolyte can comprise an aqueous electrolyte or a non-aqueous electrolyte. When the rechargeable energy source system is fully discharged, the conductive composite membrane can be adjacent to or in contact with the negative electrode. The rechargeable energy source system, when in a discharged state, can be charged by the application of an electric potential. As shown in FIG. 9A, the negative electrode can be negatively polarized and the positive electrode can be positively polarized, which creates an electric field between the negative electrode and the positive electrode. Upon application of the electric potential, lithium ions in the electrolyte can form a current (Arrows), in response to the electric field created by the polarization, that traverses through the one or more lithium ion conductive particles of the conductive composite membrane. Meanwhile, other components in the electrolyte, such as organic components or water, can be substantially prevented or inhibited from traversing through the one or more lithium ion conductive particles to come into contact with the negative electrode. When the lithium ions contact or come into proximity with the negative electrode, lithium ions can be reduced to lithium metal 205. The lithium metal, when the rechargeable energy source system is fully charged, can comprise a thickness of at least 1, 2, 3, 4, 5, 6, 7, 8, 9, 10, 15, 20, 25, 30, 35, 40, 45, or 50 μm. The lithium metal, when the rechargeable energy source system is fully charged, can comprise a thickness of at most 1, 2, 3, 4, 5, 6, 7, 8, 9, 10, 15, 20, 25, 30, 35, 40, 45, or 50 μm. The rechargeable energy source system, when in a charged stated as shown in FIG. 9B, can be discharged by providing a load 206 that completes an electrochemical circuit. The electrochemical potential difference between the negative electrode and the positive electrode provides an electrical current through the load, and an ionic current (Arrows) through the electrolyte. Lithium from the negative electrode can be oxidized to lithium ions, which can traverse through the conductive composite membrane, and enter the electrolyte. In some embodiments, the conductive composite membrane can selectively conduct lithium for at least 100 charge-discharge cycles. The charging can be performed using an applied potential of at least 3 V. The charging or discharging can be performed using a current density of at least 0.1 mA/cm².

In some embodiments, the polymer of the conductive composite membrane does not conduct lithium ions. In some embodiments, the polymer comprises a hydrophobic polymer. The hydrophobic polymer can comprise, e.g., a cyclic olefin copolymer, fluorinated ethylene propylene, ethylene-methyl acrylate copolymer, perfluoroalkoxy polymer, polymethylpentene, polypropylene, polyphenylene sulfide, polystyrene, polytetrafluoroethylene, polyvinylchloride, polyethylene, ethylene vinyl acetate, poly(chlorotrifluoroethylene), polyester, parylene, polycarbonate, polybutadiene or any combination thereof. In some embodiments, the polymer comprises a cyclic olefin copolymer (COC) with a heat deflection temperature of 75° C. In some embodiments, the polymer can comprise an olefin polymer. In some embodiments, the polymer can comprise a non-olefin polymer. In some embodiments, the polymer can comprise a cyclic polymer. In some embodiments, the polymer can comprise an acrylic polymer. In some embodiments, the polymer can comprise a copolymer. In some embodiments, the polymer can comprise an amorphous domain. In some embodiments, the polymer can comprise a crystalline domain. In some embodiments, the polymer can comprise a cyclic olefin copolymer. The cyclic olefin copolymer can comprise an amorphous polymer produced by, e.g., copolymerization of cyclic monomers with ethylene. Some examples of cyclic monomers comprise 8,9,10-trinorborn-2-ene (norbornene) and 1,2,3,4,4a,5,8,8a-octahydro-1,4:5,8-dimethanonaphthalene (tetracyclododecene). In some embodiments, the cyclic olefin copolymer comprises TOPAS® Advanced Polymers' TOPAS, or Mitsui Chemical's APEL®. In some embodiments, hydrophobic alkyl or fluoroalkyl chains may be grafted onto the surface of the polymer matrix to increase it hydrophobicity. In some embodiments, the hydrophobic alkyl or fluoroalkyl chains grafted to the polymer matrix may enhance water blocking capability of the polymer.

In some embodiments, the conductive composite membrane can comprise low water permeability and low pore volumes. Water permeability of the conductive composite membrane can be measured by various techniques. One technique is Near-Infrared (NIR) spectroscopy. In some embodiments, a NIR measurement can report a water permeability of the conductive composite membrane of less than 1.0 nL/cm²/min under 1 mA/cm². In some embodiments, a NIR measurement can report a water permeability of the conductive composite membrane of less than 10, 9, 8, 7, 6, 5, 4, 3, 2, 1, 0.9, 0.8, 0.7, 0.6, 0.5, 0.4, 0.3, 0.2, or 0. nL/cm²/min under a current density of 10, 9, 8, 7, 6, 5, 4, 3, 2, 1, 0.9, 0.8, 0.7, 0.6, 0.5, 0.4, 0.3, 0.2, or 0.1 mA/cm². In some embodiments, a NIR measurement can report a water permeability of the conductive composite membrane as greater than 1.0 nL/cm²/min under 1 mA/cm². In some embodiments, a NIR measurement can report a water permeability of the conductive composite membrane as greater than 10, 9, 8, 7, 6, 5, 4, 3, 2, 1, 0.9, 0.8, 0.7, 0.6, 0.5, 0.4, 0.3, 0.2, or 0.1 nL/cm²/min under a current density of 10, 9, 8, 7, 6, 5, 4, 3, 2, 1, 0.9, 0.8, 0.7, 0.6, 0.5, 0.4, 0.3, 0.2, or 0.1 mA/cm². In some embodiments, the composite membrane has a water permeability of less than 10⁻¹⁰ m² s⁻¹ Pa⁻¹, 10⁻¹⁵ m² s⁻¹ Pa⁻¹, 10⁻¹⁸ m² s⁻¹ Pa⁻¹, or 10⁻²¹ m² s⁻¹ Pa⁻¹ under 1 mA/cm² of the current density as measured at least in part by Near-Infrared (NIR) spectroscopy. In some embodiments, the composite membrane has a water permeability of less than 10⁻²¹ m² s⁻¹ Pa⁻¹ under 1 mA/cm² of the current density as measured at least in part by Near-Infrared (NIR) spectroscopy. Pore volume of the conductive composite membrane can be measured by various techniques. One technique for measuring pore volume is gas pycnometry. In some embodiments, the conductive composite membrane comprises less than 30% pores by volume. In some embodiments, the conductive composite membrane comprises greater than 30% pores by volume. In some embodiments, the conductive composite membrane comprises less than 50, 40, 30, 20, 10, 9, 8, 7, 6, 5, 4, 3, 2, 1% pores by volume. In some embodiments, the conductive composite membrane comprises greater than 50, 40, 30, 20, 10, 9, 8, 7, 6, 5, 4, 3, 2, 1% pores by volume.

The conductive composite membrane can comprise various values of Li⁺ conductivity. The conductivity can depend on various fabrication parameters, such as the choice of materials, particle density, and other parameters detailed herein. The conductivity can also depend on temperature, as the conductivity usually varies with temperature (e.g., which may be approximated by the Arrhenius relation). The conductivity of the conductive composite membrane can be increased by fabricating it with using polymers that have high decomposition temperatures, which can accordingly be used at high temperatures to conduct lithium ions. In some embodiments, the conductive composite membrane comprises a Li⁺ conductivity of at least 10⁻⁷, 10⁻⁶, 10⁻⁵, 10⁻⁵, 10⁻⁴, 10⁻³, or 10⁻² S/cm. In some embodiments, the conductive composite membrane comprises a Li⁺ conductivity of at most 10⁻⁷, 10⁻⁶, 10⁻⁵, 10⁻⁵, 10⁻⁴, 10⁻³, or 10⁻² S/cm. In some embodiments, the conductive composite membrane comprises a Li⁺ conductivity of at least 1.0×10⁻⁵ S/cm. In some embodiments, the conductive composite membrane comprises a Li⁺ conductivity of at most 1.0×10⁻⁵ S/cm. In some embodiments, the conductive composite membrane comprises a Li⁺ conductivity of at least 0.1, 0.2, 0.3, 0.4, 0.5, 0.6, 0.7, 0.8, 0.9, 1, 2, 3, 4, 5, 6, 7, 8, or 9×10⁻⁵ S/cm. In some embodiments, the conductive composite membrane comprises a Li⁺ conductivity of at least 0.1, 0.2, 0.3, 0.4, 0.5, 0.6, 0.7, 0.8, 0.9, 1, 2, 3, 4, 5, 6, 7, 8, or 9×10⁻⁴ S/cm. In some embodiments, the conductive composite membrane comprises a Li⁺ conductivity of at least 0.1, 0.2, 0.3, 0.4, 0.5, 0.6, 0.7, 0.8, 0.9, 1, 2, 3, 4, 5, 6, 7, 8, or 9×10⁻³ S/cm. In some embodiments, the conductive composite membrane comprises a Li⁺ conductivity of at least 0.1, 0.2, 0.3, 0.4, 0.5, 0.6, 0.7, 0.8, 0.9, 1, 2, 3, 4, 5, 6, 7, 8, or 9×10⁻² S/cm. In some embodiments, the conductive composite membrane comprises a Li⁺ conductivity of at most 0.1, 0.2, 0.3, 0.4, 0.5, 0.6, 0.7, 0.8, 0.9, 1, 2, 3, 4, 5, 6, 7, 8, or 9×10⁻⁵ S/cm. In some embodiments, the conductive composite membrane comprises a Li⁺ conductivity of at most 0.1, 0.2, 0.3, 0.4, 0.5, 0.6, 0.7, 0.8, 0.9, 1, 2, 3, 4, 5, 6, 7, 8, or 9×10⁻⁴ S/cm. In some embodiments, the conductive composite membrane comprises a Li⁺ conductivity of at most 0.1, 0.2, 0.3, 0.4, 0.5, 0.6, 0.7, 0.8, 0.9, 1, 2, 3, 4, 5, 6, 7, 8, or 9×10⁻³ S/cm. In some embodiments, the conductive composite membrane comprises a Li⁺ conductivity of at most 0.1, 0.2, 0.3, 0.4, 0.5, 0.6, 0.7, 0.8, 0.9, 1, 2, 3, 4, 5, 6, 7, 8, or 9×10⁻² S/cm. In some embodiments, the conductive composite membrane comprises a Li⁺ conductivity from 10⁻⁴ to 10⁻² S/cm. In some embodiments, the conductive composite membrane comprises an activation energy for lithium conductivity of about 0.2 to 0.8 eV. In some embodiments, the conductive composite membrane comprises an activation energy for lithium conductivity that is at least 0.2, 0.3, 0.4, 0.5, 0.6, 0.7, or 0.8 eV. In some embodiments, the conductive composite membrane comprises an activation energy for lithium conductivity that is at most 0.2, 0.3, 0.4, 0.5, 0.6, 0.7, or 0.8 eV. The activation energy can be obtained, e.g., by measuring the lithium conductivity at various temperatures and fitting the measured conductivities to the Arrhenius equation. The slope of the logarithm of conductivity as a function of the inverse temperature can lead to the activation energy.

The conductive composite membrane can comprise mechanical properties that permit scalability and application in industrial settings. In some embodiments, the conductive composite membrane can comprise a curved form factor. For example, the conductive composite membrane can be formed into various shapes, including bended shapes. The conductive composite membrane can be rolled, folded, or etc. In some embodiments, the conductive composite membrane comprises a Young's modulus of less than 10 GPa. In some embodiments, the conductive composite membrane comprises a Young's modulus of less than 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, or 100 GPa. In some embodiments, the conductive composite membrane comprises a Young's modulus of greater than 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, or 100 GPa. In some embodiments, the conductive composite membrane is bendable to a radius of curvature of at least 1 mm without substantially affecting a water impermeability and/or the Lit conductivity of the conductive composite membrane. In some embodiments, the conductive composite membrane is bendable to a radius of curvature of at least 0.1, 0.2, 0.3, 0.4, 0.5, 0.6, 0.7, 0.8, 0.9, 1, 2, 3, 4, 5, 6, 7, 8, 9, or 10 mm without substantially affecting a water impermeability and/or the Li⁺ conductivity of the conductive composite membrane. In some embodiments, the conductive composite membrane is bendable to a radius of curvature of at most 0.1, 0.2, 0.3, 0.4, 0.5, 0.6, 0.7, 0.8, 0.9, 1, 2, 3, 4, 5, 6, 7, 8, 9, or 10 mm without substantially affecting a water impermeability and/or the Lit conductivity of the conductive composite membrane.

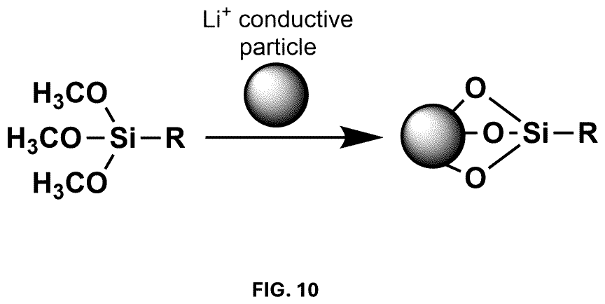

In some embodiments, the one or more lithium ion conductive particles can be functionalized with one or more molecules to improve adhesion and/or dispersion in the conductive composite membrane. The one or more molecules can improve adhesion and/or dispersion at by reducing the occurrence of defects at interfaces between the one or more lithium ion conductive particles and the polymer. The defects can be reduced by strengthening the interaction between the one or more lithium ion conductive particles and the polymer. As shown in FIG. 10, adhesion can be strengthened by hydrophobically modifying a surface of a lithium ion conductive particle. The hydrophobic modification can be performed by, e.g., incubating the lithium ion conductive particle in a solution with a hydrophobically derivatized silane. In the example shown in FIG. 10, the lithium ion conductive particle comprises lithium ion conductive glass ceramic (LICGC), the hydrophobically derivatized silane comprises alkyl chain, and the incubation is performed overnight in an organic. Various other hydrophobically derivatized silanes and other reaction conditions can also be used to improve the adhesion. Various other lithium ion conductive particles can be functionalized.

The one or more lithium ion conductive particles can be functionalized prior to processing with the polymer or the monomers that form the polymer. In some embodiments, the surfaces of the one or more lithium ion conductive particles can be modified with a reactive group, e.g., a trimethoxy (octadecyl) silane group. The reactive group can then be chemically reacted, in the presence of inorganic materials, to cover the surfaces with one or more adhesive molecules, e.g., alkyl chains. In some embodiments, alkyl chains can provide good compatibility with the base polymer matrix (which can be provided as a film), which can be a cyclic olefin copolymer, which can increase adhesion between the one or more lithium ion conductive particles and the polymer matrix. Various adhesive molecules can be used for various polymer matrices—the adhesive molecules and the polymer matrix can be selected together to provide adhesion between the one or more lithium ion conductive particles and the polymer matrix. For example, some polymer matrices may provide chemically reactive groups, e.g., NH, CO or CN groups. When the polymer matrix comprises chemically reactive groups, the adhesive molecules can be selected that react with the chemically reactive groups to form chemical bonds with the polymer. In some embodiments, the one or more lithium ion conductive particles comprises an adhesive configured to adhere or bind to a hydrophobic polymer matrix.

In some embodiments, at least one side of the conductive composite membrane can further comprise a lithium conductive polymer. The lithium conductive polymer can be in contact with or be adhered to the conductive composite membrane. The lithium conductive polymer can provide a substantially inert surface in contact with lithium metal, while also providing a medium for lithium ions to conduct through. The lithium conductive polymer can increase uniformity of current distribution for lithium deposition. In some embodiments, the lithium conductive polymer is substantially unreactive with the lithium metal.

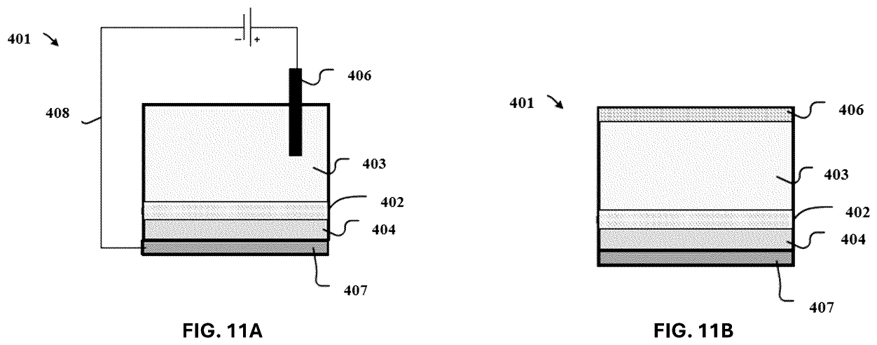

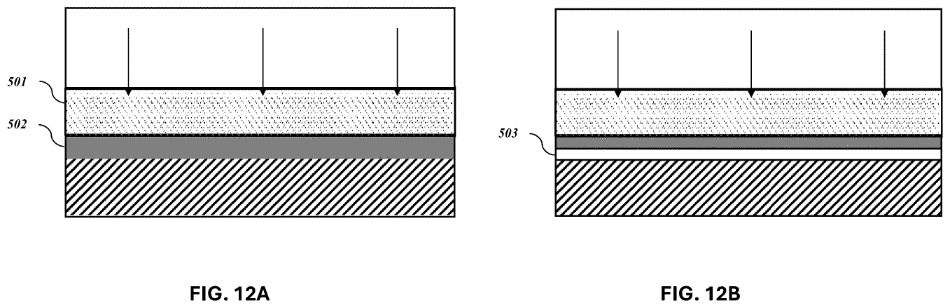

The lithium conductive polymer can be an elastic or a flexible polymer. The growing thickness of the lithium while charging or electrodepositing can be accommodated by an elastic and flexible membrane, which is illustrated in FIGS. 11A-11B. As shown in FIGS. 11A-11B, the lithium conductive polymer 402 can compress in response to a growing thickness of the lithium metal deposit 404. The lithium conductive polymer can be squeezed out to the side. In some embodiments, the expansion of the lithium metal can be accommodated additional by a mechanism, such as a spring in a battery cell. An elastic or flexible lithium conductive polymer which accommodates expansion of lithium metal can improve good contact between lithium and the conductive composite membrane, can provide mechanical support which can suppress dendrite formation on lithium metal, and can homogenize Li⁺ flux toward the lithium metal to plate Li uniformly. In some embodiments, the lithium conductive polymer is a compressible polymer. In some embodiments, the lithium conductive polymer is configured to accommodate for volume changes, which can be created by electrodepositing lithium adjacent to the lithium conductive polymer.

In some embodiments, the lithium conductive polymer comprises a copolymer. In some embodiments, the lithium conductive polymer comprises a block copolymer. In some embodiments, the lithium conductive polymer comprises a random copolymer, diblock copolymer, a triblock copolymer, a triblock terpolymer, a multiblock copolymer, grafted copolymer, or any combination thereof. In some embodiments, the lithium conductive polymer comprises a grafted random copolymer.

In some embodiments, a portion of the copolymer is in contact with lithium metal, wherein the portion is substantially unreactive with the lithium metal. A copolymer can, for example, be annealed to undergo microphase separation, providing an exposed hydrophobic surface that is substantially unreactive with lithium metal. Meanwhile, the copolymer can further comprise a percolating hydrophilic domain that provides paths for lithium ions to traverse through from one side of the copolymer to the other. In some embodiments, the copolymer can comprise poly(polydimethylsiloxane methacrylate)-b-poly(oligo (ethylene glycol) methacrylate) (PPDMSM-b-POEM). In some embodiments, the copolymer can comprise poly(lauryl methacrylate)-b-POEM, or both.

The lithium conductive polymer can comprise a glass transition temperature lower than operating temperatures. The lithium conductive polymer can comprise one domain comprising a glass transition temperature lower than operating temperatures, and another domain comprising a glass transition temperature higher than operating temperatures. The lithium conductive polymer can comprise two or more domains each comprising a glass transition temperature lower than operating temperatures.

The copolymer can comprise a combination of a low-T_{g} hydrophobic polymer (lower than operating temperatures), high-T_{g} hydrophobic polymer, and a low-T_{g} lithium-ion conductive polymer. A low-T_{g} hydrophobic polymer can comprise poly(butyl acrylate) (PBA), poly(butyl methacrylate) (PBMA), poly(lauryl methacrylate) (PLMA), poly(ethylene) (PE), poly(ethylene-alt-propylene) (PEP), poly(urethane) (PU), poly(butadiene) (PB), poly(polyvinylidene methacrylate) (PPVDFMA), poly(perfluoropolyether) (PFPE), poly(perfluoropolyether methacrylate) (PFPEMA), poly(perfluoropolyether acrylate) (PFPEA), or any combination thereof. A high-T_{g} hydrophobic polymer can comprise poly(polytetrafluoroethylene methacrylate) (PPTFEMA), poly(styrene) (PS), poly(methyl methacrylate) (PMMA), polynorbornene (PN), poly(ether ether ketone (PEEK) or any combination thereof. In some embodiments, a low-T_{g} lithium-ion conductive polymer can comprise poly(poly(ethylene glycol) methacrylate) (PPEGMA), poly(poly(ethylene glycol) acrylate) (PPEGA), poly(perfluoropolyether methacrylate) (PFPEMA), poly(perfluoropolyether acrylate) (PFPEA), poly(fluorinated 1,6-dimethoxyhexane) (PFDMH) or any combination thereof.

In some embodiments, the copolymer can comprise a combination of a low-T_{g} (lower than operating temperatures) hydrophobic polymer, and a high-T_{g} lithium-ion conductive polymer. The high-T_{g} hydrophobic polymer can form glassy, hard, and hydrophobic polymer domains in a copolymer. The mechanical strength imparted by the high-T_{g} polymer domains can allow designs which decrease the volume fraction of the hydrophobic domains, leading to higher conductivity of the copolymer while maintaining the mechanical stability of the copolymer.

In some embodiments, the lithium-ion conductive polymer can comprise a high-T_{g} lithium-ion conductive polymer. For example, the high-T_{g} lithium-ion conductive polymer can comprise a superionic glass-type Li⁺ conductor.

In some embodiments, the lithium conductive polymer comprises a glass transition above about room temperature, or above operating temperatures. In some embodiments, the lithium conductive polymer comprises a glass transition temperature lower than about room temperature, or operating temperatures. When the lithium conductive polymer is used below the glass transition temperature, thermal energy can be insufficient to permit large-scale conformational changes in the material (e.g., rearrangement of polymer chains), which can substantially prevent or inhibit large-scale deformations (e.g., melting of the polymer membrane), which can aid in maintaining the mechanical integrity of the polymer membrane. In some cases, the lithium conductive polymer be substantially prevented or inhibited from large-scale deformations when the lithium conductive polymer comprises crosslinks. Crosslinks can be chemical bonds (e.g., C—C bonds, CO—NH bonds, etc.), or physical bonds (e.g., hydrogen bonds, hydrophobic interactions, pi-pi stacking, entanglement, etc.). For example, the lithium conductive polymer can be a copolymer (random, block, graft, etc.) comprising appropriate functional groups that form cross links. PPDMSM-r-POEM, for example, can exhibit rubbery properties with G′ greater than G″, while being conductive to lithium ions. Both PDMSM and POEM can have low Tg, the PPDMSM can create a cross-linked structure via hydrophobic interactions. Furthermore, the polymer topology can be designed such that it provides a large number of physical entanglement of the polymer chains which also can act as a form of physical bonding. The glass transition temperature can be the glass transition temperature of the polymer matrix constituting the lithium conductive polymer. When a copolymer constitutes the lithium conductive polymer and creates microphase separated domains, then the glass transition temperature can be the highest glass transition temperature among two or more domains in the lithium conductive polymer.

In some embodiments, the lithium conductive polymer comprises mechanically rigid domains. The mechanically rigid domains can comprise a glass transition temperature greater than 20° C. In some embodiments, the mechanically rigid domains comprise a glass transition temperature greater than 20, 30, 40, 50, 60, 70, 80, 90, 100, 150, 200, 250, or 300° C. In some embodiments, the mechanically rigid domains comprise a glass transition temperature less than 30, 40, 50, 60, 70, 80, 90, 100, 150, 200, 250, or 300° C. In some embodiments, the lithium conductive polymer comprises a heat deflection temperature greater than 20, 30, 40, 50, 60, 70, 80, 90, 100, 150, 200, 250, or 300° C. In some embodiments, the lithium conductive polymer comprises a heat deflection temperature less than 30, 40, 50, 60, 70, 80, 90, 100, 150, 200, 250, or 300° C. The “heat deflection temperature” of a polymer can refer to the temperature at which a sample of the polymer deforms to a specific degree under a specified load. It can be determined by the test procedure outlined in, e.g., ASTM D648.

The lithium conductive polymer can comprise lithium conducting domains which comprise a glass transition below about room temperature, or below operating temperatures. When the lithium conductive polymer is used above the glass transition temperature of the lithium conducting domains, thermal energy can be sufficient to permit rearrangement of polymer molecules in the lithium conducting domains, which can permit lithium ions more easily traverse through the lithium conducting domains to provide high lithium conductivities. In some embodiments, ion conductive domains of the lithium conductive polymer comprise a glass transition temperature of less than 20° C. In some embodiments, ion conductive domains of the lithium conductive polymer comprise a glass transition temperature of less than −100, −90, −80, −70, −60, −50, −40, −30, −20, −10, 0, 10, or 20° C. In some embodiments, ion conductive domains of the lithium conductive polymer comprise a glass transition temperature of greater than −100, −90, −80, −70, −60, −50, −40, −30, −20, −10, 0, or 10° C. In some embodiments, ion conductive domains of the lithium conductive polymer comprise a heat deflection temperature greater than −100, −90, −80, −70, −60, −50, −40, −30, −20, −10, 0, 10, or 20° C. In some embodiments, ion conductive domains of the lithium conductive polymer comprise a heat deflection temperature less than −100, −90, −80, −70, −60, −50, −40, −30, −20, −10, 0, or 10° C. For example, PDMS can comprise a glass transition temperature of about −150° C., PLMA can comprise a glass transition temperature of about −66.3° C., and PBA can comprise a glass transition temperature of about −43° C.

The lithium conductive polymer can provide dimensional stability at and above operating temperatures. The lithium conductive polymer can comprise an apparent melting temperature, which can be defined as the temperature when tan δ=1 at ω=1 rad/s of angular frequency as measured through a rheological experiment. The tangent of the phase angle (tan δ=1) can be obtained by dividing the loss modulus (G′) by the storage modulus (G″). When tan δ>1, the lithium conductive polymer can be considered to be above the apparent melting temperature.

In some embodiments, the lithium conductive polymer can be a cross-linked elastomer. A cross-linked elastomer can comprise physical crosslinks, chemical crosslinks, or both. The tan δ of a cross-linked elastomer may be less than 1, unless e.g., the elastomer is decomposed by heat.

In some embodiments, the conductive composite membrane comprises a thermoplastic polymer or a thermoset polymer.

In some embodiments, the conductive composite membrane is substantially impermeable to water while electroplating lithium with a thickness of 10 to 50 μm. In some embodiments, the conductive composite membrane can be used at least 100 times in the system for lithium extraction. In some embodiments, the conductive composite membrane is substantially impermeable to water while electroplating lithium with a thickness of 10 to 50 μm at least 100 times in the system for lithium extraction. In some embodiments, the conductive composite membrane is substantially impermeable to water while electroplating lithium with a thickness of at least 10, 20, 30, 40, or 50 μm; with a thickness at most 10, 20, 30, 40, or 50 μm; at least 100, 200, 300, 400, 500 times; and/or at most 100, 200, 300, 400 or 500 times. The lithium electrodeposition can be performed using an applied potential of at least 3, 4, 5, 6, 7, 8, 9, or 10 V. The lithium electrodeposition can be performed using an applied potential of at least 3.05 V. The electrodeposition can be performed using an applied potential of at most 3, 4, 5, 6, 7, 8, 9, or 10 V. The lithium electrodeposition can be performed using a current density of at least 1 mA/cm². The lithium electrodeposition can be performed using a current density of at least 0.1, 0.2, 0.3, 0.4, 0.5, 0.6, 0.7, 0.8, 0.9, 1, 2, 3, 4, 5, 6, 7, 8, 9, or 10 mA/cm². The lithium electrodeposition can be performed using a current density of at most 0.1, 0.2, 0.3, 0.4, 0.5, 0.6, 0.7, 0.8, 0.9, 1, 2, 3, 4, 5, 6, 7, 8, 9, or 10 mA/cm².

In some embodiments, the conductive composite membrane is impermeable to liquid water and to water vapor for a period of time greater than 1, 2, 3, 4, 5, 6, 7, 8, 9, 10, 11, 12, or 24 hours when immersed in water. In some embodiments, the conductive composite membrane is impermeable to liquid water and to water vapor for a period of time greater than 1, 2, 3, 4, 5, 6, or 7 days when immersed in water. In some embodiments, the conductive composite membrane is impermeable to liquid water and to water vapor for a period of time greater than 2 or 3 weeks when immersed in water. In some embodiments, the conductive composite membrane is impermeable to liquid water and to water vapor for a period of time less than 1, 2, 3, 4, 5, 6, 7, 8, 9, 10, 11, 12, or 24 hours when immersed in water. In some embodiments, the conductive composite membrane is impermeable to liquid water and to water vapor for a period of time less than 1, 2, 3, 4, 5, 6, or 7 days when immersed in water. In some embodiments, the conductive composite membrane is impermeable to liquid water and to water vapor for a period of time less than 2 or 3 weeks when immersed in water.

In some embodiments, the conductive composite membrane is impermeable to liquid water and to water vapor for a period of time greater than 1, 2, 3, 4, 5, 6, 7, 8, 9, 10, 11, 12, or 24 hours when used to extract lithium from brine-under an applied voltage/current of at least 3.1 V or at least 1 mA/cm². In some embodiments, the conductive composite membrane is impermeable to liquid water and to water vapor for a period of time greater than 1, 2, 3, 4, 5, 6, or 7 days when used to extract lithium brine under an applied voltage/current of at least 3.1 V or at least 1 mA/cm². In some embodiments, the conductive composite membrane is impermeable to liquid water and to water vapor for a period of time greater than 2 or 3 weeks when used to extract lithium brine under an applied voltage/current of at least 3.1 V or at least 1 mA/cm². In some embodiments, the conductive composite membrane is impermeable to liquid water and to water vapor for a period of time less than 1, 2, 3, 4, 5, 6, 7, 8, 9, 10, 11, 12, or 24 hours when used to extract lithium from brine-under an applied voltage/current of at least 3.1 V or at least 1 mA/cm². In some embodiments, the conductive composite membrane is impermeable to liquid water and to water vapor for a period of time less than 1, 2, 3, 4, 5, 6, or 7 days when used to extract lithium brine under an applied voltage/current of at least 3.1 V or at least 1 mA/cm². In some embodiments, the conductive composite membrane is impermeable to liquid water and to water vapor for a period of time less than 2 or 3 weeks when used to extract lithium brine under an applied voltage/current of at least 3.1 V or at least 1 mA/cm². The applied voltage can be at least 3.1, 3.5, 4, 4.5, 5, 6, 7, 8, 9, or 10 Volts. The applied voltage can be at most 3.5, 4, 4.5, 5, 6, 7, 8, 9, or 10 Volts. The applied current can be at least 1, 2, 3, 4, 5, 6, 7, 8, 9, or 10 mA/cm². The applied current can be at most 1, 2, 3, 4, 5, 6, 7, 8, 9, or 10 mA/cm².

In some embodiments, the conductive composite membrane is substantially impermeable to water over at least 100, 200, 300, 400, 500, 600, 700, 800, 900, or 1000 charge-discharge cycles for a rechargeable energy source system. In some embodiments, the conductive composite membrane is substantially impermeable to water over at most 100, 200, 300, 400, 500, 600, 700, 800, 900, or 1000 charge-discharge cycles for a rechargeable energy source system. The charge or discharge cycles can be performed using an applied potential of at least 1, 2, 3, 4, 5, 6, 7, 8, 9, or 10 V. The charge or discharge cycles can be performed using an applied potential of at most 1, 2, 3, 4, 5, 6, 7, 8, 9, or 10 V. The charge or discharge cycles can be performed using a current density of at least 1 mA/cm². The charge or discharge cycles can be performed using a current density of at least 0.1, 0.2, 0.3, 0.4, 0.5, 0.6, 0.7, 0.8, 0.9, 1, 2, 3, 4, 5, 6, 7, 8, 9, or 10 mA/cm². The charge or discharge cycles can be performed using a current density of at most 0.1, 0.2, 0.3, 0.4, 0.5, 0.6, 0.7, 0.8, 0.9, 1, 2, 3, 4, 5, 6, 7, 8, 9, or 10 mA/cm².

### Ion Conductive Particles

In some embodiments, the one or more lithium ion conducting particles selectively conduct lithium ions. In some embodiments, the one or more lithium ion conducting particles do not conduct non-lithium ions. In some embodiments, the non-lithium ion can be an alkali metal, an alkaline earth metal, a transition metal, a post-transition metal, or a metalloid. In some embodiments, the non-lithium ion can be sodium, potassium, rubidium, cesium, francium, beryllium, magnesium, calcium, strontium, barium, or radium. In some embodiments, a transference number of lithium ions in the one or more lithium ion conducting particles is between 0.9 and 1. In some embodiments, a transference number of lithium ions in the one or more lithium ion conducting particles is at least 0.5, 0.6, 0.7, 0.8, 0.9, 0.91, 0.92, 0.93, 0.94, 0.95, 0.96, 0.97, 0.98, 0.99, 0.995, 0.999, 0.9995, or 0.9999. In some embodiments, a transference number of lithium ions in the one or more lithium ion conducting particles is at most 0.5, 0.6, 0.7, 0.8, 0.9, 0.91, 0.92, 0.93, 0.94, 0.95, 0.96, 0.97, 0.98, 0.99, 0.995, 0.999, 0.9995, or 0.9999. In some embodiments, a transference number of lithium ions in the one or more lithium ion conducting particles is about 1. In some embodiments, a transference number of the non-lithium ions in the one or more lithium ion conducting particles is between 0 and 0.1. In some embodiments, a transference number of the non-lithium ions in the one or more lithium ion conducting particles is at most 0.5, 0.4, 0.3, 0.2, 0.1, 0.09, 0.08, 0.07, 0.06, 0.05, 0.04, 0.03, 0.02, 0.01, 0.005, 0.001, 0.0005, or 0.0001. In some embodiments, a transference number of the non-lithium ions in the one or more lithium ion conducting particles is at least 0.5, 0.4, 0.3, 0.2, 0.1, 0.09, 0.08, 0.07, 0.06, 0.05, 0.04, 0.03, 0.02, 0.01, 0.005, 0.001, 0.0005, or 0.0001. In some embodiments, a transference number of the non-lithium ions in the one or more lithium ion conducting particles is about 0.

In some embodiments, the one or more lithium ion conductive particles comprises a ceramic material. In some embodiments, the ceramic material comprises lithium ion conductive glass ceramic (LICGC), lithium aluminum titanium phosphate (LATP), lithium lanthanum zirconium tantalum oxide (LLZTO), LiFePO₄, LiCoO₂, lithium-lanthanum titanates (LLTO), garnet type electrolytes, NASICON, LISICON and Thio-LISICON electrolytes, Li₇LaZr₃O₁₂ (LLZO), cubic phase LLZO, Li₆PS₅Cl, Li₆PS₅Br, Li₆PS₅I, a transition metal oxide, LiFePO₄, LiCoO₂, LiNiO₂, LiMnO₂, layered LiCoO₂ and LiNiO₂ and LiMnO₂, LiV₂O₅, a garnet material, an argyrodite material, an olivine material, or any combination thereof. In some embodiments, the one or more lithium ion conductive particles comprises LATP. Table 2 shows some relevant properties of various lithium ion conductive particles. In some embodiments, higher lithium ion conductivities may be preferred to provide higher conductivity for the conductive composite membrane. In some embodiments, lower thermal expansion coefficient may be preferred to provide better mechanical stability for the conductive composite membrane. Also relevant is the electrochemical stability window, which may be modified by the addition of dopants, to be compatible for the potentials applied during electrodeposition during plating or charging-discharging for rechargeable energy systems. Another consideration is the reactivity of the material to create side reactions with water.

TABLE 2
Physical properties of lithium ion conductive particles.

| | Lithium Ion | Thermal Expansion |
|---|---|---|
| Material | Conductivity (S/cm) | Coefficient (K⁻¹) |
| LICGC | 1 × 10⁻⁴ to 4 × 10⁻⁴ | 30 × 10^{×7} (350° C.) |
| | (20° C.) | 350 × 10^{×7} (600° C.) |
| LATP | 6 × 10⁻⁴ to 8 × 10⁻⁴ | 0.38-31 × 10^{×6} |
| | (20° C.) | (anisotropic; 20° C. to 1200° C.) |
| LLZTO | 2.7 × 10⁻⁴ | — |
| | (25° C.) | |
| LLTO | 9.5 × 10⁻⁴ | 1 × 10^{×5} |
| LLZO (AL- | 5 × 10⁻⁴ | 3.6 × 10^{×5} (30° C.) |
| LLZO/cubic) | (33° C.) | 1.6 × 10^{×5} (500° C.) |
| LiPON | 1 × 10⁻⁸ to 1 × 10⁻⁴ | |
| | (25° C.) | |

The one or more lithium ion conducting particles can comprise various sizes. Smaller particles can reduce the cost of the conductive composite membrane and increase the conductivity.

The diameters of the lithium ion conductive particles can be smaller than a thickness of the polymer layer. The thickness of the polymer layer can be at least 5, 10, 20, 30, 40, 50, 60, 70, 80, 90, or 100 μm. The thickness of the polymer layer can be at most 5, 10, 20, 30, 40, 50, 60, 70, 80, 90, or 100 μm. The average of the diameters of the lithium ion conductive particles can be greater than 0.1, 0.5, 1, 2, 3, 4, 5, 6, 7, 8, 9, 10, 11, 12, 13, 14, or 15 μm. The average of the diameters of the lithium ion conductive particles can be less than 0.1, 0.5, 1, 2, 3, 4, 5, 6, 7, 8, 9, 10, 11, 12, 13, 14, or 15 μm. A ratio of the thickness to an average of the diameters can be at least 2, 3, 4, 5, 6, 7, 8, 9, or 10. A ratio of the thickness to an average of the diameters can be at most 2, 3, 4, 5, 6, 7, 8, 9, or 10.

In some embodiments, the one or more lithium ion conducting particles comprise a size of at least 50 μm. In some embodiments, the one or more lithium ion conducting particles comprise a size of at least 1, 2, 3, 4, 5, 6, 7, 8, 9, 10, 20, 30, 40, 50, 60, 70, 80, 90, 100, 200, 300, 400, or 500 μm. In some embodiments, the one or more lithium ion conducting particles comprise a size of at most 1, 2, 3, 4, 5, 6, 7, 8, 9, 10, 20, 30, 40, 50, 60, 70, 80, 90, 100, 200, 300, 400, or 500 μm. In some embodiments, the one or more lithium ion conductive particles comprise a dispersity of less than 0.4, 0.3, 0.2, 0.1, or 0.05. In some embodiments, the one or more lithium ion conductive particles comprise a dispersity of greater than 0, 0.05, 0.1, 0.2, or 0.3. In some embodiments, the one or more lithium ion conductive particles comprise a dispersity of about 0. The dispersity (D) can be defined as

$$\text{?} = {( \frac{σ}{μ} )}^{2} ,$$

where σ is the standard deviation and μ is the mean of the size of the particles. In some embodiments, the one or more lithium ion conductive particles comprise a size range of about +/−1, 2, 3, 4, 5, 6, 7, 8, 9, 10, 20, 30, 40, or 50 μm for at least 50, 60, 70, 80, 90, or 100% of the particles by number. In some embodiments, the one or more lithium ion conductive particles comprise a size range of about +/−1, 2, 3, 4, 5, 6, 7, 8, 9, 10, 20, 30, 40, or 50 μm for at most 50, 60, 70, 80, 90, or 100% of the particles by number. Dispersity and size range can be measured, e.g., using dynamic light scattering or scanning electron microscopy (SEM).

In some embodiments, the one or more lithium ion conducting particles comprise a hydrophobically modified surface. The hydrophobic modification can comprise alkyl chains, perfluoro chains, fluorinated groups, or any combination thereof. In some embodiments, the one or more lithium ion conducting particles comprise a chemically reactive surface. The chemically reactive surface can comprise OH groups, NH₂ groups, N₃ groups, allyl groups, SH groups, or any combination thereof. Chemically reactive groups can be introduced on the surfaces of the one or more lithium ion conductive particles by, e.g., silane coupling. In some embodiments, the one or more lithium ion conducting particles comprise a hydrophilically modified surface. The hydrophilic modification can comprise, e.g., a OH group or a hydrophilic polymer. The hydrophilic polymer can be grafted onto the surfaces of the one or more lithium ion conducting particles.

### Electrodes

Provided herein are various electrodes or current collectors. As shown in FIG. 8B, an electrode can be used in the system for lithium extraction of brine as the electrode or current collector for depositing lithium 104 (the negative electrode) or the counter electrode or current collector 108 (the positive electrode). As shown in FIGS. 9A-9B, an electrode can be used in a rechargeable energy system as the electrode or current collector 201 or the counter electrode (anode) or current collector 202 (cathode).

In some embodiments, a negative electrode can comprise copper, silicon, silver, carbon, aluminum, gold, or any combination thereof. The carbon can comprise various forms, e.g., a carbon material with roughened surface, graphene, or both. The copper can comprise a copper alloy (e.g., Cu—Zn, Cu—Al, Cu—Sn, or any combination thereof). The negative electrode can comprise one of various lithiophilic metals. The negative electrode can comprise a layer of lithium metal deposited thereon. Lithium metal can be deposited on the negative electrode with a thickness of at least 10 μm. Lithium metal can be deposited on the negative electrode with a thickness of at least 1, 5, 10, 20, 30, 40, 50, 100, 200, 300, 400, 500, 600, 700, 800, 900, or 1000 μm. Lithium metal can be deposited on the negative electrode with a thickness of at most 1, 5, 10, 20, 30, 40, 50, 100, 200, 300, 400, 500, 600, 700, 800, 900, or 1000 μm. Lithium metal can be deposited on the negative electrode with a thickness from 10 to 250 μm.

In some embodiments, a positive electrode can comprise vanadium pentoxide, magnesium oxide, iron phosphate, cobalt phosphate, nickel oxide, lithium phosphate, cobalt oxide, nickel manganese cobalt oxide, nickel cobalt aluminum oxide, iron magnesium phosphate, titanium oxide, or any combination thereof. In some embodiments, an electrode comprises an air electrode. The air electrode can be a porous substrate (e.g., a carbon substrate) configured to allow air flow into the electrode from the environment and oxygen flow out of the electrode into the environment. In some embodiments, the air electrode comprises embedded catalysts for oxygen reduction and oxidation.

### Electrolytes

Provided herein are various electrolytes. As shown in FIG. 8B, an electrolyte can be used in the system for lithium extraction of brine. The electrolyte can comprise the layer, or it can form a component of the layer. For example, the layer can comprise a porous filter or a hydrophobic film layer that is wet with an electrolyte. As shown in FIGS. 9A-9B, an electrolyte can be used in a rechargeable energy system as the electrolyte 204 on the positive electrode side. In some embodiments, the electrolyte may be disposed in a layer 105 between the conductive composite membrane and the electrode or the current collector. In some embodiments, the electrolyte can form a layer of the conductive composite membrane.

In some embodiments, an electrolyte comprises an aqueous electrolyte. In some embodiments, an electrolyte comprises a non-aqueous electrolyte. In some embodiments, an electrolyte comprises a polymer electrolyte. In some embodiments, an electrolyte comprises an organic electrolyte. In some embodiments, an electrolyte comprises a lithium salt. In some embodiments, an electrolyte comprises an ionic liquid. In some embodiments, an electrolyte comprises a deep eutectic solvent.

In some embodiments, an electrolyte comprises a decomposition potential of at least 2, 3, 4, 5, 6, 7, 8, 9, or 10 V. In some embodiments, an electrolyte comprises a decomposition potential of at most 2, 3, 4, 5, 6, 7, 8, 9, or 10 V. In some embodiments, an electrolyte comprises a dielectric constant of at least 2, 5, 10, 20, 30, 40, 50, 60, 70, or 80. In some embodiments, an electrolyte comprises a dielectric constant of at most 3, 5, 10, 20, 30, 40, 50, 60, 70, 80, or 90. An electrolyte can comprise various viscosities. Polymeric or polymer solution electrolytes can comprise a large viscosities, as the viscosity can scale exponentially with molecular weight of the polymer above a critical molecular weight (e.g., entanglement molecular weight). In some embodiments, an electrolyte comprises a viscosity of at least 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, or 900 mPa·s. In some embodiments, an electrolyte comprises a viscosity of at least 1, 2, 3, 4, 5, 6, 7, 8, 9, 10, 20, 30, 40, 50, 60, 70, 80, 90, 100, 200, 300, 400, 500, 600, 700, 800, or 900 Pa·s. In some embodiments, an electrolyte comprises a viscosity of at least 1, 2, 3, 4, 5, 6, 7, 8, 9, 10, 20, 30, 40, 50, 60, 70, 80, 90, 100, 200, 300, 400, 500, 600, 700, 800, or 900 kPa·s. In some embodiments, an electrolyte comprises a viscosity of at most 0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, or 900 mPa·s. In some embodiments, an electrolyte comprises a viscosity of at most 1, 2, 3, 4, 5, 6, 7, 8, 9, 10, 20, 30, 40, 50, 60, 70, 80, 90, 100, 200, 300, 400, 500, 600, 700, 800, or 900 Pa·s. In some embodiments, an electrolyte comprises a viscosity of at most 1, 2, 3, 4, 5, 6, 7, 8, 9, 10, 20, 30, 40, 50, 60, 70, 80, 90, 100, 200, 300, 400, 500, 600, 700, 800, or 900 kPa·s.

Various organic electrolytes can be used. In some embodiments, an organic electrolyte can comprise dimethyl carbonate, ethylmethyl carbonate, diethyl carbonate, ethylene carbonate, propylene carbonate, 1,3-dioxolan-2-one, 4-methyl-1,3-dioxolan-2-one, oxolan-2-one, and any combination thereof.

Various polymeric electrolytes can be used. A polymer electrolyte can comprise poly(ethylene oxide), poly(vinyl alcohol), poly(methyl methacrylate), poly(caprolactone), poly(chitosan), poly(vinyl pyrrolidone), poly(vinyl chloride), poly(vinyl fluoride), polyvinylidene difluoride (PVDF), poly(vinylidene fluoride-co-hexafluoropropylene) (PVDF-HFP), poly(imide), or any combination thereof, which can inherently conduct lithium ions or be doped with one or more lithium salts to made the polymer be lithium conductive.

Various ionic liquids can be used, e.g., any one of the ionic liquids listed on the Ionic Liquids Database (ILThermo) of the National Institute of Standards and Technology.

Various lithium salts can be used. A lithium salt can comprise lithium 12-hydroxystearate, lithium acetate, lithium amide, lithium aspartate, lithium azide, lithium bis(trifluoromethanesulfonyl)imide, lithium bis(fluorosulfonyl)imide (LiFSI), lithium borohydride, lithium bromide, lithium carbonate, lithium chlorate, lithium chloride, lithium citrate, lithium cyanide, lithium diphenylphosphide, lithium hexafluorogermanate, lithium hexafluorophosphate, lithium hypochlorite, lithium hypofluorite, lithium metaborate, lithium methoxide, lithium naphthalene, lithium niobate, lithium nitrate, lithium nitrite, lithium oxalate, lithium perchlorate, lithium stearate, lithium succinate, lithium sulfate, lithium sulfide, lithium superoxide, lithium tantalate, lithium tetrachloroaluminate, lithium tetrafluoroborate, lithium tetrakis(pentafluorophenyl)borate, lithium triflate, lithium tungstate, or any combination thereof.

Various porous filters can be used. A porous filter can be wet by a liquid electrolyte or an elastic polyelectrolyte. The porous filter can be a relatively soft and flexible material at room or operational temperatures. The softness and flexibility of the filter can provide good contact with ion-conductive particles, underlying substrate (e.g., a current collector like copper foil), and/or good compatibility with lithium metal. The porous filter can suppress dendrite formation, suppress solid electrolyte interphase formation, promote high coulombic efficiency, prevent side-reactions, or etc.

### Lithium Resource

In some aspects, the present disclosure provides systems and methods of extracting lithium from a lithium resource. A lithium resource can be a natural resource, e.g., a geological resource comprising ore, minerals, or brine, or seawater. A lithium resource can be a salar brine, a salt-lake brine, an oil-field brine, a bromine-plan tail brine, a geothermal brine, a fracking brine, a leachate from mining, an effluent from an industrial process (e.g., from a battery recycling plant), or a combination thereof.

In some embodiments, the lithium resource comprises an aqueous solution of metal salts comprising (i) a lithium salt and (ii) a sodium salt, a magnesium salt, a calcium salt, a potassium salt, or any combination thereof. In some embodiments, the lithium resource comprises an aqueous salt solution. In some embodiments, the lithium resource comprises sodium, potassium, magnesium, calcium, boron, chlorine, SO₄²⁻, nitrogen, an alkali metal, an alkali earth metal, or any combination thereof. In some embodiments, the magnesium salt comprises MgCl₂. In some embodiments, the sodium salt comprises NaCl. In some embodiments, the lithium resource comprises LiCl, Li₂SO₄, or both.

In some embodiments, a ratio of magnesium to lithium in the lithium resource is at least 0, 1, 2, 3, 4, 5, 6, 7, 8, 9, 10, 20, 30, 40, 50, 60, 70, 80, 90, 100, 200, 300, 400, 500, 600, 700, 800, 900, or 1000 on a molar basis. In some embodiments, a ratio of magnesium to lithium in the lithium resource is at most 1, 2, 3, 4, 5, 6, 7, 8, 9, 10, 20, 30, 40, 50, 60, 70, 80, 90, 100, 200, 300, 400, 500, 600, 700, 800, 900, or 1000 on a molar basis. In some embodiments, a ratio of magnesium to lithium in the lithium resource is at least 0, 1, 2, 3, 4, 5, 6, 7, 8, 9, 10, 20, 30, 40, 50, 60, 70, 80, 90, 100, 200, 300, 400, 500, 600, 700, 800, 900, or 1000 on a mass basis. In some embodiments, a ratio of magnesium to lithium in the lithium resource is at most 1, 2, 3, 4, 5, 6, 7, 8, 9, 10, 20, 30, 40, 50, 60, 70, 80, 90, 100, 200, 300, 400, 500, 600, 700, 800, 900, or 1000 on a mass basis.

In some embodiments, the lithium resource comprises a total dissolved solid concentration of at least 100, 200, 300, 400, 500, 600, 700, 800, 900, 1000, 2000, 3000, 4000, 5000, 6000, 7000, 8000, 9000, 10000, 20000, 30000, 40000, 50000, 60000, 70000, 80000, 90000, or 100000 mg/L. In some embodiments, the lithium resource comprises a total dissolved solid concentration of at most 100, 200, 300, 400, 500, 600, 700, 800, 900, 1000, 2000, 3000, 4000, 5000, 6000, 7000, 8000, 9000, 10000, 20000, 30000, 40000, 50000, 60000, 70000, 80000, 90000, or 100000 mg/L.

In some embodiments, the lithium resource is pretreated to remove a metal cation. In some embodiments, the metal cation comprises magnesium, calcium, sodium, potassium, iron, or any combination thereof. In some embodiments, the metal cation is removed by adsorption, extraction, absorption, electrodialysis, precipitation, nanofiltration, solvent extraction, or any combination thereof. In some embodiments, the adsorption or the extraction comprises binding the metal cation to a coordination compound. In some embodiments, the absorption is performed by contacting the lithium resource with lithium-manganese oxide, titanium oxide, aluminum hydroxide, iron phosphate, clay minerals, zeolite, zirconium phosphate, tin antimonate, antimony oxide, tantalum oxide, niobium oxide, or any combination thereof.

In some embodiments, lithium can be extracted from a geological resource, such as clay and/or ore. In some embodiments, the geological resource can comprise a lithium mineral (e.g., LiAlSi₂O₆). The geological resource can be treated with sulfuric acid to obtain solution comprising Li₂SO₄. The Li₂SO₄ can be crystallized or further treated with a base to obtain LiOH (e.g., by adding Ca(OH)₂) or Li₂CO₃ (e.g., by adding Na₂CO₃). In some embodiments, CaSO₄ can be added to the geological resource. In some embodiments, the geological resource can be baked at high temperature. In some embodiments, LiSO₄ can be extracted using water to obtain an aqueous solution. In some embodiments, the aqueous solution can be concentrated to obtain Li₂SO₄ as a crystal.

In some embodiments, the lithium resource or the electrolyte comprises an additive, wherein the additive is configured to bind with lithium ions in the lithium resource preferentially over the lithium ions binding with water. In some embodiments, the lithium resource comprises an anion with a chemical structure of (RS (O) 2) 2N, where R is a substituent selected from the group of alkyl, perfluorinated alkyl, partially fluorinated alkyl, aryl, perfluorinated aryl, partially fluorinated aryl, and combinations thereof.

In some embodiments, the lithium resource comprises at least 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, 20000, 30000, 40000, or 50000 mg/L of lithium. In some embodiments, the lithium resource comprises at most 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, 20000, 30000, 40000, or 50000 mg/L of lithium.

### Pretreatment of Lithium Resource

In some embodiments, a lithium resource can be pretreated. The lithium resource can be limed. Liming can adjust the pH, reduce the concentration of non-lithium components, precipitate phosphorus, precipitate non-lithium metals such as magnesium, or a combination thereof. Precipitates can be separated from the lithium resource by, e.g., solid-liquid separation.

In some embodiments, a lithium resource can be concentrated. For example, the lithium resource can be concentrated using reverse osmosis. The lithium resource can be boiled to remove water. In some embodiments, the lithium resource can be pretreated to remove organic molecules, remove hydrogen sulfide, precipitate iron, flocculated, filtered to remove solids, or any combination thereof.

In some embodiments, a lithium resource can be used to generate lithium hydroxide, lithium chloride, lithium carbonate, or any combination thereof. The generated lithium hydroxide, lithium chloride, or lithium carbonate can be in an aqueous solution. The generated lithium hydroxide, lithium chloride, or lithium carbonate can be dried to generate a solid. The dried lithium hydroxide, lithium chloride, or lithium carbonate can be mixed in water to generate an aqueous solution comprising lithium ions for making a negative electrode comprising lithium metal.

### Electrolytes for Selective Extraction of Lithium

In some embodiments, an electrolyte can be a polymer membrane. In some embodiments, the polymer membrane can comprise a hydrophilic polymer. In some embodiments, the polymer membrane can comprise a hydrophobic polymer. In some embodiments, the polymer can be glassy at room temperature. In some embodiments, the polymer can be a melt at room temperature. In some embodiments, the polymer membrane can selectively conduct and/or diffuse lithium ions over magnesium ions, calcium ions, sodium ions, or any combination thereof. In some embodiments, the polymer membrane can comprise a lithium ion to magnesium ion selectivity of at least 10, 50, 100, 500, 1000, 5000, or 10000. In some embodiments, the polymer membrane can comprise a lithium ion to magnesium ion selectivity of at most 10, 50, 100, 500, 1000, 5000, or 10000. In some embodiments, the polymer membrane can comprise a lithium ion to sodium ion selectivity of at least 10, 50, 100, 500, 1000, 5000, or 10000. In some embodiments, the polymer membrane can comprise a lithium ion to sodium ion selectivity of at most 10, 50, 100, 500, 1000, 5000, or 10000. In some embodiments, the polymer membrane can comprise a lithium ion to calcium ion selectivity of at least 10, 50, 100, 500, 1000, 5000, or 10000. In some embodiments, the polymer membrane can comprise a lithium ion to calcium ion selectivity of at most 10, 50, 100, 500, 1000, 5000, or 10000. For example, the polymer can comprise cellulose. In some embodiments, the polymer can comprise cellulose diacetate, cellulose triacetate, cellulose nitrate, cellulose acetate butyrate, or a combination thereof. The cellulose can be at least 5, 10, 20, 30, 40, 50, 60, 70, or 80 percent acetylated. The cellulose can be at most 5, 10, 20, 30, 40, 50, 60, 70, or 80 percent acetylated.

In some embodiments, the polymer membrane comprises anisotropic properties. In some embodiments, the polymer membrane comprises a lithium conductivity that is different in the direction perpendicular to the plane of the polymer membrane, compared to the direction that is parallel to the plane of the polymer membrane. For example, when the polymer membrane is spin cast or extruded, the properties of the polymer membrane may be different in the planar direction when the molecules of the polymer become partially aligned due to shear forces. In some embodiments, the polymer membrane can become isotropic when the polymer molecules are given sufficient time to relax and reorganize to an isotropic state.

In some embodiments, the polymer membrane comprises pores. In some embodiments, the polymer membrane can comprise manufacturing defects which can sporadically introduce air bubbles which occupy a certain amount of space in the polymer. In some embodiments, the polymer membrane can be nonporous when the air bubbles are sufficiently annealed out of the polymer membrane.

In some embodiments, the polymer membrane is semi-crystalline. In some embodiments, the polymer membrane comprises a crystallinity of at least 0, 5, 10, 15, or 20 percent. In some embodiments, the polymer membrane comprises a crystallinity of at most 0, 5, 10, 15, or 20 percent.

In some embodiments, the polymer membrane can comprise a thickness of at least 0.1, 0.5, 1, 5, 10, 50, 100, 200, 300, 400, or 500 microns. In some embodiments, the polymer membrane can comprise a thickness of at most 0.1, 0.5, 1, 5, 10, 50, 100, 200, 300, 400, or 500 microns. In some embodiments, the polymer membrane comprises a glass transition temperature of at least 25, 50, 75, 100, 250, 450, or 500° C. In some embodiments, the polymer membrane comprises a glass transition temperature of at most 25, 50, 75, 100, 250, 450, or 500° C.

In some embodiments, the polymer membrane is a monovalent selective ion exchange membrane. In some embodiments, electrodialysis can be performed to a lithium resource using a polymer membrane to extract lithium from the lithium resource. In some embodiments, the monovalent selective cation exchange membrane comprises a modified surface. In some embodiments, the modified surface comprises charge moieties to provide a larger Coulombic energy barrier against some ions than other ions. In some embodiments, the membrane is an anion exchange membrane. In some embodiments, the charge moiety can be an amine or an ammonium group. In some embodiments, the anion exchange membrane is configured to selectively extract monovalent anions, such as chlorine or bromine ions, over multivalent anions, such as sulfate ions.

In some embodiments, an alkyl of the ammonium group of the membrane can be varied to provide different degrees of hydrophobicity. In some embodiments, the ammonium group can be a primary ammonium, a secondary ammonium, a tertiary ammonium, or a quaternary ammonium group. The alkyl group can be a methyl, ethyl, propyl, butyl, pentyl, hectyl, heptyl, octyl, nonyl, decyl, undecyl, dodecyl, or a longer alkyl group.

In some embodiments, the membrane comprises a water content of at least 1, 2, 3, 4, 5, 6, 7, 8, 9, 10, 15, 20, 25, 30, 35, or 40 percent by weight in operation. In some embodiments, the membrane comprises a water content of at most 1, 2, 3, 4, 5, 6, 7, 8, 9, 10, 15, 20, 25, 30, 35, or 40 percent by weight in operation. In some embodiments, the membrane comprises a resistivity of at least 0.5, 1, 1.5, 2, 2.5, 3, 3.5, 4, 4.5, 5, 5.5, or 6 Ω·cm². In some embodiments, the membrane comprises a resistivity of at most 0.5, 1, 1.5, 2, 2.5, 3, 3.5, 4, 4.5, 5, 5.5, or 6 Ω·cm². In some embodiments, the membrane comprises a Donnan potential of at least 1, 2, 3, 4, 5, 10, 15, 20, 25, or 30 mV in operation. In some embodiments, the membrane comprises a Donnan potential of at most 1, 2, 3, 4, 5, 10, 15, 20, 25, or 30 mV in operation. In some embodiments, the membrane can be used with a current density of at least 100, 200, 300, 400, 500, 1000, or 2000 A/m². In some embodiments, the membrane can be used with a current density of at most 100, 200, 300, 400, 500, 1000, or 2000 A/m².

In some embodiments, the membrane is configured to block the transport of protons. In some embodiments, the membrane does not comprise a percolating network of water molecules. In some embodiments, the membrane has an aprotic chemistry. In some embodiments, the membrane comprises polar functional groups capable of conducting lithium ions.

In some embodiments, an electrolyte can be a liquid. In some embodiments, a liquid electrolyte can be configured to selectively conduct lithium ions over other cations.

Any number and any combination of liquid electrolytes disclosed herein may be employed to selectively extract lithium from brine. For example, a method or system of the present disclosure may use 1, 2, 3, 4, 5 or more liquid electrolytes. In some embodiments, a liquid electrolyte can be a non-aqueous electrolytes. In some embodiments, the non-aqueous electrolyte can comprise a coordination compound which are configured to selectively transport lithium ions through the non-aqueous electrolyte. In some embodiments, the liquid electrolyte comprises a fluorinated electrolyte, e.g., FDMB (2,2,3,3-tetrafluoro-1,4-dimethoxylbutane)

By using compounds which can selectively coordinate with lithium ions in a lithium resource, the methods and the systems described herein can simplify the process of extracting lithium from the lithium resource (e.g., brine, a type of aqueous lithium resource). The liquid electrolyte can selectively conduct Li⁺ compared to other cations in the lithium resource. When voltage is applied across a first electrode in the lithium resource and a second electrode across the liquid electrolyte, lithium ions can be transported from the lithium resource, into the liquid electrolyte.

Certain compounds, such as clathrates and crown ethers, can form molecular “cages” that can envelop and bind to lithium ions. These compounds which can coordinate with lithium ions can be used to concentrate lithium ions in the liquid electrolyte from a lithium resource, while preventing or reducing the amount of other cations into the liquid electrolyte (e.g., Mg²⁺ or Na⁺). In some aspects, the present disclosure provides systems, methods, and compositions for using coordination chemistries to concentrate lithium ions by liquid-liquid extraction.

In some embodiments, the electrolyte can be washed with an acidic solution. Washing the electrolyte, which has been enriched in Lit, can extract Li⁺ from the electrolyte.

### Materials for Selective Extraction of Lithium

In some embodiments, lithium can be extracted from a lithium resource using an adsorbent or an absorbent. In some embodiments, the adsorbent or the absorbent can comprise resins, particles or beads, a column, a packed bed, a membrane, or any combination thereof. In some embodiments, the particles or beads can comprise nanoparticles, microparticles, or both. In some embodiments, the particles or beads can comprise particles having a diameter of at least 1, 2, 3, 4, 5, 6, 7, 9, 10, 20, 30, 40, 50, 60, 70, 80, 90, or 100 μm. In some embodiments, the particles or beads can comprise particles having a diameter of at most 1, 2, 3, 4, 5, 6, 7, 9, 10, 20, 30, 40, 50, 60, 70, 80, 90, or 100 μm.

In some embodiments, the particles in a membrane can comprise a particle density of at least 30%. In some embodiments, the particles in a membrane can comprise a particle density of at least 5, 10, 15, 20, 35, 30, 35, 40, 45, 50, 55, 60, 65, 70, 75, 80, 85, 90, or 95%. In some embodiments, the particles in a membrane can comprise a particle density of at most 30%. In some embodiments, the particles in a membrane can comprise a particle density of at most 5, 10, 15, 20, 35, 30, 35, 40, 45, 50, 55, 60, 65, 70, 75, 80, 85, 90, 95, or 100%.

In some embodiments, the adsorbent or absorbent comprises a membrane. The membrane can be a composite membrane. The composite membrane can have a polymer and a plurality of particles. The composite membrane can be provided on a support. In some embodiments, the polymer can be amorphous or semi-crystalline. In some embodiments, the polymer is a thermoplastic or a thermoset. In some embodiments, the polymer is an entangled polymer. In some embodiments, the polymer comprises cross-linkers. In some embodiments, the polymer comprises a molecular weight of at least 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000 kg/mol. In some embodiments, the polymer comprises a molecular weight of at most 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000 kg/mol. In some embodiments, the polymer comprises polyvinyl chloride, polyethylene, polystyrene, polyurethane, polyester, polymethylmethacylate, or any combination thereof.

In some embodiments, the membrane can comprise a thickness of at least 0.1, 0.5, 1, 5, 10, 50, 100, 200, 300, 400, or 500 microns. In some embodiments, the membrane can comprise a thickness of at most 0.1, 0.5, 1, 5, 10, 50, 100, 200, 300, 400, or 500 microns.

In some embodiments, the polymer or the particles can be functionalized with chelating groups. In some embodiments, the chelating groups are bound to a metal hydroxide or a metal oxide, such as, AlOH₃, Al₂O₃, or both. The metal hydroxide or metal oxide can bind and/or adsorb lithium. In some embodiments, the particles can comprise a metal-organic framework (MOF). A MOF can be configured to bind and/or absorb lithium ions. In some embodiments, the polymer or the particles can comprise a lithium ion exchange resin.

In some embodiments, the membrane can comprise a flat shape, a tube shape, or a spiral shape. In some embodiments, the membrane comprises a hollow fiber membrane. A plurality of hollow fiber membranes can be formed into a bundle, where the lithium resource can be flowed outside of the bundle, and extracted lithium can flow inside of the hollow fibers. Alternatively, the lithium resource can be flowed inside of the bundle, and extracted lithium can flow outside of the hollow fibers. The flow on the inside and the outside of the bundle can be in opposite direction, i.e., countercurrent, which can improve the transfer of lithium ions. In some embodiments, the membrane comprises a spiral shape. The membrane can form a spiral around an inner tube.

In some embodiments, the adsorbent or absorbent is provided in a column. The column can comprise an input port. The column can comprise a flow distributor that is configured to spread a flow from the input into a wider area.

In some embodiments, the adsorbent or absorbent can comprise an ion exchange material. The ion exchange material can be configured to bind to lithium ions when contacted with the lithium resource. The ion exchange material can be configured to release the lithium ions when contacted with a solution. The solution can be, e.g., water. The solution can comprise a concentration of lithium that is lower than the lithium resource. Having a concentration of lithium that is lower than the lithium resource can allow the lithium in the ion exchange material to release into the second solution. The concentration of lithium in the solution can be less than 1, 2, 3, 4, 5, 6, 7, 8, 9, 10, 20, 30, 40, 50, 60, 70, 80, 90, 100, 200, 300, 400, 500, 600, 700, 800, 900, or 1000 mg/L of lithium. The concentration of lithium in the solution can be greater than 0, 1, 2, 3, 4, 5, 6, 7, 8, 9, 10, 20, 30, 40, 50, 60, 70, 80, 90, 100, 200, 300, 400, 500, 600, 700, 800, 900, or 1000 mg/L of lithium.

### Systems for Pretreating Lithium Resource

In some embodiments, the pretreating can be performed using a system. The system can comprise a pump configured to pressurize an input flow of the lithium resource. The lithium resource can be pressurized into one or more vessels comprising one or more membranes and one or more columns disclosed herein. The one or more membrane and/or the one or more columns can be configured to selectively transport lithium over other cations, or a monovalent anion over other anions. In some embodiments, the one or more membrane and/or the one or more columns can be configured to concentrate lithium by removing water, e.g., by reverse osmosis. The lithium resource can be treated to adjust its pH, filter solids, precipitate non-lithium salts, or any combination thereof before inputting to the system. The output flow from the system can have a lithium purity of at least 50, 60, 70, 80, 85, 90, 91, 92, 93, 94, 95, 96, 97, 98, or 99 percent on a metals basis. The output flow from the system can have a lithium purity of at most 50, 60, 70, 80, 85, 90, 91, 92, 93, 94, 95, 96, 97, 98, 99, or 99.9 percent on a metals basis. In some embodiments, the system recovers at least 60, 70, 80, 85, 90, 91, 92, 93, 94, 95, 96, 97, 98, or 99 percent of lithium in the lithium resource. In some embodiments, the system recovers at most 60, 70, 80, 85, 90, 91, 92, 93, 94, 95, 96, 97, 98, or 99 percent of lithium in the lithium resource.

In some embodiments, the system is configured to adjust the pH of the lithium resource. In some embodiments, the pH of the lithium resource can be adjusted to at least 1, 2, 3, 4, 5, 6, 7, 8, 9, 10, 11, 12, 13, or 14. In some embodiments, the pH of the lithium resource can be adjusted to at most 1, 2, 3, 4, 5, 6, 7, 8, 9, 10, 11, 12, 13, or 14.

In some embodiments, the system comprises a filter. The filter can be used to remove solids, organics, or descaling the lithium resource. In some embodiments, the system can comprise a water softener. In some embodiments, the system can be configured to remove hydrogen sulfide from the lithium resource.

In some embodiments, the system can comprise an electrodialyzer. The electrodialyzer can be configured to increase a concentration of lithium in a solution and/or to extract lithium from a lithium resource. The electrodialyzer can be configured to increase a concentration of lithium chloride, lithium hydroxide, or lithium carbonate in the lithium resource.

### Lithium Metal

Lithium metal electrodes for lithium metal batteries can comprise a thin layer (usually <50 μm thick) of lithium metal on a conductive substrate. Some processes for manufacturing lithium metal electrodes from brine can take multiple steps, including purification of brine, electrolysis of molten LiCl, and extrusion of Li ingots into thin films on copper.

In some embodiments, a lithium metal electrode has a specific capacity of greater than 3500, 3600, 3700, 3750, or 3800 mAh per gram. In some embodiments, a lithium metal electrode has a specific capacity of less than 3600, 3700, 3750, or 3800 mAh per gram. The overall capacity of the lithium metal electrode (e.g., in basis of mAh) can be substantially matched with the capacity of the positive electrode. In some embodiments, a lithium metal electrode has a density of between about 0.4 g/cm³ and about 0.534 g/cm³. In some embodiments, lithium metal electrode has a density of between about 0.45 g/cm³ and about 0.543 g/cm³. In some embodiments, lithium metal electrode has a density of greater than 0.46, 0.47, 0.48, 0.49, 0.50, 0.51, 0.52, or 0.53 g/cm³. In some embodiments, lithium metal electrode has a density of less than 0.46, 0.47, 0.48, 0.49, 0.50, 0.51, 0.52, 0.53, or 0.543 g/cm³.

Lithium metal can comprise less than 1000, 900, 800, 700, 600, 500, 400, 300, 200, 100, 90, 80, 70, 60, 50, 40, 30, 20, 10, 9, 8, 7, 6, 5, 4, 3, 2, 1, 0.9, 0.8, 0.7, 0.6, 0.5, 0.4, 0.3, 0.2, or 0.1 ppm of a non-metallic element. The ppm can be by mass or by count. The ppm can correspond to a basis used for the instrument to detect the non-metallic element. Lithium metal can comprise less than 5 parts-per-million (ppm) of non-metallic elements. In some embodiments, the lithium metal comprises no more than 1 ppm of non-metallic elements by mass. The non-metallic element can be nitrogen, boron, oxygen, carbon, hydrogen, or fluorine. Non-metallic elements can be present as atomic species, or molecular species (e.g., as Li₃N, OH, lithium-boron compounds, carbonate, or O₂). In some embodiments, a non-metallic element may form resistive material on a surface of the lithium metal. For example, LiCO₃ or LiOH can create resistive losses for a lithium metal electrode. The presence of a non-metallic element can be detected using, for example, inductively coupled plasma optical emission spectroscopy (ICP-OES) or X-ray microtomography. The presence of a non-metallic elements may be detected using focused Ion Beam (FIB) with a secondary ion mass spectrometry (SIMS). The presence of a non-metallic elements may be detected using electron energy loss spectroscopy (EELS), and/or transmission electron microscopy (TEM), by detecting and mapping lithium via the high ionization cross-section of the shallow Li K-edge that is 10-100 times greater than those of other light elements, e.g., O and F.

Lithium metal can comprise less than 1500 ppm of a trace metal. Lithium metal can comprise less than 1400, 1300, 1200, 1100, 1000, 900, 800, 700, 600, 500, 400, 300, 200, 100, 90, 80, 70, 60, 50, 40, 30, 20, 10, 9, 8, 7, 6, 5, 4, 3, 2, 1, 0.9, 0.8, 0.7, 0.6, 0.5, 0.4, 0.3, 0.2, or 0.1 ppm of a trace metal. Lithium metal can comprise more than 0, 1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, or 5000 parts-per-billion (ppb) of a trace metal. The ppb can be by mass or by count. The ppb can correspond to a basis used for the instrument to detect the trace element. The trace metal can be aluminum, barium, calcium, chromium, iron, iridium, magnesium, tungsten, zinc, cobalt, or sodium. In some embodiments, a trace element may form an alloy with lithium. An alloy can reduce the capacity of a lithium metal electrode. Lithium metal can comprise less than 12, 11, 10, 9, 8, 7, 6, 5, 4, 3, 2, 1, 0.9, 0.8, 0.7, 0.6, 0.5, 0.4, 0.3, 0.2, or 0.1 ppm of aluminum. Lithium metal can comprise less than 15, 14, 13, 12, 11, 10, 9, 8, 7, 6, 5, 4, 3, 2, 1, 0.9, 0.8, 0.7, 0.6, 0.5, 0.4, 0.3, 0.2, or 0.1 ppm of barium. Lithium metal can comprise less than 45, 40, 35, 30, 25, 20, 15, 10, 9, 8, 7, 6, 5, 4, 3, 2, 1, 0.9, 0.8, 0.7, 0.6, 0.5, 0.4, 0.3, 0.2, or 0.1 ppm of calcium. Lithium metal can comprise less than 1, 0.9, 0.8, 0.7, 0.6, 0.5, 0.4, 0.3, 0.2, or 0.1 ppm of chromium. Lithium metal can comprise less than 2, 1, 0.9, 0.8, 0.7, 0.6, 0.5, 0.4, 0.3, 0.2, or 0.1 ppm of iron. Lithium metal can comprise less than 13, 12, 11, 10, 9, 8, 7, 6, 5, 4, 3, 2, 1, 0.9, 0.8, 0.7, 0.6, 0.5, 0.4, 0.3, 0.2, or 0.1 ppm of iridium. Lithium metal can comprise less than 1000, 900, 800, 700, 600, 500, 400, 300, 200, 100, 90, 80, 70, 60, 5,0 40, 30, 20, 10, 9, 8, 7, 6, 5, 4, 3, 2, or 1 ppm of magnesium. Lithium metal can comprise less than 23, 20, 15, 10, 9, 8, 7, 6, 5, 4, 3, 2, 1, 0.9, 0.8, 0.7, 0.6, 0.5, 0.4, 0.3, 0.2, or 0.1 ppm of tungsten. Lithium metal can comprise less than 0.7, 0.6, 0.5, 0.4, 0.3, 0.2, or 0.1 ppm of zinc. Lithium metal can comprise less than 45, 40, 35, 30, 25, 20, 15, 10, 9, 8, 7, 6, 5, 4, 3, 2, 1, 0.9, 0.8, 0.7, 0.6, 0.5, 0.4, 0.3, 0.2, or 0.1 ppm of sodium. Lithium metal can comprise less than 45, 40, 35, 30, 25, 20, 15, 10, 9, 8, 7, 6, 5, 4, 3, 2, 1, 0.9, 0.8, 0.7, 0.6, 0.5, 0.4, 0.3, 0.2, or 0.1 ppm of cobalt. The presence of trace metals can be detected using, for example, inductively coupled plasma optical emission spectroscopy (ICP-OES).

Lithium metal can comprise a low density of structural impurities, e.g., subsurface structural impurities. Without being bound to a particular theory, elemental or molecular impurities in lithium metal may form phases which are distinct from a pure lithium phase. When current traverses through the lithium metal, the lithium metal may be heated. Higher temperature may permit impurities to conduct or diffuse in the lithium metal, which can lead to the formation of more stable phases of impurities in the lithium metal (e.g., crystallites). When such structural impurities (phases which have distinct crystal structures, or which have grain boundaries against lithium metal phases in the lithium metal) begin to form, they may continue to grow. Structural impurities can be detected by 3D techniques, e.g., X-ray tomography. Structural impurities may be present on the surface of lithium metal, or it may be present beneath the surface. The structural impurities can provide sites for dendrite nucleation or growth, and may crack the surrounding lithium metal. In some embodiments, the lithium metal can comprise less than 10, 9, 8, 7, 6, 5, 4, 3, 2, 1, 0.9, 0.8, 0.7, 0.6, 0.5, 0.4, 0.3, 0.2, or 0.1 structural impurities/mm³. In some embodiments, the lithium metal can comprise less than 1000, 900, 800, 700, 600, 500, 400, 300, 200, 100, 90, 80, 70, 60, 5,0 40, 30, 20, 10, 9, 8, 7, 6, 5, 4, 3, 2, or 1 ppm of structural impurities by weight.

### EXAMPLES

The following examples are provided to further illustrate some embodiments of the present disclosure, but are not intended to limit the scope of the disclosure; it will be understood by their exemplary nature that other procedures, methodologies, or techniques known to those skilled in the art may alternatively be used.

### Example 1: Synthesis of Carbon Particles (Carbon Flowers) (I)

The process commenced with the combination of equal volumes of acrylonitrile and acetone, specifically 20 ml of each, within a sealed vessel that was capable of withstanding high pressure. To initiate the chain polymerization process, about 0.05 wt % of the total amount of 2,2-azobis(2-methyl-propionitrile) (AIBN) initiator was added (i.e. 20 ml acrylonitrile, 20 ml acetone, and 20 mg AIBN). Subsequently, the sealed vessel was purged with an inert gas, such as argon or nitrogen. The reaction vessel was then heated at 80° C. for 30 minutes to initiate the reaction, followed by a cooling period. The resultant white solids were collected and ground into a fine powder using a mortar and pestle. The powder was then dried under a vacuum at room temperature for a minimum of 12 hours. Following the drying process, the powder was transferred to a furnace with a controlled atmosphere. The furnace temperature was set to 230° C. under ambient conditions, where it was allowed to dwell for 2 hours to produce brown powder. The temperature was then raised to 1000° C. under an inert atmosphere, such as argon or nitrogen, and was allowed to dwell for another 2 hours. Following this heating step, the product was allowed to cool down to room temperature. The final product of this process was a black-colored powder with a synthesis yield of approximately 50% with respect to the mass of brown powder that is used in this step. Final yield was 15% with respect to the starting mass of acrylonitrile.

### Example 2: Synthesis of Carbon Particles (Carbon Flowers) (II)

The process commenced with the combination of equal volumes of acrylonitrile and acetone, specifically 20 ml of each, within a sealed vessel that was capable of withstanding high pressure. To initiate the chain polymerization process, about 0.08 wt % of the total amount of 2,2-azobis(2-methyl-propionitrile) (AIBN) initiator was added (i.e. 20 ml acrylonitrile, 20 ml acetone, and 25 mg AIBN). Subsequently, the sealed vessel was purged with an inert gas, such as argon or nitrogen. The reaction vessel was then heated at 85° C. for 45 minutes to initiate the reaction, followed by a cooling period. The resultant white solids were collected and ground into a fine powder using a mortar and pestle. The powder was then dried under a vacuum at room temperature for a minimum of 12 hours. Following the drying process, the powder was transferred to a convection oven with a controlled atmosphere. The furnace temperature was set to 230° C. under ambient conditions, where it was allowed to dwell for 4 hours to produce brown powder. The resulting powder was transferred to a furnace and heated for 2 hours at 1000 C under inert conditions. Following this heating step, the product was allowed to cool down to room temperature. The final product of this process was a black-colored powder with a synthesis yield of approximately 50% with respect to the mass of brown powder that is used in this step. Final yield was 15% with respect to the starting mass of acrylonitrile.

### Example 3: Electrode Preparation

The utilization of the synthesized carbon flower powder extended to the preparation of an electrode. The process commenced with grounding the dried carbon flower powder using a mortar and pestle followed by passing through a 30-μm or 38-μm (or similar) sieve. This aided in ensuring a uniform electrode coating. The next phase involved the composition of the electrode slurry, which was a mixture of the powder, Li polyacrylic acid (LiPAA) as binder, and C65 conductive carbon additive dispersed in water. The ratio for the mixture was 82.5 wt % powder, 12.5 wt % LiPAA, and 5 wt % C65. To achieve optimal dispersion, the LiPAA and C65 were initially combined as 5 and 2 wt % respectively in water, and mixed in a centrifugal planetary mixer (Flacktek), followed by sonication of the dispersion. This step was completed prior to the addition of any carbon flower powder. The sonication process involved about 30 minutes in a tip sonicator and another about 30 minutes in a bath sonicator. Further mixing was performed in the centrifugal planetary mixer (Flacktek) using the typical method of mixing LFP. This included wetting out with half of the binder/C65 dispersion and the powder on top of the liquid, followed by adding the other half of the binder/C65 dispersion for a laboratory mixer (Thick Phase mixing). The slurry was then cast at a thickness of about 200-300 μm on a copper current collector, dried in a vacuum oven, and calendared at about 50 μm at 120° C. to obtain the final electrode.

### Example 4: Electrochemical Measurements (I)

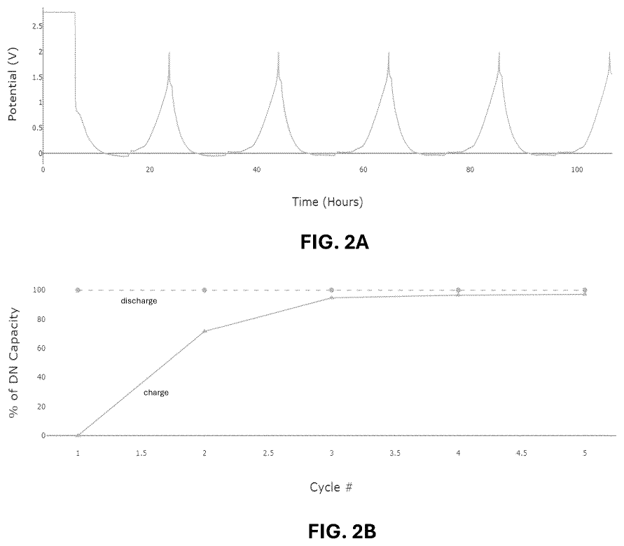

In the experimental measurements, a full cell was designed incorporating 60 cm² of carbon flower electrode against 40 μm MSE™ lithium metal with 2 mL of 1M LiTFSI DOL DME (an electrolyte, lithium bis(trifluoromethane)sulfonimide salt dissolved in a solvent mixture of 1,3-dioxolane and 1,2-dimethoxyethane) 1% wt LiNO₃. Celgard separator was also used in the cell. The methodology entailed five formation cycles running at a current density of 0.38 mA/cm² (C/10). Within these cycles, lithiation reached up to 3.86 mAh/cm² (equivalent to 700 mAh/g), whereas delithiation was performed up to 2V. Upon the completion of the fifth full cycle, as shown in FIG. 2A, the carbon flower powder was relithiated to a level of 2.08 mAh/cm², assuring an excess of approximately 10 μm Li during the full cell cycling phase (not depicted in the Potential vs. Time plot).

Following the formation process, the cell was disassembled and analyzed after the formation cycles. The carbon flower electrode was extracted, punched into 1″ diameter circles, and then employed in full cells for cycling vs LFP. A key achievement in the experiment was the attainment of a coulombic efficiency of about 96.99% on the fifth formation cycle (FIG. 2B), demonstrating the high-efficiency performance of the methodology.

### Example 5: Electrochemical Measurements (II)

In the experimental measurements, a full cell was designed incorporating 60 cm² of carbon flower electrode against 40 μm MSE™ lithium metal with 2 mL of 1M LiTFSI DOL DME (an electrolyte, lithium bis(trifluoromethane)sulfonimide salt dissolved in a solvent mixture of 1,3-dioxolane and 1,2-dimethoxyethane) 1% wt LiNO₃. Celgard separator was also used in the cell. The methodology entailed five formation cycles running at a current density of 0.38 mA/cm² (C/10). Within these cycles, lithiation reached up to 5.15 mAh/cm², which the current density at C/10 is 0.515 mA/cm² (equivalent to 700 mAh/g), whereas delithiation was performed up to 2V. Upon the completion of the fifth full cycle, as shown in FIG. 2A, the carbon flower powder was relithiated to a level of 2.61 mAh/cm² (assuming 1.25 mAh/cm² baseline), assuring an excess of approximately 10 μm Li during the full cell cycling phase (not depicted in the Potential vs. Time plot).

Following the formation process, the cell was disassembled and analyzed after the formation cycles. The carbon flower electrode was extracted, punched into 1″ diameter circles, and then employed in full cells for cycling vs LFP. A key achievement in the experiment was the attainment of a coulombic efficiency of about 96.99% on the fifth formation cycle (FIG. 2B), demonstrating the high-efficiency performance of the methodology.

### Example 6: Measurements of Full LFP Cell Cycle Life

The performance of the carbon flower anode was evaluated by cycling in a full cell with an LFP cathode at ambient temperature with a voltage window of 2.5 V-3.75 V. The performance of the carbon flower full cell was compared to a lithium metal vs. LFP full cell with comparable anode loading. The full cell was designed consisting of a cathode with a capacity of 1.25 mAh/cm² and an anode with a lithium inventory equivalent to approximately 10 micrometer (μm) carbon flower. The cell was formed at C/10 and underwent 1C cycling. The cell composition included 300 μL of 1M LiTFSI DOL DME 1% wt LiNO₃ and a Celgard Separator (trilayer membrane).

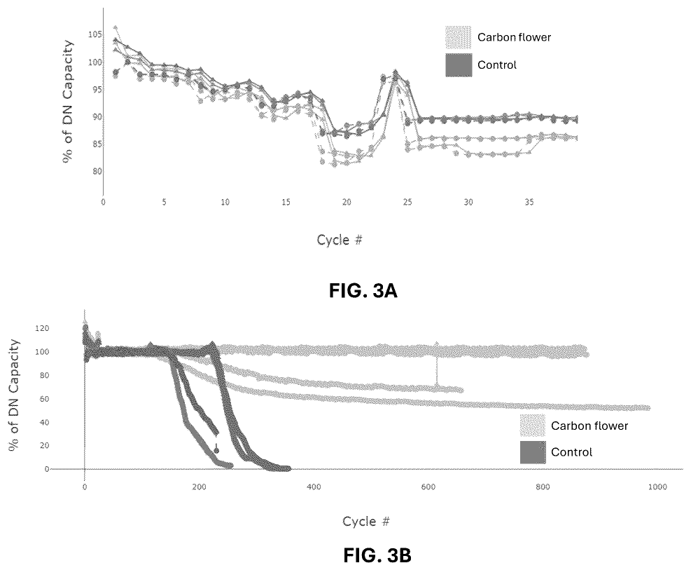

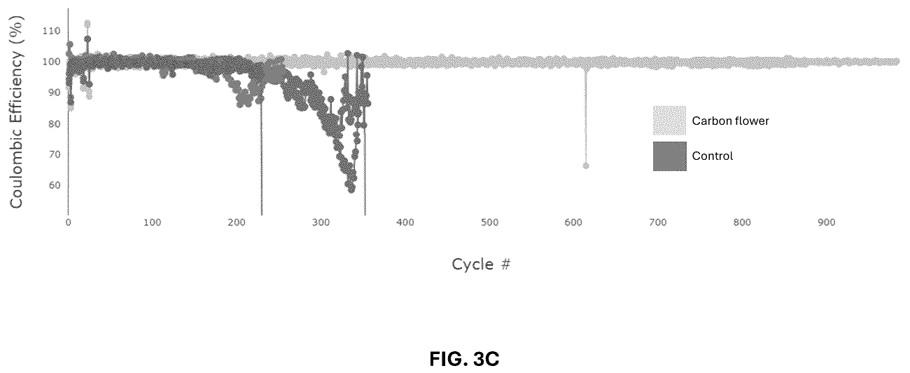

Performance metrics underscored the superiority of the carbon flower full cell, outperforming the control cell cycle life by over four times. The results are shown in FIG. 3A-FIG. 3C. Although the rate performance of the carbon flower was slightly lower than the 10 μm Li at 1C, both carbon flower and the control showed a full recovery of C/5 capacity after 1C cycling. Rate testing was conducted with 2×C/20, followed by 5×C/5, C/3, C/2, and 1C. After this, 3×C/5 was conducted, and the final cycling was performed at 1C. The results from this experiment further validate the high-efficiency performance of the full cell using the carbon flower, supporting its potential use in enhancing lithium battery technology.

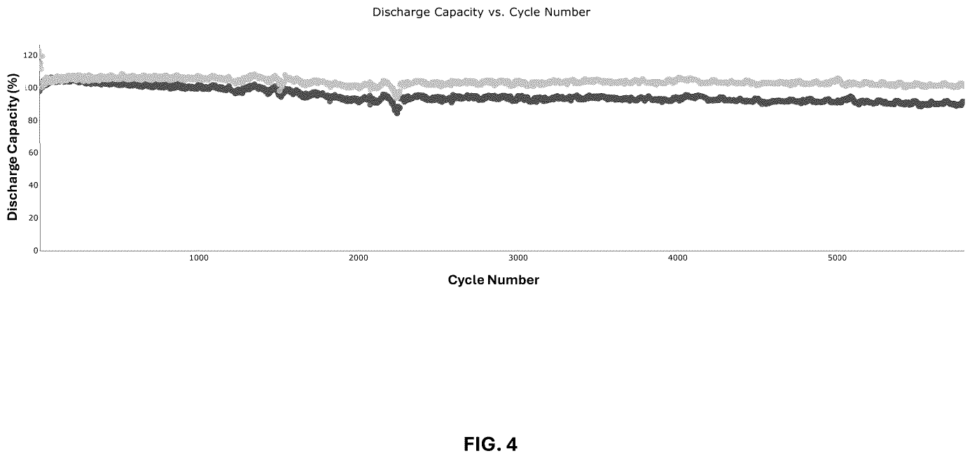

Additional results in FIG. 4 exhibit that the system may maintain about 90% of its initial discharge capacity after at least 5500 charge-discharge cycles.

### Example 7: Lithium Metal Battery

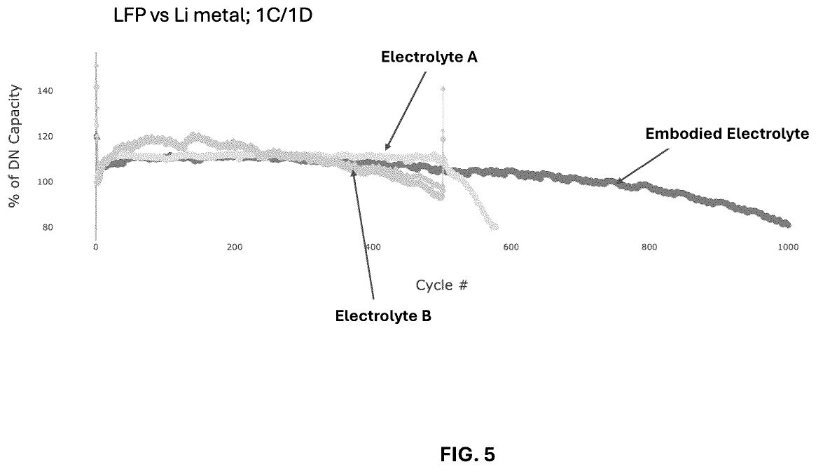

Three different configurations of electrochemical cells were constructed. Each cell had a negative electrode with 20 μm lithium on copper current collector and an LFP positive electrode. The electrolytes in the electrochemical cells varied. Cell A contained DOL:DME 1M LiTFSI, 1 wt % LiNO₃. Cell B contained LHCE 4M LiFSI in DME, dilute with TTE. Cell C contained a 50:50 mixture of the electrolyte in Cell A and Cell B, leading to a composition of: 0.50M LiTFSI+0.87M LiFSI in DOL:DME: TTE (0.250:0.358:0.392 v/v) w/0.45% wt LiNO₃. Cycling experiments were conducted for each cell. As shown in FIG. 5, Cell C remarkably showed the best properties of both Cell A and Cell B electrolytes, and doubled the achievable cycle-life.

### Example 8: Lithium Metal Battery with Vanadium Based Compound

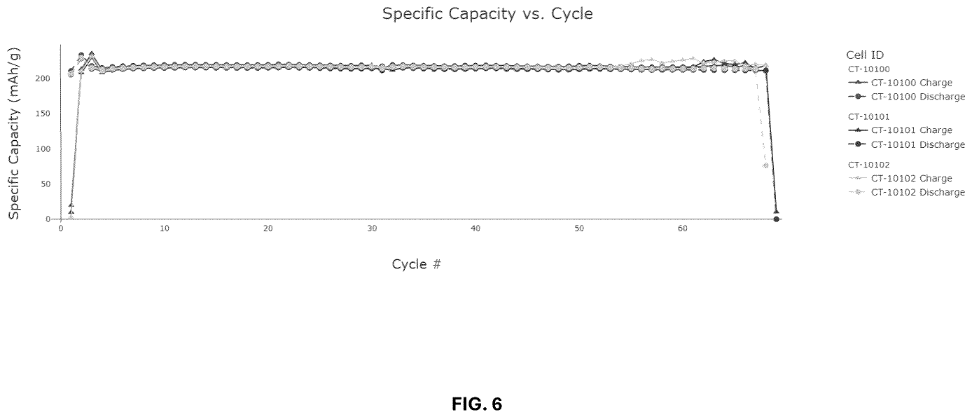

This example evaluates the performance of a Li-metal cell utilizing an electrolyte disclosed in the present disclosure in conjunction with a V₂O₅ based compound positive electrode. The electrolyte formulation comprises a 1:1 mixture of two components: a solution of 1M LiTFSI and 1 wt % LiNO₃ in a DOL:DME solvent, and a solution of 4M LiFSI in DME, further diluted with TTE (tetraethylene glycol dimethyl ether), referred to as LHCE. To evaluate the performance and stability of the full cell, three separate cells were constructed and put through a series of measurements. The observed results, illustrated in FIG. 6, showed that all three cells demonstrated sustained specific capacity over an extended cycle life of approximately 70 cycles.

### Example 9: Lithium Metal Battery with Complex Electrolyte (I)

This example describes a cell comprising various electrolytes. A full cell with an LFP cathode is cycled at ambient temperature with a voltage window of 2 V-3.75 V. The full cell comprises a cathode with a capacity of 1.25 mAh/cm² and an anode of 20 μm Li-metal. The cell is formed at C/20:D/20 and is exposed to 1C:1D cycling. Cell I includes an electrolyte composition of 1.8M LiTFSI EC/EMC-BTFE (0.3:0.7:2 by mol.), 5 wt. % FEC, while Cell II includes an electrolyte composition of LiFSI/EC-EMC-BTFE (0.51:0.22:0.88:2 by mol.), 0.15 M LiDFOB.

### Example 10: Lithium Metal Battery with Complex Electrolyte (II)

This example describes a cell comprising various electrolytes. A full cell with an LFP cathode is cycled at ambient temperature with a voltage window of 2 V-3.75 V. The full cell comprises a cathode with a capacity of 1.25 mAh/cm² and an anode of 20 μm Li-metal. The cell is formed at C/20:D/20 and is exposed to 1C:1D cycling. Cell I includes an electrolyte composition of LiFSI/TEP-BTFE (1:1.33:4 by mol.), 0.12 wt. % FEC, while Cell II includes an electrolyte composition of LiFSI/EC-EMC-BTFE (0.51:0.22:0.88:2 by mol.), 0.15 M LiDFOB.

### Example 11: Lithium Metal Battery with Complex Electrolyte (III)

This example describes a cell comprising various electrolytes. A full cell with an LFP cathode is cycled at ambient temperature with a voltage window of 2 V-3.75 V. The full cell comprises a cathode with a capacity of 1.25 mAh/cm² and an anode of 20 μm Li-metal. The cell is formed at C/20:D/20 and is exposed to 1C:1D cycling. Cell I includes an electrolyte composition of 1.0 M LiPF₆ in EC/EMC=30/70 (w/w), 1 wt. % VC, while Cell II includes an electrolyte composition of 1.2 M LiPF₆ in EC/EMC=30/70 (w/w)+1 wt. % VC.

### Example 12: Lithium Metal Battery with Complex Electrolyte (IV)

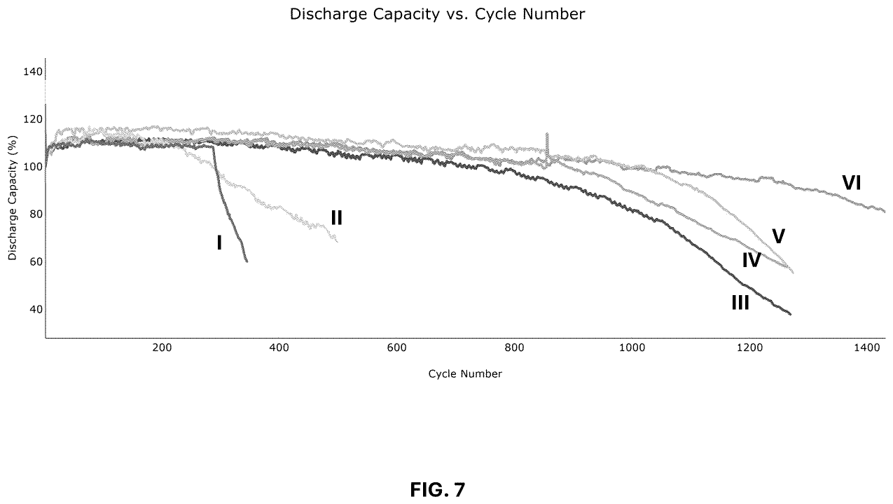

This example describes a cell comprising various electrolytes. A full cell with an LFP cathode is cycled at ambient temperature with a voltage window of 2 V-3.75 V. The full cell comprises a cathode with a capacity of 1.25 mAh/cm² and an anode of 20 μm Li-metal. The cell is formed at C/20:D/20 and is exposed to 1C:1D cycling. Cell I includes an electrolyte composition of 1M LiTFSI DOL/DME 1% wt LiNO₃, while Cell II includes an electrolyte composition of LiFSI:DME:TTE at 1:1.2:3. The results are illustrated in FIG. 7.

### Example 13: Lithium Metal Battery with Complex Electrolyte (V)

This example describes a cell comprising various electrolytes. A full cell with an LFP cathode is cycled at ambient temperature with a voltage window of 2 V-3.75 V. The full cell comprises a cathode with a capacity of 1.25 mAh/cm² and an anode of 20 μm Li-metal. The cell is formed at C/20:D/20 and is exposed to 1C:1D cycling. Cell III, IV, and VI contains an electrolyte composition of LiTFSI:LiFSI:LiNO₃:DME:DOL:TTE at 10.45:10.19:0.46:21.69:19.29:37.92. Cell V contains an electrolyte composition of LiTFSI:LiFSI:LiNO₃:DME:DOL:TTE at 6.82:13.21:0.3:17.94:12.58:49.16. The results are illustrated in FIG. 7.

### Example 14: Lithium Metal Battery with Complex Electrolyte (VI)

This example describes a cell comprising various electrolytes. A full cell with an LFP cathode is cycled at ambient temperature with a voltage window of 2 V-3.75 V. The full cell comprises a cathode with a capacity of 1.25 mAh/cm² and an anode of 20 μm Li-metal. The cell is formed at C/20:D/20 and is exposed to 1C:1D cycling. Cell I includes an electrolyte composition of 1M LiTFSI DOL/DME 1% wt LiNO₃, while Cell II includes an electrolyte composition of LiFSI:DME:TTE at 1:1.2:3. Cell III, IV, and VI contains an electrolyte composition of LiTFSI:LiFSI:LiNO₃:DME:DOL:TTE at 10.45:10.19:0.46:21.69:19.29:37.92. Cell V contains an electrolyte composition of LiTFSI:LiFSI:LiNO₃:DME:DOL:TTE at 6.82:13.21:0.3:17.94:12.58:49.16.

### Example 15: Lithium Metal Battery with Complex Electrolyte (VII)

This example describes a cell comprising various electrolytes. A full cell with an LFP cathode is cycled at ambient temperature with a voltage window of 2 V-3.75 V. The full cell comprises a cathode with a capacity of 1.25 mAh/cm² and an anode of 20 μm Li-metal. The cell is formed at C/20:D/20 and is exposed to 1C:1D cycling. Cell I includes an electrolyte composition of LiTFSI:LiFSI:LiNO₃:DME:DOL:TTE at 13.63:7.55:0.59:24.97:25.17:28.09, while Cell II includes an electrolyte composition of LiTFSI:LiFSI:LiNO₃:DME:DOL:TTE at 18.18:3.77:0.79:29.66:33.55:14.04.

### Example 16: Lithium Metal Battery with Complex Electrolyte (VIII)

This example describes a cell comprising various electrolytes. A full cell with an LFP cathode is cycled at ambient temperature with a voltage window of 2 V-3.75 V. The full cell comprises a cathode with a capacity of 1.25 mAh/cm² and an anode of 20 μm Li-metal. The cell is formed at C/20:D/20 and is exposed to 1C:1D cycling. Cell I includes an electrolyte composition of LiTFSI:LiFSI:LiNO₃:DME:DOL:TTE at 2.27:16.98:0.1:13.25:4.19:63.2, while Cell II includes an electrolyte composition of LiTFSI:LiFSI:LiNO₃:DME:DOL:TTE at 2.27:16.98:0.1:10.91:4.19:63.2.

### Example 17: Lithium Metal Battery with Complex Electrolyte (IX)

This example describes a cell comprising various electrolytes. A full cell with an LFP cathode is cycled at ambient temperature with a voltage window of 2 V-3.75 V. The full cell comprises a cathode with a capacity of 1.25 mAh/cm² and an anode of 20 μm Li-metal. The cell is formed at C/20:D/20 and is exposed to 1C:1D cycling. Cell I includes an electrolyte composition of 1.0M LiTFSI in DOL:DME=1:1 wt % with 2.0% LiNO₃, while Cell II includes an electrolyte composition of 0.5M LiTFSI, 0.5M LiNO₃ in DOL:DME=1:1 vol %.

### Example 18: Method of Fabricating a Composite Membrane

Ceramic particles in powder form is dissolved in a solvent (e.g., acetonitrile). The suspension is mixed with a polymer solution. Rapid stirring is used to create better contact between the polymer chains and ceramic particles. A sonicator can be used to better disperse the ceramic particles among the polymer chains. The mixture is stirred for 24 hours, after which it is evaporated to dryness (e.g., using a rotary evaporator). The composite is further dried under vacuum at elevated temperatures (e.g., 60° C.) for 24 h.

Various loadings of the ceramic can be used, e.g., from 2 wt % ceramic to 50 wt % ceramic. The fabrication can be performed inside an argon filled glove box (moisture and oxygen levels controlled) to maintain dry conditions and avoid contamination.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the present disclosure may be employed in practicing the present disclosure. It is intended that the following claims define the scope of the present disclosure and that methods and structures within the scope of these claims and their equivalents be covered thereby.

### LIST OF EMBODIMENTS

The following list of embodiments of the invention are to be considered as disclosing various features of the invention, which features can be considered to be specific to the particular embodiment under which they are discussed, or which are combinable with the various other features as listed in other embodiments. Thus, simply because a feature is discussed under one particular embodiment does not necessarily limit the use of that feature to that embodiment.

Embodiment 1. A rechargeable energy source system, comprising:
(a) a positive electrode; and
(b) a negative electrode comprising a plurality of carbon particles, wherein the plurality of carbon particles is concavely shaped and has a diameter of at least 1 μm;
   wherein the rechargeable energy source system is configured to (1) intercalate the plurality of carbon particles with a plurality of lithium ions from an electrolyte, and (2) plate the plurality of lithium ions as lithium metal on a surface of the plurality of carbon particles.

Embodiment 2. A rechargeable energy source system, comprising:
(a) a positive electrode; and
(b) a negative electrode comprising a plurality of carbon particles, wherein the plurality of carbon particles is concavely shaped and has a multimodal distribution of sizes;
   wherein the rechargeable energy source system is configured to (1) intercalate the plurality of carbon particles with a plurality of lithium ions from an electrolyte, and (2) plate the plurality of lithium ions as lithium metal on a surface of the plurality of carbon particles.

Embodiment 3. A rechargeable energy source system, comprising:
(a) a positive electrode comprising a transition metal phosphate; and
(b) a negative electrode comprising a plurality of carbon particles, wherein the plurality of carbon particles is concavely shaped;
wherein the rechargeable energy source system is configured to (1) intercalate the plurality of carbon particles with a plurality of lithium ions from an electrolyte, and (2) plate the plurality of lithium ions as lithium metal on a surface of the plurality of carbon particles.

Embodiment 4. A rechargeable energy source system, comprising:
(a) a positive electrode that is substantially free of lithium when the rechargeable energy source system is in a charged state; and
(b) a negative electrode comprising a plurality of carbon particles, wherein the plurality of carbon particles is concavely shaped,
   wherein the rechargeable energy source system is configured to (1) intercalate the plurality of carbon particles with a plurality of lithium ions from an electrolyte, and (2) plate the plurality of lithium ions as lithium metal on a surface of the plurality of carbon particles.

Embodiment 5. A rechargeable energy source system, comprising:
(a) a positive electrode; and
(b) a negative electrode comprising a plurality of carbon particles, wherein the plurality of carbon particles is concavely shaped,
   wherein the rechargeable energy source system is configured to maintain the capacity when the rechargeable energy source system is cycled for at least 200 cycles, and
   wherein the rechargeable energy source system is configured to (1) intercalate the plurality of carbon particles with a plurality of lithium ions from an electrolyte, and (2) plate the plurality of lithium ions as lithium metal on a surface of the plurality of carbon particles.

Embodiment 6. A rechargeable energy source system, comprising:
(a) a positive electrode;
(b) an electrolyte comprising lithium ions; and
(c) a negative electrode comprising lithium metal and a plurality of carbon particles, wherein the plurality of carbon particles is concavely shaped, and wherein the negative electrode comprises an areal capacity of at least 4 mAh/cm²;
   wherein the rechargeable energy source system is configured to (1) intercalate the plurality of carbon particles with a plurality of lithium ions from an electrolyte, and (2) plate the plurality of lithium ions as lithium metal on a surface of the plurality of carbon particles.

Embodiment 7. A rechargeable energy source system, comprising:
(a) a positive electrode; and
(b) a negative electrode comprising a plurality of carbon particles, wherein the plurality of carbon particles comprises a plurality of graphitic nanosheets resembling flower petals and wherein each carbon particle has a diameter of at least 1 μm;
   wherein the rechargeable energy source system is configured to (1) intercalate the plurality of carbon particles with a plurality of lithium ions from an electrolyte, and (2) plate the plurality of lithium ions as lithium metal on a surface of the plurality of carbon particles.

Embodiment 8. A rechargeable energy source system, comprising:
(a) a positive electrode; and
(b) a negative electrode comprising a plurality of carbon particles, wherein the plurality of carbon particles comprises a plurality of graphitic nanosheets resembling flower petals and has a multimodal distribution of sizes;
   wherein the rechargeable energy source system is configured to (1) intercalate the plurality of carbon particles with a plurality of lithium ions from an electrolyte, and (2) plate the plurality of lithium ions as lithium metal on a surface of the plurality of carbon particles.

Embodiment 9. A rechargeable energy source system, comprising:
(a) a positive electrode comprising a transition metal phosphate; and
(b) a negative electrode comprising a plurality of carbon particles, wherein the plurality of carbon particles comprises a plurality of graphitic nanosheets resembling flower petals;
   wherein the rechargeable energy source system is configured to (1) intercalate the plurality of carbon particles with a plurality of lithium ions from an electrolyte, and (2) plate the plurality of lithium ions as lithium metal on a surface of the plurality of carbon particles.

Embodiment 10. A rechargeable energy source system, comprising:
(a) a positive electrode that is substantially free of lithium when the rechargeable energy source system is in a charged state; and
(b) a negative electrode comprising a plurality of carbon particles, wherein the plurality of carbon particles comprises a plurality of graphitic nanosheets resembling flower petals;
   wherein the rechargeable energy source system is configured to (1) intercalate the plurality of carbon particles with a plurality of lithium ions from an electrolyte, and (2) plate the plurality of lithium ions as lithium metal on a surface of the plurality of carbon particles.

Embodiment 11. A rechargeable energy source system, comprising:
(a) a positive electrode; and
(b) a negative electrode comprising a plurality of carbon particles, wherein the plurality of carbon particles comprises a plurality of graphitic nanosheets resembling flower petals;
   wherein the rechargeable energy source system is configured to maintain the capacity when the rechargeable energy source system is cycled for at least 200 cycles, and
   wherein the rechargeable energy source system is configured to (1) intercalate the plurality of carbon particles with a plurality of lithium ions from an electrolyte, and (2) plate the plurality of lithium ions as lithium metal on a surface of the plurality of carbon particles.

Embodiment 12. A rechargeable energy source system, comprising:
(a) a positive electrode;
(b) an electrolyte comprising lithium ions; and
(c) a negative electrode comprising lithium metal and a plurality of carbon particles, wherein the plurality of carbon particles comprises a plurality of graphitic nanosheets resembling flower petals and wherein the negative electrode comprises an areal capacity of at least 4 mAh/cm²;
   wherein the rechargeable energy source system is configured to (1) intercalate the plurality of carbon particles with a plurality of lithium ions from an electrolyte, and (2) plate the plurality of lithium ions as lithium metal on a surface of the plurality of carbon particles.

Embodiment 13. The rechargeable energy source system of any one of Embodiments 1-12, wherein the diameter the plurality of carbon particles is at least 1, 2, 3, 4, 5, 6, 7, 8, or 9 μm.

Embodiment 14. The rechargeable energy source system of any one of Embodiments 1-13, wherein the diameter the plurality of carbon particles is at most 2, 3, 4, 5, 6, 7, 8, 9, or 10 μm.

Embodiment 15. The rechargeable energy source system of any one of Embodiments 1-14, the plurality of carbon particles has a multimodal distribution of sizes.

Embodiment 16. The rechargeable energy source system of Embodiment 15, wherein the multimodal distribution of sizes comprises a bimodal, a trimodal, or a quadmodal distribution.

Embodiment 17. The rechargeable energy source system of any one of Embodiments 1-16, wherein the positive electrode comprises a transition metal phosphate.

Embodiment 18. The rechargeable energy source system of Embodiment 17, wherein the transition metal phosphate comprises LiFePO₄.

Embodiment 19. The rechargeable energy source system of any one of Embodiments 1-18, wherein the positive electrode is substantially free of lithium when the rechargeable energy source system is in a charged state.

Embodiment 20. The rechargeable energy source system of Embodiment 19, wherein the positive electrode comprises vanadium atoms.

Embodiment 21. The rechargeable energy source system of Embodiment 20, wherein the positive electrode comprises VₓO_{y}.

Embodiment 22. The rechargeable energy source system of Embodiment 21, wherein the positive electrode comprises VₓO_{y}F_{z}.

Embodiment 23. The rechargeable energy source system of Embodiment 22, wherein the positive electrode comprises at least one of: V₆O₅F₁₉, V₃OF₁₁, VO₂F, VOF₃, VPO₄F, LiV₃OF₁₁, Mn₃V (PO₄)₆, V₆O₅F₁₉, V₂(PO₄)₃, LiVOF₄, LiV(OF)₂, LiV(OF)₂, MnVP₂(O₄F)₂, V₄O₇F₅, LiV₃CoO₁₀, VPO₅, VFeP₂(O₄F)₂, TiVO₄, LiTiV₃O₁₀, VFeP₂(HO₅)₂, Li₂VOF₅, MnV₄O₁₂, VBO₄, LiV₂P₂(O₄F)₂, LiV₃CrO₈, V₄(OF₃)₃, LiV₄₀₈, V(CO₃)₂, LiV₅O₁₀, VCuO₄, or VCo₃O₈.

Embodiment 24. The rechargeable energy source system of any one of Embodiments 1-23, wherein the negative electrode comprises an areal capacity of at least 4, 6, 8, or 10 mAh/cm².

Embodiment 25. The rechargeable energy source system of any one of Embodiments 1-24, wherein the negative electrode comprises an areal capacity of at most 6, 8, 10, or 12 mAh/cm².

Embodiment 26. The rechargeable energy source system of any one of Embodiments 1-25, wherein the rechargeable energy source system is configured to maintain a cycling efficiency of at least 99%, 99.1%, 99.2%, 99.3%, 99.4%, 99.5%, 99.6%, 99.7%, 99.8%, 99.9%, 99.91%, 99.92%, 99.93%, 99.94%, 99.95%, 99.96%, 99.97%, 99.98%, 99.99% over at least 200, 300, 400, 500, 600, 700, 800, 900, or 1000 cycles when charged and discharged from 2.5 to 3.75 volts at a C-rate of at least 1C and a D-rate of at least 1C.

Embodiment 27. The rechargeable energy source system of any one of Embodiments 1-26, wherein the negative electrode has an intercalation capacity of at least 450, 600, 750, or 900 mAh per gram of active material.

Embodiment 28. The rechargeable energy source system of any one of Embodiments 1-27, wherein the negative electrode has an intercalation capacity of at most 600, 750, 900, or 1000 mAh per gram of active material.

Embodiment 29. The rechargeable energy source system of any one of Embodiments 1-28, wherein the negative electrode has a lithium metal capacity of at least 500, 750, 1000, or 1250 mAh per gram of active material.

Embodiment 30. The rechargeable energy source system of any one of Embodiments 1-29, wherein the negative electrode has a lithium metal capacity of at most 750, 1000, 1250, or 1500 mAh per gram of active material.

Embodiment 31. The rechargeable energy source system of any one of Embodiments 1-30, wherein each carbon particle of the plurality of carbon particles comprises a plurality of indents and a plurality of apexes.

Embodiment 32. The rechargeable energy source system of any one of Embodiments 1-31, wherein the plurality of carbon particles comprises a flower-like surface structure.

Embodiment A1. An electrolyte composition comprising a localized high-concentration electrolyte, wherein the localized high-concentration electrolyte comprises a plurality of solvents and a plurality of lithium salts.

Embodiment A2. The electrolyte composition of Embodiment A1, wherein a solvent of the plurality of solvents comprises an ether.

Embodiment A3. The electrolyte composition of Embodiment A2, wherein the plurality of solvents comprises ethers.

Embodiment A4. The electrolyte composition of any one of Embodiments A1-A3, wherein a solvent of the plurality of solvents comprises a ring.

Embodiment A5. The electrolyte composition of Embodiment A4, wherein the ring comprises a dioxolane ring.

Embodiment A6. The electrolyte composition of any one of Embodiments A1-A5, wherein a solvent of the plurality of solvents comprises an acetal.

Embodiment A7. The electrolyte composition of Embodiment A6, wherein the acetal comprises a heterocyclic acetal.

Embodiment A8. The electrolyte composition of any one of Embodiments A4-A7, wherein the solvent comprises 1,3-Dioxolane (DOL).

Embodiment A9. The electrolyte composition of any one of Embodiments A1-A8, wherein a solvent of the plurality of solvents comprises an alkyl ether.

Embodiment A10. The electrolyte composition of Embodiment A9, wherein the solvent comprises a dialkyl ether.

Embodiment A11. The electrolyte composition of Embodiment A10, wherein the solvent comprises a dimethyl ether (DME).

Embodiment A12. The electrolyte composition of any one of Embodiments A1-A11, wherein a solvent of the plurality of solvents comprises a partially fluorinated alkyl ether.

Embodiment A13. The electrolyte composition of Embodiment A12, wherein the solvent comprises a partially fluorinated dialkyl ether.

Embodiment A14. The electrolyte composition of Embodiment A13, wherein the solvent comprises 1,1,2,2-tetrafluoroethyl-2,2,3,3-tetrafluoropropyl ether (TTE).

Embodiment A15. The electrolyte composition of any one of Embodiments A1-A14, wherein a solvent of the plurality of solvents comprises a fully fluorinated alkyl ether.

Embodiment A16. The electrolyte composition of Embodiment A15, wherein the solvent comprises a fully fluorinated dialkyl ether.

Embodiment A17. The electrolyte composition of any one of Embodiments A1-A16, wherein a lithium salt of the plurality of lithium salts comprises a nitrogen atom.

Embodiment A18. The electrolyte composition of Embodiment A17, wherein at least two lithium salts of the plurality of lithium salts comprises a nitrogen atom.

Embodiment A19. The electrolyte composition of any one of Embodiments A1-A18, wherein a lithium salt of the plurality of lithium salts comprises a non-coordinating anion.

Embodiment A20. The electrolyte composition of Embodiment A19, wherein at least two lithium salts of the plurality of lithium salts comprises a non-coordinating anion.

Embodiment A21. The electrolyte composition of Embodiment A19 or A20, wherein the non-coordinating anion comprises bis(trifluoromethane)sulfonimide (TFSI⁻) or bis(fluorosulfonyl)imide (FSI⁻).

Embodiment A22. The electrolyte composition of any one of Embodiments A1-A21, wherein a lithium salt of the plurality of lithium salts comprises NO₃⁻.

Embodiment A23. The electrolyte composition of any one of Embodiments A1-A22, wherein the plurality of solvents comprises a first solvent, a second solvent, and a third solvent.

Embodiment A24. The electrolyte composition of Embodiment A23, wherein the first solvent comprises from 0.05 to 0.5, from 0.1 to 0.4, or from 0.2 to 0.3 v/v of the plurality of solvents.

Embodiment A25. The electrolyte composition of Embodiment A23 or A24, wherein the second solvent comprises from 0.1 to 0.6, from 0.2 to 0.5, or from 0.3 to 0.4 v/v of the plurality of solvents.

Embodiment A26. The electrolyte composition of any one of Embodiments A23-A25, wherein the third solvent comprises from 0.1 to 0.6, from 0.2 to 0.5, or from 0.3 to 0.4 v/v of the plurality of solvents.

Embodiment A27. The electrolyte composition of any one of Embodiments A23-A26, wherein the first solvent is DOL.

Embodiment A28. The electrolyte composition of any one of Embodiments A23-A27, wherein the second solvent is DME.

Embodiment A29. The electrolyte composition of any one of Embodiments A23-A28, wherein the third solvent is TTE.

Embodiment A30. A rechargeable energy source system comprising the electrolyte composition of any one of Embodiments A1-A29, wherein a cycling efficiency of the rechargeable energy source system is at least 99.9% if measured at a cycling rate of 1C:1D.

Embodiment A31. A rechargeable energy source system comprising the electrolyte composition of any one of Embodiments A1-A29, wherein a capacity retention of the rechargeable energy source system is at least 80% if measured over 1000 cycles with a cycling rate of 1C:1D.

Embodiment A32. The rechargeable energy source system of Embodiment A30 or A31, further comprising a lithium metal negative electrode.

Embodiment A33. The rechargeable energy source system of any one of Embodiments A30-A32, further comprising an LFP positive electrode.

What is claimed is:

1. A rechargeable energy source system, comprising:
a positive electrode comprising:
a transition metal phosphate;
a metal oxide comprising aluminum or vanadium; and
a negative electrode comprising a plurality of carbon particles, wherein the plurality of carbon particles comprises a corrugated surface;
wherein the rechargeable energy source system is configured to (1) intercalate a plurality of lithium ions into the plurality of carbon particles and (2) plate the plurality of lithium ions as lithium metal on the corrugated surface of the plurality of carbon particles from an electrolyte.

2. The rechargeable energy source system of claim 1, wherein the rechargeable energy source system is configured to maintain a cycling efficiency of at least 90% over at least 500 cycles when charged and discharged from 2 to 3.75 volts at a charge rate of at least 1C and a discharge rate of at least 1C.

3. The rechargeable energy source system of claim 2, wherein the rechargeable energy source system is configured to maintain a cycling efficiency of at least 90% over at least 1000 cycles when charged and discharged from 2 to 3.75 volts at a charge rate of at least 1C and a discharge rate of at least 1C.

4. The rechargeable energy source system of claim 3, wherein the rechargeable energy source system is configured to maintain a cycling efficiency of at least 99% over at least 2000 cycles when charged and discharged from 2 to 3.75 volts at a charge rate of at least 1C and a discharge rate of at least 1C.

5. The rechargeable energy source system of claim 3, wherein the rechargeable energy source system is configured to maintain a cycling efficiency of at least 99% over at least 1000 cycles when charged and discharged from 1.75 to 3.75 volts at a charge rate of at least 1C and a discharge rate of at least 1C.

6. The rechargeable energy source system of claim 1, wherein the positive electrode comprises the transition metal phosphate.

7. The rechargeable energy source system of claim 6, wherein the transition metal phosphate comprises FePO₄ or ε-VOPO₄.

8. The rechargeable energy source system of claim 1, wherein the positive electrode comprises the metal oxide.

9. The rechargeable energy source system of claim 8, wherein the metal oxide further comprises nickel.

10. The rechargeable energy source system of claim 9, wherein the metal oxide comprises nickel cobalt aluminum oxide.

11. The rechargeable energy source system of claim 8, wherein the metal oxide comprises ζ-V₂O₅.

12. The rechargeable energy source system of claim 1, wherein the electrolyte comprises an ether.

13. The rechargeable energy source system of claim 12, wherein the electrolyte comprises LiNO₃.

14. The rechargeable energy source system of claim 13, wherein the electrolyte comprises lithium bis(trifluoromethane)sulfonimide (LiTFSI) or lithium bis(fluorosulfonyl)imide (LiFSI).

15. The rechargeable energy source system of claim 1, wherein the electrolyte comprises fluoroethylene carbonate.

16. The rechargeable energy source system of claim 1, wherein the electrolyte comprises a solid state electrolyte.

17. The rechargeable energy source system of claim 16, wherein the solid state electrolyte comprises a ceramic solid state electrolyte.

18. The rechargeable energy source system of claim 17, wherein the ceramic solid state electrolyte comprises a Li⁺ conductivity of at least 2×10⁻³ S/cm.

19. The rechargeable energy source system of claim 18, wherein the electrolyte comprises LiPF₆.

20. The rechargeable energy source system of claim 1, wherein a lithium metal capacity the negative electrode is at least 0.5 mAh/cm².

21. The rechargeable energy source system of claim 20, wherein a lithium metal capacity the negative electrode is at least 1 mAh/cm².

22. The rechargeable energy source system of claim 1, wherein the electrolyte comprises a polymer-ceramic composite electrolyte.

23. A rechargeable energy source system, comprising:
a positive electrode comprising LiFePO₄, ε-VOPO₄, ζ-V₂O₅, or nickel cobalt aluminum oxide; and
a negative electrode comprising a plurality of carbon particles, wherein the plurality of carbon particles comprises a corrugated surface;
wherein the rechargeable energy source system is configured to (1) intercalate a plurality of lithium ions into the plurality of carbon particles and (2) plate the plurality of lithium ions as lithium metal on the corrugated surface of the plurality of carbon particles from an electrolyte, wherein a lithium metal capacity the negative electrode is at least 0.5 mAh/cm², and
wherein the rechargeable energy source system is configured to maintain a cycling efficiency of at least 90% over at least 500 cycles when charged and discharged from 2 to 3.75 volts at a charge rate of at least 1 C and a discharge rate of at least 1 C.
